(19) United States
(12) Patent Application Publication
(10) Pub. No.: US 2014/0045873 A1
(43) Pub. Date: Feb. 13, 2014

(54) NOVEL MICROBIOCIDES

(71) Applicants: Stephan Trah, Stein (CH); Werner Zambach, Stein (CH); Daniel Stierli, Stein (CH); Kurt Nebel, Stein (CH); Andrea Bortolato, Barnet Herts (GB)

(72) Inventors: Stephan Trah, Stein (CH); Werner Zambach, Stein (CH); Daniel Stierli, Stein (CH); Kurt Nebel, Stein (CH); Andrea Bortolato, Barnet Herts (GB)

(73) Assignee: SYNGENTA PARTICIPATIONS AG, Basel (CH)

(21) Appl. No.: 13/884,678

(22) PCT Filed: Nov. 10, 2011
(86) PCT No.: PCT/EP2011/069818

§ 371 Date: May 29, 2013

(30) Foreign Application Priority Data
Nov. 12, 2010 (EP) 10190968.7

(51) Int. Cl. A01N 43/40; A01N 43/90; A01N 43/54

(52) U.S. Cl. CPC A01N 43/40; A01N 43/54; A01N 43/90
USPC 514/274; 546/264; 514/334; 544/333; 514/256; 544/316; 544/296; 546/88; 514/292

(57) ABSTRACT

The present invention provides compounds of formula (I) wherein A¹, A², R¹, D¹, D², Y³ and X are as defined in the claims. The invention further relates to compositions which comprise these compounds and to their use in agriculture or horticulture for controlling or preventing infestation of plants by phytopathogenic microorganisms, preferably fungi.

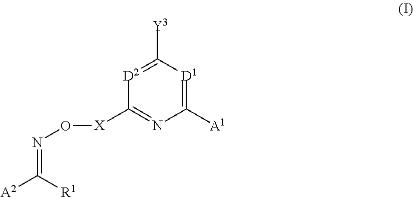

The present invention relates to novel microbiocidally active, in particular fungicidally active, oxime derivatives. It further relates to intermediates used in the preparation of these compounds, to compositions which comprise these compounds and to their use in agriculture or horticulture for controlling or preventing infestation of plants by phytopathogenic microorganisms, preferably fungi.

Fungicidally active bisoximes are described in WO08074418.

Surprisingly, it has been found that novel oxime derivatives have microbiocidal activity.

The present invention accordingly relates to oxime derivatives of formula (I)

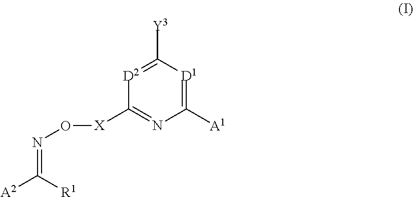

wherein

R¹ represents hydrogen, halogen, CN, SH, C₁-C₈ alkylthio, C₁-C₈ alkylsulphinyl, C₁-C₈ alkylsulphonyl, NH₂, C₁-C₁₀ alkyl, C₃-C₈ cycloalkyl, C₂-C₈ alkenyl, C₂-C₈ alkynyl, (R⁷O)carbonyl(C₁-C₄ alkyl), phenyl or pyridyl, wherein the alkyl, cycloalkyl, alkenyl, alkynyl, phenyl and pyridyl are optionally substituted by one or more groups independently selected from halogen, CN, NH₂, NH—C₁-C₈ alkyl, N(C₁-C₈ alkyl)₂, NO₂, OR⁷, C₁-C₄ alkyl, C₁-C₄ haloalkyl, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms;

A² represents cycle G-1:

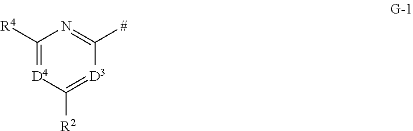

D¹ represents N or C—Y¹;

D² represents N or C—Y²;

wherein both D¹ and D² cannot be N;

D³ represents N or C—R⁶;

D⁴ represents N or C—R⁵;

wherein both D³ and D⁴ cannot be N;

R², R⁴, R⁵ and R⁶ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, COR⁸, OR⁷, SH, C₁-C₈ alkylthio, C₁-C₈ alkylsulphinyl, C₁-C₈ alkylsulphonyl, phenylthio, phenylsulphinyl, phenylsulphonyl, N(R⁹)₂, CO₂R⁷, O(CO)R⁸, CON(R⁹)₂, NR⁹COR⁸ or CR⁸N—OR⁷, wherein the alkyl, cycloalkyl, alkenyl, alkynyl, phenyl and heterocycle are optionally substituted by one or more groups independently selected from halogen, CN, NH₂, NO₂, OR⁷, C₁-C₄ alkyl, C₁-C₄ haloalkyl;

or R⁴ and R⁵, R⁵ and R², or R⁶ and R² together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, and wherein the ring formed by R⁴ and R⁵, R⁵ and R², or R⁶ and R² is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

X represents X-2, X-3, X-4 or X-5:

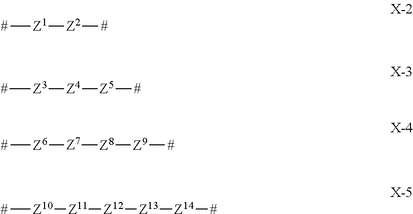

Z¹, Z², Z³, Z⁵, Z⁶, Z⁷, Z⁸, Z⁹, Z¹⁰, Z¹¹, Z¹³ and Z¹⁴ independently of one another represent CR¹⁰R¹¹, C═O or C═CR¹²R¹³;

Z⁴ and Z¹² represent CR¹⁴R¹⁵, SiR¹⁶R¹⁷, C═O or C═CR¹²R¹³;

or in each case two adjacent radicals Z⁴ and Z⁵ or Z⁷ and Z⁸ or Z⁸ and Z⁹ or Z¹¹ and Z¹² or Z¹² and Z¹³ or Z¹³ and Z¹⁴ may together represent a group selected from CR¹⁵═CR¹¹— and —C≡C—, wherein X-4 or X-5 may not contain more than one such group;

each R¹⁰ and R¹¹ independently of one another represent hydrogen, halogen, CN, OH, C₁-C₄ alkyl, C₁-C₄ haloalkyl or phenyl, wherein the phenyl is optionally substituted by one or more groups independently selected from halogen, CN, C₁-C₄ alkyl, C₁-C₄ haloalkyl, C₁-C₄ alkoxy and C₁-C₄ haloalkoxy;

or R¹⁰ and R¹¹ together with the carbon atom to which they are attached may form a C₃-C₆ cycloalkyl group or a C₃-C₆ halocycloalkyl group;

each R¹² and R¹³ independently of one another represent hydrogen, halogen, C₁-C₄ alkyl or C₁-C₄ haloalkyl;

each R¹⁴, R¹⁵, R¹⁶ and R¹⁷ independently of one another represent hydrogen, halogen, CN, OH, C₁-C₄ alkyl, C₁-C₄ haloalkyl, C₁-C₄ alkoxy or phenyl, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;

or R¹⁴ and R¹⁵ together with the carbon atom to which they are attached may form a C₃-C₆ cycloalkyl group or a C₃-C₆ halocycloalkyl group;

wherein the groupings X-2, X-3, X-4 and X-5 contain at most one ring which contains either only one of the radicals Z¹ to Z¹⁴ or two radicals Z¹ to Z¹⁴ or three radicals Z¹ to Z¹⁴ or four radicals Z¹ to Z¹⁴ as ring members; and wherein radicals Z¹, Z³, Z⁶ and Z¹⁰ are not substituted by OH; and wherein none of Z¹, Z², Z³, Z⁴, Z⁵, Z⁶, Z⁷, Z⁸, Z⁹, Z¹⁰, Z¹¹, Z¹², Z¹³ and Z¹⁴ represent a carbon atom substituted by two OH;

Y¹, Y² and Y³ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, COR⁸, OR⁷, SH, C₁-C₈ alkylthio, C₁-C₈ alkylsulphinyl, C₁-C₈ alkylsulphonyl, phenylthio, phenylsulphinyl, phenylsulphonyl, N(R⁹)₂, CO₂R⁷, O(CO)R⁸, CON(R⁹)₂, NR⁹COR⁸ or CR⁸N—OR⁷, wherein the alkyl, cycloalkyl, alkenyl, alkynyl, phenyl, and heterocycle are optionally substituted by one or more groups independently selected from halogen, CN, NH₂, NO₂, OR⁷, C₁-C₄ alkyl and C₁-C₄ haloalkyl;

or Y¹ and Y³, or Y² and Y³ together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, and wherein the ring formed by Y¹ and Y³, or Y² and Y³ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

A¹ represents cycle A-1, A-2, A-3, A-4, A-5, A-6 or A-7:

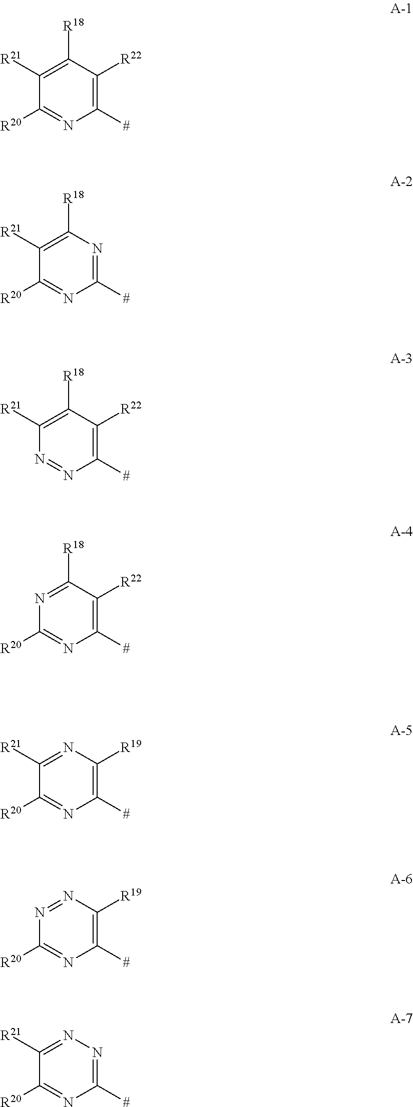

R¹⁸, R¹⁹, R²⁰, R²¹ and R²² independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, benzyl, COR⁸, OR⁷, SH, C₁-C₈ alkylthio, C₁-C₈ alkylsulphinyl, C₁-C₈ alkylsulphonyl, phenylthio, phenylsulphinyl, phenylsulphonyl, N(R⁹)₂, CO₂R⁷, O(CO)R⁸, CON(R⁹)₂, NR⁹COR⁸ or CR⁸N—OR⁷, wherein the alkyl, cycloalkyl, alkenyl, alkynyl, phenyl, heterocycle and benzyl are optionally substituted by one or more groups independently selected from halogen, CN, NH₂, NO₂, OR⁷, C₁-C₄ alkyl, C₁-C₄ haloalkyl;

or R¹⁸ and R²¹, R¹⁸ and R²², or R²⁰ and R²¹ together with the fragment of the ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, and wherein the ring formed by R¹⁸ and R²¹, R¹⁸ and R²², or R²⁰ and R²¹ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

when A¹ is A-1 and D¹ is C—Y¹, then R²² and Y¹ together with the fragment to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, and wherein the ring formed by R²² and Y¹ is optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy and C₁-C₄ alkylthio;

each R⁷ independently of one another represents hydrogen, C₁-C₈ alkyl, C₃-C₈ cycloalkyl, C₃-C₈ alkenyl, C₃-C₈ alkynyl, C₁-C₄ alkylsulphonyl, phenyl, benzyl or a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, wherein the alkyl, cycloalkyl, alkenyl, alkynyl, phenyl, benzyl and heterocycle are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy, C₁-C₄-alkyl-C₁-C₄-alkoxy and C₁-C₄-alkoxy-C₁-C₄-alkyl;

each R⁸ independently of one another represents hydrogen, C₁-C₈ alkyl, C₃-C₈ cycloalkyl, C₂-C₈ alkenyl, C₂-C₈ alkynyl, phenyl, benzyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;

each R⁹ independently of one another represents hydrogen, OH, C₁-C₈ alkyl, C₁-C₈ alkoxy, C₁-C₈-alkoxy-C₁-C₄-alkyl, C₃-C₈ alkenyl, C₃-C₈ alkynyl, or COR⁸, wherein the alkyl, alkoxy, alkenyl and alkynyl are optionally substituted by one or more halogen;

wherein when two radicals R⁹ are attached to the same nitrogen atom, these radicals can be identical or different;

wherein when two radicals R⁹ are attached to the same nitrogen atom, both of these radicals cannot be OH, C₁-C₄ alkoxy or C₁-C₄ haloalkoxy;

and wherein when two radicals R⁹ are attached to the same nitrogen atom, these two radicals together with the nitrogen atom to which they are attached may form a cycle B-1, B-2, B-3, B-4, B-5, B-6, B-7 or B-8:

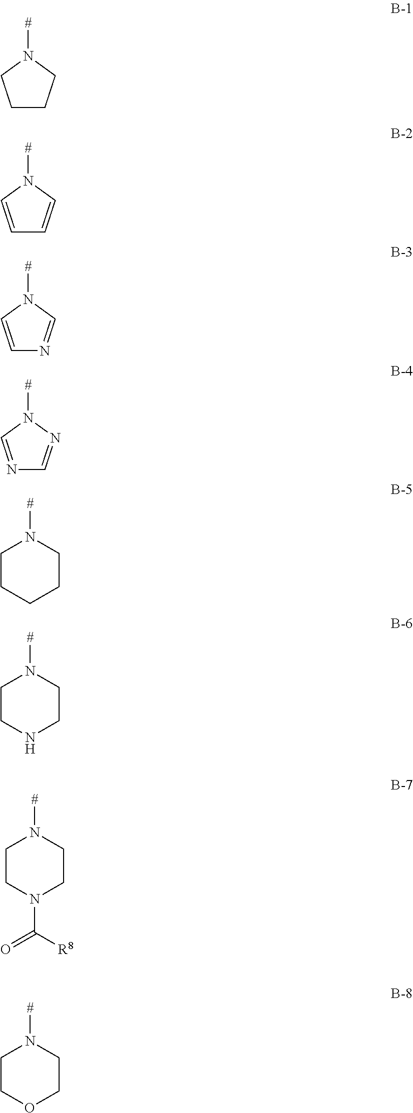

wherein the cycle formed is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy; or a salt or N-oxide thereof.

The invention covers all agronomically acceptable salts, isomers, structural isomers, stereoisomers, diastereoisomers, enantiomers, tautomers, atropisomers and N-oxides of those compounds. The compounds of formula I may exist in different geometric or optical isomeric forms or in different tautomeric forms. One or more centres of chirality may be present, in which case compounds of the formula I may be present as pure enantiomers, mixtures of enantiomers, pure diastereomers or mixtures of diastereomers. There may be double bonds present in the molecule, such as C═C or C═N bonds, in which case compounds of formula I may exist as single isomers or mixtures of isomers. Centres of tautomerisation may be present. This invention covers all such isomers and tautomers and mixtures thereof in all proportions as well as isotopic forms such as deuterated compounds. Also atropisomerism may occur as a result of a restricted rotation about a single bond.

Halogen, either as a lone substituent or in combination with another substituent (e.g. haloalkyl) is generally fluorine, chlorine, bromine or iodine, and usually fluorine, chlorine or bromine.

Each alkyl moiety (including the alkyl moiety of alkoxy, alkylthio, etc.) is a straight or branched chain and, depending on the number of carbon atoms it contains, is, for example, methyl, ethyl, n-propyl, n-butyl, n-pentyl, n-hexyl, iso-propyl, sec-butyl, iso-butyl, tert-butyl, neo-pentyl, n-heptyl or 1,3-dimethylbutyl, and usually methyl or ethyl.

The alkenyl and alkynyl groups can be mono- or di-unsaturated and are examples thereof are derived from the above mentioned alkyl groups.

Haloalkyl moieties are alkyl moieties which are substituted by one or more of the same or different halogen atoms and are, for example, monofluoromethyl, difluoromethyl, trifluoromethyl, monochloromethyl, dichloromethyl, trichloromethyl, 2,2,2-trifluoroethyl, 2,2-difluoroethyl, 2-fluoroethyl, 1,1-difluoroethyl, 1-fluoroethyl, 2-chloroethyl, pentafluoroethyl, 1,1-difluoro-2,2,2-trichloroethyl, 2,2,3,3-tetrafluoroethyl and 2,2,2-trichloroethyl, and typically trichloromethyl, difluorochloromethyl, difluoromethyl, trifluoromethyl and dichlorofluoromethyl.

Alkoxy is, for example, methoxy, ethoxy, propoxy, iso-propoxy, n-butoxy, iso-butoxy, sec-butoxy and tert-butoxy, and usually methoxy or ethoxy.

Haloalkoxy is, for example, fluoromethoxy, difluoromethoxy, trifluoromethoxy, 2,2,2-trifluoroethoxy, 1,1,2,2-tetrafluoroethoxy, 2-fluoroethoxy, 2-chloroethoxy, 2,2-difluoroethoxy and 2,2,2-trichloroethoxy, and usually difluoromethoxy, 2-chloroethoxy and trifluoromethoxy.

Alkylthio is, for example, methylthio, ethylthio, propylthio, iso-propylthio, n-butylthio, iso-butylthio, sec-butylthio or tert-butylthio, and usually methylthio or ethylthio.

Alkylsulphonyl is, for example, methylsulphonyl, ethylsulphonyl, propylsulphonyl, iso-propylsulphonyl, n-butylsulphonyl, iso-butylsulphonyl, sec-butylsulphonyl or tert-butylsulphonyl, and usually methylsulphonyl or ethylsulphonyl.

Alkylsulphinyl is, for example, methylsulphinyl, ethylsulphinyl, propylsulphinyl, iso-propylsulphinyl, n-butylsulphinyl, iso-butylsulphinyl, sec-butylsulphinyl or tert-butylsulphinyl, and usually methylsulphinyl or ethylsulphinyl.

Cycloalkyl may be saturated or partially unsaturated, preferably fully saturated, and is, for example, cyclopropyl, cyclobutyl, cyclopentyl or cyclohexyl.

Alkoxyalkyl is, for example, methoxymethyl, methoxyethyl, ethoxymethyl, ethoxyethyl, n-propoxymethyl, n-propoxyethyl, iso-propoxymethyl or iso-propoxyethyl.

Aryl includes phenyl, naphthyl, anthracyl, fluorenyl and indanyl, but is usually phenyl.

Carbocycle includes cycloalkyl groups and aryl groups.

Heterocycloalkyl is a non-aromatic ring that may be saturated or partially unsaturated, preferably fully saturated, containing carbon atoms as ring members and at least one heteroatom selected from O, S and N as ring members. Examples include oxiranyl, oxetanyl, tetrahydrofuranyl, tetrahydropyranyl, 1,3-dioxolanyl, 1,4-dioxanyl, aziridinyl, azetidinyl, pyrrolidinyl, piperidinyl, oxazinanyl, morpholinyl, thiomorpholinyl, imidazolidinyl, pyrazolidinyl and piperazinyl, preferably morpholinyl, pyrrolidinyl, piperidinyl and piperazinyl, more preferably morpholinyl and pyrollidinyl.

Heteroaryl is, for example, a monovalent monocyclic or bicyclic aromatic hydrocarbon radical. Examples of monocyclic groups include pyridyl, pyridazinyl, pyrimidinyl, pyrazinyl, pyrrolyl, pyrazolyl, imidazolyl, triazolyl, tetrazolyl, furanyl, thiophenyl, oxazolyl, isoxazolyl, oxadiazolyl, thiazolyl, isothiazolyl, and thiadiazolyl. Examples of bicyclic groups include quinolinyl, cinnolinyl, quinoxalinyl, benzimidazolyl, benzothiophenyl, and benzothiadiazolyl. Monocyclic heteroaryl groups are preferred, preferably pyridyl, pyrrolyl, imidazolyl and triazolyl, e.g. 1,2,4 triazolyl, pyridyl and imidazolyl being most preferred.

The terms “heterocycle” and “heterocyclic ring” are used interchangeably and are defined to include heterocycloalkyl and heteroaryl groups. Any reference herein to a heterocycle or heterocyclic ring preferably refers to the specific examples given under the definition of heteroaryl and heterocycloalkyl above, and are preferably morpholinyl, pyrrolidinyl, piperidinyl, piperazinyl pyridyl, pyrrolyl, imidazolyl and triazolyl, e.g. 1,2,4 triazolyl, more preferably morpholinyl, pyrollidinyl, pyridyl and imidazolyl. No heterocycle contains adjacent oxygen atoms, adjacent sulphur atoms, or adjacent oxygen and sulphur atoms.

Where a moiety is indicated as being (optionally) substituted, e.g. alkyl, this includes those moieties where they are part of a larger group, e.g. the alkyl in the alkylthio group. The same applies, e.g. to the phenyl moiety in phenylthio etc. Where a moiety is indicated as being optionally substituted by one or more other groups, preferably there are one to five optional substituents, more preferably one to three optional substituents. Where a moiety is substituted by a cyclic group, e.g. aryl, heteroaryl, cycloalkyl, preferably there are no more than two such substituents, more preferably no more than one such substituent.

The following substituents definitions, including preferred definitions, may be combined in any combination:

R¹ represents hydrogen, halogen, CN, SH, C₁-C₈ alkylthio, C₁-C₈ alkylsulphinyl, C₁-C₈ alkylsulphonyl, NH₂, C₁-C₁₀ alkyl, C₃-C₈ cycloalkyl, C₂-C₈ alkenyl, C₂-C₈ alkynyl, (R⁷O)carbonyl(C₁-C₄ alkyl), phenyl or pyridyl, wherein the alkyl, cycloalkyl, alkenyl, alkynyl, phenyl and pyridyl are optionally substituted by one or more groups, e.g. one to five groups, independently selected from halogen, CN, NH₂, NH—C₁-C₈ alkyl, N(C₁-C₈ alkyl)₂, NO₂, OR⁷, C₁-C₄ alkyl, C₁-C₄ haloalkyl, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms. The heterocycle is preferably one as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl.

Preferably, R¹ represents hydrogen, C₁-C₈ alkyl, C₂-C₈ alkenyl, C₂-C₈ alkynyl, C₃-C₈ cycloalkyl, phenyl, pyridyl, or (R⁷O)carbonyl(C₁-C₄ alkyl), wherein the alkyl, alkenyl, alkynyl, cycloalkyl, phenyl and pyridyl are optionally substituted by one or more groups, e.g. one to five groups, independently selected from halogen, CN, OR⁷, NH₂, NH—C₁-C₈ alkyl, N(C₁-C₈ alkyl)₂, C₁-C₄ alkyl, C₁-C₄ haloalkyl, C₃-C₆ cycloalkyl and pyridyl.

More preferably, R¹ represents hydrogen, C₁-C₄ alkyl, C₂-C₄ alkenyl, phenyl or pyridyl, wherein the alkyl, alkenyl, phenyl and pyridyl are optionally substituted by one or more groups, e.g. one to five groups, independently selected from halogen, CN, OH, NH₂, NH—C₁-C₄ alkyl, N(C₁-C₄ alkyl)₂, C₁-C₄ alkyl, C₁-C₄ haloalkyl, C₁-C₄ alkoxy, C₁-C₄ haloalkoxy and C₃-C₆ cycloalkyl.

Even more preferably, R¹ represents hydrogen or C₁-C₄ alkyl.

Yet more preferably, R¹ represents C₁-C₄ alkyl.

In one preferred group of compounds, R¹ represents C₁-C₄ alkyl, C₂-C₄ alkenyl, phenyl or pyridyl, wherein the alkyl, alkenyl, phenyl and pyridyl are optionally substituted by one or more groups, e.g. one to five groups, independently selected from halogen, CN, C₁-C₄ alkoxy and C₁-C₄ haloalkoxy.

In another preferred group of compounds, R¹ represents hydrogen, C₁-C₄ alkyl, C₁-C₄ haloalkyl, phenyl or pyridin-2-yl, wherein the phenyl and pyridin-2-yl are optionally substituted by one or more groups, e.g. one to five groups, independently selected from halogen, CN, methyl, halomethyl, methoxy and halomethoxy.

In another preferred group of compounds, R¹ represents hydrogen, C₁-C₄ alkyl or C₂-C₄ alkenyl wherein the alkyl and alkenyl are optionally substituted by one or more groups, e.g. one to five groups, independently selected from halogen, CN, methoxy and halomethoxy.

D¹ represents N or C—Y¹;

D² represents N or C—Y²;

wherein both D¹ and D² cannot be N.

Preferably, D¹ represents N or C—Y¹;

D² represents C—Y².

More preferably, D¹ represents C—Y¹;

D² represents C—Y².

D³ represents N or C—R⁶;

D⁴ represents N or C—R⁵;

wherein both D³ and D⁴ cannot be N.

Preferably, D³ represents N or C—R⁶;

D⁴ represents C—R⁵.

More preferably, D³ represents C—R⁶;

D⁴ represents C—R⁵.

In one group of compounds D¹ is N and D² is C—Y².

In another group of compounds D¹ is C—Y¹ and D² is N.

In another group of compounds D¹ is C—Y¹ and D² is C—Y².

In one group of compounds D³ is N and D⁴ is C—R⁵.

In another group of compounds D³ is C—R⁶ and D⁴ is N.

In another group of compounds D³ is C—R⁶ and D⁴ is C—R⁵.

In one group of compounds, D¹ and D³ are N;

D² is C—Y²;

D⁴ is C—Y⁴.

In another group of compounds, D¹ is N;

D² is C—Y²;

D³ is C—Y³;

D⁴ is C—Y⁴.

In another group of compounds, D¹ is C—Y¹;

D² is C—Y²;

D³ is N;

D⁴ is C—Y⁴.

In a more preferred group of compounds, D¹ is C—Y¹;

D² is C—Y²;

D³ is C—Y³;

D⁴ is C—Y⁴.

R², R⁴, R⁵ and R⁶ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms (e.g. a heterocycle as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl), COR⁸, OR⁷, SH, C₁-C₈ alkylthio, C₁-C₈ alkylsulphinyl, C₁-C₈ alkylsulphonyl, phenylthio, phenylsulphinyl, phenylsulphonyl, N(R⁹)₂, CO₂R⁷, O(CO)R⁸, CON(R⁹)₂, NR⁹COR⁸ or CR⁸N—OR⁷, wherein the alkyl, cycloalkyl, alkenyl, alkynyl, phenyl and heterocycle are optionally substituted by one or more groups, e.g. one to five groups, independently selected from halogen, CN, NH₂, NO₂, OR⁷, C₁-C₄ alkyl, C₁-C₄ haloalkyl;

or R⁴ and R⁵, R⁵ and R², or R⁶ and R² together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms (e.g. R⁴ and R⁵, R⁵ and R², or R⁶ and R² together with the fragment of the pyridyl ring to which they are attached may form a ring system selected from isoquinoline; 5,6,7,8-tetrahydro-isoquinoline; 6,7-dihydro-5H-[2]pyrindine; 3,4-dihydro-1H-pyrano[3,4-c]pyridine; 6,7,8,9-tetrahydro-5H-cyclohepta[c]pyridine; [1,7]naphthyridine; quinoline; 5,6,7,8-tetrahydro-quinoline; 6,7-dihydro-5H-[1]pyrindine; [1,8]naphthyridine; 6,7,8,9-tetrahydro-5H-cyclohepta[b]pyridine; and 7,8-dihydro-5H-pyrano[4,3-b]pyridine; these cyclic systems are illustrated below), and wherein the ring formed R⁴ and R⁵, R⁵ and R², or R⁶ and R² is optionally substituted by one or more groups, e.g. one to five groups, independently selected from halogen, CN, NH₂, NO₂, OH, C₁-C₄ alkyl, C₁-C₄ haloalkyl, C₁-C₄ alkoxy and C₁-C₄ haloalkoxy.

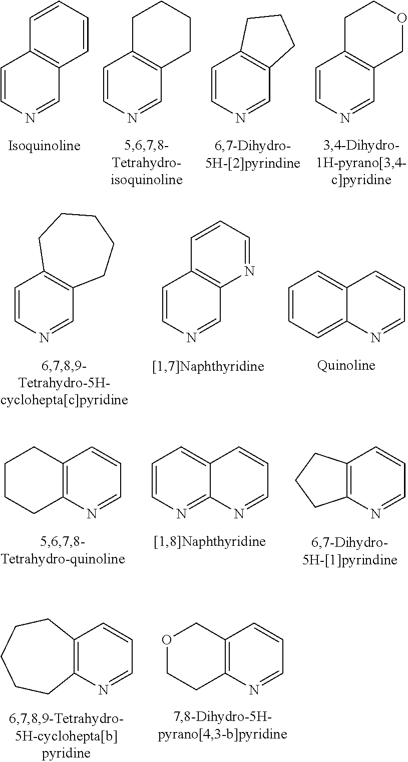

Preferably, R², R⁴, R⁵ and R⁶ independently of one another represent hydrogen, halogen, CN, OR⁷, C₁-C₈ alkyl, C₂-C₈ alkenyl, C₃-C₈ cycloalkyl, phenyl, pyridyl, N(R⁹)₂, CO₂R⁷, NR⁹COR⁸, SH, C₁-C₈ alkylthio, C₁-C₈ alkylsulphinyl, C₁-C₈ alkylsulphonyl, phenylthio, phenylsulphinyl or phenylsulphonyl, wherein the alkyl, alkenyl, cycloalkyl, phenyl and pyridyl are optionally substituted by one or more groups, e.g. one to five groups, independently selected from halogen, CN, OR⁷, C₁-C₄ alkyl and C₁-C₄ haloalkyl;

or R⁴ and R⁵, R⁵ and R², or R⁶ and R², together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms (e.g. R⁴ and R⁵, R⁵ and R², or R⁶ and R² together with the fragment of the pyridyl ring to which they are attached may form a ring system selected from isoquinoline; 5,6,7,8-tetrahydro-isoquinoline; 6,7-dihydro-5H-[2]pyrindine; 3,4-dihydro-1H-pyrano[3,4-c]pyridine; 6,7,8,9-tetrahydro-5H-cyclohepta[c]pyridine; [1,7]naphthyridine; quinoline; 5,6,7,8-tetrahydro-quinoline; 6,7-dihydro-5H-[1]pyrindine; [1,8]naphthyridine; 6,7,8,9-tetrahydro-5H-cyclohepta[b]pyridine; and 7,8-dihydro-5H-pyrano[4,3-b]pyridine), wherein the ring formed by R⁴ and R⁵, R⁵ and R², or R⁶ and R² is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy.

More preferably, R², R⁴, R⁵ and R⁶ independently of one another represent hydrogen, halogen, OR⁷, CN, C₁-C₄ alkyl, C₃-C₆ cycloalkyl, N(R⁹)₂, phenyl, CO₂R⁷ or NR⁹COR⁸, wherein the alkyl, cycloalkyl and phenyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy;

or R⁴ and R⁵, R⁵ and R², or R⁶ and R², together with the fragment of the pyridyl ring to which they are attached may form a fully or partially unsaturated 5- or 6-membered carbocyclic ring (e.g. R⁴ and R⁵, R⁵ and R², or R⁶ and R² together with the fragment of the pyridyl ring to which they are attached may form a ring system selected from isoquinoline; 5,6,7,8-tetrahydro-isoquinoline; quinoline; and 5,6,7,8-tetrahydro-quinoline) optionally substituted by one or more groups, e.g. one to five groups, independently selected from halogen, methyl and halomethyl.

More preferably, R², R⁴, R⁵ and R⁶ independently of one another represent hydrogen, halogen, OH, CN, C₁-C₄ alkyl, C₁-C₄ alkoxy, C₃-C₆ alkenyloxy, C₃-C₆ cycloalkyl, N(R⁹)₂, phenyl or CO₂R⁷, wherein the alkyl, alkoxy, alkenyloxy, cycloalkyl and phenyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy;

or R⁴ and R⁵, R⁵ and R², or R⁶ and R², together with the fragment of the pyridyl ring to which they are attached may form a fully or partially unsaturated 6-membered carbocyclic ring (e.g. R⁴ and R⁵, R⁵ and R², or R⁶ and R² together with the fragment of the pyridyl ring to which they are attached may form a ring system selected from isoquinoline; 5,6,7,8-tetrahydro-isoquinoline; quinoline; and 5,6,7,8-tetrahydro-quinoline) optionally substituted by one or more groups, e.g. one to five groups, independently selected from halogen, methyl and halomethyl.

More preferably, R², R⁴, R⁵ and R⁶ independently of one another represent hydrogen, C₁-C₄ alkyl, CN or C₁-C₄ alkoxy, wherein the alkyl and alkoxy are optionally substituted by one or more groups, e.g. one to five groups, independently selected from halogen, CN, C₁-C₄ alkoxy and C₁-C₄ haloalkoxy.

Even more preferably, R², R⁴, R⁵ and R⁶ independently of one another represent hydrogen, C₁-C₄ alkyl or C₂-C₄ alkenyl wherein the alkyl and alkenyl are optionally substituted by one or more groups, e.g. one to five groups, independently selected from halogen, CN, methoxy and halomethoxy.

In one group of compounds, R², R⁵ and R⁶ independently of one another represent hydrogen or C₁-C₄alkyl.

In this group of compounds, R⁴ preferably represents hydrogen or C₁-C₄alkyl. More preferably R⁴ represents C₁-C₄alkyl, most preferably methyl.

X represents X-2, X-3, X-4 or X-5.

Preferably X represents X-3 or X-5.

More preferably X represents X-3.

Z¹, Z², Z³, Z⁴, Z⁵, Z⁶, Z⁷, Z⁸, Z⁹, Z¹⁰, Z¹¹, Z¹³ and Z¹⁴ independently of one another represent CR¹⁰R¹¹, C═O or C═CR¹²R¹³; preferably CR¹⁰R¹¹ or C═CR¹²R¹³; more preferably CR¹⁰R¹¹.

Z⁴ and Z¹² represent CR¹⁴R¹⁵, SiR¹⁶R¹⁷, C═O or C═CR¹²R¹³; preferably CR¹⁴R¹⁵ or C═CR¹²R¹³; more preferably CR¹⁴R¹⁵.

In each case two adjacent radicals Z⁴ and Z⁵ or Z⁷ and Z⁸ or Z⁸ and Z⁹ or Z¹¹ and Z¹² or Z¹² and Z¹³ or Z¹³ and Z¹⁴ may together represent a group selected from CR¹⁹═CR¹¹— and —C≡C—, wherein X-4 or X-5 may not contain more than one such group.

When X is X-2, preferably one of Z¹ and Z² is methylene or halomethylene, preferably methylene.

When X is X-3, preferably at least two of Z³, Z⁴ and Z⁵ are substituted only by hydrogen or halogen, preferably hydrogen, or Z⁴ and Z⁵ together are —C≡C—, more preferably two of Z³, Z⁴ and Z⁵ are independently methylene or halomethylene, preferably methylene. Preferably, Z³ and Z⁵ are methylene or halomethylene, preferably methylene.

When X is X-4, preferably at least three of Z⁶, Z⁷, Z⁸ and Z⁹ are substituted only by hydrogen or halogen, preferably hydrogen, with the proviso that Z⁷ and Z⁸ or Z⁸ and Z together may be —C≡C—, more preferably at least three of Z⁶, Z⁷, Z⁸ and Z⁹ are independently methylene or halomethylene, preferably methylene.

When X is X-5, preferably at least four of Z¹⁰, Z¹¹, Z¹², Z¹³ and Z¹⁴ are substituted only by hydrogen or halogen, preferably hydrogen, with the proviso that Z¹¹ and Z¹² or Z¹² and Z¹³ or Z¹³ and Z¹⁴ together may be —C≡C—, more preferably four of Z¹⁰, Z¹¹, Z¹², Z¹³ and Z¹⁴ are independently methylene or halomethylene, preferably methylene. Preferably, Z¹⁰, Z¹¹, Z¹³ and Z¹⁴ are independently methylene or halomethylene, preferably methylene.

Wherein radicals Z¹, Z³, Z⁶ and Z¹⁰ are not substituted by OH; and none of Z¹, Z², Z³, Z⁴, Z⁵, Z⁶, Z⁷, Z⁸, Z⁹, Z¹⁰, Z¹¹, Z¹², Z¹³ and Z¹⁴ represent a carbon atom substituted by two OH groups.

Each R¹⁰ and R¹¹ independently of one another represent hydrogen, halogen, CN, OH, C₁-C₄ alkyl, C₁-C₄ haloalkyl or phenyl, wherein the phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy;

or R¹⁰ and R¹¹ together with the carbon atom to which they are attached may form a C₃-C₆ cycloalkyl group or a C₃-C₆ halocycloalkyl group.

Preferably, each R¹⁰ and R¹¹ independently of one another represent hydrogen, halogen, CN, OH, C₁-C₄ alkyl or C₁-C₄ haloalkyl.

More preferably, R¹⁰ and R¹¹ represent hydrogen.

Each R¹² and R¹³ independently of one another represent hydrogen, halogen, C₁-C₄ alkyl or C₁-C₄ haloalkyl.

Preferably, each R¹² and R¹³ independently of one another represent hydrogen, halogen, methyl or halomethyl.

Each R¹⁴ and R¹⁵ independently of one another represent hydrogen, halogen, CN, OH, C₁-C₄ alkyl, C₁-C₄ haloalkyl, C₁-C₄ alkoxy or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy;

or R¹⁴ and R¹⁵ together with the carbon atom to which they are attached may form a C₃-C₆ cycloalkyl group or a C₃-C₆ halocycloalkyl group.

Preferably, each R¹⁴ and R¹⁵ independently of one another represent hydrogen, halogen, CN, OH, C₁-C₄ alkyl, C₁-C₄ haloalkyl, C₁-C₄ alkoxy or phenyl, wherein the phenyl is optionally substituted by one or more groups, e.g. one to five groups, independently selected from halogen, CN, methyl, halomethyl, methoxy and halomethoxy;

or R¹⁴ and R¹⁵ together with the carbon atom to which they are attached may form a C₃-C₆ cycloalkyl group or a C₃-C₆ halocycloalkyl group.

More preferably, R¹⁴ and R¹⁵ represent hydrogen.

Each R¹⁶ and R¹⁷ independently of one another represent hydrogen, halogen, CN, OH, C₁-C₄ alkyl, C₁-C₄ haloalkyl or phenyl, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy.

Preferably, each R¹⁶ and R¹⁷ independently of one another represent hydrogen, halogen, CN, OH, C₁-C₄ alkyl, C₁-C₄ haloalkyl or phenyl, wherein the phenyl is optionally substituted by one or more groups, e.g. one to five groups, independently selected from halogen, CN, methyl, halomethyl, methoxy and halomethoxy.

Y¹, Y² and Y³ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms (e.g. a heterocycle as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl), COR⁸, OR⁷, SH, C₁-C₈ alkylthio, C₁-C₈ alkylsulphinyl, C₁-C₈ alkylsulphonyl, phenylthio, phenylsulphinyl, phenylsulphonyl, N(R⁹)₂, CO₂R⁷, O(CO)R⁸, CON(R⁹)₂, NR⁹COR⁸ or CR⁸N—OR⁷, wherein the alkyl, cycloalkyl, alkenyl, alkynyl, phenyl and heterocycle are optionally substituted by one or more groups, e.g. one to five groups, independently selected from halogen, CN, NH₂, NO₂, OR⁷, C₁-C₄ alkyl and C₁-C₄ haloalkyl;

or Y¹ and Y³, or Y² and Y³ together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms (e.g. Y¹ and Y³, or Y² and Y³ together with the fragment of the pyridyl ring to which they are attached may form a ring system selected from isoquinoline; tetrahydro-isoquinoline; 6,7-dihydro-5H-[2]pyrindine; 3,4-dihydro-1H-pyrano[3,4-c]pyridine; 6,7,8,9-tetrahydro-5H-cyclohepta[c]pyridine; and [1,7]naphthyridine), and wherein the ring formed by Y¹ and Y³, or Y² and Y³ is optionally substituted by one or more groups, e.g. one to five groups, independently selected from halogen, CN, NH₂, NO₂, OH, C₁-C₄ alkyl, C₁-C₄ haloalkyl, C₁-C₄ alkoxy and C₁-C₄ haloalkoxy.

Preferably, Y¹, Y² and Y³ independently of one another represent hydrogen, halogen, CN, OR⁷, C₁-C₈ alkyl, C₂-C₈ alkenyl, C₃-C₈ cycloalkyl, phenyl, pyridyl, N(R⁹)₂, CO₂R⁷, NR⁹COR⁸, SH, C₁-C₈ alkylthio, C₁-C₈ alkylsulphinyl, C₁-C₈ alkylsulphonyl, phenylthio, phenylsulphinyl or phenylsulphonyl, wherein the alkyl, alkenyl, cycloalkyl, phenyl and pyridyl are optionally substituted by one or more groups, e.g. one to five groups, independently selected from halogen, CN, OR⁷, C₁-C₄ alkyl and C₁-C₄ haloalkyl.

More preferably Y¹, Y² and Y³ independently of one another represent hydrogen, halogen, OR⁷, CN, C₁-C₄ alkyl, C₃-C₆ cycloalkyl, N(R⁹)₂, phenyl, CO₂R⁷ or NR⁹COR⁸, wherein the alkyl, cycloalkyl and phenyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy.

More preferably, Y¹, Y², and Y³ independently of one another represent hydrogen, halogen, OH, CN, C₁-C₄ alkyl, C₁-C₄ alkoxy, C₃-C₆ alkenyloxy, C₃-C₆ cycloalkyl, N(R⁹)₂, phenyl or CO₂R⁷, wherein the alkyl, alkoxy, alkenyloxy, cycloalkyl and phenyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy.

More preferably Y¹, Y² and Y³ independently of one another represent hydrogen, halogen, C₁-C₄ alkyl, CN or C₁-C₄ alkoxy, wherein the alkyl and alkoxy are optionally substituted by one or more groups, e.g. one to five groups, independently selected from halogen, CN, C₁-C₄ alkoxy and C₁-C₄ haloalkoxy.

More preferably still Y¹, Y² and Y³ independently of one another represent hydrogen, C₁-C₄ alkyl or C₂-C₄ alkenyl wherein the alkyl and alkenyl are optionally substituted by one or more groups, e.g. one to five groups, independently selected from halogen, CN, methoxy and halomethoxy.

Even more preferably Y¹, Y² and Y³ independently of one another represent hydrogen or C₁-C₄ alkyl.

In one group of compounds Y¹ and Y² independently of one another represent hydrogen, halogen, C₁-C₄ alkyl, CN or C₁-C₄ alkoxy, wherein the alkyl and alkoxy are optionally substituted by one or more groups, e.g. one to five groups, independently selected from halogen, CN, C₁-C₄ alkoxy and C₁-C₄ haloalkoxy and Y³ is as defined according to any of the definitions above.

A¹ represents cycle A-1, A-2, A-3, A-4, A-5, A-6, or A-7:

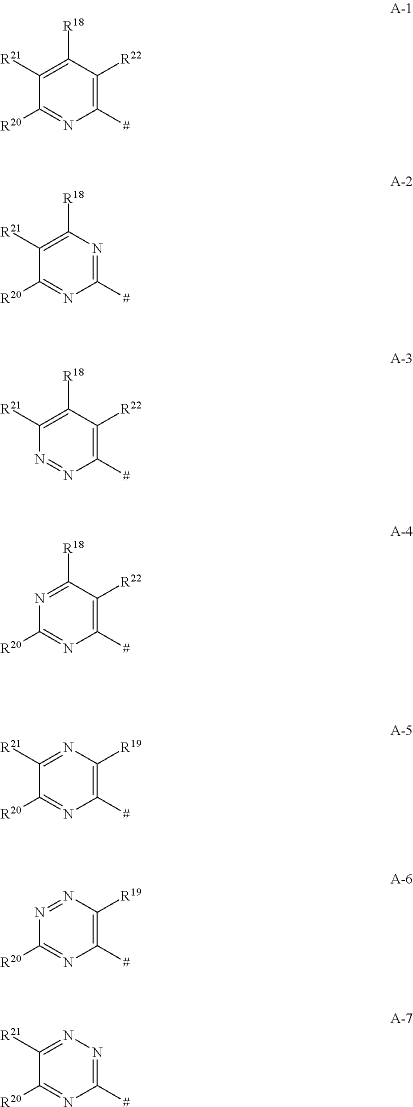

Preferably, A¹ represents cycle A-1, A-2 or A-4.

More preferably, A¹ represents cycle A-1 or A-2.

Even more preferably, A¹ represents cycle A-1.

R¹⁸, R¹⁹, R²⁰, R²¹ and R²² independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms (e.g. a heterocycle as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl), benzyl, COR⁸, OR⁷, SH, C₁-C₈ alkylthio, C₁-C₈ alkylsulphinyl, C₁-C₈ alkylsulphonyl, phenylthio, phenylsulphinyl, phenylsulphonyl, N(R⁹)₂, CO₂R⁷, O(CO)R⁸, CON(R⁹)₂, NR⁹COR⁸ or CR⁸N—OR⁷, wherein the alkyl, cycloalkyl, alkenyl, alkynyl, phenyl, heterocycle and benzyl are optionally substituted by one or more groups, e.g. one to five groups, independently selected from halogen, CN, NH₂, NO₂, OR⁷, C₁-C₄ alkyl, C₁-C₄ haloalkyl;

or R¹⁸ and R²¹, R¹⁸ and R²², or R²⁰ and R²¹ together with the fragment of the ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, (e.g. R¹⁸ and R²¹, R¹⁸ and R²², or R²⁰ and R²¹ together with the fragment of the ring to which they are attached may form a ring system selected from isoquinoline; 5,6,7,8-tetrahydro-isoquinoline; 6,7-dihydro-5H-[2]pyrindine; 3,4-dihydro-1H-pyrano[3,4-c]pyridine; 6,7,8,9-tetrahydro-5H-cyclohepta[c]pyridine; [1,7]naphthyridine; quinoline; 5,6,7,8-tetrahydro-quinoline; 6,7-dihydro-5H-[1]pyrindine; [1,8]naphthyridine; 6,7,8,9-tetrahydro-5H-cyclohepta[b]pyridine; and 7,8-dihydro-5H-pyrano[4,3-b]pyridine), and wherein the ring formed by R¹⁸ and R²¹, R¹⁸ and R²², or R²⁰ and R²¹ is optionally substituted by one or more groups, e.g. one to five groups, independently selected from halogen, CN, NH₂, NO₂, OH, C₁-C₄ alkyl, C₁-C₄ haloalkyl, C₁-C₄ alkoxy and C₁-C₄ haloalkoxy.

Preferably, R¹⁸, R¹⁹, R²⁰, R²¹ and R²² independently of one another represent hydrogen, halogen, CN, OR⁷, C₁-C₈ alkyl, C₂-C₈ alkenyl, C₃-C₈ cycloalkyl, phenyl, pyridyl, benzyl, N(R⁹)₂, CO₂R⁷, NR⁹COR⁸, CR⁸N—OR⁷, SH, C₁-C₈ alkylthio, C₁-C₈ alkylsulphinyl, C₁-C₈ alkylsulphonyl, phenylthio, phenylsulphinyl or phenylsulphonyl, wherein the alkyl, alkenyl, cycloalkyl, phenyl, pyridyl and benzyl are optionally substituted by one or more groups, e.g. one to five groups, independently selected from halogen, CN, OR⁷, C₁-C₄ alkyl and C₁-C₄ haloalkyl.

More preferably, R¹⁸, R¹⁹, R²⁰, R²¹ and R²² independently of one another represent hydrogen, halogen, OR⁷, CN, C₁-C₄ alkyl, C₃-C₆ cycloalkyl, N(R⁹)₂, C₁-C₄ alkylthio, C₁-C₄ alkylsulphinyl, C₁-C₄ alkylsulphonyl, phenyl, benzyl, CO₂R⁷, CR⁸N—OR⁷ or NR⁹COR⁸ wherein the alkyl, cycloalkyl, phenyl and benzyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy.

Yet more preferably R¹⁸ represents hydrogen, halogen, C₁-C₄ alkoxy, C₃-C₆ alkenyloxy, C₃-C₆ alkynyloxy, CN, C₁-C₄ alkyl, NH₂, N(C₁-C₄ alkyl)₂, C₁-C₄ alkylthio, phenyl, benzyl, phenoxy or benzyloxy wherein the alkyl, alkoxy, alkenyloxy, alkynyloxy, phenoxy, benzoxy, phenyl and benzyl are optionally substituted by one or more groups, e.g. one to five groups, independently selected from halogen, CN, methyl, halomethyl, methoxy and halomethoxy.

Yet more preferably R¹⁹ represents hydrogen, halogen, C₁-C₄ alkoxy, C₁-C₄ alkyl.

Even more preferably, R¹⁹ represents hydrogen or C₁-C₄ alkyl.

Yet more preferably R²⁰ represents hydrogen, halogen, OH, C₁-C₄ alkyl, C₃-C₆ cycloalkyl, NH₂, C₁-C₄ alkylthio, phenyl or benzyl wherein the alkyl, cycloalkyl, phenyl and benzyl are optionally substituted by one or more groups, e.g. one to five groups, independently selected from halogen, CN, methyl, halomethyl, methoxy and halomethoxy.

Yet more preferably R²⁰ represents hydrogen, halogen, OH, C₁-C₄ alkyl, C₃-C₆ cycloalkyl, NH₂, C₁-C₄ alkylthio, phenyl or benzyl wherein the alkyl, cycloalkyl, phenyl and benzyl are optionally substituted by one or more groups, e.g. one to five groups, independently selected from halogen, CN, methyl, halomethyl, methoxy and halomethoxy.

Yet more preferably R²¹ represents hydrogen, halogen, OH, C₁-C₄ alkyl, CO₂H, CO₂(C₁-C₄ alkyl), C(C₁-C₄ alkyl)N—O(C₁-C₄ alkyl) or CHN—OH wherein the alkyl, cycloalkyl, phenyl and benzyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy.

Yet more preferably R²² represents hydrogen, halogen, C₁-C₄ alkoxy, C₁-C₄ alkyl.

Even more preferably, R²² represents hydrogen or C₁-C₄ alkyl.

In one group of compounds, R¹⁸, R¹⁹, R²⁰, R²¹ and R²² independently of one another represent hydrogen, halogen, OH, CN, C₁-C₄ alkyl, C₁-C₄ alkoxy, C₃-C₆ alkenyloxy, C₃-C₆ cycloalkyl, N(R⁹)₂, C₁-C₄ alkylthio, C₁-C₄ alkylsulphinyl, C₁-C₄ alkylsulphonyl, phenyl, phenyloxy, benzyl, CR⁸N—OR⁷ or CO₂R⁷, wherein the alkyl, alkoxy, alkenyloxy, cycloalkyl, phenyl and benzyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy.

More preferably in this group of compounds, R¹⁸, R¹⁹, R²⁰, R²¹ and R²² independently of one another represent hydrogen, C₁-C₄ alkyl, CN or C₁-C₄ alkoxy, wherein the alkyl and alkoxy are optionally substituted by one or more groups, e.g. one to five groups, independently selected from halogen, CN, C₁-C₄ alkoxy and C₁-C₄ haloalkoxy.

Each R⁷ independently of one another represents hydrogen, C₁-C₈ alkyl, C₃-C₈ cycloalkyl, C₃-C₈ alkenyl, C₃-C₈ alkynyl, C₁-C₄ alkylsulphonyl, phenyl, benzyl or a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, wherein the alkyl, cycloalkyl, alkenyl, alkynyl, phenyl, benzyl and heterocycle are optionally substituted by one or more groups, e.g. one to five groups, independently selected from halogen, CN, NH₂, NO₂, OH, C₁-C₄ alkyl, C₁-C₄-haloalkyl, C₁-C₄ alkoxy, C₁-C₄ haloalkoxy, C₁-C₄-alkyl-C₁-C₄-alkoxy and C₁-C₄-alkoxy-C₁-C₄-alkyl. The heterocycle is preferably one as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl.

Preferably, each R⁷ independently of one another represents hydrogen, C₁-C₈ alkyl, C₁-C₈ haloalkyl, C₃-C₈ alkenyl, C₃-C₈ alkynyl, C₃-C₈ haloalkenyl, C₃-C₈ haloalkynyl, C₁-C₄ alkylsulphonyl, C₁-C₄ haloalkylsulphonyl, phenyl, benzyl or pyridyl, wherein the phenyl, benzyl and pyridyl are optionally substituted by one or more groups, e.g. one to five groups, independently selected from halogen, CN, NH₂, NO₂, OH, C₁-C₄ alkyl, C₁-C₄-haloalkyl, C₁-C₄ alkoxy and C₁-C₄ haloalkoxy.

More preferably, each R⁷ independently of one another represents hydrogen, C₁-C₈ alkyl, C₁-C₈ haloalkyl, C₃-C₈ alkenyl, C₃-C₈ haloalkenyl, C₃-C₈ alkynyl, C₃-C₈ haloalkynyl, C₁-C₄ alkylsulphonyl, C₁-C₄ haloalkylsulphonyl, phenyl, benzyl, or pyridyl, wherein the phenyl, benzyl and pyridyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy.

More preferably, each R⁷ independently of one another represents hydrogen, C₁-C₄ alkyl or C₁-C₄ haloalkyl.

Each R⁸ independently of one another represents hydrogen, C₁-C₈ alkyl, C₃-C₈ cycloalkyl, C₂-C₈ alkenyl, C₂-C₈ alkynyl, phenyl, benzyl or pyridyl, wherein the alkyl, cycloalkyl, alkenyl, alkynyl, phenyl, benzyl and pyridyl are optionally substituted by one or more groups, e.g. one to five groups, independently selected from halogen, CN, NH₂, NO₂, OH, C₁-C₄ alkyl, C₁-C₄ haloalkyl, C₁-C₄ alkoxy and C₁-C₄ haloalkoxy.

Preferably, each R⁸ independently of one another represents hydrogen, C₁-C₈ alkyl or C₁-C₈ haloalkyl.

More preferably each R⁸ independently of one another represents hydrogen, C₁-C₄ alkyl or C₁-C₄ haloalkyl.

Each R⁹ independently of one another represents hydrogen, OH, C₁-C₈ alkyl, C₁-C₈ alkoxy, C₁-C₈-alkoxy-C₁-C₄-alkyl, C₃-C₈ alkenyl, C₃-C₈ alkynyl, or COR⁸, wherein the alkyl, alkoxy, alkenyl and alkynyl are optionally substituted by one or more halogen; wherein when two radicals R⁹ are attached to the same nitrogen atom, these radicals can be identical or different; wherein when two radicals R⁹ are attached to the same nitrogen atom, both of these radicals cannot be OH, C₁-C₄ alkoxy or C₁-C₄ haloalkoxy; and wherein when two radicals R⁹ are attached to the same nitrogen atom, these two radicals together with the nitrogen atom to which they are attached may form a cycle B-1, B-2, B-3, B-4, B-5, B-6, B-7 or B-8:

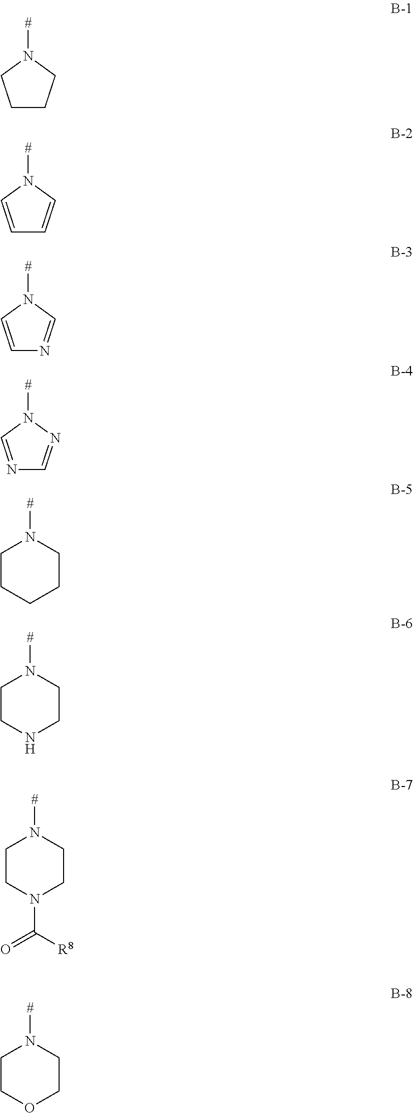

wherein the cycle formed is optionally substituted by one or more groups, e.g. one to five groups, independently selected from halogen, CN, NH₂, NO₂, OH, C₁-C₄ alkyl, C₁-C₄ haloalkyl, C₁-C₄ alkoxy and C₁-C₄ haloalkoxy.

Preferably, each R⁹ independently of one another represents hydrogen, C₁-C₈ alkyl or COR⁸; wherein when two radicals R⁹ are attached to the same nitrogen atom, these radicals can be identical or different; and wherein when two radicals R⁹ are attached to the same nitrogen atom, these two radicals together with the nitrogen atom to which they are attached may form a cycle B-1, B-2, B-3, B-4 or B-5 wherein the cycle formed is optionally substituted by one or more groups, e.g. one to five groups, independently selected from halogen, methyl and halomethyl.

More preferably, each R⁹ independently of one another represents hydrogen or C₁-C₄ alkyl; wherein when two radicals R⁹ are attached to the same nitrogen atom, these radicals can be identical or different; and wherein when two radicals R⁹ are attached to the same nitrogen atom, these two radicals together with the nitrogen atom to which they are attached may form a cycle B-1, B-2, B-3, B-4 or B-5 wherein the cycle formed is optionally substituted by one or more groups, e.g. one to five groups, independently selected from halogen, methyl and halomethyl.

In one preferred group of compounds:

R¹ represents hydrogen, C₁-C₈ alkyl, C₂-C₈ alkenyl, C₂-C₈alkynyl, C₃-C₈ cycloalkyl, phenyl, pyridyl, or (R⁷O)carbonyl(C₁-C₄ alkyl), wherein the alkyl, cycloalkyl, phenyl and pyridyl are optionally substituted by one or more groups independently selected from halogen, CN, OR⁷, NH₂, NH—C₁-C₈ alkyl, N(C₁-C₈ alkyl)₂, C₁-C₄ alkyl, C₁-C₄ haloalkyl, C₃-C₆ cycloalkyl and pyridyl;

D¹ represents N or C—Y¹;

D² represents C—Y²;

D³ represents N or C—R⁶;

D⁴ represents C—R⁵;

R², R⁴, R⁵ and R⁶ independently of one another represent hydrogen, halogen, CN, OR⁷, C₁-C₈ alkyl, C₂-C₈ alkenyl, C₃-C₈ cycloalkyl, phenyl, pyridyl, N(R⁹)₂, CO₂R⁷, NR⁹COR⁸, SH, C₁-C₈ alkylthio, C₁-C₈ alkylsulphinyl, C₁-C₈ alkylsulphonyl, phenylthio, phenylsulphinyl or phenylsulphonyl, wherein the alkyl, alkenyl, cycloalkyl, phenyl and pyridyl are optionally substituted by one or more groups independently selected from halogen, CN, OR⁷, C₁-C₄ alkyl and C₁-C₄ haloalkyl;

or R⁴ and R⁵, R⁵ and R², or R² and R⁶, together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, wherein the ring formed by R⁴ and R⁵, R⁵ and R², or R² and R⁶ is optionally substituted by one or more groups independently selected from halogen, CN, C₁-C₄ alkyl, C₁-C₄ haloalkyl, C₁-C₄ alkoxy and C₁-C₄ haloalkoxy;

X represents X-3 or X-5;

Z³, Z⁵, Z¹⁰, Z¹¹, Z¹³ and Z¹⁴ independently of one another represent CR¹⁰R¹¹ or C═CR¹²R¹³;

Z⁴ and Z¹² represent CR¹⁴R¹⁵ or C═CR¹²R¹³;

or in each case two adjacent radicals Z⁴ and Z⁵ or Z¹¹ and Z¹² or Z¹² and Z¹³ or Z¹³ and Z¹⁴ may together represent a group selected from —CR¹⁰═CR¹¹— and —C≡C—, wherein X-3 or X-5 may not contain more than one such group;

each R¹⁰ and R¹¹ independently of one another represent hydrogen, halogen, CN, OH, C₁-C₄ alkyl or C₁-C₄ haloalkyl;

each R¹² and R¹³ independently of one another represent hydrogen, halogen, C₁-C₄ alkyl or C₁-C₄ haloalkyl;

each R¹⁴ and R¹⁵ independently of one another represent hydrogen, halogen, CN, OH, C₁-C₄ alkyl, C₁-C₄ haloalkyl, C₁-C₄ alkoxy or phenyl, wherein the phenyl is optionally substituted by one or more groups independently selected from halogen, CN, methyl, halomethyl, methoxy and halomethoxy;

or R¹⁴ and R¹⁵ together with the carbon atom to which they are attached may form a C₃-C₆ cycloalkyl group or a C₃-C₆ halocycloalkyl group;

Y¹, Y² and Y³ independently of one another represent hydrogen, halogen, CN, OR⁷, C₁-C₈ alkyl, C₂-C₈ alkenyl, C₃-C₈ cycloalkyl, phenyl, pyridyl, N(R⁹)₂, CO₂R⁷, NR⁹COR⁸, SH, C₁-C₈ alkylthio, C₁-C₈ alkylsulphinyl, C₁-C₈ alkylsulphonyl, phenylthio, phenylsulphinyl or phenylsulphonyl, wherein the alkyl, alkenyl, cycloalkyl, phenyl and pyridyl are optionally substituted by one or more groups independently selected from halogen, CN, OR⁷, C₁-C₄ alkyl and C₁-C₄ haloalkyl;

A¹ represents cycle A-1, A-2, A-3, A-4, A-5, A-6 or A-7;

R¹⁸, R¹⁹, R²⁰, R²¹ and R²² independently of one another represent hydrogen, halogen, CN, OR⁷, C₁-C₈ alkyl, C₂-C₈ alkenyl, C₃-C₈ cycloalkyl, phenyl, pyridyl, benzyl, N(R⁹)₂, CO₂R⁷, NR⁹COR⁸, CR⁸N—OR⁷, SH, C₁-C₈ alkylthio, C₁-C₈ alkylsulphinyl, C₁-C₈ alkylsulphonyl, phenylthio, phenylsulphinyl or phenylsulphonyl, wherein the alkyl, alkenyl, cycloalkyl, phenyl, pyridyl and benzyl are optionally substituted by one or more groups independently selected from halogen, CN, OR⁷, C₁-C₄ alkyl and C₁-C₄ haloalkyl;

each R⁷ independently of one another represents hydrogen, C₁-C₈ alkyl, C₁-C₈ haloalkyl, C₃-C₈ alkenyl, C₃-C₈ haloalkenyl, C₃-C₈ haloalkynyl, C₁-C₄ alkylsulphonyl, C₁-C₄ haloalkylsulphonyl, phenyl, benzyl or pyridyl, wherein the phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy and C₁-C₄ haloalkoxy;

each R⁸ independently of one another represents hydrogen, C₁-C₈ alkyl or C₁-C₈ haloalkyl;

each R⁹ independently of one another represents hydrogen, C₁-C₈ alkyl or COR⁸;

wherein when two radicals R⁹ are attached to the same nitrogen atom, these radicals can be identical or different;

and wherein when two radicals R⁹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

In a more preferred group of compounds:

R¹ represents hydrogen, C₁-C₄ alkyl, C₂-C₄ alkenyl, phenyl or pyridyl, wherein the alkyl, alkenyl, phenyl and pyridyl are optionally substituted by one or more groups independently selected from halogen, CN, OH, NH₂, NH—C₁-C₄ alkyl, N(C₁-C₄ alkyl)₂, C₁-C₄ alkyl, C₁-C₄ haloalkyl, C₁-C₄ alkoxy, C₁-C₄ haloalkoxy and C₃-C₆ cycloalkyl;

D¹ represents N or C—Y¹;

D² represents C—Y²;

D³ represents N or C—R⁶;

D⁴ represents C—R⁵;

R², R⁴, R⁵ and R⁶ independently of one another represent hydrogen, halogen, OR⁷, CN, C₁-C₄ alkyl, C₃-C₆ cycloalkyl, N(R⁹)₂, phenyl, CO₂R⁷ or NR⁹COR⁸, wherein the alkyl, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;

or R⁴ and R⁵, R⁵ and R², or R² and R⁶, together with the fragment of the pyridyl ring to which they are attached may form a fully or partially unsaturated 5- or 6-membered carbocyclic ring, optionally substituted by one or more groups independently selected from halogen, methyl and halomethyl;

X represents X-3;

Z³ and Z⁵ independently of one another represent CR¹⁰R¹¹ or C═CR¹²R¹³;

Z⁴ represents CR¹⁴R¹⁵ or C═CR¹²R¹³;

or Z⁴ and Z⁵ together represent a group selected from —CR¹⁰═CR¹¹— and —C≡C—;

each R¹⁰ and R¹¹ independently of one another represent hydrogen, halogen, CN, OH, C₁-C₄ alkyl or C₁-C₄ haloalkyl;

each R¹² and R¹³ independently of one another represent hydrogen, halogen, C₁-C₄ alkyl or C₁-C₄ haloalkyl;

each R¹⁴ and R¹⁵ independently of one another represent hydrogen, halogen, CN, OH, C₁-C₄ alkyl, C₁-C₄ haloalkyl, C₁-C₄ alkoxy or phenyl, wherein the phenyl is optionally substituted by one or more groups independently selected from halogen, CN, methyl, halomethyl, methoxy and halomethoxy;

or R¹⁴ and R¹⁵ together with the carbon atom to which they are attached may form a C₃-C₆ cycloalkyl group or a C₃-C₆ halocycloalkyl group;

wherein at least two of Z³, Z⁴ and Z⁵ are substituted only by hydrogen or Z⁴ and Z⁵ together represent —C≡C—;

Y¹, Y² and Y³ independently of one another represent hydrogen, halogen, OR⁷, CN, C₁-C₄ alkyl, C₃-C₆ cycloalkyl, N(R⁹)₂, phenyl, CO₂R⁷ or NR⁹COR⁸ wherein the alkyl, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;

A¹ represents cycle A-1, A-2 or A-4;

R¹⁸, R²⁰, R²¹ and R²² independently of one another represent hydrogen, halogen, OR⁷, CN, C₁-C₄ alkyl, C₃-C₆ cycloalkyl, N(R⁹)₂, C₁-C₄ alkylthio, C₁-C₄ alkylsulphinyl, C₁-C₄ alkylsulphonyl, phenyl, benzyl, CO₂R⁷, CR⁸N—OR⁷ or NR⁹COR⁸ wherein the alkyl, cycloalkyl, phenyl and benzyl are optionally substituted by one or more groups independently selected from halogen, CN, C₁-C₄ alkyl, C₁-C₄-haloalkyl, C₁-C₄ alkoxy and C₁-C₄ haloalkoxy;

each R⁷ independently of one another represents hydrogen, C₁-C₈ alkyl, C₁-C₈ haloalkyl, C₃-C₈ alkenyl, C₃-C₈ haloalkenyl, C₃-C₈ alkynyl, C₃-C₈ haloalkynyl, C₁-C₄ alkylsulphonyl, C₁-C₄ haloalkylsulphonyl, phenyl, benzyl, or pyridyl, wherein the phenyl, benzyl and pyridyl are optionally substituted by one or more groups independently selected from halogen, CN, C₁-C₄ alkyl, C₁-C₄-haloalkyl, C₁-C₄ alkoxy and C₁-C₄ haloalkoxy;

each R⁸ independently of one another represents hydrogen, C₁-C₄ alkyl or C₁-C₄ haloalkyl;

each R⁹ independently of one another represents hydrogen or C₁-C₄ alkyl;

wherein when two radicals R⁹ are attached to the same nitrogen atom, these radicals can be identical or different;

and wherein when two radicals R⁹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

In a more preferred group of compounds:

R¹ represents hydrogen, C₁-C₄ alkyl, C₁-C₄ haloalkyl, phenyl or pyridin-2-yl, wherein the phenyl and pyridin-2-yl are optionally substituted by one or more groups independently selected from halogen, CN, methyl, halomethyl, methoxy and halomethoxy;

D¹ represents C—Y¹;

D² represents C—Y²;

D³ represents C—R⁶;

D⁴ represents C—R⁵;

R², R⁴, R⁵ and R⁶ independently of one another represent hydrogen, halogen, OH, CN, C₁-C₄ alkyl, C₁-C₄ alkoxy, C₃-C₆ alkenyloxy, C₃-C₆ cycloalkyl, N(R⁹)₂, phenyl or CO₂R⁷, wherein the alkyl, alkoxy, alkenyloxy, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;

or R⁴ and R⁵, R⁵ and R², or R² and R⁶, together with the fragment of the pyridyl ring to which they are attached may form a fully or partially unsaturated 6-membered carbocyclic ring optionally substituted by one or more groups independently selected from halogen, methyl and halomethyl;

X represents X-3;

Z³ and Z⁵ independently of one another represent CR¹⁰R¹¹ or C═CR¹²R¹³;

Z⁴ represents CR¹⁴R¹⁵ or C═CR¹²R¹³;

or Z⁴ and Z⁵ together represent a group selected from —CR¹⁰═CR¹¹— and —C≡C—;

each R¹⁰ and R¹¹ independently of one another represent hydrogen, halogen, CN, OH, C₁-C₄ alkyl or C₁-C₄ haloalkyl;

each R¹² and R¹³ independently of one another represent hydrogen, halogen, methyl or halomethyl;

each R¹⁴ and R¹⁵ independently of one another represent hydrogen, halogen, CN, OH, C₁-C₄ alkyl, C₁-C₄ haloalkyl, C₁-C₄ alkoxy or phenyl, wherein the phenyl is optionally substituted by one or more groups independently selected from halogen, CN, methyl, halomethyl, methoxy and halomethoxy;

or R¹⁴ and R¹⁵ together with the carbon atom to which they are attached may form a C₃-C₆ cycloalkyl group or a C₃-C₆ halocycloalkyl group;

wherein at least two of Z³, Z⁴ and Z⁵ are substituted only by hydrogen or Z⁴ and Z⁵ together represent —C≡C—;

Y¹, Y², and Y³ independently of one another represent hydrogen, halogen, OH, CN, C₁-C₄ alkyl, C₁-C₄ alkoxy, C₃-C₆ alkenyloxy, C₃-C₆ cycloalkyl, N(R⁹)₂, phenyl or CO₂R⁷, wherein the alkyl, alkoxy, alkenyloxy, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;

A¹ represents cycle A-1, A-2 or A-4;

R¹⁸, R²⁰, R²¹ and R²² independently of one another represent hydrogen, halogen, OH, CN, C₁-C₄ alkyl, C₁-C₄ alkoxy, C₃-C₆ alkenyloxy, C₃-C₆ cycloalkyl, N(R⁹)₂, C₁-C₄ alkylthio, C₁-C₄ alkylsulphinyl, C₁-C₄ alkylsulphonyl, phenyl, phenyloxy, benzyl, benzyloxy, CR⁸N—OR⁷, or CO₂R⁷, wherein the alkyl, alkoxy, alkenyloxy, cycloalkyl, phenyl and benzyl are optionally substituted by one or more groups independently selected from halogen, CN, C₁-C₄ alkyl, C₁-C₄-haloalkyl, C₁-C₄ alkoxy and C₁-C₄ haloalkoxy;

each R⁷ independently or one another represents hydrogen, C₁-C₄ alkyl or C₁-C₄ haloalkyl;

each R⁹ independently of one another represents hydrogen or C₁-C₄ alkyl;

wherein when two radicals R⁹ are attached to the same nitrogen atom, these radicals can be identical or different;

and wherein when two radicals R⁹ are attached to the same nitrogen atom, these two radicals together with the nitrogen atom to which they are attached may form a cycle B-1, B-2, B-3, B-4 or B-5, wherein the cycle formed is optionally substituted by one or more groups independently selected from halogen, methyl and halomethyl.

In a more preferred group of compounds:

R¹ represents hydrogen, C₁-C₄ alkyl, C₁-C₄ haloalkyl, phenyl or pyridin-2-yl, wherein the phenyl and pyridin-2-yl are optionally substituted by one or more groups independently selected from halogen, CN, methyl, halomethyl, methoxy and halomethoxy;

D¹ represents C—Y¹;

D² represents C—Y²;

D³ represents C—R⁶;

D⁴ represents C—R⁵;

R², R⁴, R⁵ and R⁶ independently of one another represent hydrogen, halogen, OH, CN,

C₁-C₄ alkyl, C₁-C₄ alkoxy, C₃-C₆ alkenyloxy, C₃-C₆ cycloalkyl, N(R⁹)₂, phenyl or CO₂R⁷, wherein the alkyl, alkoxy, alkenyloxy, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;

or R⁴ and R⁵, R⁵ and R², or R² and R⁶, together with the fragment of the pyridyl ring to which they are attached may form a fully or partially unsaturated 6-membered carbocyclic ring optionally substituted by one or more groups independently selected from halogen, methyl and halomethyl;

X represents X-3;

Z³ and Z⁵ independently of one another represent CR¹⁰R¹¹ or C═CR¹²R¹³;

Z⁴ represents CR¹⁴R¹⁵ or C═CR¹²R¹³;

or Z⁴ and Z⁵ together represent a group selected from —CR¹⁰═CR¹¹— and —C≡C—;

each R¹⁰ and R¹¹ independently of one another represent hydrogen, halogen, CN, OH, C₁-C₄ alkyl or C₁-C₄ haloalkyl;

each R¹² and R¹³ independently of one another represent hydrogen, halogen, methyl or halomethyl;

each R¹⁴ and R¹⁵ independently of one another represent hydrogen, halogen, CN, OH, C₁-C₄ alkyl, C₁-C₄ haloalkyl, C₁-C₄ alkoxy or phenyl, wherein the phenyl is optionally substituted by one or more groups independently selected from halogen, CN, methyl, halomethyl, methoxy and halomethoxy;

or R¹⁴ and R¹⁵ together with the carbon atom to which they are attached may form a C₃-C₆ cycloalkyl group or a C₃-C₆ halocycloalkyl group;

wherein at least two of Z³, Z⁴ and Z⁵ are substituted only by hydrogen or Z⁴ and Z⁵ together represent —C≡C—;

Y¹, Y², and Y³ independently of one another represent hydrogen, halogen, OH, CN, C₁-C₄ alkyl, C₁-C₄ alkoxy, C₃-C₆ alkenyloxy, C₃-C₆ cycloalkyl, N(R⁹)₂, phenyl or CO₂R⁷, wherein the alkyl, alkoxy, alkenyloxy, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;

A¹ represents cycle A-1, A-2 or A-4;

R¹⁸, R²⁰, R²¹ and R²² independently of one another represent hydrogen, halogen, OH, CN, C₁-C₄ alkyl, C₁-C₄ alkoxy, C₃-C₆ alkenyloxy, C₃-C₆ cycloalkyl, N(R⁹)₂, C₁-C₄ alkylthio, C₁-C₄ alkylsulphinyl, C₁-C₄ alkylsulphonyl, phenyl, phenyloxy, benzyl or CO₂R⁷, wherein the alkyl, alkoxy, alkenyloxy, cycloalkyl, phenyl and benzyl are optionally substituted by one or more groups independently selected from halogen, CN, C₁-C₄ alkyl, C₁-C₄-haloalkyl, C₁-C₄ alkoxy and C₁-C₄ haloalkoxy;

each R⁷ independently or one another represents hydrogen, C₁-C₄ alkyl or C₁-C₄ haloalkyl;

each R⁹ independently of one another represents hydrogen or C₁-C₄ alkyl;

wherein when two radicals R⁹ are attached to the same nitrogen atom, these radicals can be identical or different;

and wherein when two radicals R⁹ are attached to the same nitrogen atom, these two radicals together with the nitrogen atom to which they are attached may form a cycle B-1, B-2, B-3, B-4 or B-5, wherein the cycle formed is optionally substituted by one or more groups independently selected from halogen, methyl and halomethyl.

In one group of compounds R¹ represents pyridyl, optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms. The heterocycle is preferably one as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl.

In another group of compounds A² and R¹ represent pyridin-2-yl, optionally substituted by one or more groups independently selected from halogen, CN, NH₂, NO₂, OH, C₁-C₄-alkyl, C₁-C₄-haloalkyl, C₁-C₄-alkoxy, C₁-C₄-haloalkoxy, C₃-C₆ cycloalkyl and a 5 or 6-membered heterocycle containing one to three heteroatoms independently selected from O, S and N, providing that the heterocycle does not contain adjacent oxygen atoms, adjacent sulphur atoms, or adjacent sulphur and oxygen atoms. The heterocycle is preferably one as defined herein, preferably morpholinyl, pyrrolidinyl, piperidinyl, piperazinyl, pyridyl, pyrrolyl, imidazolyl or triazolyl, e.g. 1,2,4 triazolyl, more preferably morpholinyl, pyrollidinyl, pyridyl or imidazolyl.

In another group of compounds A² and R¹ represent are identical substituents.

In another group of compounds R¹ represents C₁-C₄ alkyl, C₂-C₄ alkenyl, phenyl or pyridyl, wherein the alkyl, alkenyl, phenyl and pyridyl are optionally substituted by one or more groups independently selected from halogen, CN, C₁-C₄ alkoxy and C₁-C₄ haloalkoxy.

In another group of compounds:

X represents X-3;

Z³ and Z⁵ represent methylene;

Z⁴ represents CR¹⁴R¹⁵ or C═CR¹²R¹³;

each R¹² and R¹³ independently of one another represent hydrogen, halogen, methyl or halomethyl;

each R¹⁴ and R¹⁵ independently of one another represent hydrogen, halogen, CN, OH, C₁-C₄ alkyl, C₁-C₄ haloalkyl, C₁-C₄ alkoxy or phenyl, wherein the phenyl is optionally substituted by one or more groups independently selected from halogen, CN, methyl, halomethyl, methoxy and halomethoxy;

or R¹⁴ and R¹⁵ together with the carbon atom to which they are attached may form a C₃-C₆ cycloalkyl group optionally substituted by halogen.

In another group of compounds, when A¹ is A-1 and D¹ is C—Y¹ then R²² and Y¹ together with the fragment to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, and wherein the ring formed by R²² and Y¹ is optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy and C₁-C₄ alkylthio.

Preferably in this group of compounds, R²² and Y¹ together with the fragment to which they are attached may form a partially or fully unsaturated 6-membered carbocyclic ring or a partially or fully unsaturated 6-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, and wherein the ring formed by R²² and Y¹ is optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy and C₁-C₄ alkylthio.

More preferably in this group of compounds, R²² and Y¹ together with the fragment to which they are attached may form a partially or fully unsaturated 6-membered carbocyclic ring or a partially or fully unsaturated 6-membered heterocyclic ring containing one heteroatom independently selected from O, S, N and N(R⁹) wherein the ring formed by R²² and Y¹ is optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy and C₁-C₄ alkylthio.

Yet more preferably in this group of compounds, R²² and Y¹ together with the fragment to which they are attached may form a partially or fully unsaturated 6-membered carbocyclic ring or a partially or fully unsaturated 6-membered heterocyclic ring containing one heteroatom independently selected from N wherein the ring formed by R²² and Y¹ is optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy and C₁-C₄

Yet more preferably still in this group of compounds, R²² and Y¹ together with the fragment to which they are attached may form a partially or fully unsaturated 6-membered carbocyclic ring, wherein the ring formed by R²² and Y¹ is optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy and C₁-C₄ alkylthio.

Even more preferably in this group of compounds, R²² and Y¹ together with the fragment to which they are attached may form a partially or fully unsaturated 6-membered carbocyclic ring, wherein the ring formed by R²² and Y¹ is optionally substituted by one or more groups independently selected from halogen, CN, NH₂, NO₂, OH, methyl, halomethyl, methoxy, halomethoxy and methylthio.

Even more preferably in this group of compounds, R²² and Y¹ together with the fragment to which they are attached may form a fully unsaturated 6-membered carbocyclic ring,

wherein the ring formed by R²² and Y¹ is optionally substituted by one or more groups independently selected from halogen, CN, NH₂, NO₂, OH, methyl, halomethyl, methoxy, halomethoxy and methylthio.

In one group of compounds, R¹ represents C₁-C₄ alkyl;

D¹ is C—Y¹;

D² is C—Y²;

D³ is C—Y³;

D⁴ is C—Y⁴;

R², R⁴, R⁵ and R⁶ independently of one another represent hydrogen, C₁-C₄ alkyl or C₂-C₄ alkenyl wherein the alkyl and alkenyl are optionally substituted by one or more groups, e.g. one to five groups, independently selected from halogen, CN, methoxy and halomethoxy;

X represents X-3;

Z³ and Z⁵ represent CR¹⁰R¹¹;

Z⁴ represents CR¹⁴R¹⁵;

R¹⁰, R¹¹, R¹⁴ and R¹⁵ represent hydrogen;

Y¹, Y² and Y³ independently of one another represent hydrogen or C₁-C₄ alkyl;

A¹ represents cycle A-1 or A-2;

R¹⁸ represents hydrogen, halogen, C₁-C₄ alkoxy, C₃-C₆ alkenyloxy, C₃-C₆ alkynyloxy, CN, C₁-C₄ alkyl, NH₂, N(C₁-C₄ alkyl)₂, C₁-C₄ alkylthio, phenyl, benzyl, phenoxy or benzyloxy wherein the alkyl, alkoxy, alkenyloxy, alkynyloxy, phenoxy, benzoxy, phenyl and benzyl are optionally substituted by one or more groups, e.g. one to five groups, independently selected from halogen, CN, methyl, halomethyl, methoxy and halomethoxy;

R¹⁸, R¹⁹, R²⁰, R²¹ and R²² independently of one another represent hydrogen, halogen, CN, OR⁷, C₁-C₈ alkyl, C₂-C₈ alkenyl, C₃-C₈ cycloalkyl, phenyl, pyridyl, benzyl, N(R⁹)₂, CO₂R⁷, NR⁹COR⁸, CR⁸N—OR⁷, SH, C₁-C₈ alkylthio, C₁-C₈ alkylsulphinyl, C₁-C₈ alkylsulphonyl, phenylthio, phenylsulphinyl or phenylsulphonyl, wherein the alkyl, alkenyl, cycloalkyl, phenyl, pyridyl and benzyl are optionally substituted by one or more groups, e.g. one to five groups, independently selected from halogen, CN, OR⁷, C₁-C₄ alkyl and C₁-C₄ haloalkyl;

each R⁷ independently of one another represents hydrogen, C₁-C₄ alkyl or C₁-C₄ haloalkyl;

each R⁸ independently of one another represents hydrogen, C₁-C₄ alkyl or C₁-C₄ haloalkyl;

each R⁹ independently of one another represents hydrogen or C₁-C₄ alkyl; wherein when two radicals R⁹ are attached to the same nitrogen atom, these radicals can be identical or different; and wherein when two radicals R⁹ are attached to the same nitrogen atom, these two radicals together with the nitrogen atom to which they are attached may form a cycle B-1, B-2, B-3, B-4 or B-5 wherein the cycle formed is optionally substituted by one or more groups, e.g. one to five groups, independently selected from halogen, methyl and halomethyl.

In one group of compounds, R¹ represents C₁-C₄ alkyl;

D¹ is C—Y¹;

D² is C—Y²;

D³ is C—Y³;

D⁴ is C—Y⁴;

R², R⁴, R⁵ and R⁶ independently of one another represent hydrogen, C₁-C₄ alkyl or C₂-C₄ alkenyl wherein the alkyl and alkenyl are optionally substituted by one or more groups, e.g. one to five groups, independently selected from halogen, CN, methoxy and halomethoxy;

X represents X-3;

Z³ and Z⁵ represent CR¹⁰R¹¹;

Z⁴ represents CR¹⁴R¹⁵;

R¹⁰, R¹¹, R¹⁴ and R¹⁵ represent hydrogen;

Y¹, Y² and Y³ independently of one another represent hydrogen or C₁-C₄ alkyl;

A¹ represents cycle A-1 or A-2;

R¹⁸ represents hydrogen, halogen, C₁-C₄ alkoxy, C₃-C₆ alkenyloxy, C₃-C₆ alkynyloxy, CN, C₁-C₄ alkyl, NH₂, N(C₁-C₄ alkyl)₂, C₁-C₄ alkylthio, phenyl, benzyl, phenoxy or benzyloxy wherein the alkyl, alkoxy, alkenyloxy, alkynyloxy, phenoxy, benzoxy, phenyl and benzyl are optionally substituted by one or more groups, e.g. one to five groups, independently selected from halogen, CN, methyl, halomethyl, methoxy and halomethoxy;

R¹⁹ represents hydrogen or C₁-C₄ alkyl;

R²⁰ represents hydrogen, halogen, OH, C₁-C₄ alkyl, C₃-C₆ cycloalkyl, NH₂, C₁-C₄ phenyl or benzyl wherein the alkyl, cycloalkyl, phenyl and benzyl are optionally substituted by one or more groups, e.g. one to five groups, independently selected from halogen, CN, methyl, halomethyl, methoxy and halomethoxy;

R²¹ represents hydrogen, halogen, OH, C₁-C₄ alkyl, CO₂H, CO₂(C₁-C₄ alkyl), C(C₁-C₄ alkyl)N—O(C₁-C₄ alkyl) or CHN—OH wherein the alkyl, cycloalkyl, phenyl and benzyl are optionally substituted by one or more groups, e.g. one to five groups, independently selected from halogen, CN, C₁-C₄ alkyl, C₁-C₄-haloalkyl, C₁-C₄ alkoxy and C₁-C₄ haloalkoxy;

R²² represents hydrogen or C₁-C₄ alkyl.

Intermediates that can be used to prepare compounds of formula (I) also form part of the present invention.

Accordingly, in a further aspect, the invention provides a compound of formula (VII)

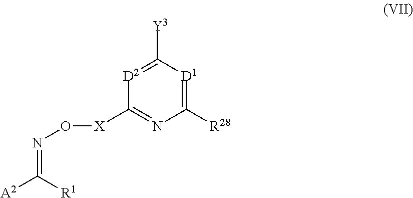

wherein R²⁸ is a halogen and A², R¹, X, D¹, D² and Y³ are as defined herein for compounds of formula (I); or a salt or N-oxide thereof. The preferred definitions of A², R¹, X, D¹, D² and Y³ defined in respect of compounds of formula (I) also apply to compounds of formula (VII). R²⁸ preferably represents chlorine, bromine or iodine.

In a further aspect, the invention provides a compound of formula (IX)

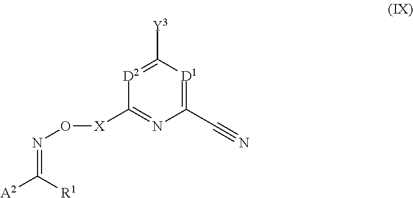

wherein A², R¹, X, D¹, D² and Y³ are as defined herein for a compound of formula (I); or a salt or N-oxide thereof. The preferred definitions of A², R¹, X, D¹, D² and Y³ defined in respect of compounds of formula (I) also apply to compounds of formula (IX).

In a further aspect, the invention provides a compound of formula (X)

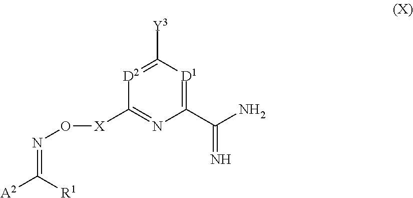

wherein A², R¹, X, D¹, D² and Y³ are as defined for a compound of formula (I); or a salt or N-oxide thereof. The preferred definitions of A², R¹, X, D¹, D² and Y³ defined in respect of compounds of formula (I) also apply to compounds of formula (X).

In a further aspect, the invention provides a compound of formula (XI)

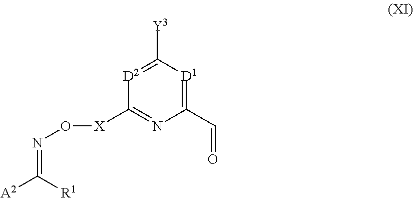

wherein A², R¹, X, D¹, D² and Y³ are as defined for a compound of formula (I); or a salt or N-oxide thereof. The preferred definitions of A², R¹, X, D¹, D² and Y³ defined in respect of compounds of formula (I) also apply to compounds of formula (XI).

In a further aspect, the invention provides a compound of formula (XIII)

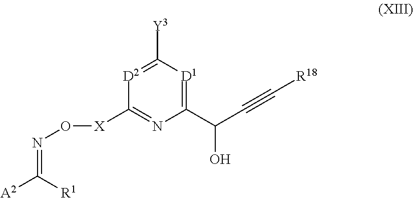

wherein A², R¹, R¹⁸, X, D¹, D² and Y³ are as defined for a compound of formula (I); or a salt or N-oxide thereof. The preferred definitions of A², R¹, R¹⁸, X, D¹, D² and Y³ defined in respect of compounds of formula (I) also apply to compounds of formula (XIII).

In a further aspect, the invention provides a compound of formula (XIV)

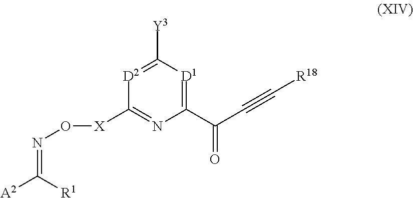

wherein A², R¹, R¹⁸, X, D¹, D² and Y³ are as defined for a compound of formula (I); or a salt or N-oxide thereof. The preferred definitions of A², R¹, R¹⁸, X, D¹, D² and Y³ defined in respect of compounds of formula (I) also apply to compounds of formula (XIV).

The compounds of formula (I) may exist as different geometric or optical isomers or in different tautomeric forms. These may be separated and isolated by well-known (usually chromatographic) techniques, and all such isomers and tautomers and mixtures thereof in all proportions as well as isotopic forms, such as deuterated compounds, are part of the present invention. In particular, the carbon-nitrogen double bonds of the compound of formula (I) allow the cis/trans isomers shown below:

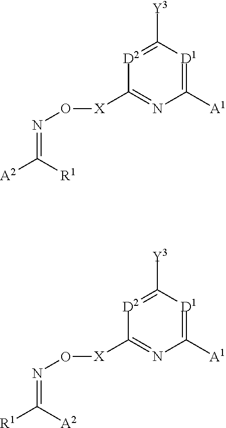

The present invention includes each of these isomers. The invention may provide a compound of formula (I) as just one of these isomers or as a mixture of one or more isomers in any ratio. Likewise, the invention also includes the corresponding isomers of the intermediates described herein, in particular compounds (VII), (IX), (X), (XI), (XIII) and (XIV). In addition, where a reaction scheme depicts synthesis of one geometric isomer, the scheme also includes synthesis of the other geometric isomers where possible. For example reaction scheme A shown below also encompasses reaction scheme B:

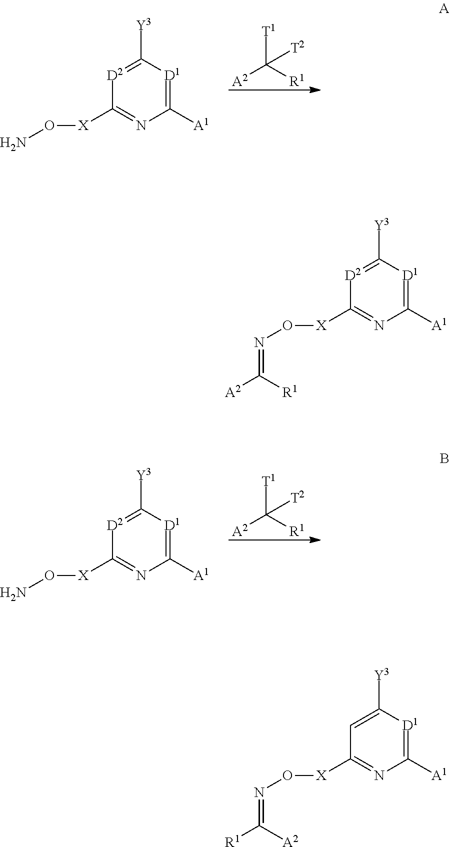

The compounds in tables 1 to 24 illustrate compounds of formula (I). Table X represents Table 1 (when X is 1), Table 2 (when X is 2), Table 3 (when X is 3),

Table 4 (when X is 4), Table 5 (when X is 5), Table 6 (when X is 6), Table 7 (when X is 7), Table 8 (when X is 8), Table 9 (when X is 9), Table 10 (when X is 10), Table 11 (when X is 11), Table 12 (when X is 12), Table 13 (when X is 13), Table 14 (when X is 14) and Table 15 (when X is 15), Table 16 (when X is 16), Table 17 (when X is 17), Table 18 (when X is 18), Table 19 (when X is 19), Table 20 (when X is 20), Table 21 (when X is 21), Table 22 (when X is 22), Table 23 (when X is 23), Table 24 (when X is 24), Table 25 (when X is 25), Table 26 (when X is 26), Table 27 (when X is 27), Table 28 (when X is 28), Table 29 (when X is 29), Table 30 (when X is 30), Table 31 (when X is 31), Table 32 (when X is 32), Table 33 (when X is 33), Table 34 (when X is 34), Table 35 (when X is 35), Table 36 (when X is 36), Table 37 (when X is 37).

| Compound | A² | R¹ | Y¹ | Y² | Y³ |
|---|---|---|---|---|---|
| X.001 | 6-methylpyridin-2-yl | H | CH₃ | H | H |
| X.002 | 6-methylpyridin-2-yl | CH₃ | H | H | H |
| X.003 | 6-methylpyridin-2-yl | CH₃ | H | H | CH₃ |
| X.004 | 6-methylpyridin-2-yl | CH₃ | H | H | CH₂CH₃ |
| X.005 | 6-methylpyridin-2-yl | CH₃ | H | H | CH₂CH(CH₃)₂ |
| X.006 | 6-methylpyridin-2-yl | CH₃ | H | H | CH(CH₃)₂ |
| X.007 | 6-methylpyridin-2-yl | CH₃ | H | H | C(CH₃)₃ |
| X.008 | 6-methylpyridin-2-yl | CH₃ | H | H | cyclopropyl |
| X.009 | 6-methylpyridin-2-yl | CH₃ | H | H | cyclohexyl |
| X.010 | 6-methylpyridin-2-yl | CH₃ | H | H | CH═CH(CH₃) |
| X.011 | 6-methylpyridin-2-yl | CH₃ | H | H | CF₃ |
| X.012 | 6-methylpyridin-2-yl | CH₃ | H | H | CON(CH₃)₂ |
| X.013 | 6-methylpyridin-2-yl | CH₃ | H | H | Br |
| X.014 | 6-methylpyridin-2-yl | CH₃ | H | H | CN |
| X.015 | 6-methylpyridin-2-yl | CH₃ | H | H | OH |
| X.016 | 6-methylpyridin-2-yl | CH₃ | H | H | OCH₃ |
| X.017 | 6-methylpyridin-2-yl | CH₃ | H | H | OCH₂CH₃ |
| X.018 | 6-methylpyridin-2-yl | CH₃ | H | H | OCH(CH₃)₂ |
| X.019 | 6-methylpyridin-2-yl | CH₃ | H | H | OCH₂CH₂CH₃ |
| X.020 | 6-methylpyridin-2-yl | CH₃ | H | H | OCH₂CH═CH₂ |
| X.021 | 6-methylpyridin-2-yl | CH₃ | H | H | OCH₂CH≡CH |
| X.022 | 6-methylpyridin-2-yl | CH₃ | H | H | CH₂OCH₃ |
| X.023 | 6-methylpyridin-2-yl | CH₃ | H | H | CH₂OCH₂CH═CH₂ |
| X.024 | 6-methylpyridin-2-yl | CH₃ | H | H | CH₂OCH₂CH≡CH |
| X.025 | 6-methylpyridin-2-yl | CH₃ | H | H | CH₂OCH₂-phenyl |
| X.026 | 6-methylpyridin-2-yl | CH₃ | H | H | CH₂OCH₂- |
| | | | | | (4-chlorophenyl) |
| X.027 | 6-methylpyridin-2-yl | CH₃ | H | H | NH₂ |
| X.028 | 6-methylpyridin-2-yl | CH₃ | H | H | NH(CH₃) |
| X.029 | 6-methylpyridin-2-yl | CH₃ | H | H | N(CH₃)₂ |
| X.030 | 6-methylpyridin-2-yl | CH₃ | H | H | N(CH₂CH₃)₂ |
| X.031 | 6-methylpyridin-2-yl | CH₃ | H | H | NHCH₂CH═CH₂ |
| X.032 | 6-methylpyridin-2-yl | CH₃ | H | H | NHCH₂-cyclopropyl |
| X.033 | 6-methylpyridin-2-yl | CH₃ | H | H | NHCOCH₃ |
| X.034 | 6-methylpyridin-2-yl | CH₃ | H | H | N(CH₃)COOCH₃ |
| X.035 | 6-methylpyridin-2-yl | CH₃ | H | H | NHCOCH(CH₃)₂ |
| X.036 | 6-methylpyridin-2-yl | CH₃ | H | H | N(COCH₃)₂ |
| X.037 | 6-methylpyridin-2-yl | CH₃ | H | H | NHCOCHCl₂ |
| X.038 | 6-methylpyridin-2-yl | CH₃ | H | H | N(CH₃)COC(CH₃)₃ |
| X.039 | 6-methylpyridin-2-yl | CH₃ | H | H | phenyl |
| X.040 | 6-methylpyridin-2-yl | CH₃ | H | H | 2-CH₃-phenyl |
| X.041 | 6-methylpyridin-2-yl | CH₃ | H | H | 3-F-phenyl |
| X.042 | 6-methylpyridin-2-yl | CH₃ | H | H | 4-Cl-phenyl |
| X.043 | 6-methylpyridin-2-yl | CH₃ | H | H | 2,4-diCl-phenyl |
| X.044 | 6-methylpyridin-2-yl | CH₃ | H | H | 3-CN-phenyl |
| X.045 | 6-methylpyridin-2-yl | CH₃ | H | H | 3-CH₃O-phenyl |
| X.046 | 6-methylpyridin-2-yl | CH₃ | H | H | 4-CH₃O-phenyl |
| X.047 | 6-methylpyridin-2-yl | CH₃ | H | H | 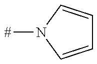 |
| X.048 | 6-methylpyridin-2-yl | CH₃ | H | H | 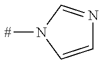 |
| X.049 | 6-methylpyridin-2-yl | CH₃ | H | H | 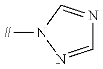 |
| X.050 | 6-methylpyridin-2-yl | CH₃ | H | H | 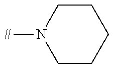 |
| X.051 | 6-methylpyridin-2-yl | CH₃ | H | H | H |
| X.052 | 6-methylpyridin-2-yl | CH₃ | H | H | CH₃ |
| X.053 | 6-methylpyridin-2-yl | CH₃ | H | H | CH₂CH₃ |
| X.054 | 6-methylpyridin-2-yl | CH₃ | H | H | CH₂CH(CH₃)₂ |
| X.055 | 6-methylpyridin-2-yl | CH₃ | H | CH₃ | CH(CH₃)₂ |
| X.056 | 6-methylpyridin-2-yl | CH₃ | H | CH₃ | C(CH₃)₃ |
| X.057 | 6-methylpyridin-2-yl | CH₃ | H | CH₃ | cyclopropyl |
| X.058 | 6-methylpyridin-2-yl | CH₃ | H | CH₃ | cyclohexyl |
| X.059 | 6-methylpyridin-2-yl | CH₃ | H | CH₃ | CH═CH(CH₃) |
| X.060 | 6-methylpyridin-2-yl | CH₃ | H | CH₃ | CF₃ |
| X.061 | 6-methylpyridin-2-yl | CH₃ | H | CH₃ | CON(CH₃)₂ |
| X.062 | 6-methylpyridin-2-yl | CH₃ | H | CH₃ | Br |
| X.063 | 6-methylpyridin-2-yl | CH₃ | H | CH₃ | CN |
| X.064 | 6-methylpyridin-2-yl | CH₃ | H | CH₃ | OH |
| X.065 | 6-methylpyridin-2-yl | CH₃ | H | CH₃ | OCH₃ |
| X.066 | 6-methylpyridin-2-yl | CH₃ | H | CH₃ | OCH₂CH₃ |
| X.067 | 6-methylpyridin-2-yl | CH₃ | H | CH₃ | OCH(CH₃)₂ |
| X.068 | 6-methylpyridin-2-yl | CH₃ | H | CH₃ | OCH₂CH₂CH₃ |
| X.069 | 6-methylpyridin-2-yl | CH₃ | H | CH₃ | OCH₂CH═CH₂ |
| X.070 | 6-methylpyridin-2-yl | CH₃ | H | CH₃ | OCH₂CH≡CH |
| X.071 | 6-methylpyridin-2-yl | CH₃ | H | CH₃ | CH₂OCH₃ |
| X.072 | 6-methylpyridin-2-yl | CH₃ | H | CH₃ | CH₂OCH₂CH═CH₂ |
| X.073 | 6-methylpyridin-2-yl | CH₃ | H | CH₃ | NH₂ |
| X.074 | 6-methylpyridin-2-yl | CH₃ | H | CH₃ | NH(CH₃) |
| X.075 | 6-methylpyridin-2-yl | CH₃ | H | CH₃ | N(CH₃)₂ |
| X.076 | 6-methylpyridin-2-yl | CH₃ | H | CH₃ | N(CH₂CH₃)₂ |
| X.077 | 6-methylpyridin-2-yl | CH₃ | H | CH₃ | NHCH₂CH═CH₂ |
| X.078 | 6-methylpyridin-2-yl | CH₃ | H | CH₃ | NHCH₂-cyclopropyl |
| X.079 | 6-methylpyridin-2-yl | CH₃ | H | CH₃ | NHCOCH₃ |
| X.080 | 6-methylpyridin-2-yl | CH₃ | H | CH₃ | N(CH₃)COCH₃ |
| X.081 | 6-methylpyridin-2-yl | CH₃ | H | CH₃ | NHCOCH(CH₃)₂ |
| X.082 | 6-methylpyridin-2-yl | CH₃ | H | CH₃ | N(COCH₃)₂ |
| X.083 | 6-methylpyridin-2-yl | CH₃ | H | CH₃ | NHCOCHCl₂ |
| X.084 | 6-methylpyridin-2-yl | CH₃ | H | CH₃ | N(CH₃)COC(CH₃)₃ |
| X.085 | 6-methylpyridin-2-yl | CH₃ | H | CH₃ | phenyl |
| X.086 | 6-methylpyridin-2-yl | CH₃ | H | CH₃ | 2-CH₃-phenyl |
| X.087 | 6-methylpyridin-2-yl | CH₃ | H | CH₃ | 3-F-phenyl |
| X.088 | 6-methylpyridin-2-yl | CH₃ | H | CH₃ | 4-Cl-phenyl |
| X.089 | 6-methylpyridin-2-yl | CH₃ | H | CH₃ | 2,4-diCl-phenyl |
| X.090 | 6-methylpyridin-2-yl | CH₃ | H | CH₃ | 3-CN-phenyl |
| X.091 | 6-methylpyridin-2-yl | CH₃ | H | CH₃ | 3-CH₃O-phenyl |
| X.092 | 6-methylpyridin-2-yl | CH₃ | H | CH₃ | 4-CH₃O-phenyl |
| X.093 | 6-methylpyridin-2-yl | CH₃ | H | CH₃ | 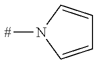 |
| X.094 | 6-methylpyridin-2-yl | CH₃ | H | CH₃ | 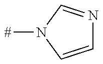 |
| X.095 | 6-methylpyridin-2-yl | CH₃ | H | CH₃ | 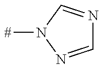 |
| X.096 | 6-methylpyridin-2-yl | CH₃ | H | CH₃ | 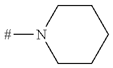 |
| X.097 | 6-methylpyridin-2-yl | CH₃ | CH₃ | H | H |
| X.098 | 6-methylpyridin-2-yl | CH₃ | CH₃ | H | CH₃ |
| X.099 | 6-methylpyridin-2-yl | CH₃ | CH₃ | H | CH₂CH₃ |
| X.100 | 6-methylpyridin-2-yl | CH₃ | CH₃ | H | CH₂CH(CH₃)₂ |
| X.101 | 6-methylpyridin-2-yl | CH₃ | CH₃ | H | CH(CH₃)₂ |
| X.102 | 6-methylpyridin-2-yl | CH₃ | CH₃ | H | C(CH₃)₃ |
| X.103 | 6-methylpyridin-2-yl | CH₃ | CH₃ | H | cyclopropyl |
| X.104 | 6-methylpyridin-2-yl | CH₃ | CH₃ | H | cyclohexyl |
| X.105 | 6-methylpyridin-2-yl | CH₃ | CH₃ | H | CH═CH(CH₃) |
| X.106 | 6-methylpyridin-2-yl | CH₃ | CH₃ | H | CF₃ |
| X.107 | 6-methylpyridin-2-yl | CH₃ | CH₃ | H | CON(CH₃)₂ |
| X.108 | 6-methylpyridin-2-yl | CH₃ | CH₃ | H | Br |
| X.109 | 6-methylpyridin-2-yl | CH₃ | CH₃ | H | CN |
| X.110 | 6-methylpyridin-2-yl | CH₃ | CH₃ | H | OH |
| X.111 | 6-methylpyridin-2-yl | CH₃ | CH₃ | H | OCH₃ |
| X.112 | 6-methylpyridin-2-yl | CH₃ | CH₃ | H | OCH₂CH₃ |
| X.113 | 6-methylpyridin-2-yl | CH₃ | CH₃ | H | OCH(CH₃)₂ |
| X.114 | 6-methylpyridin-2-yl | CH₃ | CH₃ | H | OCH₂CH₂CH₃ |
| X.115 | 6-methylpyridin-2-yl | CH₃ | CH₃ | H | OCH₂CH═CH₂ |
| X.116 | 6-methylpyridin-2-yl | CH₃ | CH₃ | H | OCH₂CH≡CH |
| X.117 | 6-methylpyridin-2-yl | CH₃ | CH₃ | H | CH₂OCH₃ |
| X.118 | 6-methylpyridin-2-yl | CH₃ | CH₃ | H | CH₂OCH₂CH═CH₂ |
| X.119 | 6-methylpyridin-2-yl | CH₃ | CH₃ | H | NH₂ |
| X.120 | 6-methylpyridin-2-yl | CH₃ | CH₃ | H | NH(CH₃) |
| X.121 | 6-methylpyridin-2-yl | CH₃ | CH₃ | H | N(CH₃)₂ |
| X.122 | 6-methylpyridin-2-yl | CH₃ | CH₃ | H | N(CH₂CH₃)₂ |
| X.123 | 6-methylpyridin-2-yl | CH₃ | CH₃ | H | NHCH₂CH═CH₂ |
| X.124 | 6-methylpyridin-2-yl | CH₃ | CH₃ | H | NHCH₂-cyclopropyl |
| X.125 | 6-methylpyridin-2-yl | CH₃ | CH₃ | H | NHCOCH₃ |
| X.126 | 6-methylpyridin-2-yl | CH₃ | CH₃ | H | N(CH₃)COCH₃ |
| X.127 | 6-methylpyridin-2-yl | CH₃ | CH₃ | H | NHCOCH(CH₃)₂ |
| X.128 | 6-methylpyridin-2-yl | CH₃ | CH₃ | H | N(COCH₃)₂ |
| X.129 | 6-methylpyridin-2-yl | CH₃ | CH₃ | H | NHCOCHCl₂ |
| X.130 | 6-methylpyridin-2-yl | CH₃ | CH₃ | H | N(CH₃)COC(CH₃)₃ |
| X.131 | 6-methylpyridin-2-yl | CH₃ | CH₃ | H | phenyl |
| X.132 | 6-methylpyridin-2-yl | CH₃ | CH₃ | H | 2-CH₃-phenyl |
| X.133 | 6-methylpyridin-2-yl | CH₃ | CH₃ | H | 3-F-phenyl |
| X.134 | 6-methylpyridin-2-yl | CH₃ | CH₃ | H | 4-Cl-phenyl |
| X.135 | 6-methylpyridin-2-yl | CH₃ | CH₃ | H | 2,4-diCl-phenyl |
| X.136 | 6-methylpyridin-2-yl | CH₃ | CH₃ | H | 3-CN-phenyl |
| X.137 | 6-methylpyridin-2-yl | CH₃ | CH₃ | H | 3-CH₃O-phenyl |
| X.138 | 6-methylpyridin-2-yl | CH₃ | CH₃ | H | 4-CH₃O-phenyl |
| X.139 | 6-methylpyridin-2-yl | CH₃ | CH₃ | H | 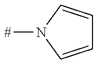 |
| X.140 | 6-methylpyridin-2-yl | CH₃ | CH₃ | H | 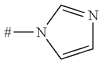 |
| X.141 | 6-methylpyridin-2-yl | CH₃ | CH₃ | H | 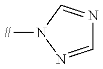 |
| X.142 | 6-methylpyridin-2-yl | CH₃ | CH₃ | C | 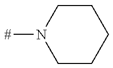 |
| X.143 | 6-methylpyridin-2-yl | CH₃ | H | OCH₃ | H |
| X.144 | 6-methylpyridin-2-yl | CH₃ | H | OCH₃ | CH₃ |
| X.145 | 6-methylpyridin-2-yl | CH₃ | H | OCH₃ | CH₂CH₃ |
| X.146 | 6-methylpyridin-2-yl | CH₃ | H | OCH₃ | cyclopropyl |
| X.147 | 6-methylpyridin-2-yl | CH₃ | H | OCH₃ | CF₃ |
| X.148 | 6-methylpyridin-2-yl | CH₃ | H | OCH₃ | phenyl |
| X.149 | 6-methylpyridin-2-yl | CH₃ | H | OCH₃ | OH |
| X.150 | 6-methylpyridin-2-yl | CH₃ | H | OCH₃ | OCH₃ |
| X.151 | 6-methylpyridin-2-yl | CH₃ | H | OCH₃ | NH(CH₃) |
| X.152 | 6-methylpyridin-2-yl | CH₃ | H | OCH₃ | N(CH₃)₂ |
| X.153 | 6-methylpyridin-2-yl | CH₃ | OCH₃ | H | H |
| X.154 | 6-methylpyridin-2-yl | CH₃ | OCH₃ | H | CH₃ |
| X.155 | 6-methylpyridin-2-yl | CH₃ | OCH₃ | H | CH₂CH₃ |
| X.156 | 6-methylpyridin-2-yl | CH₃ | OCH₃ | H | cyclopropyl |
| X.157 | 6-methylpyridin-2-yl | CH₃ | OCH₃ | H | CF₃ |
| X.158 | 6-methylpyridin-2-yl | CH₃ | OCH₃ | H | phenyl |
| X.159 | 6-methylpyridin-2-yl | CH₃ | OCH₃ | H | OH |
| X.160 | 6-methylpyridin-2-yl | CH₃ | OCH₃ | H | OCH₃ |
| X.161 | 6-methylpyridin-2-yl | CH₃ | OCH₃ | H | NH(CH₃) |
| X.162 | 6-methylpyridin-2-yl | CH₃ | OCH₃ | H | N(CH₃)₂ |
| X.163 | 6-methylpyridin-2-yl | CH₃ | CH₃ | CH₃ | H |
| X.164 | 6-methylpyridin-2-yl | CH₃ | CH₃ | CH₃ | CH₃ |
| X.165 | 6-methylpyridin-2-yl | CH₃ | CH₃ | CH₃ | CH₂CH₃ |
| X.166 | 6-methylpyridin-2-yl | CH₃ | CH₃ | CH₃ | cyclopropyl |
| X.167 | 6-methylpyridin-2-yl | CH₃ | CH₃ | CH₃ | CF₃ |
| X.168 | 6-methylpyridin-2-yl | CH₃ | CH₃ | CH₃ | phenyl |
| X.169 | 6-methylpyridin-2-yl | CH₃ | CH₃ | CH₃ | OH |
| X.170 | 6-methylpyridin-2-yl | CH₃ | CH₃ | CH₃ | OCH₃ |
| X.171 | 6-methylpyridin-2-yl | CH₃ | CH₃ | CH₃ | NH(CH₃) |
| X.172 | 6-methylpyridin-2-yl | CH₃ | CH₃ | CH₃ | N(CH₃)₂ |
| X.173 | 6-methylpyridin-2-yl | CH₃ | N(CH₃)₂ | H | H |
| X.174 | 6-methylpyridin-2-yl | CH₃ | N(CH₃)₂ | H | CH₃ |
| X.175 | 6-methylpyridin-2-yl | CH₃ | N(CH₃)₂ | H | CH₂CH₃ |
| X.176 | 6-methylpyridin-2-yl | CH₃ | N(CH₃)₂ | H | cyclopropyl |
| X.177 | 6-methylpyridin-2-yl | CH₃ | N(CH₃)₂ | H | CF₃ |
| X.178 | 6-methylpyridin-2-yl | CH₃ | N(CH₃)₂ | H | phenyl |
| X.179 | 6-methylpyridin-2-yl | CH₃ | N(CH₃)₂ | H | OH |
| X.180 | 6-methylpyridin-2-yl | CH₃ | N(CH₃)₂ | H | OCH₃ |
| X.181 | 6-methylpyridin-2-yl | CH₃ | H | N(CH₃)₂ | H |
| X.182 | 6-methylpyridin-2-yl | CH₃ | H | N(CH₃)₂ | CH₃ |
| X.183 | 6-methylpyridin-2-yl | CH₃ | H | N(CH₃)₂ | CH₂CH₃ |
| X.184 | 6-methylpyridin-2-yl | CH₃ | H | N(CH₃)₂ | cyclopropyl |
| X.185 | 6-methylpyridin-2-yl | CH₃ | H | N(CH₃)₂ | CF₃ |
| X.186 | 6-methylpyridin-2-yl | CH₃ | H | N(CH₃)₂ | phenyl |
| X.187 | 6-methylpyridin-2-yl | CH₃ | H | N(CH₃)₂ | OH |
| X.188 | 6-methylpyridin-2-yl | CH₃ | H | N(CH₃)₂ | OCH₃ |
| X.189 | 6-methylpyridin-2-yl | CH₃ | OH | H | H |
| X.190 | 6-methylpyridin-2-yl | CH₃ | OCH₂CH₃ | H | H |
| X.191 | 6-methylpyridin-2-yl | CH₃ | OCH(CH₃)₂ | H | H |
| X.192 | 6-methylpyridin-2-yl | CH₃ | OCH₂CH₂CH₃ | H | H |
| X.193 | 6-methylpyridin-2-yl | CH₃ | OCH₂CH═CH₂ | H | H |
| X.194 | 6-methylpyridin-2-yl | CH₃ | OCH₂CH≡CH | H | H |
| X.195 | 6-methylpyridin-2-yl | CH₃ | H | OH | H |
| X.196 | 6-methylpyridin-2-yl | CH₃ | H | OCH₂CH₃ | H |
| X.197 | 6-methylpyridin-2-yl | CH₃ | H | OCH(CH₃)₂ | H |
| X.198 | 6-methylpyridin-2-yl | CH₃ | H | OCH₂CH₂CH₃ | H |
| X.199 | 6-methylpyridin-2-yl | CH₃ | H | OCH₂CH═CH₂ | H |
| X.200 | 6-methylpyridin-2-yl | CH₃ | H | OCH₂CH≡CH | H |
| X.201 | 4,6-dimethyl- | H | CH₃ | H | H |
| | pyridin-2-yl | | | | |
| X.202 | 4,6-dimethyl- | CH₃ | H | H | H |
| | pyridin-2-yl | | | | |
| X.203 | 4,6-dimethyl- | CH₃ | H | H | CH₃ |
| | pyridin-2-yl | | | | |
| X.204 | 4,6-dimethyl- | CH₃ | H | H | CH₂CH₃ |
| | pyridin-2-yl | | | | |
| X.205 | 4,6-dimethyl- | CH₃ | H | H | CH₂CH(CH₃)₂ |
| | pyridin-2-yl | | | | |
| X.206 | 4,6-dimethyl- | CH₃ | H | H | CH(CH₃)₂ |
| | pyridin-2-yl | | | | |
| X.207 | 4,6-dimethyl- | CH₃ | H | H | C(CH₃)₃ |
| | pyridin-2-yl | | | | |
| X.208 | 4,6-dimethyl- | CH₃ | H | H | cyclopropyl |
| | pyridin-2-yl | | | | |
| X.209 | 4,6-dimethyl- | CH₃ | H | H | cyclohexyl |
| | pyridin-2-yl | | | | |
| X.210 | 4,6-dimethyl- | CH₃ | H | H | CH═CH(CH₃) |
| | pyridin-2-yl | | | | |
| X.211 | 4,6-dimethyl- | CH₃ | H | H | CF₃ |
| | pyridin-2-yl | | | | |
| X.212 | 4,6-dimethyl- | CH₃ | H | H | CON(CH₃)₂ |
| | pyridin-2-yl | | | | |
| X.213 | 4,6-dimethyl- | CH₃ | H | H | Br |
| | pyridin-2-yl | | | | |
| X.214 | 4,6-dimethyl- | CH₃ | H | H | CN |
| | pyridin-2-yl | | | | |
| X.215 | 4,6-dimethyl- | CH₃ | H | H | OH |
| | pyridin-2-yl | | | | |
| X.216 | 4,6-dimethyl- | CH₃ | H | H | OCH₃ |
| | pyridin-2-yl | | | | |
| X.217 | 4,6-dimethyl- | CH₃ | H | H | OCH₂CH₃ |
| | pyridin-2-yl | | | | |
| X.218 | 4,6-dimethyl- | CH₃ | H | H | OCH(CH₃)₂ |
| | pyridin-2-yl | | | | |
| X.219 | 4,6-dimethyl- | CH₃ | H | H | OCH₂CH₂CH₃ |
| | pyridin-2-yl | | | | |
| X.220 | 4,6-dimethyl- | CH₃ | H | H | OCH₂CH═CH₂ |
| | pyridin-2-yl | | | | |
| X.221 | 4,6-dimethyl- | CH₃ | H | H | OCH₂CH≡CH |
| | pyridin-2-yl | | | | |
| X.222 | 4,6-dimethyl- | CH₃ | H | H | CH₂OCH₃ |
| | pyridin-2-yl | | | | |
| X.223 | 4,6-dimethyl- | CH₃ | H | H | CH₂OCH₂CH═CH₂ |
| | pyridin-2-yl | | | | |
| X.224 | 4,6-dimethyl- | CH₃ | H | H | CH₂OCH₂CH≡CH |
| | pyridin-2-yl | | | | |
| X.225 | 4,6-dimethyl- | CH₃ | H | H | CH₂OCH₂-phenyl |
| | pyridin-2-yl | | | | |
| X.226 | 4,6-dimethyl- | CH₃ | H | H | CH₂OCH₂- |
| | pyridin-2-yl | | | | (4-chlorophenyl) |
| X.227 | 4,6-dimethyl- | CH₃ | H | H | NH₂ |
| | pyridin-2-yl | | | | |
| X.228 | 4,6-dimethyl- | CH₃ | H | H | NH(CH₃) |
| | pyridin-2-yl | | | | |
| X.229 | 4,6-dimethyl- | CH₃ | H | H | N(CH₃)₂ |
| | pyridin-2-yl | | | | |
| X.230 | 4,6-dimethyl- | CH₃ | H | H | N(CH₂CH₃)₂ |
| | pyridin-2-yl | | | | |
| X.231 | 4,6-dimethyl- | CH₃ | H | H | NHCH₂CH═CH₂ |
| | pyridin-2-yl | | | | |
| X.232 | 4,6-dimethyl- | CH₃ | H | H | NHCH₂-cyclopropyl |
| | pyridin-2-yl | | | | |
| X.233 | 4,6-dimethyl- | CH₃ | H | H | NHCOCH₃ |
| | pyridin-2-yl | | | | |
| X.234 | 4,6-dimethyl- | CH₃ | H | H | N(CH₃)COCH3 |
| | pyridin-2-yl | | | | |
| X.235 | 4,6-dimethyl- | CH₃ | H | H | NHCOCH(CH₃)₂ |
| | pyridin-2-yl | | | | |
| X.236 | 4,6-dimethyl- | CH₃ | H | H | N(COCH₃)₂ |
| | pyridin-2-yl | | | | |
| X.237 | 4,6-dimethyl- | CH₃ | H | H | NHCOCHCl₂ |
| | pyridin-2-yl | | | | |
| X.238 | 4,6-dimethyl- | CH₃ | H | H | N(CH₃)COC(CH₃)₃ |
| | pyridin-2-yl | | | | |
| X.239 | 4,6-dimethyl- | CH₃ | H | H | phenyl |
| | pyridin-2-yl | | | | |
| X.240 | 4,6-dimethyl- | CH₃ | H | H | 2-CH₃-phenyl |
| | pyridin-2-yl | | | | |
| X.241 | 4,6-dimethyl- | CH₃ | H | H | 3-F-phenyl |
| | pyridin-2-yl | | | | |
| X.242 | 4,6-dimethyl- | CH₃ | H | H | 4-Cl-phenyl |
| | pyridin-2-yl | | | | |
| X.243 | 4,6-dimethyl- | CH₃ | H | H | 2,4-diCl-phenyl |
| | pyridin-2-yl | | | | |
| X.244 | 4,6-dimethyl- | CH₃ | H | H | 3-CN-phenyl |
| | pyridin-2-yl | | | | |
| X.245 | 4,6-dimethyl- | CH₃ | H | H | 3-CH₃O-phenyl |
| | pyridin-2-yl | | | | |
| X.246 | 4,6-dimethyl- | CH₃ | H | H | 4-CH₃O-phenyl |
| | pyridin-2-yl | | | | |
| X.247 | 4,6-dimethyl- pyridin-2-yl | CH₃ | H | H | 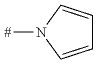 |
| X.248 | 4,6-dimethyl- pyridin-2-yl | CH₃ | H | H | 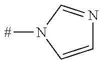 |
| X.249 | 4,6-dimethyl- pyridin-2-yl | CH₃ | H | H | 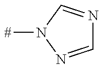 |
| X.250 | 4,6-dimethyl- pyridin-2-yl | CH₃ | H | H | 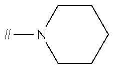 |
| X.251 | 4,6-dimethyl- | CH₃ | H | CH₃ | H |
| | pyridin-2-yl | | | | |
| X.252 | 4,6-dimethyl- | CH₃ | H | CH₃ | CH₃ |
| | pyridin-2-yl | | | | |
| X.253 | 4,6-dimethyl- | CH₃ | H | CH₃ | CH₂CH₃ |
| | pyridin-2-yl | | | | |
| X.254 | 4,6-dimethyl- | CH₃ | H | CH₃ | CH₂CH(CH₃)₂ |
| | pyridin-2-yl | | | | |
| X.255 | 4,6-dimethyl- | CH₃ | H | CH₃ | CH(CH₃)₂ |
| | pyridin-2-yl | | | | |
| X.256 | 4,6-dimethyl- | CH₃ | H | CH₃ | C(CH₃)₃ |
| | pyridin-2-yl | | | | |
| X.257 | 4,6-dimethyl- | CH₃ | H | CH₃ | cyclopropyl |
| | pyridin-2-yl | | | | |
| X.258 | 4,6-dimethyl- | CH₃ | H | CH₃ | cyclohexyl |
| | pyridin-2-yl | | | | |
| X.259 | 4,6-dimethyl- | CH₃ | H | CH₃ | CH═CH(CH₃) |
| | pyridin-2-yl | | | | |
| X.260 | 4,6-dimethyl- | CH₃ | H | CH₃ | CF₃ |
| | pyridin-2-yl | | | | |
| X.261 | 4,6-dimethyl- | CH₃ | H | CH₃ | CON(CH₃)₂ |
| | pyridin-2-yl | | | | |
| X.262 | 4,6-dimethyl- | CH₃ | H | CH₃ | Br |
| | pyridin-2-yl | | | | |
| X.263 | 4,6-dimethyl- | CH₃ | H | CH₃ | CN |
| | pyridin-2-yl | | | | |
| X.264 | 4,6-dimethyl- | CH₃ | H | CH₃ | OH |
| | pyridin-2-yl | | | | |
| X.265 | 4,6-dimethyl- | CH₃ | H | CH₃ | OCH₃ |
| | pyridin-2-yl | | | | |
| X.266 | 4,6-dimethyl- | CH₃ | H | CH₃ | OCH₂CH₃ |
| | pyridin-2-yl | | | | |
| X.267 | 4,6-dimethyl- | CH₃ | H | CH₃ | OCH(CH₃)₂ |
| | pyridin-2-yl | | | | |
| X.268 | 4,6-dimethyl- | CH₃ | H | CH₃ | OCH₂CH₂CH₃ |
| | pyridin-2-yl | | | | |
| X.269 | 4,6-dimethyl- | CH₃ | H | CH₃ | OCH₂CH═CH₂ |
| | pyridin-2-yl | | | | |
| X.270 | 4,6-dimethyl- | CH₃ | H | CH₃ | OCH₂CH≡CH |
| | pyridin-2-yl | | | | |
| X.271 | 4,6-dimethyl- | CH₃ | H | CH₃ | CH₂OCH₃ |
| | pyridin-2-yl | | | | |
| X.272 | 4,6-dimethyl- | CH₃ | H | CH₃ | CH₂OCH₂CH═CH₂ |
| | pyridin-2-yl | | | | |
| X.273 | 4,6-dimethyl- | CH₃ | H | CH₃ | NH₂ |
| | pyridin-2-yl | | | | |
| X.274 | 4,6-dimethyl- | CH₃ | H | CH₃ | NH(CH₃) |
| | pyridin-2-yl | | | | |
| X.275 | 4,6-dimethyl- | CH₃ | H | CH₃ | N(CH₃)₂ |
| | pyridin-2-yl | | | | |
| X.276 | 4,6-dimethyl- | CH₃ | H | CH₃ | N(CH₂CH₃)₂ |
| | pyridin-2-yl | | | | |
| X.277 | 4,6-dimethyl- | CH₃ | H | CH₃ | NHCH₂CH═CH₂ |
| | pyridin-2-yl | | | | |
| X.278 | 4,6-dimethyl- | CH₃ | H | CH₃ | NHCH₂-cyclopropyl |
| | pyridin-2-yl | | | | |
| X.279 | 4,6-dimethyl- | CH₃ | H | CH₃ | NHCOCH₃ |
| | pyridin-2-yl | | | | |
| X.280 | 4,6-dimethyl- | CH₃ | H | CH₃ | N(CH₃)COCH₃ |
| | pyridin-2-yl | | | | |
| X.281 | 4,6-dimethyl- | CH₃ | H | CH₃ | NHCOCH(CH₃)₂ |
| | pyridin-2-yl | | | | |
| X.282 | 4,6-dimethyl- | CH₃ | H | CH₃ | N(COCH₃)₂ |
| | pyridin-2-yl | | | | |
| X.283 | 4,6-dimethyl- | CH₃ | H | CH₃ | NHCOCHCl₂ |
| | pyridin-2-yl | | | | |
| X.284 | 4,6-dimethyl- | CH₃ | H | CH₃ | N(CH₃)COC(CH₃)₃ |
| | pyridin-2-yl | | | | |
| X.285 | 4,6-dimethyl- | CH₃ | H | CH₃ | phenyl |
| | pyridin-2-yl | | | | |
| X.286 | 4,6-dimethyl- | CH₃ | H | CH₃ | 2-CH₃-phenyl |
| | pyridin-2-yl | | | | |
| X.287 | 4,6-dimethyl- | CH₃ | H | CH₃ | 3-F-phenyl |
| | pyridin-2-yl | | | | |
| X.288 | 4,6-dimethyl- | CH₃ | H | CH₃ | 4-Cl-phenyl |
| | pyridin-2-yl | | | | |
| X.289 | 4,6-dimethyl- | CH₃ | H | CH₃ | 2,4-diCl-phenyl |
| | pyridin-2-yl | | | | |
| X.290 | 4,6-dimethyl- | CH₃ | H | CH₃ | 3-CN-phenyl |
| | pyridin-2-yl | | | | |
| X.291 | 4,6-dimethyl- | CH₃ | H | CH₃ | 3-CH₃O-phenyl |
| | pyridin-2-yl | | | | |
| X.292 | 4,6-dimethyl- | CH₃ | H | CH₃ | 4-CH₃O₃-phenyl |
| | pyridin-2-yl | | | | |
| X.293 | 4,6-dimethyl- pyridin-2-yl | CH₃ | H | CH₃ | 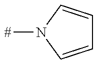 |
| X.294 | 4,6-dimethyl- pyridin-2-yl | CH₃ | H | CH₃ | 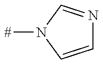 |
| X.295 | 4,6-dimethyl- pyridin-2-yl | CH₃ | H | CH₃ | 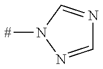 |
| X.296 | 4,6-dimethyl- pyridin-2-yl | CH₃ | CH₃ | H | 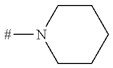 |
| X.297 | 4,6-dimethyl- | CH₃ | CH₃ | H | H |
| | pyridin-2-yl | | | | |
| X.298 | 4,6-dimethyl- | CH₃ | CH₃ | H | CH₃ |
| | pyridin-2-yl | | | | |
| X.299 | 4,6-dimethyl- | CH₃ | CH₃ | H | CH₂CH₃ |
| | pyridin-2-yl | | | | |
| X.300 | 4,6-dimethyl- | CH₃ | CH₃ | H | CH₂CH(CH₃)₂ |
| | pyridin-2-yl | | | | |
| X.301 | 4,6-dimethyl- | CH₃ | CH₃ | H | CH(CH₃)₂ |
| | pyridin-2-yl | | | | |
| X.302 | 4,6-dimethyl- | CH₃ | CH₃ | H | C(CH₃)₃ |
| | pyridin-2-yl | | | | |
| X.303 | 4,6-dimethyl- | CH₃ | CH₃ | H | cyclopropyl |
| | pyridin-2-yl | | | | |
| X.304 | 4,6-dimethyl- | CH₃ | CH₃ | H | cyclohexyl |
| | pyridin-2-yl | | | | |
| X.305 | 4,6-dimethyl- | CH₃ | CH₃ | H | CH═CH(CH₃) |
| | pyridin-2-yl | | | | |
| X.306 | 4,6-dimethyl- | CH₃ | CH₃ | H | CF₃ |
| | pyridin-2-yl | | | | |
| X.307 | 4,6-dimethyl- | CH₃ | CH₃ | H | CON(CH₃)₂ |
| | pyridin-2-yl | | | | |
| X.308 | 4,6-dimethyl- | CH₃ | CH₃ | H | Br |
| | pyridin-2-yl | | | | |
| X.309 | 4,6-dimethyl- | CH₃ | CH₃ | H | CN |
| | pyridin-2-yl | | | | |
| X.310 | 4,6-dimethyl- | CH₃ | CH₃ | H | OH |
| | pyridin-2-yl | | | | |
| X.311 | 4,6-dimethyl- | CH₃ | CH₃ | H | OCH₃ |
| | pyridin-2-yl | | | | |
| X.312 | 4,6-dimethyl- | CH₃ | CH₃ | H | OCH₂CH₃ |
| | pyridin-2-yl | | | | |
| X.313 | 4,6-dimethyl- | CH₃ | CH₃ | H | OCH(CH₃)₂ |
| | pyridin-2-yl | | | | |
| X.314 | 4,6-dimethyl- | CH₃ | CH₃ | H | OCH₂CH₂CH₃ |
| | pyridin-2-yl | | | | |
| X.315 | 4,6-dimethyl- | CH₃ | CH₃ | H | OCH₂CH═CH₂ |
| | pyridin-2-yl | | | | |
| X.316 | 4,6-dimethyl- | CH₃ | CH₃ | H | OCH₂CH≡CH |
| | pyridin-2-yl | | | | |
| X.317 | 4,6-dimethyl- | CH₃ | CH₃ | H | CH₂OCH₃ |
| | pyridin-2-yl | | | | |
| X.318 | 4,6-dimethyl- | CH₃ | CH₃ | H | CH₂OCH₂CH═CH₂ |
| | pyridin-2-yl | | | | |
| X.319 | 4,6-dimethyl- | CH₃ | CH₃ | H | NH₂ |
| | pyridin-2-yl | | | | |
| X.320 | 4,6-dimethyl- | CH₃ | CH₃ | H | NH(CH₃) |
| | pyridin-2-yl | | | | |
| X.321 | 4,6-dimethyl- | CH₃ | CH₃ | H | N(CH₃)₂ |
| | pyridin-2-yl | | | | |
| X.322 | 4,6-dimethyl- | CH₃ | CH₃ | H | N(CH₂CH₃)₂ |
| | pyridin-2-yl | | | | |
| X.323 | 4,6-dimethyl- | CH₃ | CH₃ | H | NHCH₂CH═CH₂ |
| | pyridin-2-yl | | | | |
| X.324 | 4,6-dimethyl- | CH₃ | CH₃ | H | NHCH₂-cyclopropyl |
| | pyridin-2-yl | | | | |
| X.325 | 4,6-dimethyl- | CH₃ | CH₃ | H | NHCOCH₃ |
| | pyridin-2-yl | | | | |
| X.326 | 4,6-dimethyl- | CH₃ | CH₃ | H | N(CH₃)COCH₃ |
| | pyridin-2-yl | | | | |
| X.327 | 4,6-dimethyl- | CH₃ | CH₃ | H | NHCOCH(CH₃)₂ |
| | pyridin-2-yl | | | | |
| X.328 | 4,6-dimethyl- | CH₃ | CH₃ | H | N(COCH₃)₂ |
| | pyridin-2-yl | | | | |
| X.329 | 4,6-dimethyl- | CH₃ | CH₃ | H | NHCOCHCl₂ |
| | pyridin-2-yl | | | | |
| X.330 | 4,6-dimethyl- | CH₃ | CH₃ | H | N(CH₃)COC(CH₃)₃ |
| | pyridin-2-yl | | | | |
| X.331 | 4,6-dimethyl- | CH₃ | CH₃ | H | phenyl |
| | pyridin-2-yl | | | | |
| X.332 | 4,6-dimethyl- | CH₃ | CH₃ | H | 2-CH₃-phenyl |
| | pyridin-2-yl | | | | |
| X.333 | 4,6-dimethyl- | CH₃ | CH₃ | H | 3-F-phenyl |
| | pyridin-2-yl | | | | |
| X.334 | 4,6-dimethyl- | CH₃ | CH₃ | H | 4-Cl-phenyl |
| | pyridin-2-yl | | | | |
| X.335 | 4,6-dimethyl- | CH₃ | CH₃ | H | 2,4-diCl-phenyl |
| | pyridin-2-yl | | | | |
| X.336 | 4,6-dimethyl- | CH₃ | CH₃ | H | 3-CN-phenyl |
| | pyridin-2-yl | | | | |
| X.337 | 4,6-dimethyl- | CH₃ | CH₃ | H | 3-CH₃O-phenyl |
| | pyridin-2-yl | | | | |
| X.338 | 4,6-dimethyl- | CH₃ | CH₃ | H | 4-CH₃O-phenyl |
| | pyridin-2-yl | | | | |
| X.339 | 4,6-dimethyl- pyridin-2-yl | CH₃ | CH₃ | H | 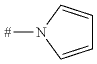 |
| X.340 | 4,6-dimethyl- pyridin-2-yl | CH₃ | CH₃ | H | 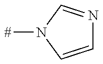 |
| X.341 | 4,6-dimethyl- pyridin-2-yl | CH₃ | CH₃ | H | 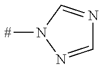 |
| X.342 | 4,6-dimethyl- pyridin-2-yl | CH₃ | CH₃ | H | 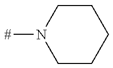 |
| X.343 | 4,6-dimethyl- | CH₃ | H | OCH₃ | H |
| | pyridin-2-yl | | | | |
| X.344 | 4,6-dimethyl- | CH₃ | H | OCH₃ | CH₃ |
| | pyridin-2-yl | | | | |
| X.345 | 4,6-dimethyl- | CH₃ | H | OCH₃ | CH₂CH₃ |
| | pyridin-2-yl | | | | |
| X.346 | 4,6-dimethyl- | CH₃ | H | OCH₃ | cyclopropyl |
| | pyridin-2-yl | | | | |
| X.347 | 4,6-dimethyl- | CH₃ | H | OCH₃ | CF₃ |
| | pyridin-2-yl | | | | |
| X.348 | 4,6-dimethyl- | CH₃ | H | OCH₃ | phenyl |
| | pyridin-2-yl | | | | |
| X.349 | 4,6-dimethyl- | CH₃ | H | OCH₃ | OH |
| | pyridin-2-yl | | | | |
| X.350 | 4,6-dimethyl- | CH₃ | H | OCH₃ | OCH₃ |
| | pyridin-2-yl | | | | |
| X.351 | 4,6-dimethyl- | CH₃ | H | OCH₃ | NH(CH₃) |
| | pyridin-2-yl | | | | |
| X.352 | 4,6-dimethyl- | CH₃ | H | OCH₃ | N(CH₃)₂ |
| | pyridin-2-yl | | | | |
| X.353 | 4,6-dimethyl- | CH₃ | OCH₃ | H | H |
| | pyridin-2-yl | | | | |
| X.354 | 4,6-dimethyl- | CH₃ | OCH₃ | H | CH₃ |
| | pyridin-2-yl | | | | |
| X.355 | 4,6-dimethyl- | CH₃ | OCH₃ | H | CH₂CH₃ |
| | pyridin-2-yl | | | | |
| X.356 | 4,6-dimethyl- | CH₃ | OCH₃ | H | cyclopropyl |
| | pyridin-2-yl | | | | |
| X.357 | 4,6-dimethyl- | CH₃ | OCH₃ | H | CF₃ |
| | pyridin-2-yl | | | | |
| X.358 | 4,6-dimethyl- | CH₃ | OCH₃ | H | phenyl |
| | pyridin-2-yl | | | | |
| X.359 | 4,6-dimethyl- | CH₃ | OCH₃ | H | OH |
| | pyridin-2-yl | | | | |
| X.360 | 4,6-dimethyl- | CH₃ | OCH₃ | H | OCH₃ |
| | pyridin-2-yl | | | | |
| X.361 | 4,6-dimethyl- | CH₃ | OCH₃ | H | NH(CH₃) |
| | pyridin-2-yl | | | | |
| X.362 | 4,6-dimethyl- | CH₃ | OCH₃ | H | N(CH₃)₂ |
| | pyridin-2-yl | | | | |
| X.363 | 4,6-dimethyl- | CH₃ | CH₃ | CH₃ | H |
| | pyridin-2-yl | | | | |
| X.364 | 4,6-dimethyl- | CH₃ | CH₃ | CH₃ | CH₃ |
| | pyridin-2-yl | | | | |
| X.365 | 4,6-dimethyl- | CH₃ | CH₃ | CH₃ | CH₂CH₃ |
| | pyridin-2-yl | | | | |
| X.366 | 4,6-dimethyl- | CH₃ | CH₃ | CH₃ | cyclopropyl |
| | pyridin-2-yl | | | | |
| X.367 | 4,6-dimethyl- | CH₃ | CH₃ | CH₃ | CF₃ |
| | pyridin-2-yl | | | | |
| X.368 | 4,6-dimethyl- | CH₃ | CH₃ | CH₃ | phenyl |
| | pyridin-2-yl | | | | |
| X.369 | 4,6-dimethyl- | CH₃ | CH₃ | CH₃ | OH |
| | pyridin-2-yl | | | | |
| X.370 | 4,6-dimethyl- | CH₃ | CH₃ | CH₃ | OCH₃ |
| | pyridin-2-yl | | | | |
| X.371 | 4,6-dimethyl- | CH₃ | CH₃ | CH₃ | NH(CH₃) |
| | pyridin-2-yl | | | | |
| X.372 | 4,6-dimethyl- | CH₃ | CH₃ | CH₃ | N(CH₃)₂ |
| | pyridin-2-yl | | | | |
| X.373 | 4,6-dimethyl- | CH₃ | N(CH₃)₂ | H | H |
| | pyridin-2-yl | | | | |
| X.374 | 4,6-dimethyl- | CH₃ | N(CH₃)₂ | H | CH₃ |
| | pyridin-2-yl | | | | |
| X.375 | 4,6-dimethyl- | CH₃ | N(CH₃)₂ | H | CH₂CH₃ |
| | pyridin-2-yl | | | | |
| X.376 | 4,6-dimethyl- | CH₃ | N(CH₃)₂ | H | cyclopropyl |
| | pyridin-2-yl | | | | |
| X.377 | 4,6-dimethyl- | CH₃ | N(CH₃)₂ | H | CF₃ |
| | pyridin-2-yl | | | | |
| X.378 | 4,6-dimethyl- | CH₃ | N(CH₃)₂ | H | phenyl |
| | pyridin-2-yl | | | | |
| X.379 | 4,6-dimethyl- | CH₃ | N(CH₃)₂ | H | OH |
| | pyridin-2-yl | | | | |
| X.380 | 4,6-dimethyl- | CH₃ | N(CH₃)₂ | H | OCH₃ |
| | pyridin-2-yl | | | | |
| X.381 | 4,6-dimethyl- | CH₃ | H | N(CH₃)₂ | H |
| | pyridin-2-yl | | | | |
| X.382 | 4,6-dimethyl- | CH₃ | H | N(CH₃)₂ | CH₃ |
| | pyridin-2-yl | | | | |
| X.383 | 4,6-dimethyl- | CH₃ | H | N(CH₃)₂ | CH₂CH₃ |
| | pyridin-2-yl | | | | |
| X.384 | 4,6-dimethyl- | CH₃ | H | N(CH₃)₂ | cyclopropyl |
| | pyridin-2-yl | | | | |
| X.385 | 4,6-dimethyl- | CH₃ | H | N(CH₃)₂ | CF₃ |
| | pyridin-2-yl | | | | |
| X.386 | 4,6-dimethyl- | CH₃ | H | N(CH₃)₂ | phenyl |
| | pyridin-2-yl | | | | |
| X.387 | 4,6-dimethyl- | CH₃ | H | N(CH₃)₂ | OH |
| | pyridin-2-yl | | | | |
| X.388 | 4,6-dimethyl- | CH₃ | H | N(CH₃)₂ | OCH₃ |
| | pyridin-2-yl | | | | |
| X.389 | 4,6-dimethyl- | CH₃ | OH | H | H |
| | pyridin-2-yl | | | | |
| X.390 | 4,6-dimethyl- | CH₃ | OCH₂CH₃ | H | H |
| | pyridin-2-yl | | | | |
| X.391 | 4,6-dimethyl- | CH₃ | OCH(CH₃)₂ | H | H |
| | pyridin-2-yl | | | | |
| X.392 | 4,6-dimethyl- | CH₃ | OCH₂CH₂CH₃ | H | H |
| | pyridin-2-yl | | | | |
| X.393 | 4,6-dimethyl- | CH₃ | OCH₂CH═CH₂ | H | H |
| | pyridin-2-yl | | | | |
| X.394 | 4,6-dimethyl- | CH₃ | OCH₂CH≡CH | H | H |
| | pyridin-2-yl | | | | |
| X.395 | 4,6-dimethyl- | CH₃ | H | OH | H |
| | pyridin-2-yl | | | | |
| X.396 | 4,6-dimethyl- | CH₃ | H | OCH₂CH₃ | H |
| | pyridin-2-yl | | | | |
| X.397 | 4,6-dimethyl- | CH₃ | H | OCH(CH₃)₂ | H |
| | pyridin-2-yl | | | | |
| X.398 | 4,6-dimethyl- | CH₃ | H | OCH₂CH₂CH₃ | H |
| | pyridin-2-yl | | | | |
| X.399 | 4,6-dimethyl- | CH₃ | H | OCH₂CH═CH₂ | H |
| | pyridin-2-yl | | | | |
| X.400 | 4,6-dimethyl- | CH₃ | H | OCH₂CH≡CH | H |
| | pyridin-2-yl | | | | |
| X.401 | 6-methyl-4- | CH₃ | H | H | H |
| | isopropoxy- | | | | |
| | pyridin-2-yl | | | | |
| X.402 | 6-methyl-4- | CH₃ | H | H | OCH₃ |
| | isopropoxy- | | | | |
| | pyridin-2-yl | | | | |
| X.403 | 6-methyl-4- | CH₃ | H | OCH₃ | H |
| | isopropoxy- | | | | |
| | pyridin-2-yl | | | | |
| X.404 | 6-methyl-4- | CH₃ | OCH₃ | H | H |
| | isopropoxy- | | | | |
| | pyridin-2-yl | | | | |
| X.405 | 6-methyl-4- | CH₃ | H | H | CH₃ |
| | isopropoxy- | | | | |
| | pyridin-2-yl | | | | |
| X.406 | 6-methyl-4- | CH₃ | H | CH₃ | H |
| | isopropoxy- | | | | |
| | pyridin-2-yl | | | | |
| X.407 | 6-methyl-4- | CH₃ | CH₃ | H | H |
| | isopropoxy- | | | | |
| | pyridin-2-yl | | | | |
| X.408 | 6-methyl-4- | CH₃ | H | H | N(CH₃)₂ |
| | isopropoxy- | | | | |
| | pyridin-2-yl | | | | |
| X.409 | 6-methyl-4- | CH₃ | H | N(CH₃)₂ | H |
| | isopropoxy- | | | | |
| | pyridin-2-yl | | | | |
| X.410 | 6-methyl-4- | CH₃ | N(CH₃)₂ | H | H |
| | isopropoxy- | | | | |
| | pyridin-2-yl | | | | |
| X.411 | 6-methyl-4- | CH₃ | H | H | H |
| | cyclopropyl- | | | | |
| | pyridin-2-yl | | | | |
| X.412 | 6-methyl-4- | CH₃ | H | H | OCH₃ |
| | cyclopropyl- | | | | |
| | pyridin-2-yl | | | | |
| X.413 | 6-methyl-4- | CH₃ | H | OCH₃ | H |
| | cyclopropyl- | | | | |
| | pyridin-2-yl | | | | |
| X.414 | 6-methyl-4- | CH₃ | OCH₃ | H | H |
| | cyclopropyl- | | | | |
| | pyridin-2-yl | | | | |
| X.415 | 6-methyl-4- | CH₃ | H | H | CH₃ |
| | cyclopropyl- | | | | |
| | pyridin-2-yl | | | | |
| X.416 | 6-methyl-4- | CH₃ | H | CH₃ | H |
| | cyclopropyl- | | | | |
| | pyridin-2-yl | | | | |
| X.417 | 6-methyl-4- | CH₃ | CH₃ | H | H |
| | cyclopropyl- | | | | |
| | pyridin-2-yl | | | | |
| X.418 | 6-methyl-4- | CH₃ | H | H | N(CH₃)₂ |
| | cyclopropyl- | | | | |
| | pyridin-2-yl | | | | |
| X.419 | 6-methyl-4- | CH₃ | H | N(CH₃)₂ | H |
| | cyclopropyl- | | | | |
| | pyridin-2-yl | | | | |
| X.420 | 6-methyl-4- | CH₃ | N(CH₃)₂ | H | H |
| | cyclopropyl- | | | | |
| | pyridin-2-yl | | | | |
| X.421 | 6-methoxy- | CH₃ | H | H | H |
| | pyridin-2-yl | | | | |
| X.422 | 6-methoxy- | CH₃ | H | H | OCH₃ |
| | pyridin-2-yl | | | | |
| X.423 | 6-methoxy- | CH₃ | H | OCH₃ | H |
| | pyridin-2-yl | | | | |
| X.424 | 6-methoxy- | CH₃ | OCH₃ | H | H |
| | pyridin-2-yl | | | | |
| X.425 | 6-methoxy- | CH₃ | H | H | CH₃ |
| | pyridin-2-yl | | | | |
| X.426 | 6-methoxy- | CH₃ | H | CH₃ | H |
| | pyridin-2-yl | | | | |
| X.427 | 6-methoxy- | CH₃ | CH₃ | H | H |
| | pyridin-2-yl | | | | |
| X.428 | 6-methoxy- | CH₃ | H | H | N(CH₃)₂ |
| | pyridin-2-yl | | | | |
| X.429 | 6-methoxy- | CH₃ | H | N(CH₃)₂ | H |
| | pyridin-2-yl | | | | |
| X.430 | 6-methoxy- | CH₃ | N(CH₃)₂ | H | H |
| | pyridin-2-yl | | | | |
| X.431 | 6-methoxy-4-methyl- | CH₃ | H | H | H |
| | pyridin-2-yl | | | | |
| X.432 | 6-methoxy-4-methyl- | CH₃ | H | H | OCH₃ |
| | pyridin-2-yl | | | | |
| X.433 | 6-methoxy-4-methyl- | CH₃ | H | OCH₃ | H |
| | pyridin-2-yl | | | | |
| X.434 | 6-methoxy-4-methyl- | CH₃ | OCH₃ | H | H |
| | pyridin-2-yl | | | | |
| X.435 | 6-methoxy-4-methyl- | CH₃ | H | H | CH₃ |
| | pyridin-2-yl | | | | |
| X.436 | 6-methoxy-4-methyl- | CH₃ | H | CH₃ | H |
| | pyridin-2-yl | | | | |
| X.437 | 6-methoxy-4-methyl- | CH₃ | CH₃ | H | H |
| | pyridin-2-yl | | | | |
| X.438 | 6-methoxy-4-methyl- | CH₃ | H | H | N(CH₃)₂ |
| | pyridin-2-yl | | | | |
| X.439 | 6-methoxy-4-methyl- | CH₃ | H | N(CH₃)₂ | H |
| | pyridin-2-yl | | | | |
| X.440 | 6-methoxy-4-methyl- | CH₃ | N(CH₃)₂ | H | H |
| | pyridin-2-yl | | | | |
| X.441 | 6-methyl-4- | CH₃ | H | H | H |
| | dimethylamino- | | | | |
| | pyridin-2-yl | | | | |
| X.442 | 6-methyl-4- | CH₃ | H | H | OCH₃ |
| | dimethylamino- | | | | |
| | pyridin-2-yl | | | | |
| X.443 | 6-methyl-4- | CH₃ | H | OCH₃ | H |
| | dimethylamino- | | | | |
| | pyridin-2-yl | | | | |
| X.444 | 6-methyl-4- | CH₃ | OCH₃ | H | H |
| | dimethylamino- | | | | |
| | pyridin-2-yl | | | | |
| X.445 | 6-methyl-4- | CH₃ | H | H | CH₃ |
| | dimethylamino- | | | | |
| | pyridin-2-yl | | | | |
| X.446 | 6-methyl-4- | CH₃ | H | CH₃ | H |
| | dimethylamino- | | | | |
| | pyridin-2-yl | | | | |
| X.447 | 6-methyl-4- | CH₃ | CH₃ | H | H |
| | dimethylamino- | | | | |
| | pyridin-2-yl | | | | |
| X.448 | 6-methyl-4- | CH₃ | H | H | N(CH₃)₂ |
| | dimethylamino- | | | | |
| | pyridin-2-yl | | | | |
| X.449 | 6-methyl-4- | CH₃ | H | N(CH₃)₂ | H |
| | dimethylamino- | | | | |
| | pyridin-2-yl | | | | |
| X.450 | 6-methyl-4- | CH₃ | N(CH₃)₂ | H | H |
| | dimethylamino- | | | | |
| | pyridin-2-yl | | | | |
| X.451 | 6-methyl-5-methoxy- | CH₃ | H | H | H |
| | pyridin-2-yl | | | | |
| X.452 | 6-methyl-5-methoxy- | CH₃ | H | H | OCH₃ |
| | pyridin-2-yl | | | | |
| X.453 | 6-methyl-5-methoxy- | CH₃ | H | OCH₃ | H |
| | pyridin-2-yl | | | | |
| X.454 | 6-methyl-5-methoxy- | CH₃ | OCH₃ | H | H |
| | pyridin-2-yl | | | | |
| X.455 | 6-methyl-5-methoxy- | CH₃ | H | H | CH₃ |
| | pyridin-2-yl | | | | |
| X.456 | 6-methyl-5-methoxy- | CH₃ | H | CH₃ | H |
| | pyridin-2-yl | | | | |
| X.457 | 6-methyl-5-methoxy- | CH₃ | CH₃ | H | H |
| | pyridin-2-yl | | | | |
| X.458 | 6-methyl-5-methoxy- | CH₃ | H | H | N(CH₃)₂ |
| | pyridin-2-yl | | | | |
| X.459 | 6-methyl-5-methoxy- | CH₃ | H | N(CH₃)₂ | H |
| | pyridin-2-yl | | | | |
| X.460 | 6-methyl-5-methoxy- | CH₃ | N(CH₃)₂ | H | H |
| | pyridin-2-yl | | | | |
| X.461 | 6-methyl-5-methyl- | CH₃ | H | H | H |
| | pyridin-2-yl | | | | |
| X.462 | 6-methyl-5-methyl- | CH₃ | H | H | OCH₃ |
| | pyridin-2-yl | | | | |
| X.463 | 6-methyl-5-methyl- | CH₃ | H | OCH₃ | H |
| | pyridin-2-yl | | | | |
| X.464 | 6-methyl-5-methyl- | CH₃ | OCH₃ | H | H |
| | pyridin-2-yl | | | | |
| X.465 | 6-methyl-5-methyl- | CH₃ | H | H | CH₃ |
| | pyridin-2-yl | | | | |
| X.466 | 6-methyl-5-methyl- | CH₃ | H | CH₃ | H |
| | pyridin-2-yl | | | | |
| X.467 | 6-methyl-5-methyl- | CH₃ | CH₃ | H | H |
| | pyridin-2-yl | | | | |
| X.468 | 6-methyl-5-methyl- | CH₃ | H | H | N(CH₃)₂ |
| | pyridin-2-yl | | | | |
| X.469 | 6-methyl-5-methyl- | CH₃ | H | N(CH₃)₂ | H |
| | pyridin-2-yl | | | | |
| X.470 | 6-methyl-5-methyl- | CH₃ | N(CH₃)₂ | H | H |
| | pyridin-2-yl | | | | |
| X.471 | 6-methylpyridin-2-yl | CH₂CH₃ | H | H | H |
| X.472 | 6-methylpyridin-2-yl | CH₂CH₃ | H | H | OCH₃ |
| X.473 | 6-methylpyridin-2-yl | CH₂CH₃ | H | OCH₃ | H |
| X.474 | 6-methylpyridin-2-yl | CH₂CH₃ | OCH₃ | H | H |
| X.475 | 6-methylpyridin-2-yl | CH₂CH₃ | H | H | CH₃ |
| X.476 | 6-methylpyridin-2-yl | CH₂CH₃ | H | CH₃ | H |
| X.477 | 6-methylpyridin-2-yl | CH₂CH₃ | CH₃ | H | H |
| X.478 | 6-methylpyridin-2-yl | CH₂CH₃ | H | H | N(CH₃)₂ |
| X.479 | 6-methylpyridin-2-yl | CH₂CH₃ | H | N(CH₃)₂ | H |
| X.480 | 6-methylpyridin-2-yl | CH₂CH₃ | N(CH₃)₂ | H | H |
| X.481 | 4,6-dimethyl- | CH₂CH₃ | H | H | H |
| | pyridin-2-yl | | | | |
| X.482 | 4,6-dimethyl- | CH₂CH₃ | H | H | OCH₃ |
| | pyridin-2-yl | | | | |
| X.483 | 4,6-dimethyl- | CH₂CH₃ | H | OCH₃ | H |
| | pyridin-2-yl | | | | |
| X.484 | 4,6-dimethyl- | CH₂CH₃ | OCH₃ | H | H |
| | pyridin-2-yl | | | | |
| X.485 | 4,6-dimethyl- | CH₂CH₃ | H | H | CH₃ |
| | pyridin-2-yl | | | | |
| X.486 | 4,6-dimethyl- | CH₂CH₃ | H | CH₃ | H |
| | pyridin-2-yl | | | | |
| X.487 | 4,6-dimethyl- | CH₂CH₃ | CH₃ | H | H |
| | pyridin-2-yl | | | | |
| X.488 | 4,6-dimethyl- | CH₂CH₃ | H | H | N(CH₃)₂ |
| | pyridin-2-yl | | | | |
| X.489 | 4,6-dimethyl- | CH₂CH₃ | H | N(CH₃)₂ | H |
| | pyridin-2-yl | | | | |
| X.490 | 4,6-dimethyl- | CH₂CH₃ | N(CH₃)₂ | H | H |
| | pyridin-2-yl | | | | |
| X.491 | 6-methyl-4- | CH₂CH₃ | H | H | H |
| | isopropoxy- | | | | |
| | pyridin-2-yl | | | | |
| X.492 | 6-methyl-4- | CH₂CH₃ | H | H | OCH₃ |
| | isopropoxy- | | | | |
| | pyridin-2-yl | | | | |
| X.493 | 6-methyl-4- | CH₂CH₃ | H | OCH₃ | H |
| | isopropoxy- | | | | |
| | pyridin-2-yl | | | | |
| X.494 | 6-methyl-4- | CH₂CH₃ | OCH₃ | H | H |
| | isopropoxy- | | | | |
| | pyridin-2-yl | | | | |
| X.495 | 6-methyl-4- | CH₂CH₃ | H | H | CH₃ |
| | isopropoxy- | | | | |
| | pyridin-2-yl | | | | |
| X.496 | 6-methyl-4- | CH₂CH₃ | H | CH₃ | H |
| | isopropoxy- | | | | |
| | pyridin-2-yl | | | | |
| X.497 | 6-methyl-4- | CH₂CH₃ | CH₃ | H | H |
| | isopropoxy- | | | | |
| | pyridin-2-yl | | | | |
| X.498 | 6-methyl-4- | CH₂CH₃ | H | H | N(CH₃)₂ |
| | isopropoxy- | | | | |
| | pyridin-2-yl | | | | |
| X.499 | 6-methyl-4- | CH₂CH₃ | H | N(CH₃)₂ | H |
| | isopropoxy- | | | | |
| | pyridin-2-yl | | | | |
| X.500 | 6-methyl-4- | CH₂CH₃ | N(CH₃)₂ | H | H |
| | isopropoxy- | | | | |
| | pyridin-2-yl | | | | |
| X.501 | 6-methoxy-4-methyl- | CH₂CH₃ | H | H | H |
| | pyridin-2-yl | | | | |
| X.502 | 6-methoxy-4-methyl- | CH₂CH₃ | H | H | OCH₃ |
| | pyridin-2-yl | | | | |
| X.503 | 6-methoxy-4-methyl- | CH₂CH₃ | H | OCH₃ | H |
| | pyridin-2-yl | | | | |
| X.504 | 6-methoxy-4-methyl- | CH₂CH₃ | OCH₃ | H | H |
| | pyridin-2-yl | | | | |
| X.505 | 6-methoxy-4-methyl- | CH₂CH₃ | H | H | CH₃ |
| | pyridin-2-yl | | | | |
| X.506 | 6-methoxy-4-methyl- | CH₂CH₃ | H | CH₃ | H |
| | pyridin-2-yl | | | | |
| X.507 | 6-methoxy-4-methyl- | CH₂CH₃ | CH₃ | H | H |
| | pyridin-2-yl | | | | |
| X.508 | 6-methoxy-4-methyl- | CH₂CH₃ | H | H | N(CH₃)₂ |
| | pyridin-2-yl | | | | |
| X.509 | 6-methoxy-4-methyl- | CH₂CH₃ | H | N(CH₃)₂ | H |
| | pyridin-2-yl | | | | |
| X.510 | 6-methoxy-4-methyl- | CH₂CH₃ | N(CH₃)₂ | H | H |
| | pyridin-2-yl | | | | |
| X.511 | 6-methoxy- | CH₂CH₃ | H | H | H |
| | pyridin-2-yl | | | | |
| X.512 | 6-methoxy- | CH₂CH₃ | H | H | OCH₃ |
| | pyridin-2-yl | | | | |
| X.513 | 6-methoxy- | CH₂CH₃ | H | OCH₃ | H |
| | pyridin-2-yl | | | | |
| X.514 | 6-methoxy- | CH₂CH₃ | OCH₃ | H | H |
| | pyridin-2-yl | | | | |
| X.515 | 6-methoxy- | CH₂CH₃ | H | H | CH₃ |
| | pyridin-2-yl | | | | |
| X.516 | 6-methoxy- | CH₂CH₃ | H | CH₃ | H |
| | pyridin-2-yl | | | | |
| X.517 | 6-methoxy- | CH₂CH₃ | CH₃ | H | H |
| | pyridin-2-yl | | | | |
| X.518 | 6-methoxy- | CH₂CH₃ | H | H | N(CH₃)₂ |
| | pyridin-2-yl | | | | |
| X.519 | 6-methoxy- | CH₂CH₃ | H | N(CH₃)₂ | H |
| | pyridin-2-yl | | | | |
| X.520 | 6-methoxy- | CH₂CH₃ | N(CH₃)₂ | H | H |
| | pyridin-2-yl | | | | |
| X.521 | 4,6-dimethyl- | phenyl | H | H | H |
| | pyridin-2-yl | | | | |
| X.522 | 4,6-dimethyl- | phenyl | H | H | OCH₃ |
| | pyridin-2-yl | | | | |
| X.523 | 4,6-dimethyl- | phenyl | H | OCH₃ | H |
| | pyridin-2-yl | | | | |
| X.524 | 4,6-dimethyl- | phenyl | OCH₃ | H | H |
| | pyridin-2-yl | | | | |
| X.525 | 4,6-dimethyl- | phenyl | H | H | CH₃ |
| | pyridin-2-yl | | | | |
| X.526 | 4,6-dimethyl- | phenyl | H | CH₃ | H |
| | pyridin-2-yl | | | | |
| X.527 | 4,6-dimethyl- | phenyl | CH₃ | H | H |
| | pyridin-2-yl | | | | |
| X.528 | 4,6-dimethyl- | phenyl | H | H | N(CH₃)₂ |
| | pyridin-2-yl | | | | |
| X.529 | 4,6-dimethyl- | phenyl | H | N(CH₃)₂ | H |
| | pyridin-2-yl | | | | |
| X.530 | 4,6-dimethyl- | phenyl | N(CH₃)₂ | H | H |
| | pyridin-2-yl | | | | |
| X.531 | 6-methylpyridin-2-yl | 6-methyl- | H | H | H |
| | | pyridin-2-yl | | | |
| X.532 | 6-methylpyridin-2-yl | 6-methyl- | H | H | OCH₃ |
| | | pyridin-2-yl | | | |
| X.533 | 6-methylpyridin-2-yl | 6-methyl- | H | OCH₃ | H |
| | | pyridin-2-yl | | | |
| X.534 | 6-methylpyridin-2-yl | 6-methyl- | OCH₃ | H | H |
| | | pyridin-2-yl | | | |
| X.535 | 6-methylpyridin-2-yl | 6-methyl- | H | H | CH₃ |
| | | pyridin-2-yl | | | |
| X.536 | 6-methylpyridin-2-yl | 6-methyl- | H | CH₃ | H |
| | | pyridin-2-yl | | | |
| X.537 | 6-methylpyridin-2-yl | 6-methyl- | CH₃ | H | H |
| | | pyridin-2-yl | | | |
| X.538 | 6-methylpyridin-2-yl | 6-methyl- | H | H | N(CH₃)₂ |
| | | pyridin-2-yl | | | |
| X.539 | 6-methylpyridin-2-yl | 6-methyl- | H | N(CH₃)₂ | H |
| | | pyridin-2-yl | | | |
| X.540 | 6-methylpyridin-2-yl | 6-methyl- | N(CH₃)₂ | H | H |
| | | pyridin-2-yl | | | |
| X.541 | quinolin-2-yl | CH₃ | H | H | H |
| X.542 | 6-bromopyridin-2-yl | CH₃ | H | H | H |
| X.543 | 6-fluoro-5-chloro- | CH₃ | H | H | H |
| | pyridin-2-yl | | | | |

Table 1: This table discloses compounds 1.001 to 1.543 of the formula (I-I)

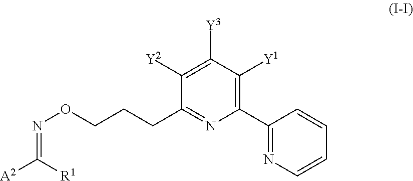

wherein R¹, A², Y¹, Y² and Y³ have the specific meanings given in the Table.
Table 2: This table discloses compounds 2.001 to 2.543 of the formula (I-II)

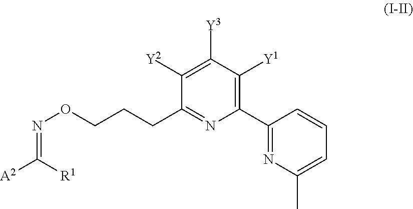

wherein R¹, A², Y¹, Y² and Y³ have the specific meanings given in the Table.

Table 3: This table discloses compounds 3.001 to 3.543 of the formula (I-III)

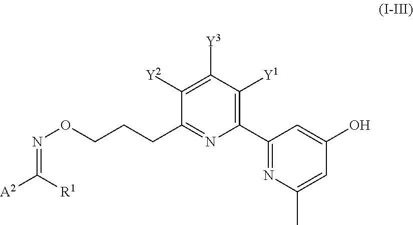

wherein R¹, A², Y¹, Y² and Y³ have the specific meanings given in the Table.

Table 4: This table discloses compounds 4.001 to 4.543 of the formula (I-IV)

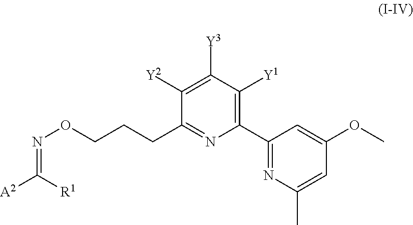

wherein R¹, A², Y¹, Y² and Y³ have the specific meanings given in the Table.

Table 5: This table discloses compounds 5.001 to 5.543 of the formula (I-V)

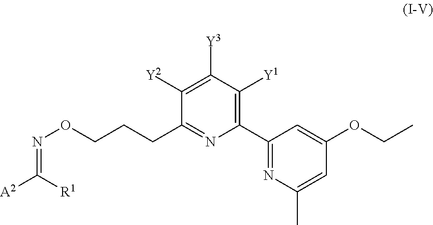

wherein R¹, A², Y¹, Y² and Y³ have the specific meanings given in the Table.

Table 6: This table discloses compounds 6.001 to 6.543 of the formula (I-VI)

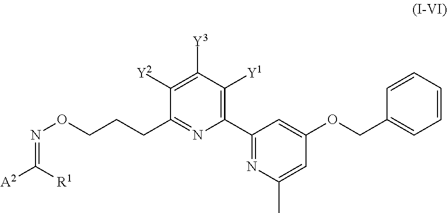

wherein R¹, A², Y¹, Y² and Y³ have the specific meanings given in the Table.

Table 7: This table discloses compounds 7.001 to 7.543 of the formula (I-VII)

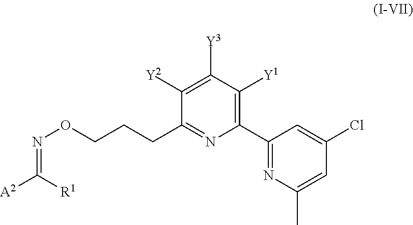

wherein R¹, A², Y¹, Y² and Y³ have the specific meanings given in the Table.

Table 8: This table discloses compounds 8.001 to 8.543 of the formula (I-VIII)

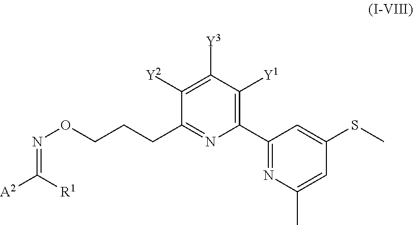

wherein R¹, A², Y¹, Y² and Y³ have the specific meanings given in the Table.

Table 9: This table discloses compounds 9.001 to 9.543 of the formula (I-IX)

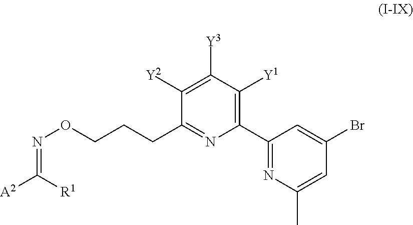

wherein R¹, A², Y¹, Y² and Y³ have the specific meanings given in the Table.

Table 10: This table discloses compounds 10.001 to 10.543 of the formula (I-X)

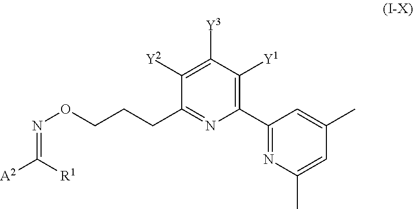

wherein R¹, A², Y¹, Y² and Y³ have the specific meanings given in the Table.

Table 11: This table discloses compounds 11.001 to 11.543 of the formula (I-XI)

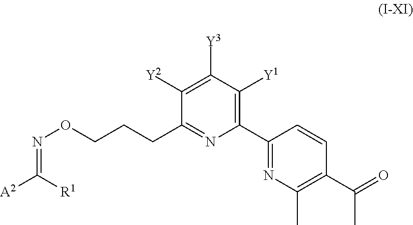

wherein R¹, A², Y¹, Y² and Y³ have the specific meanings given in the Table.

Table 12: This table discloses compounds 12.001 to 12.543 of the formula (I-XII)

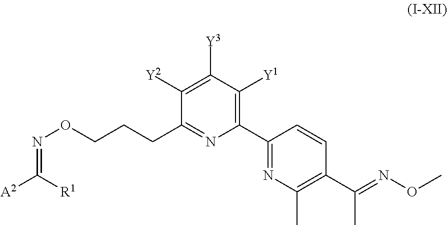

wherein R¹, A², Y¹, Y² and Y³ have the specific meanings given in the Table.

Table 13: This table discloses compounds 13.001 to 13.543 of the formula (I-XIII)

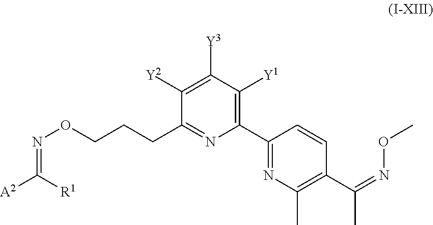

wherein R¹, A², Y¹, Y² and Y³ have the specific meanings given in the Table.

Table 14: This table discloses compounds 14.001 to 14.543 of the formula (I-XIV)

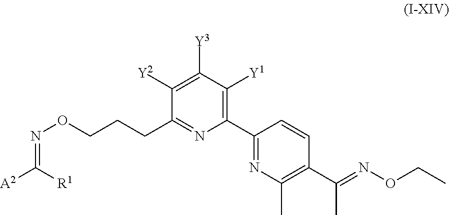

wherein R¹, A², Y¹, Y² and Y³ have the specific meanings given in the Table.

Table 15: This table discloses compounds 15.001 to 15.543 of the formula (I-XV)

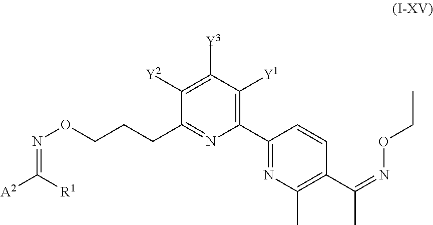

wherein R¹, A², Y¹, Y² and Y³ have the specific meanings given in the Table.

Table 16: This table discloses compounds 16.001 to 16.543 of the formula (I-XVI)

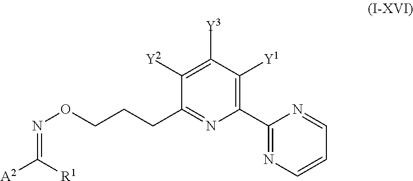

wherein R¹, A², Y¹, Y² and Y³ have the specific meanings given in the Table.

Table 17: This table discloses compounds 17.001 to 17.543 of the formula (I-XVII)

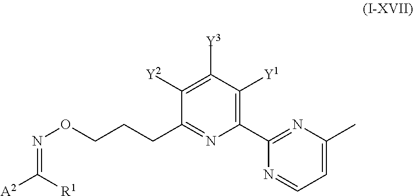

wherein R¹, A², Y¹, Y² and Y³ have the specific meanings given in the Table.

Table 18: This table discloses compounds 18.001 to 18.543 of the formula (I-XVIII)

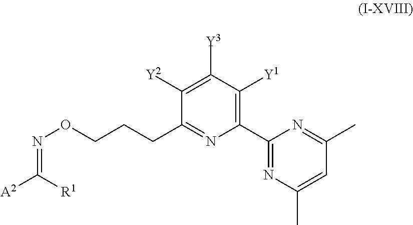

wherein R¹, A², Y¹, Y² and Y³ have the specific meanings given in the Table.

Table 19: This table discloses compounds 19.001 to 19.543 of the formula (I-XIX)

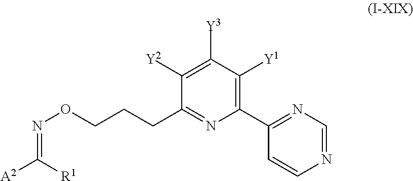

wherein R¹, A², Y¹, Y² and Y³ have the specific meanings given in the Table. Table 20: This table discloses compounds 20.001 to 20.543 of the formula (POO

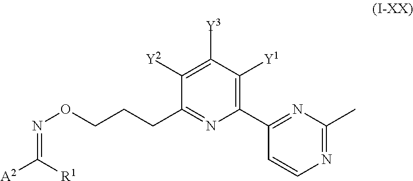

wherein R¹, A², Y¹, Y² and Y³ have the specific meanings given in the Table.

Table 21: This table discloses compounds 21.001 to 21.543 of the formula (I-XXII)

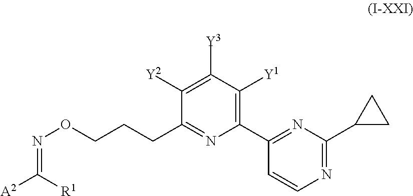

wherein R¹, A², Y¹, Y² and Y³ have the specific meanings given in the Table.

Table 22: This table discloses compounds 21.001 to 21.543 of the formula (I-XXII)

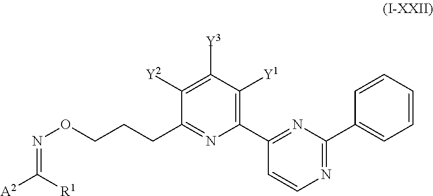

wherein R¹, A², Y¹, Y² and Y³ have the specific meanings given in the Table.

Table 23: This table discloses compounds 23.001 to 23.543 of the formula (I-XXIII)

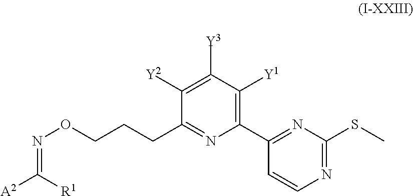

wherein R¹, A², Y¹, Y² and Y³ have the specific meanings given in the Table.

Table 24: This table discloses compounds 24.001 to 24.543 of the formula (I-XXIV)

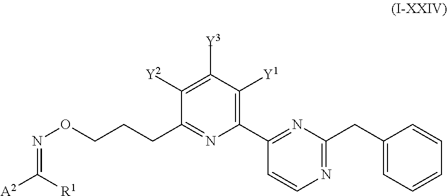

wherein R¹, A², Y¹, Y² and Y³ have the specific meanings given in the Table.

Table 25: This table discloses compounds 25.001 to 25.543 of the formula (I-XXV)

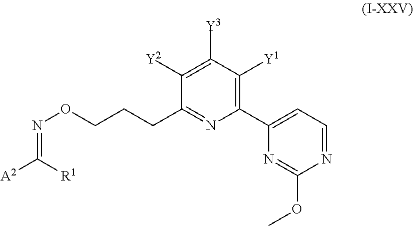

wherein R¹, A², Y¹, Y² and Y³ have the specific meanings given in the Table.

Table 26: This table discloses compounds 26.001 to 26.543 of the formula (I-XXVI)

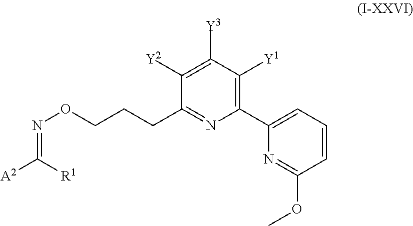

wherein R¹, A², Y¹, Y² and Y³ have the specific meanings given in the Table.

Table 27: This table discloses compounds 27.001 to 27.543 of the formula (I-XXVII)

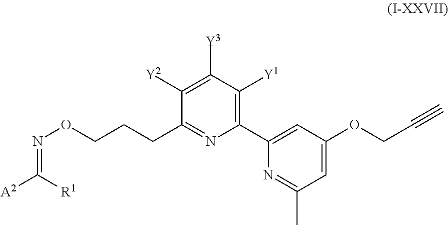

wherein R¹, A², Y¹, Y² and Y³ have the specific meanings given in the Table.

Table 28: This table discloses compounds 28.001 to 28.543 of the formula (I-XXVIII)

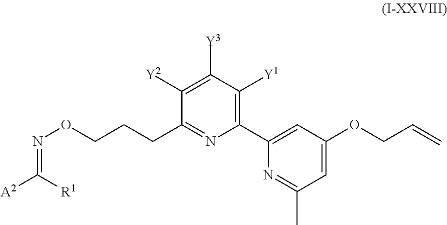

wherein R¹, A², Y¹, Y² and Y³ have the specific meanings given in the Table.

Table 29: This table discloses compounds 29.001 to 29.543 of the formula (I-XXIX)

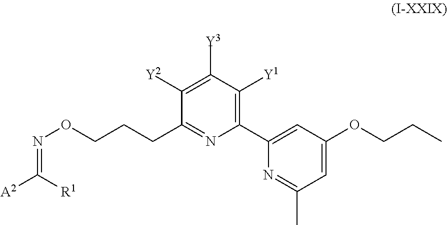

wherein R¹, A², Y¹, Y² and Y³ have the specific meanings given in the Table.

Table 30: This table discloses compounds 30.001 to 30.543 of the formula (I-XXX)

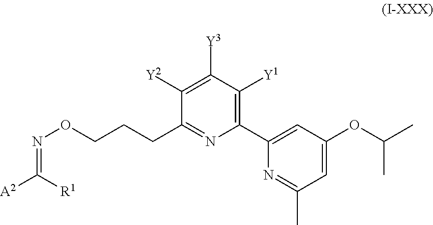

wherein R¹, A², Y¹, Y² and Y³ have the specific meanings given in the Table.

Table 31: This table discloses compounds 31.001 to 31.543 of the formula (I-XXXI)

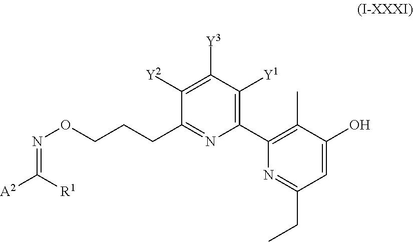

wherein R¹, A², Y¹, Y² and Y³ have the specific meanings given in the Table.

Table 32: This table discloses compounds 32.001 to 32.543 of the formula (I-XXXII)

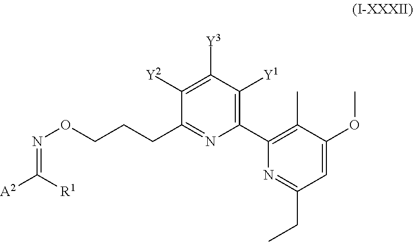

wherein R¹, A², Y¹, Y² and Y³ have the specific meanings given in the Table.

Table 33: This table discloses compounds 33.001 to 33.543 of the formula (I-XXXIII)

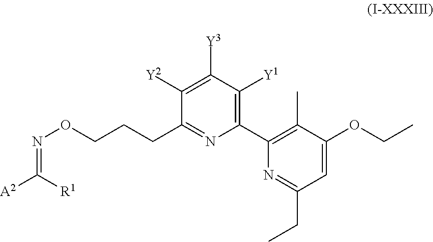

wherein R¹, A², Y¹, Y² and Y³ have the specific meanings given in the Table.

Table 34: This table discloses compounds 34.001 to 34.543 of the formula (I-XXXIV)

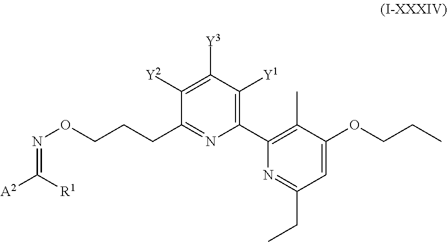

wherein R¹, A², Y¹, Y² and Y³ have the specific meanings given in the Table.

Table 35: This table discloses compounds 35.001 to 35.543 of the formula (I-XXXV)

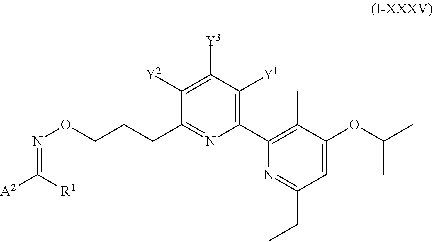

wherein R¹, A², Y¹, Y² and Y³ have the specific meanings given in the Table.

Table 36: This table discloses compounds 36.001 to 36.543 of the formula (I-XXXVI)

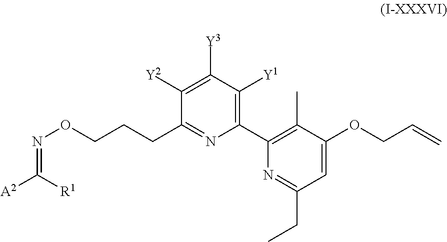

wherein R¹, A², Y¹, Y² and Y³ have the specific meanings given in the Table.

Table 37: This table discloses compounds 37.001 to 37.543 of the formula (I-XXXVII)

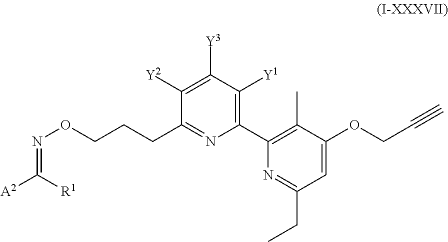

wherein R¹, A², Y¹, Y² and Y³ have the specific meanings given in the Table.

Table 38 illustrates embodiments A² and E of

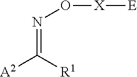

The compounds in table 39 illustrate compounds of formula (I) wherein R¹ is CH₃ and A² and E are as defined in table 38.

TABLE 38

| | |
|---|---|
| 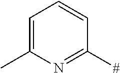 | A^{2a} |
| 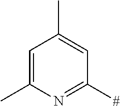 | A^{2b} |
| 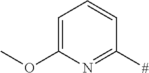 | A^{2c} |
| 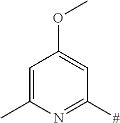 | A^{2d} |
| 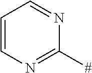 | A^{2e} |
| 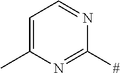 | A^{2f} |
| 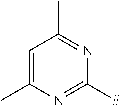 | A^{2g} |
| 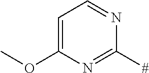 | A^{2h} |
| 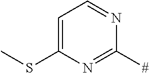 | A²ⁱ |
| 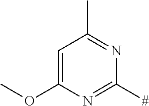 | A^{2j} |
| 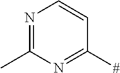 | A^{2k} |
| 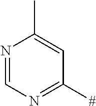 | A^{2l} |
| 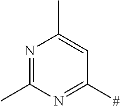 | A^{2m} |
| 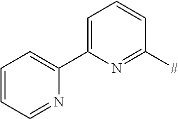 | E-1 |
| 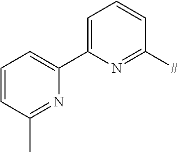 | E-2 |
| 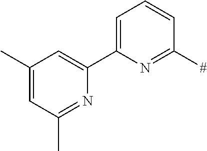 | E-3 |
| 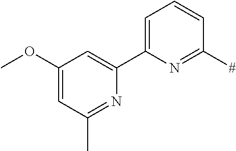 | E-4 |
| 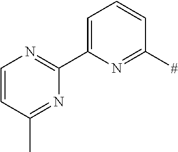 | E-5 |
| 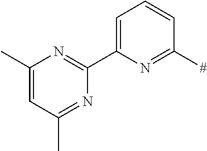 | E-6 |
| 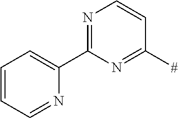 | E-7 |
| 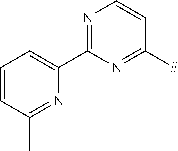 | E-8 |
| 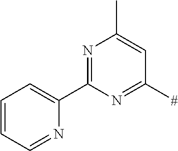 | E-9 |
| 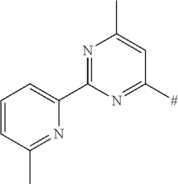 | E-10 |
| 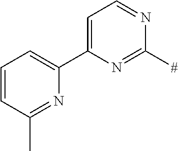 | E-11 |
| 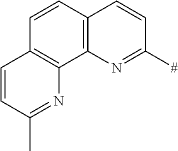 | E-12 |
| 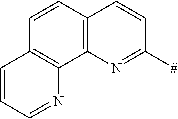 | E-13 |

TABLE 39

| Compound | A² | X | E |
|---|---|---|---|
| 39.001 | A^{2a} | —CH₂CH₂CH₂— | E-7 |
| 39.002 | A^{2a} | —CH₂CH₂CH₂— | E-8 |
| 39.003 | A^{2a} | —CH₂CH₂CH₂— | E-9 |
| 39.004 | A^{2a} | —CH₂CH₂CH₂— | E-10 |
| 39.005 | A^{2a} | —CH₂CH₂CH₂— | E-11 |
| 39.006 | A^{2a} | —CH₂CH₂CH₂— | E-12 |
| 39.007 | A^{2a} | —CH₂CH₂CH₂— | E-13 |
| 39.008 | A^{2b} | —CH₂CH₂CH₂— | E-7 |
| 39.009 | A^{2b} | —CH₂CH₂CH₂— | E-8 |
| 39.010 | A^{2b} | —CH₂CH₂CH₂— | E-9 |
| 39.011 | A^{2b} | —CH₂CH₂CH₂— | E-10 |
| 39.012 | A^{2b} | —CH₂CH₂CH₂— | E-11 |
| 39.013 | A^{2b} | —CH₂CH₂CH₂— | E-12 |
| 39.014 | A^{2b} | —CH₂CH₂CH₂— | E-13 |
| 39.015 | A^{2c} | —CH₂CH₂CH₂— | E-7 |
| 39.016 | A^{2c} | —CH₂CH₂CH₂— | E-8 |
| 39.017 | A^{2c} | —CH₂CH₂CH₂— | E-9 |
| 39.018 | A^{2c} | —CH₂CH₂CH₂— | E-10 |
| 39.019 | A^{2c} | —CH₂CH₂CH₂— | E-11 |
| 39.020 | A^{2c} | —CH₂CH₂CH₂— | E-12 |
| 39.021 | A^{2c} | —CH₂CH₂CH₂— | E-13 |
| 39.022 | A^{2d} | —CH₂CH₂CH₂— | E-7 |
| 39.023 | A^{2d} | —CH₂CH₂CH₂— | E-8 |
| 39.024 | A^{2d} | —CH₂CH₂CH₂— | E-9 |
| 39.025 | A^{2d} | —CH₂CH₂CH₂— | E-10 |
| 39.026 | A^{2d} | —CH₂CH₂CH₂— | E-11 |
| 39.027 | A^{2d} | —CH₂CH₂CH₂— | E-12 |
| 39.028 | A^{2d} | —CH₂CH₂CH₂— | E-13 |
| 39.029 | A^{2e} | —CH₂CH₂CH₂— | E-1 |
| 39.030 | A^{2e} | —CH₂CH₂CH₂— | E-2 |
| 39.031 | A^{2e} | —CH₂CH₂CH₂— | E-3 |
| 39.032 | A^{2e} | —CH₂CH₂CH₂— | E-4 |
| 39.033 | A^{2e} | —CH₂CH₂CH₂— | E-5 |
| 39.034 | A^{2e} | —CH₂CH₂CH₂— | E-6 |
| 39.035 | A^{2f} | —CH₂CH₂CH₂— | E-1 |
| 39.036 | A^{2f} | —CH₂CH₂CH₂— | E-2 |
| 39.037 | A^{2f} | —CH₂CH₂CH₂— | E-3 |
| 39.038 | A^{2f} | —CH₂CH₂CH₂— | E-4 |
| 39.039 | A^{2f} | —CH₂CH₂CH₂— | E-5 |
| 39.040 | A^{2f} | —CH₂CH₂CH₂— | E-6 |
| 39.041 | A^{2g} | —CH₂CH₂CH₂— | E-1 |
| 39.042 | A^{2g} | —CH₂CH₂CH₂— | E-2 |
| 39.043 | A^{2g} | —CH₂CH₂CH₂— | E-3 |
| 39.044 | A^{2g} | —CH₂CH₂CH₂— | E-4 |
| 39.045 | A^{2g} | —CH₂CH₂CH₂— | E-5 |
| 39.046 | A^{2g} | —CH₂CH₂CH₂— | E-6 |
| 39.047 | A^{2h} | —CH₂CH₂CH₂— | E-1 |
| 39.048 | A^{2h} | —CH₂CH₂CH₂— | E-2 |
| 39.049 | A^{2h} | —CH₂CH₂CH₂— | E-3 |
| 39.050 | A^{2h} | —CH₂CH₂CH₂— | E-4 |
| 39.051 | A^{2h} | —CH₂CH₂CH₂— | E-5 |
| 39.052 | A^{2h} | —CH₂CH₂CH₂— | E-6 |
| 39.053 | A²ⁱ | —CH₂CH₂CH₂— | E-1 |
| 39.054 | A²ⁱ | —CH₂CH₂CH₂— | E-2 |
| 39.055 | A²ⁱ | —CH₂CH₂CH₂— | E-3 |
| 39.056 | A²ⁱ | —CH₂CH₂CH₂— | E-4 |
| 39.057 | A²ⁱ | —CH₂CH₂CH₂— | E-5 |
| 39.058 | A²ⁱ | —CH₂CH₂CH₂— | E-6 |
| 39.059 | A^{2j} | —CH₂CH₂CH₂— | E-1 |
| 39.060 | A^{2j} | —CH₂CH₂CH₂— | E-2 |
| 39.061 | A^{2j} | —CH₂CH₂CH₂— | E-3 |
| 39.062 | A^{2j} | —CH₂CH₂CH₂— | E-4 |
| 39.063 | A^{2j} | —CH₂CH₂CH₂— | E-5 |
| 39.064 | A^{2j} | —CH₂CH₂CH₂— | E-6 |
| 39.065 | A^{2k} | —CH₂CH₂CH₂— | E-1 |
| 39.066 | A^{2k} | —CH₂CH₂CH₂— | E-2 |
| 39.067 | A^{2k} | —CH₂CH₂CH₂— | E-3 |
| 39.068 | A^{2k} | —CH₂CH₂CH₂— | E-4 |
| 39.069 | A^{2k} | —CH₂CH₂CH₂— | E-5 |
| 39.070 | A^{2k} | —CH₂CH₂CH₂— | E-6 |
| 39.071 | A^{2l} | —CH₂CH₂CH₂— | E-1 |
| 39.072 | A^{2l} | —CH₂CH₂CH₂— | E-2 |
| 39.073 | A^{2l} | —CH₂CH₂CH₂— | E-3 |
| 39.074 | A^{2l} | —CH₂CH₂CH₂— | E-4 |
| 39.075 | A^{2l} | —CH₂CH₂CH₂— | E-5 |
| 39.076 | A^{2l} | —CH₂CH₂CH₂— | E-6 |
| 39.077 | A^{2m} | —CH₂CH₂CH₂— | E-1 |
| 39.078 | A^{2m} | —CH₂CH₂CH₂— | E-2 |
| 39.079 | A^{2m} | —CH₂CH₂CH₂— | E-3 |
| 39.080 | A^{2m} | —CH₂CH₂CH₂— | E-4 |
| 39.081 | A^{2m} | —CH₂CH₂CH₂— | E-5 |
| 39.082 | A^{2m} | —CH₂CH₂CH₂— | E-6 |
| 39.083 | A^{2f} | —CH₂CH₂CH₂— | E-7 |
| 39.084 | A^{2f} | —CH₂CH₂CH₂— | E-8 |
| 39.085 | A^{2f} | —CH₂CH₂CH₂— | E-9 |
| 39.086 | A^{2f} | —CH₂CH₂CH₂— | E-10 |
| 39.087 | A^{2g} | —CH₂CH₂CH₂— | E-7 |
| 39.088 | A^{2g} | —CH₂CH₂CH₂— | E-8 |
| 39.089 | A^{2g} | —CH₂CH₂CH₂— | E-9 |
| 39.090 | A^{2g} | —CH₂CH₂CH₂— | E-10 |

The compounds in Tables 1 to 39 include all isomers, tautomers and mixtures thereof, including the cis/trans isomers shown above.

The compounds of the invention may be made by a variety of methods, illustrated in schemes 1-15. The compounds depicted in the schemes also indicate any isomers and tautomers, in particular the geometric isomers arising from the oxime and oxime ether moieties.

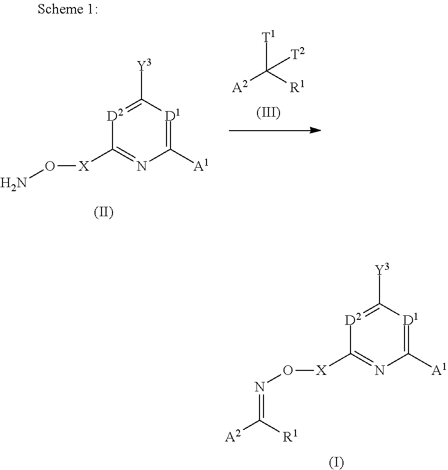

1) Compounds of formula (I) may be prepared by reacting a compound of formula (II), wherein X, D¹, D², Y³ and A¹ are as defined herein for compounds of formula (I), with a compound of formula (III), wherein A² and R¹ are as defined herein for compounds of formula (I), and T¹ and T² are C₁-C₈ alkoxy, or T¹ and T² together with the carbon they are attached to form a carbonyl group or an acetal or ketal function of the form C(O—C₁-C₆-alkylidene-O) whereby the alkylidene fragment may optionally be mono- to tetra-substituted by C₁-C₆ alkyl, as seen in scheme 1.

A general description of condensation reactions is given below, and typical reaction conditions for this type of reaction may be found in Journal of Organic Chemistry, 52(22), 4978-84; 1987; Chemical & Pharmaceutical Bulletin, 51(2), 138-151; 2003; Organic Letters, 10(2), 285-288; 2008; Journal of the American Chemical Society, 130(12), 4196-4201; 2008; Chemistry & Biology, 9(1), 113-129; 2002; Organic Preparations and Procedures International, 32(2), 153-159; 2000; Scientia Pharmaceutica, 66(1), 9-21; 1998, Journal of Medicinal Chemistry, 49(17), 5177-5186; 2006, Journal of Agricultural and Food Chemistry, 38(3), 839-44; 1990; Tetrahedron: Asymmetry, 8(2), 253-263; 1997; Journal of Medicinal Chemistry, 44(21), 3339-3342; 2001; Bioorganic & Medicinal Chemistry Letters, 12(3), 341-344; 2002; US 2007032470; WO 07/058,504; Journal of Organic Chemistry, 73(5), 2007-2010; 2008; Bioorganic & Medicinal Chemistry Letters, 19(10), 2683-2687; 2009; and Bioorganic & Medicinal Chemistry Letters, 19(10), 2654-2660; 2009.

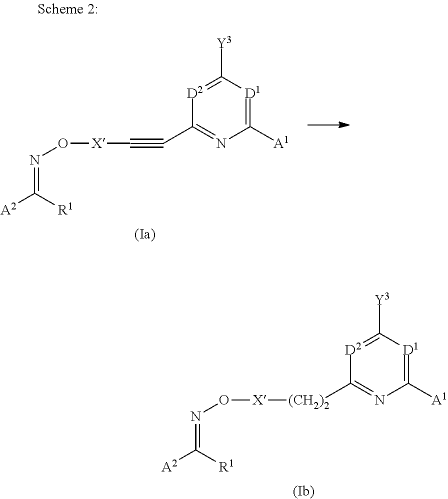

2) Alternatively, as seen in scheme 2, compounds of formula (Ib), that is a compound of formula (I) wherein Z⁴ and Z⁵, Z⁵ and Z⁹ or Z¹³ and Z¹⁴ are both methylene and X′ represents X′-1, X′-2 or X′-3:

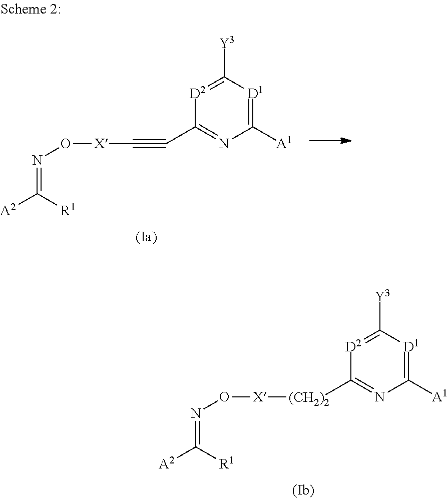

may be prepared by catalytic hydrogenation from compounds of formula (Ia), that is a compound of formula (I) wherein Z⁴ and Z⁵, Z⁵ and Z⁹ or Z¹³ and Z¹⁴ together form a eythnyl group and X′ is defined as herein for compounds of formula (Ib), in the presence of a metal catalyst, for example palladium, nickel or platinum. The reaction is usually carried out in the presence of a solvent under a hydrogen atmosphere. In some cases it is necessary to apply pressure in the range of 1 to 100 bar. Suitable solvents for such reactions are alcohols, such as methanol or ethanol, cyclic ethers, such as dioxane or tetrahydrofuran or esters like ethyl acetate. The reaction is usually carried out at a reaction temperature ranging from 0° C. to the boiling point of the solvent. Examples for the hydrogenation in the presence of a nickel catalyst can be found in Journal of Organometallic Chemistry, 333(2), 139-53; 1987. Examples for the hydrogenation in the presence of a palladium catalyst can be found in Tetrahedron, 63(26), 6015-6034; 2007 or in Bioorganic & Medicinal Chemistry, 9(11), 2863-2870; 2001. Examples for the hydrogenation in the presence of a platinum catalyst can be found in Journal of Organic Chemistry, 53(2), 386-90; 1988 or in Journal of Medicinal Chemistry, 32(8), 1820-35; 1989

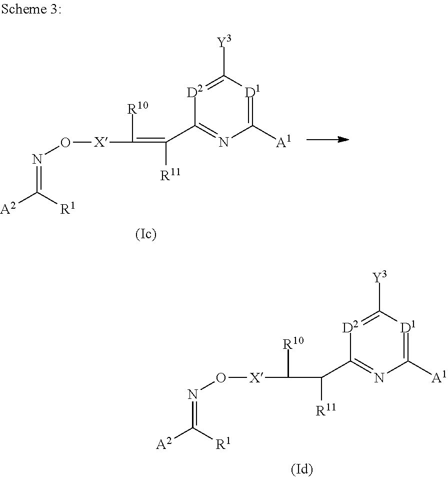

3) Alternatively, as seen in scheme 3, compounds of formula (Id), that is a compound of formula (I) wherein Z⁴, Z⁸ and Z¹⁴ represent CHR¹⁰ and Z⁵, Z⁹ and Z¹⁴ represent CHR¹¹ and X′ represents X′-1, X′-2 or X′-3:

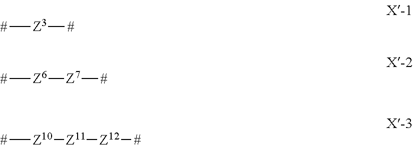

and each R¹⁰ and R¹¹ independently of one another represent hydrogen, halogen, C₁-C₄ alkyl, C₁-C₄ haloalkyl, phenyl or CN, wherein phenyl is optionally substituted by one or more groups, e.g. one to five groups, independently selected from halogen, CN, C₁-C₄ alkyl, C₁-C₄ haloalkyl, C₁-C₄ alkoxy and C₁-C₄ haloalkoxy, may be prepared by catalytic hydrogenation from compound (Ic), that is a compound of formula (I) wherein Z⁴ and Z⁵, Z⁸ and Z⁹ or Z¹³ and Z¹⁴ together form CR¹⁰═CR¹¹ and X′, R¹⁰ and R¹¹ are as defined herein for a compound of formula (Id) in the presence of a metal catalyst, for example palladium, nickel or platinum. The reaction is usually carried out in the presence of a solvent under a hydrogen atmosphere. In some cases it is necessary to apply pressure in the range of 1 to 100 bar. Suitable solvents for such reactions are alcohols, such as methanol or ethanol, cyclic ethers, such as dioxane or tetrahydrofuran or esters like ethyl acetate. The reaction is usually carried out at a reaction temperature ranging from 0° C. to the boiling point of the solvent.

Examples for the hydrogenation in the presence of a nickel catalyst can be found in Journal of Organic Chemistry, 69(6), 1959-1966; 2004. Examples for the hydrogenation in the presence of a palladium catalyst can be found in Journal of Organic Chemistry, 74(16), 6072-6076; 2009. Examples for hydrogenation in the presence of a platinum catalyst can be found in Organometallics, 5(2), 348-55; 1986.

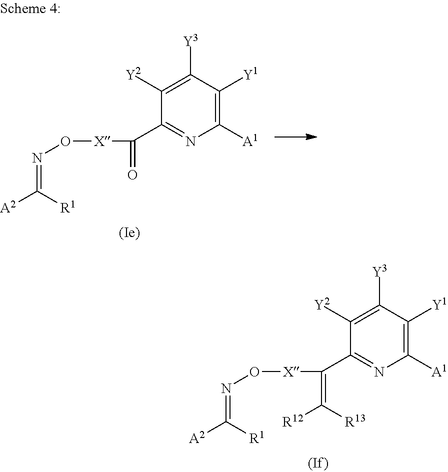

4) Compounds of formula (If), that is a compound of formula (I) wherein Z⁵, Z⁹ or Z¹⁴ represent C═CR¹²R¹³ and X″ represents

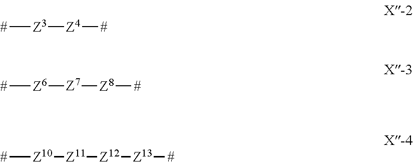

may be obtained from compounds of (Ie), that is a compound of formula (I) wherein Z⁵, Z⁹ or Z¹⁴ represent a carbonyl group and X″ is as defined for compounds of formula (If)

This can be done using one of several techniques well known to the person skilled in the art, including the Wittig reaction or condensation reactions. The Wittig reaction comprises the reaction between an aldehyde or a ketone, for example the ketone of formula (Ie) and a phosphorous ylide. Phosphorous ylides are usually prepared by treatment of a phosphonium salt with a base and phosphonium salts are usually prepared from a triarylphosphine and an alkyl halide. Several improvements and modification of the Wittig reaction are known and are described for example in March's Advanced Organic Chemistry: Reaction, Mechanisms and Structure, Sixth Edition, 2007 and references therein. Specific reaction conditions may be found in Journal of the American Chemical Society, 131(34), 12344-12353; 2009; Journal of Medicinal Chemistry, 51(22), 7193-7204; 2008 or Journal of Organic Chemistry, 74(11), 4166-4176; 2009.

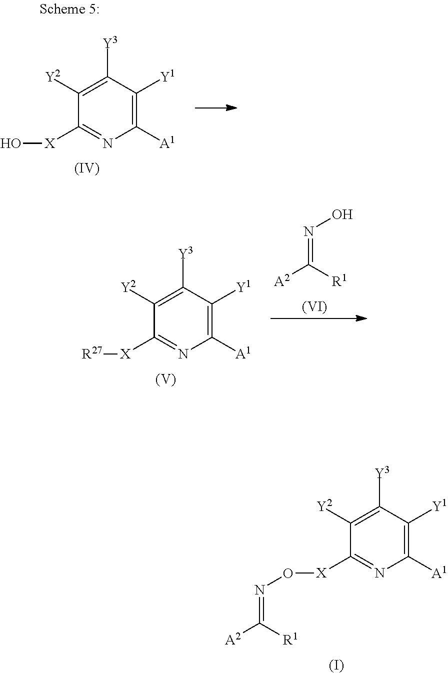

(5) Alternatively as seen in scheme 5 compounds of formula (I) may be prepared by reacting compounds of formula (V) wherein X, Y¹, Y², Y³, and A¹ are as defined herein for compounds of formula (I) and R²⁷ is a halogen, in particular chlorine, bromine or iodine, or a sulfonic acid ester group, such as mesylate, tosylate, triflate, a phenylsulfonic acid ester, a nitro-phenylsulfonic acid ester, or a nonafluorobutylsulfonic acid ester, and a compound of formula (VI) wherein A² and R¹ are as defined herein for compounds of formula (I). Typical reaction conditions for alkylation reactions such as this may be found below. These are further illustrated in Chinese Journal of Chemistry, 27(1), 33-42; 2009; WO 09/049,846; Journal of Antibiotics, 61(10), 603-614; 2008; Bioorganic & Medicinal Chemistry Letters, 18(24), 6471-6475; 2008; Journal of Medicinal Chemistry, 51(15), 4601-4608; 2008; WO 06/123145, Archiv der Pharmazie (Weinheim, Germany), 340(4), 202-208; 2007; Synthetic Communications, 37(7), 1155-1165; 2007; Russian Journal of Organic Chemistry, 42(5), 735-738; 2006; Bioinorganic Chemistry and Applications, 1(3-4), 299-308; 2003; Synthetic Communications, 28(14), 2621-2633; 1998; Synthetic Communications, 19(18), 3129-38; 1989.

(6) Compounds of formula (V) can be prepared from compounds of formula (IV). Such transformations can be effected using a number of conditions well known to the person skilled in the art.

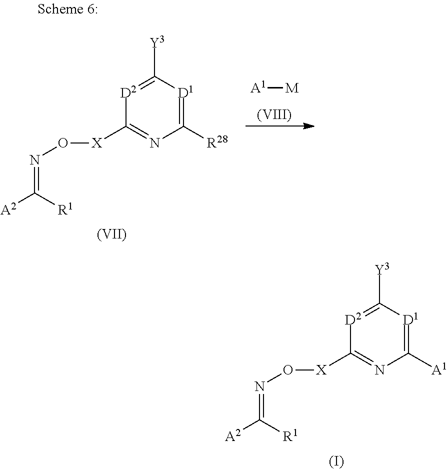

(7) Alternatively as seen in scheme 6 compounds of formula (I) may be prepared by reacting compounds of formula (VII) wherein A², R¹, X, D¹, D² and Y³ are as defined herein for compounds of formula (I) and R²⁸ is a halogen, in particular chlorine, bromine or iodine, with a compound of formula (VIII) wherein A¹ is as defined herein for compounds of formula (I) and M is an organometallic residue. This can be done using one of several techniques well known to the person skilled in the art, including Suzuki, Stille and Negishi cross coupling reactions. Examples and specific conditions for the Stille reaction may be found in Bioorganic & Medicinal Chemistry Letters, 19(19), 5689-5692; 2009; Journal of Organic Chemistry, 73(12), 4491-4495; 2008; Journal of the American Chemical Society, 129(3), 490-491; 2007 or in Journal of Organic Chemistry, 75(2), 424-433; 2010. Examples and specific conditions for the Negishi reaction may be found in European Journal of Inorganic Chemistry, (26), 4101-4110; 2008; Tetrahedron Letters, 50(38), 5329-5331; 2009; Tetrahedron Letters, 51(2), 357-359; 2010 or in Tetrahedron Letters, 51(19), 2657-2659; 2010. Examples and specific conditions for the Suzuki reaction may be found in Organic Letters, 11(2), 345-347; 2009; Journal of the American Chemical Society, 131(20), 6961-6963; 2009; Synthesis, (1), 85-90; 2010 or in Heterocycles, 80(1), 359-368.

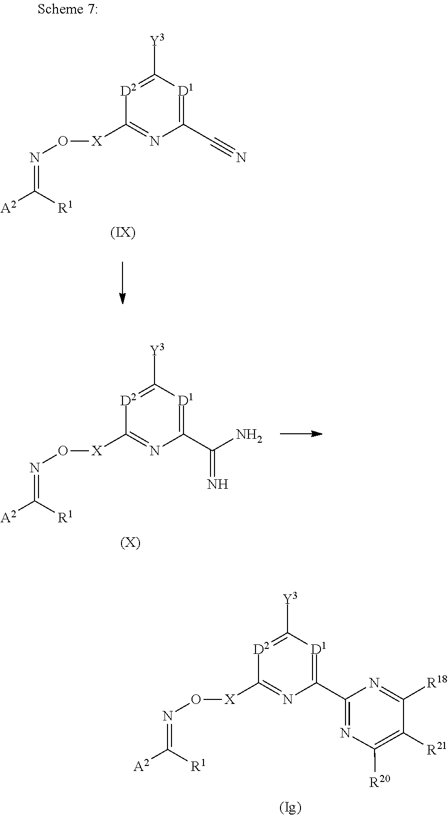

(8) Compounds of formula (Ig), that is a compound of formula (I) wherein A¹ is A-2, may be obtained from amidines of formula (X) wherein A², R¹, X, D¹, D² and Y³ are as defined herein for compounds of formula (I). Such transformations can be effected using a number of conditions well known to the person skilled in the art. Specific examples and conditions can be found in Chemistry—A European Journal, 16(1), 89-94, S89/1-S89/10; 2010; Tetrahedron Letters, 50(49), 6818-6822; 2009; Bioorganic & Medicinal Chemistry Letters, 15(12), 2990-2993; 2005; Synthetic Communications, 27(14), 2521-2526; 1997; Journal of Combinatorial Chemistry, 7(4), 517-519; 2005 and in Bioorganic & Medicinal Chemistry Letters, 15(12), 2990-2993; 2005.

(9) Amidines of formula (X) may be prepared from nitriles of formula (IX) wherein A², R¹, X, D¹, D² and Y³ are as defined herein for compounds of formula (I). Typical conditions for such transformations can be found in Bioorganic & Medicinal Chemistry, 17(18), 6651-6658; 2009; Bioorganic & Medicinal Chemistry Letters, 19(8), 2277-2281; 2009; Journal of Medicinal Chemistry, 51(6), 1719-1729; 2008 or in Journal of Medicinal Chemistry, 50(26), 6535-6544; 2007.

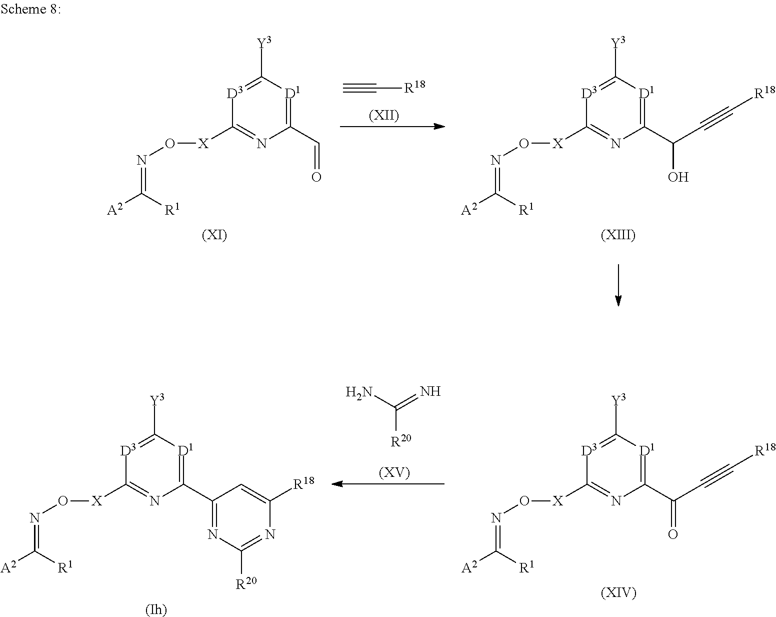

(10) Compounds of formula (Ih), that is a compound of formula (I) wherein A¹ is A-4 and R²² is hydrogen, may be obtained from compounds of (XIV) wherein A², R¹, X, D¹, D², Y³ and R¹⁸ are as defined herein for compounds of formula (I) and amidines of formula (XV) wherein R²⁰ is as defined herein for compounds of formula (I). Typical conditions for such transformations can be found in Tetrahedron Letters, 50(49), 6818-6822; 2009; Chemistry—A European Journal, 15(20), 5006-5011; 2009; Journal of Organic Chemistry (2009), 74(12), 4646-4649 or in Synlett, (19), 3036-3040; 2008. Amidines of formula (XV) are commercially available or can be prepared by methods well known to the person skilled in the art.

(11) Compounds of formula (XIV) may be prepared by oxidation from compounds of formula (XIII), wherein A², R¹, X, D¹, D², Y³ and R¹⁸ are as defined herein for compounds of formula (I). Such oxidations can be effected using a number of conditions well known to the person skilled in the art. Specific reaction conditions may be found in Journal of the American Chemical Society, 132(8), 2532-2533; 2010; Journal of Organic Chemistry, 74(15), 5750-5753; 2009 or in Tetrahedron, 64(29), 7008-7014; 2008.

(12) Compounds of formula (XIII) may be prepared from aldehydes of formula (XI) wherein A², R¹, X, D¹, D² and Y³ are as defined herein for compounds of formula (I) and compounds of formula (XII) wherein R¹⁸ is as defined herein for compounds of formula (I). Typical conditions for such transformations can be found in Tetrahedron, 64(29), 7008-7014; 2008; Journal of Organic Chemistry, 72(20), 7783-7786; 2007 or in Organic Letters, 9(6), 1169-1171; 2007.

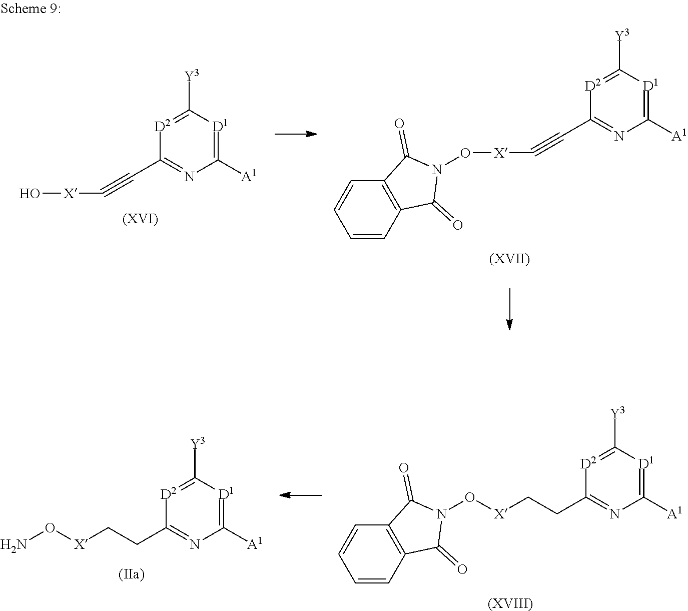

13) Compounds of formula (IIa), that is a compound of formula (II) wherein Z⁴ and Z⁵, Z⁸ and Z⁹ or Z¹³ and Z¹⁴ are both methylene and X′ is as defined for compounds of formula (Ia) may be obtained from compounds of (XVIII) wherein D¹, D², Y³ and A¹ are as defined herein for a compound of formula (I) and X′ is as herein defined for a compound of formula (Ia) by cleavage of the phthalimide protecting group. Examples for such deprotections can be found in Greene, T. W., Wuts, P. G. N., Protective Groups in Organic Synthesis, John Wiley & Sons, Inc, 2006.

14) Compounds of formula (XVIII) may be obtained by catalytic hydrogenation from compounds of formula (XVII) wherein D¹, D², Y³ and A¹ are as defined herein for a compound of formula (I) and X′ is as herein defined for a compound of formula (Ia). The reaction may be carried out analogously to procedure 2, shown in Scheme 2.

15) Compounds of formula (XVII) may be prepared from compounds of formula (XVI) wherein D¹, D², Y³ and A¹ are as defined herein for a compound of formula (I) and X′ is as herein defined for a compound of formula (Ia) by a Mitsunobu reaction. The Mitsunobu reaction comprises the substitution of primary or secondary alcohols with nucleophiles like for example N-hydroxyphthalimide as seen in Scheme 9, in the presence of a dialkyl azodicarboxylate and a trialkyl- or triaryl phosphine. Several improvements and modification of the Mitsunobu reaction are known and are described for example in March's Advanced Organic Chemistry Reaction, Mechanisms and Structure, Sixth Edition, 2007 and references therein. Specific reaction conditions may be found in Organic Preparations and Procedures International, 26(1), 111-13; 1994; Organic Letters, 11(9), 2019-2022; 2009; Tetrahedron Letters, 48(4), 647-650; 2007 or Journal of Organic Chemistry, 70(17), 6995-6998; 2005

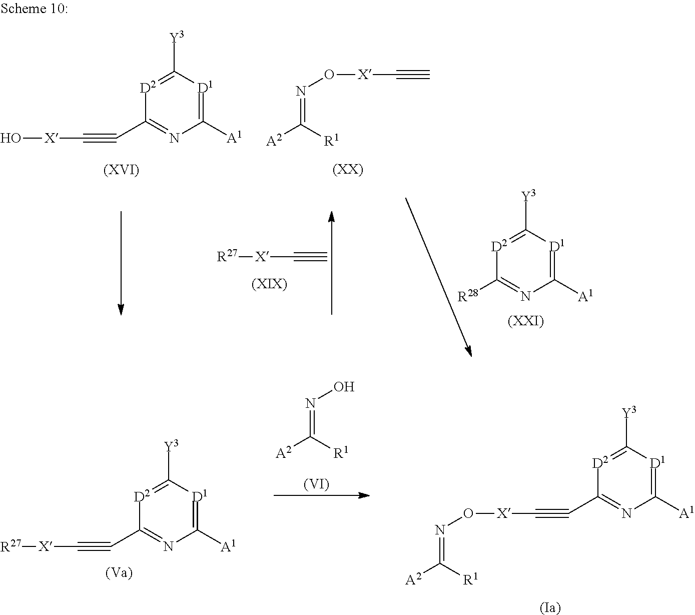

(16) Compounds of formula (Ia) may be prepared from compounds of formula (VI) wherein A² and R¹ are as defined herein for compounds of formula (I) and compounds of formula (Va), that is a compound of formula (V) wherein Z⁴ and Z⁵, Z⁵ and Z⁹ or Z¹³ and Z¹⁴ together form an ethynyl group and X′ is as defined herein for a compound of formula (Ia). The alkylation reaction can be carried out analogously to procedure 5 as shown in Scheme 5.

(17) Compounds of formula (Va) can be prepared from compounds of formula (WI), wherein D¹, D², Y³ and A² are as defined herein for a compound of formula (I), X′ is as defined herein for a compound of formula (Ia) and R²⁷ is as defined for a compound of formula (V). Such transformations can be effected using a number of conditions well known to the person skilled in the art.

(18) Alternatively as seen in Scheme 10 compounds of (Ia) can be prepared by a Sonogashira reaction of compounds of formula (XXI) wherein D¹, D², Y³ and A¹ are as defined herein for compounds of formula (I) and R²⁸ is as defined herein for a compound of formula (VII) with compounds of formula (XX) wherein A² and R¹ are as defined herein for a compound of formula (I) and X′ is as defined for a compound of formula (Ia). The reaction can be carried out in the presence of a palladium catalyst like tetrakis triphenylphosphine or dichlorobis (triphenylphosphine) palladium(II), a copper(I) salt like copper (I)chloride, copper(I)bromide or copper(I)iodide and a base, for example triethylamine, ethyl-diisopropyl-amine, diethyl-amine, diisopropyl-amine or dicyclohexyl-amine. Where possible, the base may also serve as solvent. Examples for other suitable solvents are N,N-dimethylformamide, N,N-dimethylacetamide, acetonitrile, di methylsulfoxide, dioxane or tetrahydrofuran. The reaction is usually carried out at a reaction temperature ranging from 0° C. to the boiling point of the solvent. Examples for Sonogashira reactions can be found in Handbook of Organopalladium Chemistry for Organic Synthesis 2002, 1, 493-529.

(19) Compounds of formula (XX) can be prepared from compounds of formula (VI) and compounds of (XIX) wherein X′ is as defined herein for compounds of formula (Ia) and R²⁷ is as defined herein for a compound of formula (V). Many of such compounds are known in the literature and are commercially available or can be prepared by methods well known to the person skilled in the art.

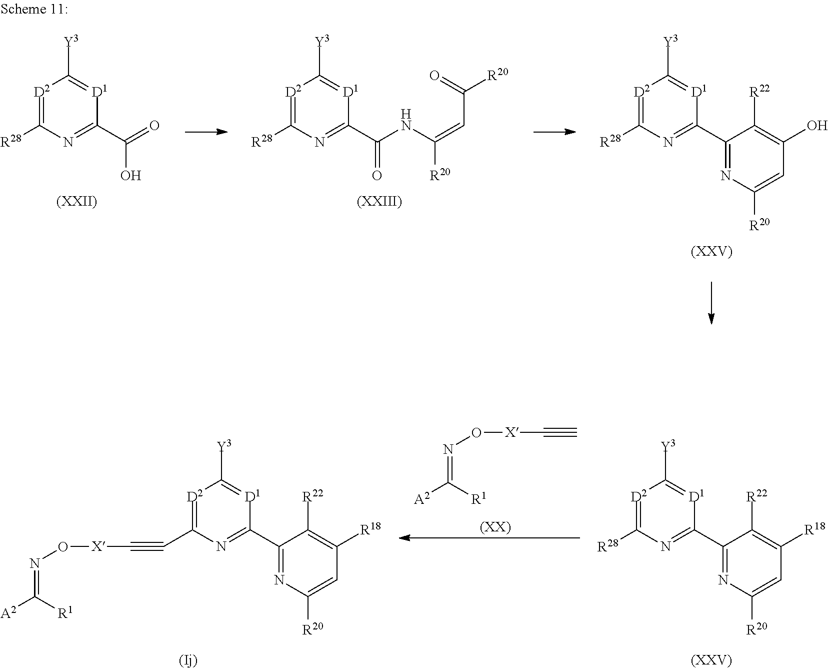

(20) Compounds of formula (Ij), that is a compound of formula (I) wherein A¹ is A-1, R²² is hydrogen or methyl, R²⁰ is methyl or ethyl, Z⁴ and Z⁵, Z⁵ and Z⁹ or Z¹³ and Z¹⁴ together form an ethynyl group and X′ is as defined for a compound of formula (Ia) may be prepared by a Sonogashira reaction of compounds of formula (XXV) wherein D¹, D² and Y³ are as defined herein for compounds of formula (I), R²² is hydrogen or methyl, R²⁰ is methyl or ethyl, R¹⁸ is as defined herein for a compound of formula (I) and R²⁸ is as defined herein for a compound of formula (VII) with compounds of formula (XX) wherein A and R¹ are as defined herein for a compound of formula (I) and X′ is as defined herein for a compound of formula (Ia). The reaction can be carried out in the presence of a palladium catalyst like tetrakis triphenylphosphine or dichlorobis (triphenylphosphine) palladium(II), a copper(I) salt like copper (I)chloride; copper(I)bromide or copper(I)iodide and a base, for example triethylamine, ethyl-diisopropyl-amine, diethyl-amine, diisopropyl-amine or dicyclohexyl-amine. Where possible, the base may also serve as solvent. Examples for other suitable solvents are N,N-dimethylformamide, N,N-dimethylacetamide, acetonitrile, dimethylsulfoxide, dioxane or tetrahydrofuran. The reaction is usually carried out at a reaction temperature ranging from 0° C. to the boiling point of the solvent. Examples for Sonogashira reactions can be found in Handbook of Organopalladium Chemistry for Organic Synthesis 2002, 1, 493-529.

(21) Compounds of formula (XXV) can be prepared from compounds of formula (XXIV) wherein D¹, D² and Y³ are as defined herein for compounds of formula (I), R²² is hydrogen or methyl, R²⁰ is methyl or ethyl and R²⁸ is as defined herein for a compound of formula (VII). Such transformations can be effected using a number of conditions well known to the person skilled in the art.

(22) Compounds of formula (XXIV) can be prepared from compounds of formula (XXIII) wherein D¹, D² and Y³ are as defined herein for compounds of formula (I), R²⁰ is methyl or ethyl and R²⁸ is as defined herein for a compound of formula (VII) by reaction with trimethylsilyl triflate and Hünig's base in 1,2-dichloroethane at reflux temperature as described in Chem. Eur. J. 2009, 15, 6811-6814.

(23) Compounds of formula (XXIII) can be prepared from compounds of formula (XXII) wherein D¹, D² and Y³ are as defined herein for compounds of formula (I) and R²⁸ is as defined herein for a compound of formula (VII). Such transformations can be effected using a number of conditions well known to the person skilled in the art.

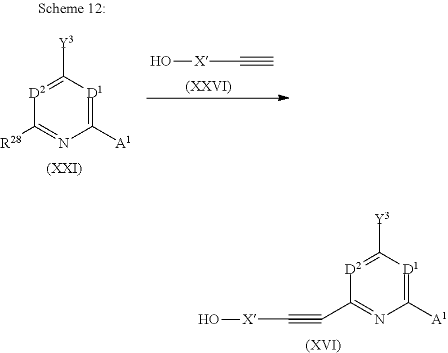

(24) Compounds of formula (XVI) may be prepared by a Sonogashira reaction from compounds of formula (XXI) and compounds of formula (XXVI) wherein X′ is as defined herein for compounds of formula (Ia). The Sonogashira reaction can be carried out analogously to procedure 20 as shown in Scheme 11.

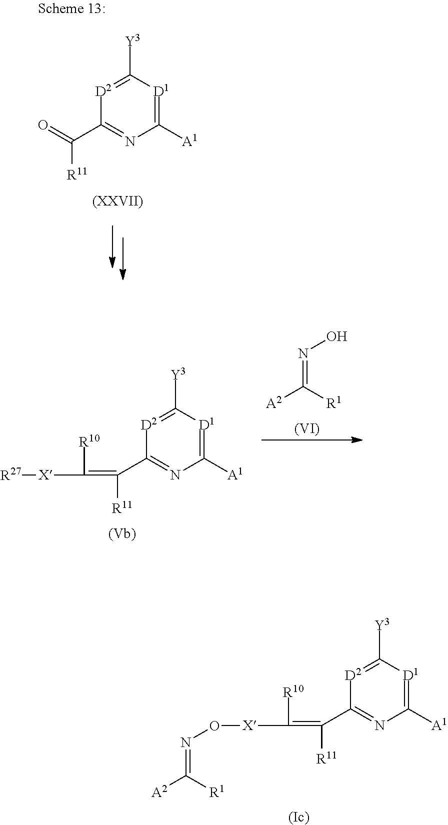

(25) Compounds of formula (Ic) may be prepared from compounds of formula (Vb) that is a compound of formula (V) wherein Z⁴ and Z⁵, Z⁸ and Z⁹ or Z¹³ and Z¹⁴ together form CR¹⁰═CR¹¹ and X′ is as defined for compounds of formula (Ia) and R¹⁰ and R¹¹ are as defined herein for compounds of formula (I), and compounds of formula (VI). The alkylation reaction can be carried out analogously to procedure 5 as shown in Scheme 5.

(26) Compounds of formula (Vb) may be prepared from compounds of formula (XXVII) wherein D¹, D², Y³ and W are as described herein for a compound of formula (I) and R¹¹ is as described herein for a compound of formula (I) in a multistep synthesis. This can be done using one of several techniques well known to the person skilled in the art, including Wittig reaction or Homer-Wadsworth Emmons reactions in the first step and further transformations. See Scheme 14 for a more specific example.

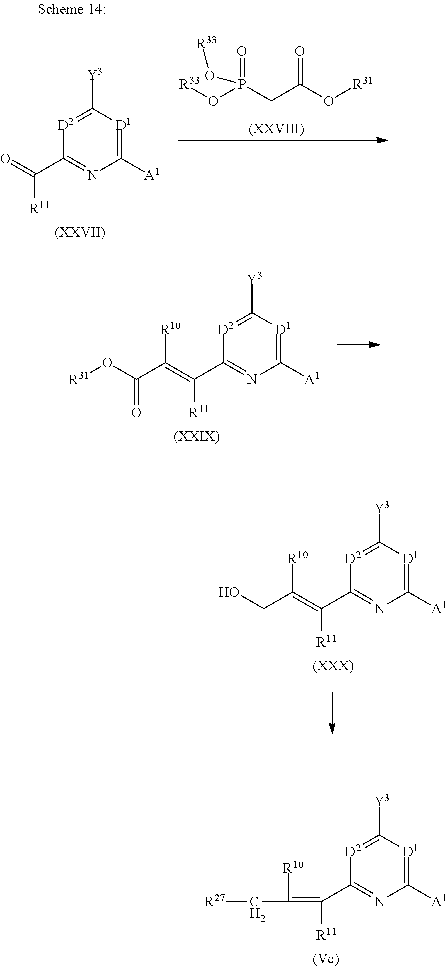

(27) Compounds of formula (Vc), that is a compound wherein X is X-3, Z¹ is methylene, Z² and Z³ together form CR¹⁰═CR¹¹, D¹, D², Y³ and A¹ are as defined herein for compounds of formula (I) and R¹⁰ and R¹¹ are as defined herein for compounds of formula (Ic) may be prepared from compounds of formula (XXX) wherein D¹, D², Y³ and A¹ are as defined herein for compounds of formula (I) and R¹⁰ and R¹¹ are as defined herein for compounds of formula (Ic). Such transformations can be effected using a number of conditions well known to the person skilled in the art.

(28) Compounds of formula (XXX) may be prepared from compounds of formula (XXIX) wherein D¹, D², Y³ and A¹ are as defined herein for compounds of formula (I), R¹⁰ and R¹¹ are as defined herein for compounds of formula (Ic) and R³¹ represents C₁-C₄ alkyl, by reduction with a metal hydride, for example lithium aluminium hydride or diisobutyl aluminium hydride. Examples for such reductions can found in Journal of Combinatorial Chemistry, 7(6), 958-967; 2005. The reaction is usually carried out at temperatures between −100 to 20° C. in the presence of a solvent.

(29) Compounds of formula (XXIX) can be prepared from compounds of formula (XXVII) and a phosphonate of formula (XXVIII) wherein R³¹, R³² and R³³ are C₁-C₄ alkyl in a Homer-Wadsworth Emmons reaction. The reaction is carried out in the presence of a base. Appropriate bases are for example metal hydrides like calcium-, lithium, sodium or potassium hydride, organometallic compounds like buthyllithium or organic bases like for example triethyl-amine or ethyl-diisopropyl-amine in combination with lithium chloride. Examples can be found in Bioorganic & Medicinal Chemistry, 11(18), 4015-4026; 2003; Synthesis, (4), 283-5; 1981 or in Journal of Medicinal Chemistry, 53(3), 1200-1210; 2010

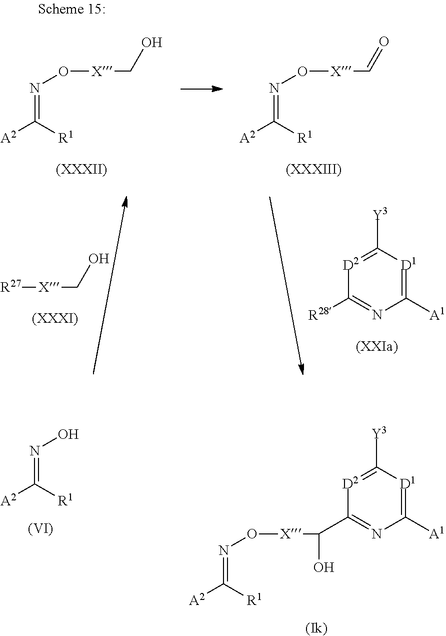

(30) Compounds of formula (Ik), that is a compound of formula (I) wherein Z¹, Z³, Z⁶ or Z¹⁴ represent CH(OH) and X′″ represents X′″-1, X′″-2, X′″-3 or X′″-4

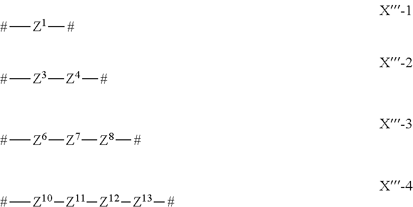

wherein Z¹, Z³, Z⁴, Z⁶, Z⁷, Z⁸, Z¹⁰, Z¹¹, Z¹² and Z¹³ are as defined herein for compounds of formula (I) may be prepared from aldehydes of formula (XXXIII), wherein A² and R¹ are as defined for compounds of formula (I) and X′″ is as defined for a compound of formula (Ik), and compounds of formula (XXIa), that is a compound of formula (XXI) wherein R²⁸ is R^{28′}, wherein R^{28′} is chlorine, bromine or iodine. Such a transformation can be done by the halogen metal exchange in compound (XXIa) with an appropriate reagent like for example magnesium, isopropyl magnesium chloride or bromide or n-buthyllithium and the reaction of this metalated pyridine intermediate with a compound of formula (XXXIII). Examples for such transformations can be found in Angewandte Chemie, International Edition, 43(25), 3333-3336; 2004; Organic Letters, 6(26), 4905-4907; 2004; Journal of the American Chemical Society, 130(38), 12592-12593; 2008 or in Organic Letters, 11(20), 4540-4543; 2009

Compounds of formula (Ik) are especially useful as intermediates to a number of other compounds, wherein the hydroxy group formed is transformed into other functional groups, like for example carbonyl, fluorine or chlorine. Such transformations can be effected using a number of conditions well known to the person skilled in the art.

(31) Compounds of formula (XXXIII) can be prepared by oxidation from compounds of formula (XXXII). Such oxidations can be effected using a number of conditions well known to the person skilled in the art. Specific reaction conditions may be found in Organic & Biomolecular Chemistry, 6(21), 4036-4040; 2008; Bioorganic & Medicinal Chemistry Letters, 19(13), 3627-3631; 2009; Chemical Communications (Cambridge, United Kingdom), (37), 5618-5620; 2009; or in Synthesis, (1), 91-97; 2010.

(32) Compounds of formula (XXXII) can be prepared from compound of formula (VI) and compounds of formula (XXXI) wherein X′″ is as defined herein for compounds of formula (Ik) and R²⁷ is as defined herein for a compound of formula (V). Many of such compounds are known in the literature and are commercially available or can be prepared by methods well known to the person skilled in the art. The alkylation reaction can be carried out analogously to procedure 5 as shown in Scheme 5.

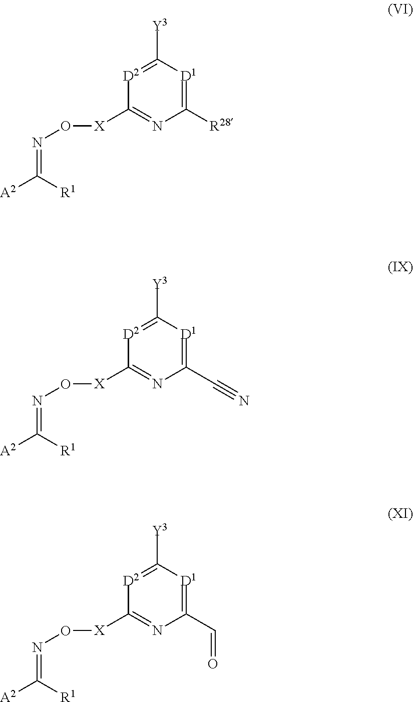

Compounds of formula (VI), (IX) and (XI) can be prepared analogously to procedures 2, 16, 17, 18 and 19 in Scheme 2 and in Scheme 10.

Typical Conditions for Condensation Reactions:

This applies to procedure 1.

Different stoichiometric set-ups may be used for these reactions, depending on the properties of reactants and product. An excess of the electrophile, the nucleophile, or equimolar amounts may be chosen. Preferentially equimolar amounts of electrophilic and nucleophilic compounds are used.

The reaction may be performed in the presence or absence of an inert organic or inorganic solvent, or in the presence of a mixture of such solvents. Preferentially, it is performed in the presence of one or more solvents. Preferred solvents include the following aliphatic or aromatic hydrocarbons, which may optionally be substituted by one or more halogen atoms, such as pentane, hexanes, heptanes, cyclohexane, petroleum ether, benzene, toluene, xylene, chlorobenzene, dichlorobenzenes, dichloromethane, chloroform, 1,2-dichloroethane or carbon tetrachloride, ethers such as diethylether, diisopropyl ether, tert-butyl methyl ether, tetrahydrofuran, 1,4-dioxane, dimethoxyethane or diglycol dimethyl ether, ketones such as acetone, methyl ethyl ketone, methyl isopropyl ketone or methyl isobutyl ketone, acids and ester such as acetic acid, ethyl acetate or methyl acetate, aprotic polar solvents such as acetonitrile, propionitrile, dimethyl formamide, dimethyl acetamide, N-methyl-pyrrolidone, dimethyl sulfoxide, sulfolane, DMPU, or pyridine and picolines. The selection of solvents includes water and alcohols such as methanol, ethanol, propanol, isopropanol, butanol, isobutanol, tert-butanol, pentanol, isopentanol, hexanol, trifluorethanol, ethylene glycol or methoxyethanol.

The reaction may be performed between −20° C. and 250° C., preferentially between 0° C. and 100° C. In some cases the reaction mixture may be heated to reflux.

Where appropriate, compounds can be used in the form of the free compound, or, alternatively, they can be used in the form of a salt such as the acetate, trifluoroacetate, propionate, benzoate, oxalate, methylsulfonate, phenylsulfonate, p-tolylsulfonate, trifluormethylsulfonate, fluoride, chloride, bromide, iodide, sulphate, hydrogensulphate or nitrate, including bis-salts if appropriate.

The reaction can be carried out in the absence of an acid using the free compounds. Alternatively, the reaction may be performed in the presence of an acid in catalytic, stoichiometric or excess amounts. Acids that could be used include acetic acid, propionic acid, oxalic acid, trifluoroacetic acid, hydrochloric acid, hydrobromic acid, hydroiodic acid, methanesulfonic acid, para-toluenesulfonic acid, sulphuric acid, sodium hydrogensulphate and phosphoric acid. The reaction can optionally be carried out in a water-free solvent system in the presence of a drying agent, such as sodium or magnesium sulphate, potassium carbonate or molecular sieves.

If the two substituents at the carbon atom of the oxime or oxime ether function are different from each other, the condensation reaction can lead to a mixture of the E- and the Z-oxime (ether) product. The condensation product may also be exclusively either the E- or the Z-oxime (ether).

Condensations can be performed under reduced pressure, normal pressure or increased pressure. Preferentially the reaction is performed under normal pressure.

Typical conditions for alkylation reactions:

This applies to procedures 16, 25 and 32.

Different stoichiometric set-ups may be used for these reactions, depending on the properties of reactants and product. An excess of the electrophile, the nucleophile, or neither may be chosen. Usually, it is preferable that equimolar amounts of electrophilic and nucleophilic compounds are used.

The reaction may be performed in the absence or presence of a solvent or a mixture of solvents. Preferential solvents include the following aliphatic or aromatic hydrocarbons that may optionally be substituted by one or more halogen atoms such as pentane, hexanes, heptanes, cyclohexane, petroleum ether, benzene, toluene, xylene, chlorobenzene, dichlorobenzenes, dichloromethane, chloroform, 1,2-dichloroethanev or carbon tetrachloride, ethers such as diethyl ether, diisopropyl ether, tert-butyl-methyl ether, tetrahydrofuran, 1,4-dioxane, dimethoxyethane or diglycol dimethyl ether, ketones such as acetone, methyl ethyl ketone, methyl isopropyl ketone or methyl isobutyl ketone, acids and ester such as acetic acid, ethyl acetate or methyl acetate, aprotic polar solvents such as acetonitrile, propionitrile, dimethyl formamide, dimethyl acetamide, N-methyl-pyrrolidone, dimethyl sulfoxide, sulfolane, DMPU, or pyridine and picolines. The selection of solvents includes also water and alcohols such as methanol, ethanol, propanol, isopropanol, butanol, isobutanol, tert-butanol, pentanol, isopentanol, hexanol, trifluorethanol, ethylene glycol or methoxyethanol.

The reaction may be performed in a biphasic system comprising an organic solvent that is not miscible with water, such as toluene, dichloromethane, dichloro-ethylene, and an aqueous solvent, such as water. Such a reaction would be performed in the presence of a phase-transfer catalyst, such as tetra-n-butylammonium bromide (TBAB), Tetradecyldimethylbenzylammonium chloride (TDMBAC), N-Benzyltrimethylammonium hydroxide, along with aqueous sodium or potassium hydroxide in stoichiometric amounts. The biphasic reaction may be performed with or without ultrasonication.

The reaction may be carried out at temperatures varying from −100° C. and 250° C. Preferentially, the temperature range is between 0° C. and 100° C.

Optionally, an organic or inorganic base may be present such as alkali- and earth alkali acetates, amides, carbonates, hydrogencarbonates, hydrides, hydroxides or alcoholates such as sodium, potassium, caesium or calcium acetate, sodium, potassium, caesium or calcium carbonate, sodium, potassium, caesium or calcium hydrogencarbonate, sodium, potassium, caesium or calcium hydride, sodium, potassium, caesium or calcium amide, sodium, potassium, caesium or calcium hydroxide, sodium, potassium, caesium or calcium methanolate, sodium, potassium, caesium or calcium ethanolate, sodium, potassium, caesium or calcium n-, i-, s- or t-butanolate, triethylamine, tripropylamine, tributylamine, di-isopropyl-ethylamine, N,N-dimethyl-cyclohexylamine, N-methyl-dicyclohexylamine, N,N-dimethyl-aniline, N,N-diethyl-aniline, N,N-dimethyl-benzylamine, N,N-diethyl-benzylamine, pyridine, 2-methyl-pyridine, 3-methyl-pyridine, 4-methyl-pyridine, 2,6-dimethyl-pyridine, 2,4,6-trimethyl-pyridine, 4-dimethylamino-pyridine, N-methyl-piperidine, N-ethyl-piperidine, N-methyl-morpholine, N-ethyl-morpholine, N,N′-dimethyl-piperazine, 1,4-Diazabicyclo[2.2.2]octane (DABCO), 1,8-Diaza-7-bicyclo[5.4.0]undecene (DBU), 1,5-Diazabicyclo[4.3.0]non-5-ene (DBN), 1-tert-Butyl-2,2,2-tri(1-pyrrolidinyl)phosphazene (BTPP), 1-tert-Butyl-2,2,2-tris(dimethylamino)phosphazene, sodium hexamethyldisilazane, potassium hexamethyldisilazane, lithium diisopropylamide, ethyl magnesium chloride, isopropylmagnesium chloride.

The alkylation can be performed under reduced pressure, normal pressure or increased pressure. Preferentially the reaction is performed under normal pressure.

The products of schemes 1) to 15) may be required to be purified using, for example, chromatography, crystallisation or other purification techniques well known to the person skilled in the art.

The compounds of formula (I) to formula (XXXIII) and, where appropriate, the tautomers thereof, can, if appropriate, also be obtained in the form of hydrates and/or include other solvents, for example those which may have been used for the crystallization of compounds which are present in solid form.

It has now been found that the compounds of formula (I) according to the invention have, for practical purposes, a very advantageous spectrum of activities for protecting useful plants against diseases that are caused by phytopathogenic microorganisms, such as fungi, bacteria or viruses.

The invention therefore also relates to a method of controlling or preventing infestation of useful plants by phytopathogenic microorganisms, wherein a compound of formula (I) is applied as active ingredient to the plants, to parts thereof or the locus thereof. The compounds of formula (I) according to the invention are distinguished by excellent activity at low rates of application, by being well tolerated by plants and by being environmentally safe. They have very useful curative, preventive and systemic properties and are used for protecting numerous useful plants. The compounds of formula (I) can be used to inhibit or destroy the diseases that occur on plants or parts of plants (fruit, blossoms, leaves, stems, tubers, roots) of different crops of useful plants, while at the same time protecting also those parts of the plants that grow later e.g. from phytopathogenic microorganisms.

It is also possible to use compounds of formula (I) as dressing agents for the treatment of plant propagation material, in particular of seeds (fruit, tubers, grains) and plant cuttings (e.g. rice), for the protection against fungal infections as well as against phytopathogenic fungi occurring in the soil.

Furthermore the compounds of formula (I) according to the invention may be used for controlling fungi in related areas, for example in the protection of technical materials, including wood and wood related technical products, in food storage or in hygiene management.

The compounds of formula (I) are, for example, effective against the phytopathogenic fungi of the following classes: Fungi imperfecti (e.g. Botrytis, Pyricularia, Helminthosporium, Fusarium, Septoria, Cercospora and Alternaria) and Basidiomycetes (e.g. Rhizoctonia, Hemileia, Puccinia). Additionally, they are also effective against the Ascomycetes classes (e.g. Venturia and Erysiphe, Podosphaera, Monilinia, Uncinula) and of the Oomycetes classes (e.g. Phytophthora, Pythium, Plasmopara). Within the scope of the invention, useful plants to be protected typically comprise the following species of plants: cereal (wheat, barley, rye, oat, rice, maize, sorghum and related species); beet (sugar beet and fodder beet); pomes, drupes and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (pumpkins, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamomum, camphor) or plants such as tobacco, nuts, coffee, eggplants, sugar cane, tea, pepper, vines, hops, bananas and natural rubber plants, as well as ornamentals.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); Nature-Gard® Agrisure® GT Advantage (GA21 glyphosate-tolerant trait), Agrisure® CB Advantage (Bt11 corn borer (CB) trait), Agrisure® RW (corn rootworm trait) and Protecta®.

The term “useful plants” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

The compounds of formula (I) can be used in unmodified form or, preferably, together with carriers and adjuvants conventionally employed in the art of formulation.

Therefore the invention also relates to compositions for controlling and protecting against phytopathogenic microorganisms, comprising a compound of formula (I) and an inert carrier, and to a method of controlling or preventing infestation of useful plants by phytopathogenic microorganisms, wherein a composition, comprising a compound of formula (I) as active ingredient and an inert carrier, is applied to the plants, to parts thereof or the locus thereof.

To this end compounds of formula (I) and inert carriers are conveniently formulated in known manner to emulsifiable concentrates, coatable pastes, directly sprayable or dilutable solutions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

Suitable carriers and adjuvants (auxiliaries) can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

The compounds of formula (I) or compositions, comprising a compound of formula (I) as active ingredient and an inert carrier, can be applied to the locus of the plant or plant to be treated, simultaneously or in succession with further compounds. These further compounds can be e.g. fertilizers or micronutrient donors or other preparations which influence the growth of plants. They can also be selective herbicides as well as insecticides, fungicides, bactericides, nematicides, molluscicides or mixtures of several of these preparations, if desired together with further carriers, surfactants or application promoting adjuvants customarily employed in the art of formulation.

A preferred method of applying a compound of formula (I), or a composition, comprising a compound of formula (I) as active ingredient and an inert carrier, is foliar application. The frequency of application and the rate of application will depend on the risk of infestation by the corresponding pathogen. However, the compounds of formula (I) may also penetrate the plant through the roots via the soil (systemic action) by drenching the locus of the plant with a liquid formulation, or by applying the compounds in solid form to the soil, e.g. in granular form (soil application). In crops of water rice such granulates can be applied to the flooded rice field. The compounds of formula (I) may also be applied to seeds (coating) by impregnating the seeds or tubers either with a liquid formulation of the fungicide or coating them with a solid formulation.

A formulation, i.e. a composition comprising the compound of formula (I) and, if desired, a solid or liquid adjuvant, is prepared in a known manner, typically by intimately mixing and/or grinding the compound with extenders, for example solvents, solid carriers and, optionally, surface-active compounds (surfactants).

The agrochemical formulations will usually contain from 0.1 to 99% by weight, preferably from 0.1 to 95% by weight, of the compound of formula (I), 99.9 to 1% by weight, preferably 99.8 to 5% by weight, of a solid or liquid adjuvant, and from 0 to 25% by weight, preferably from 0.1 to 25% by weight, of a surfactant.

Whereas it is preferred to formulate commercial products as concentrates, the end user will normally use dilute formulations.

Advantageous rates of application are normally from 5 g to 2 kg of active ingredient (a.i.) per hectare (ha), preferably from 10 g to 1 kg a.i./ha, most preferably from 20 g to 600 g a.i./ha. When used as seed drenching agent, convenient rates of application are from 10 mg to 1 g of active substance per kg of seeds. The rate of application for the desired action can be determined by experiments. It depends for example on the type of action, the developmental stage of the useful plant, and on the application (location, timing, application method) and can, owing to these parameters, vary within wide limits.

The compounds of formula (I), or a pharmaceutical salt thereof, described above may also have an advantageous spectrum of activity for the treatment and/or prevention of microbial infection in an animal. “Animal” can be any animal, for example, insect, mammal, reptile, fish, amphibian, preferably mammal, most preferably human. “Treatment” means the use on an animal which has microbial infection in order to reduce or slow or stop the increase or spread of the infection, or to reduce the infection or to cure the infection. “Prevention” means the use on an animal which has no apparent signs of microbial infection in order to prevent any future infection, or to reduce or slow the increase or spread of any future infection.

According to the present invention there is provided the use of a compound of formula (I) in the manufacture of a medicament for use in the treatment and/or prevention of microbial infection in an animal. There is also provided the use of a compound of formula (I) as a pharmaceutical agent. There is also provided the use of a compound of formula (I) as an antimicrobial agent in the treatment of an animal. According to the present invention there is also provided a pharmaceutical composition comprising as an active ingredient a compound of formula (I), or a pharmaceutically acceptable salt thereof, and a pharmaceutically acceptable diluent or carrier. This composition can be used for the treatment and/or prevention of antimicrobial infection in an animal. This pharmaceutical composition can be in a form suitable for oral administration, such as tablet, lozenges, hard capsules, aqueous suspensions, oily suspensions, emulsions dispersible powders, dispersible granules, syrups and elixirs. Alternatively this pharmaceutical composition can be in a form suitable for topical application, such as a spray, a cream or lotion. Alternatively this pharmaceutical composition can be in a form suitable for parenteral administration, for example injection. Alternatively this pharmaceutical composition can be in inhalable form, such as an aerosol spray.

The compounds of formula (I) may be effective against various microbial species able to cause a microbial infection in an animal. Examples of such microbial species are those causing Aspergillosis such as Aspergillus fumigatus, A. flavus, A. terrus, A. nidulans and A. niger, those causing Blastomycosis such as Blastomyces dermatitidis; those causing Candidiasis such as Candida albicans, C. glabrata, C. tropicalis, C. parapsilosis, C. krusei and C. lusitaniae; those causing Coccidioidomycosis such as Coccidioides immitis; those causing Cryptococcosis such as Cryptococcus neoformans; those causing Histoplasmosis such as Histoplasma capsulatum and those causing Zygomycosis such as Absidia corymbifera, Rhizomucor pusillus and Rhizopus arrhizus. Further examples are Fusarium Spp such as Fusarium oxysporum and Fusarium solani and Scedosporium Spp such as Scedosporium apiospermum and Scedosporium prolificans. Still further examples are Microsporum Spp, Trichophyton Spp, Epidermophyton Spp, Mucor Spp, Sporothorix Spp, Phialophora Spp, Cladosporium Spp, Petriellidium spp, Paracoccidioides Spp and Histoplasma Spp.

In addition, further, other biocidally active ingredients or compositions may be combined with the compound of formula (I) and used in the methods of the invention and applied simultaneously or sequentially with the compound of formula (I). When applied simultaneously, these further active ingredients may be formulated together with the compound of formula (I) or mixed in, for example, the spray tank. These further biocidally active ingredients may be fungicides, herbicides, insecticides, bactericides, acaricides, nematicides and/or plant growth regulators.

Accordingly, in one aspect, the present invention provides a composition comprising a compound of formula (I), which is selected from compounds 1 to 156 of Table 1, and (i) a further fungicide, (ii) a herbicide, (iii) an insecticide, (iv) a bactericide, (v) an acaricide, (vi) a nematicide and/or (vii) a plant growth regulator.

Additionally, the present invention provides for the use of a composition in the methods of the present invention, said composition comprising a compound of formula (I), which is selected from compounds 1 to 156 of Table 1, and (i) a further fungicide, (ii) a herbicide, (iii) an insecticide, (iv) a bactericide, (v) an acaricide, (vi) a nematicide and/or (vii) a plant growth regulator.

In addition, the compounds of the invention may also be applied with one or more systemically acquired resistance inducers (“SAR” inducer). SAR inducers are known and described in, for example, U.S. Pat. No. 6,919,298 and include, for example, salicylates and the commercial SAR inducer acibenzolar-5-methyl.

The present invention relates additionally to mixtures comprising at least a compound of formula I and at least a further, other biocidally active ingredient and optionally further ingredients. The further, other biocidally active ingredient are known for example from “The Pesticide Manual” [The Pesticide Manual—A World Compendium; Thirteenth Edition (New edition (2 Nov. 2003)); Editor: C. D. S. Tomlin; The British Crop Protection Council, ISBN-10: 1901396134; ISBN-13: 978-1901396133] or its electronic version “e-Pesticide Manual V4.2” or from the website http://www.alanwood.net/pesticides/ or preferably one of the further pesticides listed below.

The following mixtures of the compounds of TX with a further active ingredient (B) are preferred (the abbreviation “TX” means a compound encompassed by the compounds of formula I, or preferably the term “TX” refers to a compound selected from the Tables 1-39:

an adjuvant selected from the group of substances consisting of petroleum oils (alternative name) (628)+TX,

an acaricide selected from the group of substances consisting of 1,1-bis(4-chloro-phenyl)-2-ethoxyethanol (IUPAC name) (910)+TX, 2,4-dichlorophenyl benzenesulfonate (IUPAC/Chemical Abstracts name) (1059)+TX, 2-fluoro-N-methyl-N-1-naphthylacetamide (IUPAC name) (1295)+TX, 4-chlorophenyl phenyl sulfone (IUPAC name) (981)+TX, abamectin (1)+TX, acequinocyl (3)+TX, acetoprole [CCN]+TX, acrinathrin (9)+TX, aldicarb (16)+TX, aldoxycarb (863)+TX, alpha-cypermethrin (202)+TX, amidithion (870)+TX, amidoflumet [CCN]+TX, amidothioate (872)+TX, amiton (875)+TX, amiton hydrogen oxalate (875)+TX, amitraz (24)+TX, aramite (881)+TX, arsenous oxide (882)+TX, AVI 382 (compound code)+TX, AZ 60541 (compound code)+TX, azinphos-ethyl (44)+TX, azinphos-methyl (45)+TX, azobenzene (IUPAC name) (888)+TX, azocyclotin (46)+TX, azothoate (889)+TX, benomyl (62)+TX, benoxafos (alternative name) [CCN]+TX, benzoximate (71)+TX, benzyl benzoate (IUPAC name) [CCN]+TX, bifenazate (74)+TX, bifenthrin (76)+TX, binapacryl (907)+TX, brofenvalerate (alternative name)+TX, bromocyclen (918)+TX, bromophos (920)+TX, bromophos-ethyl (921)+TX, bromopropylate (94)+TX, buprofezin (99)+TX, butocarboxim (103)+TX, butoxycarboxim (104)+TX, butylpyridaben (alternative name)+TX, calcium polysulfide (IUPAC name) (111)+TX, camphechlor (941)+TX, carbanolate (943)+TX, carbaryl (115)+TX, carbofuran (118)+TX, carbophenothion (947)+TX, CGA 50′439 (development code) (125)+TX, chinomethionat (126)+TX, chlorbenside (959)+TX, chlordimeform (964)+TX, chlordimeform hydrochloride (964)+TX, chlorfenapyr (130)+TX, chlorfenethol (968)+TX, chlorfenson (970)+TX, chlorfensulphide (971)+TX, chlorfenvinphos (131)+TX, chlorobenzilate (975)+TX, chloromebuform (977)+TX, chloromethiuron (978)+TX, chloropropylate (983)+TX, chlorpyrifos (145)+TX, chlorpyrifos-methyl (146)+TX, chlorthiophos (994)+TX, cinerin I (696)+TX, cinerin II (696)+TX, cinerins (696)+TX, clofentezine (158)+TX, closantel (alternative name) [CCN]+TX, coumaphos (174)+TX, crotamiton (alternative name) [CCN]+TX, crotoxyphos (1010)+TX, cufraneb (1013)+TX, cyanthoate (1020)+TX, cyflumetofen (CAS Reg. No.: 400882-07-7)+TX, cyhalothrin (196)+TX, cyhexatin (199)+TX, cypermethrin (201)+TX, DCPM (1032)+TX, DDT (219)+TX, demephion (1037)+TX, demephion-O (1037)+TX, demephion-S (1037)+TX, demeton (1038)+TX, demeton-methyl (224)+TX, demeton-O (1038)+TX, demeton-O-methyl (224)+TX, demeton-S (1038)+TX, demeton-5-methyl (224)+TX, demeton-S-methylsulphon (1039)+TX, diafenthiuron (226)+TX, dialifos (1042)+TX, diazinon (227)+TX, dichlofluanid (230)+TX, dichlorvos (236)+TX, dicliphos (alternative name)+TX, dicofol (242)+TX, dicrotophos (243)+TX, dienochlor (1071)+TX, dimefox (1081)+TX, dimethoate (262)+TX, dinactin (alternative name) (653)+TX, dinex (1089)+TX, dinex-diclexine (1089)+TX, dinobuton (269)+TX, dinocap (270)+TX, dinocap-4 [CCN]+TX, dinocap-6 [CCN]+TX, dinocton (1090)+TX, dinopenton (1092)+TX, dinosulfon (1097)+TX, dinoterbon (1098)+TX, dioxathion (1102)+TX, diphenyl sulfone (IUPAC name) (1103)+TX, disulfuram (alternative name) [CCN]+TX, disulfoton (278)+TX, DNOC (282)+TX, dofenapyn (1113)+TX, doramectin (alternative name) [CCN]+TX, endosulfan (294)+TX, endothion (1121)+TX, EPN (297)+TX, eprinomectin (alternative name) [CCN]+TX, ethion (309)+TX, ethoate-methyl (1134)+TX, etoxazole (320)+TX, etrimfos (1142)+TX, fenazaflor (1147)+TX, fenazaquin (328)+TX, fenbutatin oxide (330)+TX, fenothiocarb (337)+TX, fenpropathrin (342)+TX, fenpyrad (alternative name)+TX, fen-pyroximate (345)+TX, fenson (1157)+TX, fentrifanil (1161)+TX, fenvalerate (349)+TX, fipronil (354)+TX, fluacrypyrim (360)+TX, fluazuron (1166)+TX, flubenzimine (1167)+TX, flucycloxuron (366)+TX, flucythrinate (367)+TX, fluenetil (1169)+TX, flufenoxuron (370)+TX, flumethrin (372)+TX, fluorbenside (1174)+TX, fluvalinate (1184)+TX, FMC 1137 (development code) (1185)+TX, formetanate (405)+TX, formetanate hydrochloride (405)+TX, formothion (1192)+TX, formparanate (1193)+TX, gamma-HCH (430)+TX, glyodin (1205)+TX, halfenprox (424)+TX, heptenophos (432)+TX, hexadecyl cyclopropanecarboxylate (IUPAC/Chemical Abstracts name) (1216)+TX, hexythiazox (441)+TX, iodomethane (IUPAC name) (542)+TX, isocarbophos (alternative name) (473)+TX, isopropyl O-(methoxyaminothiophosphoryl)salicylate (IUPAC name) (473)+TX, ivermectin (alternative name) [CCN]+TX, jasmolin I (696)+TX, jasmolin II (696)+TX, jodfenphos (1248)+TX, lindane (430)+TX, lufenuron (490)+TX, malathion (492)+TX, malonoben (1254)+TX, mecarbam (502)+TX, mephosfolan (1261)+TX, mesulfen (alternative name) [CCN]+TX, methacrifos (1266)+TX, methamidophos (527)+TX, methidathion (529)+TX, methiocarb (530)+TX, methomyl (531)+TX, methyl bromide (537)+TX, metolcarb (550)+TX, mevinphos (556)+TX, mexacarbate (1290)+TX, milbemectin (557)+TX, milbemycin oxime (alternative name) [CCN]+TX, mipafox (1293)+TX, monocrotophos (561)+TX, morphothion (1300)+TX, moxidectin (alternative name) [CCN]+TX, naled (567)+TX, NC-184 (compound code)+TX, NC-512 (compound code)+TX, nifluridide (1309)+TX, nikkomycins (alternative name) [CCN]+TX, nitrilacarb (1313)+TX, nitrilacarb 1:1 zinc chloride complex (1313)+TX, NNI-0101 (compound code)+TX, NNI-0250 (compound code)+TX, omethoate (594)+TX, oxamyl (602)+TX, oxydeprofos (1324)+TX, oxydisulfoton (1325)+TX, pp′-DDT (219)+TX, parathion (615)+TX, permethrin (626)+TX, petroleum oils (alternative name) (628)+TX, phenkapton (1330)+TX, phenthoate (631)+TX, phorate (636)+TX, phosalone (637)+TX, phosfolan (1338)+TX, phosmet (638)+TX, phosphamidon (639)+TX, phoxim (642)+TX, pirimiphos-methyl (652)+TX, polychloroterpenes (traditional name) (1347)+TX, polynactins (alternative name) (653)+TX, proclonol (1350)+TX, profenofos (662)+TX, promacyl (1354)+TX, propargite (671)+TX, propetamphos (673)+TX, propoxur (678)+TX, prothidathion (1360)+TX, prothoate (1362)+TX, pyrethrin I (696)+TX, pyrethrin II (696)+TX, pyrethrins (696)+TX, pyridaben (699)+TX, pyridaphenthion (701)+TX, pyrimidifen (706)+TX, pyrimitate (1370)+TX, quinalphos (711)+TX, quintiofos (1381)+TX, R-1492 (development code) (1382)+TX, RA-17 (development code) (1383)+TX, rotenone (722)+TX, schradan (1389)+TX, sebufos (alternative name)+TX, selamectin (alternative name) [CCN]+TX, SI-0009 (compound code)+TX, sophamide (1402)+TX, spirodiclofen (738)+TX, spiromesifen (739)+TX, SSI-121 (development code) (1404)+TX, sulfuram (alternative name) [CCN]+TX, sulfluramid (750)+TX, sulfotep (753)+TX, sulphur (754)+TX, SZ¹-121 (development code) (757)+TX, tau-fluvalinate (398)+TX, tebufenpyrad (763)+TX, TEPP (1417)+TX, terbam (alternative name)+TX, tetrachlorvinphos (777)+TX, tetradifon (786)+TX, tetranactin (alternative name) (653)+TX, tetrasul (1425)+TX, thiafenox (alternative name)+TX, thiocarboxime (1431)+TX, thiofanox (800)+TX, thiometon (801)+TX, thioquinox (1436)+TX, thuringiensin (alternative name) [CCN]+TX, triamiphos (1441)+TX, triarathene (1443)+TX, triazophos (820)+TX, triazuron (alternative name)+TX, trichlorfon (824)+TX, trifenofos (1455)+TX, trinactin (alternative name) (653)+TX, vamidothion (847)+TX, vaniliprole [CCN] and YI-5302 (compound code)+TX,

an algicide selected from the group of substances consisting of bethoxazin [CCN]+TX, copper dioctanoate (IUPAC name) (170)+TX, copper sulfate (172)+TX, cybutryne [CCN]+TX, dichlone (1052)+TX, dichlorophen (232)+TX, endothal (295)+TX, fentin (347)+TX, hydrated lime [CCN]+TX, nabam (566)+TX, quinoclamine (714)+TX, quinonamid (1379)+TX, simazine (730)+TX, triphenyltin acetate (IUPAC name) (347) and triphenyltin hydroxide (IUPAC name) (347)+TX,

an anthelmintic selected from the group of substances consisting of abamectin (1)+TX, crufomate (1011)+TX, doramectin (alternative name) [CCN]+TX, emamectin (291)+TX, emamectin benzoate (291)+TX, eprinomectin (alternative name) [CCN]+TX, ivermectin (alternative name) [CCN]+TX, milbemycin oxime (alternative name) [CCN]+TX, moxidectin (alternative name) [CCN]+TX, piperazine [CCN]+TX, selamectin (alternative name) [CCN]+TX, spinosad (737) and thiophanate (1435)+TX,

an avicide selected from the group of substances consisting of chloralose (127)+TX, endrin (1122)+TX, fenthion (346)+TX, pyridin-4-amine (IUPAC name) (23) and strychnine (745)+TX,

a bactericide selected from the group of substances consisting of 1-hydroxy-1H-pyridine-2-thione (IUPAC name) (1222)+TX, 4-(quinoxalin-2-ylamino)benzenesulfonamide (IUPAC name) (748)+TX, 8-hydroxyquinoline sulfate (446)+TX, bronopol (97)+TX, copper dioctanoate (IUPAC name) (170)+TX, copper hydroxide (IUPAC name) (169)+TX, cresol [CCN]+TX, dichlorophen (232)+TX, dipyrithione (1105)+TX, dodicin (1112)+TX, fenaminosulf (1144)+TX, formaldehyde (404)+TX, hydrargaphen (alternative name) [CCN]+TX, kasugamycin (483)+TX, kasugamycin hydrochloride hydrate (483)+TX, nickel bis(dimethyldithiocarbamate) (IUPAC name) (1308)+TX, nitrapyrin (580)+TX, octhilinone (590)+TX, oxolinic acid (606)+TX, oxytetracycline (611)+TX, potassium hydroxyquinoline sulfate (446)+TX, probenazole (658)+TX, streptomycin (744)+TX, streptomycin sesquisulfate (744)+TX, tecloftalam (766)+TX, and thiomersal (alternative name) [CCN]+TX,

a biological agent selected from the group of substances consisting of Adoxophyes orana GV (alternative name) (12)+TX, Agrobacterium radiobacter (alternative name) (13)+TX, Amblyseius spp. (alternative name) (19)+TX, Anagrapha falcifera NPV (alternative name) (28)+TX, Anagrus atomus (alternative name) (29)+TX, Aphelinus abdominalis (alternative name) (33)+TX, Aphidius colemani (alternative name) (34)+TX, Aphidoletes aphidimyza (alternative name) (35)+TX, Autographa californica NPV (alternative name) (38)+TX, Bacillus firmus (alternative name) (48)+TX, Bacillus sphaericus Neide (scientific name) (49)+TX, Bacillus thuringiensis Berliner (scientific name) (51)+TX, Bacillus thuringiensis subsp. aizawai (scientific name) (51)+TX, Bacillus thuringiensis subsp. israelensis (scientific name) (51)+TX, Bacillus thuringiensis subsp. japonensis (scientific name) (51)+TX, Bacillus thuringiensis subsp. kurstaki (scientific name) (51)+TX, Bacillus thuringiensis subsp. tenebrionis (scientific name) (51)+TX, Beauveria bassiana (alternative name) (53)+TX, Beauveria brongniartii (alternative name) (54)+TX, Chrysoperla carnea (alternative name) (151)+TX, Cryptolaemus montrouzieri (alternative name) (178)+TX, Cydia pomonella GV (alternative name) (191)+TX, Dacnusa sibirica (alternative name) (212)+TX, Diglyphus isaea (alternative name) (254)+TX, Encarsia formosa (scientific name) (293)+TX, Eretmocerus eremicus (alternative name) (300)+TX, Helicoverpa zea NPV (alternative name) (431)+TX, Heterorhabditis bacteriophora and H. megidis (alternative name) (433)+TX, Hippodamia convergens (alternative name) (442)+TX, Leptomastix dactylopii (alternative name) (488)+TX, Macrolophus caliginosus (alternative name) (491)+TX, Mamestra brassicae NPV (alternative name) (494)+TX, Metaphycus helvolus (alternative name) (522)+TX, Metarhizium anisopliae var. acridum (scientific name) (523)+TX, Metarhizium anisopliae var. anisopliae (scientific name) (523)+TX, Neodiprion sertifer NPV and N. lecontei NPV (alternative name) (575)+TX, Orius spp. (alternative name) (596)+TX, Paecilomyces fumosoroseus (alternative name) (613)+TX, Phytoseiulus persimilis (alternative name) (644)+TX, Spodoptera exigua multicapsid nuclear polyhedrosis virus (scientific name) (741)+TX, Steinernema bibionis (alternative name) (742)+TX, Steinernema carpocapsae (alternative name) (742)+TX, Steinernema feltiae (alternative name) (742)+TX, Steinernema glaseri (alternative name) (742)+TX, Steinernema riobrave (alternative name) (742)+TX, Steinernema riobravis (alternative name) (742)+TX, Steinernema scapterisci (alternative name) (742)+TX, Steinernema spp. (alternative name) (742)+TX, Trichogramma spp. (alternative name) (826)+TX, Typhlodromus occidentalis (alternative name) (844) and Verticillium lecanii (alternative name) (848)+TX,

a soil sterilant selected from the group of substances consisting of iodomethane (IUPAC name) (542) and methyl bromide (537)+TX,

a chemosterilant selected from the group of substances consisting of apholate [CCN]+TX, bisazir (alternative name) [CCN]+TX, busulfan (alternative name) [CCN]+TX, diflubenzuron (250)+TX, dimatif (alternative name) [CCN]+TX, hemel [CCN]+TX, hempa [CCN]+TX, metepa [CCN]+TX, methiotepa [CCN]+TX, methyl apholate [CCN]+TX, morzid [CCN]+TX, penfluoron (alternative name) [CCN]+TX, tepa [CCN]+TX, thiohempa (alternative name) [CCN]+TX, thiotepa (alternative name) [CCN]+TX, tretamine (alternative name) [CCN] and uredepa (alternative name) [CCN]+TX,

an insect pheromone selected from the group of substances consisting of (E)-dec-5-en-1-yl acetate with (E)-dec-5-en-1-ol (IUPAC name) (222)+TX, (E)-tridec-4-en-1-yl acetate (IUPAC name) (829)+TX, (E)-6-methylhept-2-en-4-ol (IUPAC name) (541)+TX, (E,Z)-tetradeca-4,10-dien-1-yl acetate (IUPAC name) (779)+TX, (Z)-dodec-7-en-1-yl acetate (IUPAC name) (285)+TX, (Z)-hexadec-11-enal (IUPAC name) (436)+TX, (Z)-hexadec-11-en-1-yl acetate (IUPAC name) (437)+TX, (Z)-hexadec-13-en-11-yn-1-yl acetate (IUPAC name) (438)+TX, (Z)-icos-13-en-10-one (IUPAC name) (448)+TX, (Z)-tetradec-7-en-1-al (IUPAC name) (782)+TX, (Z)-tetradec-9-en-1-ol (IUPAC name) (783)+TX, (Z)-tetradec-9-en-1-yl acetate (IUPAC name) (784)+TX, (7E,9Z)-dodeca-7,9-dien-1-yl acetate (IUPAC name) (283)+TX, (9Z,11E)-tetradeca-9,11-dien-1-yl acetate (IUPAC name) (780)+TX, (9Z,12E)-tetradeca-9,12-dien-1-yl acetate (IUPAC name) (781)+TX, 14-methyloctadec-1-ene (IUPAC name) (545)+TX, 4-methylnonan-5-ol with 4-methylnonan-5-one (IUPAC name) (544)+TX, alpha-multistriatin (alternative name) [CCN]+TX, brevicomin (alternative name) [CCN]+TX, codlelure (alternative name) [CCN]+TX, codlemone (alternative name) (167)+TX, cuelure (alternative name) (179)+TX, disparlure (277)+TX, dodec-8-en-1-yl acetate (IUPAC name) (286)+TX, dodec-9-en-1-yl acetate (IUPAC name) (287)+TX, dodeca-8+TX, 10-dien-1-yl acetate (IUPAC name) (284)+TX, dominicalure (alternative name) [CCN]+TX, ethyl 4-methyloctanoate (IUPAC name) (317)+TX, eugenol (alternative name) [CCN]+TX, frontalin (alternative name) [CCN]+TX, gossyplure (alternative name) (420)+TX, grandlure (421)+TX, grandlure I (alternative name) (421)+TX, grandlure II (alternative name) (421)+TX, grandlure III (alternative name) (421)+TX, grandlure IV (alternative name) (421)+TX, hexylure [CCN]+TX, ipsdienol (alternative name) [CCN]+TX, ipsenol (alternative name) [CCN]+TX, japonilure (alternative name) (481)+TX, lineatin (alternative name) [CCN]+TX, litlure (alternative name) [CCN]+TX, looplure (alternative name) [CCN]+TX, medlure [CCN]+TX, megatomoic acid (alternative name) [CCN]+TX, methyl eugenol (alternative name) (540)+TX, muscalure (563)+TX, octadeca-2,13-dien-1-yl acetate (IUPAC name) (588)+TX, octadeca-3,13-dien-1-yl acetate (IUPAC name) (589)+TX, orfralure (alternative name) [CCN]+TX, oryctalure (alternative name) (317)+TX, ostramone (alternative name) [CCN]+TX, siglure [CCN]+TX, sordidin (alternative name) (736)+TX, sulcatol (alternative name) [CCN]+TX, tetradec-11-en-1-yl acetate (IUPAC name) (785)+TX, trimedlure (839)+TX, trimedlure A (alternative name) (839)+TX, trimedlure B₁ (alternative name) (839)+TX, trimedlure B₂ (alternative name) (839)+TX, trimedlure C (alternative name) (839) and trunc-call (alternative name) [CCN]+TX,

an insect repellent selected from the group of substances consisting of 2-(octylthio)-ethanol (IUPAC name) (591)+TX, butopyronoxyl (933)+TX, butoxy(polypropylene glycol) (936)+TX, dibutyl adipate (IUPAC name) (1046)+TX, dibutyl phthalate (1047)+TX, dibutyl succinate (IUPAC name) (1048)+TX, diethyltoluamide [CCN]+TX, dimethyl carbate [CCN]+TX, dimethyl phthalate [CCN]+TX, ethyl hexanediol (1137)+TX, hexamide [CCN]+TX, methoquin-butyl (1276)+TX, methylneodecanamide [CCN]+TX, oxamate [CCN] and picaridin [CCN]+TX,

an insecticide selected from the group of substances consisting of 1-dichloro-1-nitroethane (IUPAC/Chemical Abstracts name) (1058)+TX, 1,1-dichloro-2,2-bis(4-ethylphenyl)ethane (IUPAC name) (1056), +TX, 1,2-dichloropropane (IUPAC/Chemical Abstracts name) (1062)+TX, 1,2-dichloropropane with 1,3-dichloropropene (IUPAC name) (1063)+TX, 1-bromo-2-chloroethane (IUPAC/Chemical Abstracts name) (916)+TX, 2,2,2-trichloro-1-(3,4-dichlorophenyl)ethyl acetate (IUPAC name) (1451)+TX, 2,2-dichlorovinyl 2-ethylsulphinylethyl methyl phosphate (IUPAC name) (1066)+TX, 2-(1,3-dithiolan-2-yl)phenyl dimethylcarbamate (IUPAC/Chemical Abstracts name) (1109)+TX, 2-(2-butoxyethoxy)ethyl thiocyanate (IUPAC/Chemical Abstracts name) (935)+TX, 2-(4,5-dimethyl-1,3-dioxolan-2-yl)phenyl methylcarbamate (IUPAC/Chemical Abstracts name) (1084)+TX, 2-(4-chloro-3,5-xylyloxy)ethanol (IUPAC name) (986)+TX, 2-chlorovinyl diethyl phosphate (IUPAC name) (984)+TX, 2-imidazolidone (IUPAC name) (1225)+TX, 2-isovalerylindan-1,3-dione (IUPAC name) (1246)+TX, 2-methyl(prop-2-ynyl)aminophenyl methylcarbamate (IUPAC name) (1284)+TX, 2-thiocyanatoethyl laurate (IUPAC name) (1433)+TX, 3-bromo-1-chloroprop-1-ene (IUPAC name) (917)+TX, 3-methyl-1-phenylpyrazol-5-yl dimethylcarbamate (IUPAC name) (1283)+TX, 4-methyl(prop-2-ynyl)amino-3,5-xylyl methylcarbamate (IUPAC name) (1285)+TX, 5,5-dimethyl-3-oxocyclohex-1-enyl dimethylcarbamate (IUPAC name) (1085)+TX, abamectin (1)+TX, acephate (2)+TX, acetamiprid (4)+TX, acethion (alternative name) [CCN]+TX, acetoprole [CCN]+TX, acrinathrin (9)+TX, acrylonitrile (IUPAC name) (861)+TX, alanycarb (15)+TX, aldicarb (16)+TX, aldoxycarb (863)+TX, aldrin (864)+TX, allethrin (17)+TX, allosamidin (alternative name) [CCN]+TX, allyxylcarb (866)+TX, alpha-cypermethrin (202)+TX, alpha-ecdysone (alternative name) [CCN]+TX, aluminium phosphide (640)+TX, amidithion (870)+TX, amidothioate (872)+TX, aminocarb (873)+TX, amiton (875)+TX, amiton hydrogen oxalate (875)+TX, amitraz (24)+TX, anabasine (877)+TX, athidathion (883)+TX, AVI 382 (compound code)+TX, AZ 60541 (compound code)+TX, azadirachtin (alternative name) (41)+TX, azamethiphos (42)+TX, azinphos-ethyl (44)+TX, azinphos-methyl (45)+TX, azothoate (889)+TX, Bacillus thuringiensis delta endotoxins (alternative name) (52)+TX, barium hexafluorosilicate (alternative name) [CCN]+TX, barium polysulfide (IUPAC/Chemical Abstracts name) (892)+TX, barthrin [CCN]+TX, Bayer 22/190 (development code) (893)+TX, Bayer 22408 (development code) (894)+TX, bendiocarb (58)+TX, benfuracarb (60)+TX, bensultap (66)+TX, beta-cyfluthrin (194)+TX, beta-cypermethrin (203)+TX, bifenthrin (76)+TX, bioallethrin (78)+TX, bioallethrin S-cyclopentenyl isomer (alternative name) (79)+TX, bioethanomethrin [CCN]+TX, biopermethrin (908)+TX, bioresmethrin (80)+TX, bis(2-chloroethyl)ether (IUPAC name) (909)+TX, bistrifluoron (83)+TX, borax (86)+TX, brofenvalerate (alternative name)+TX, bromfenvinfos (914)+TX, bromocyclen (918)+TX, bromo-DDT (alternative name) [CCN]+TX, bromophos (920)+TX, bromophos-ethyl (921)+TX, bufencarb (924)+TX, buprofezin (99)+TX, butacarb (926)+TX, butathiofos (927)+TX, butocarboxim (103)+TX, butonate (932)+TX, butoxycarboxim (104)+TX, butylpyridaben (alternative name)+TX, cadusafos (109)+TX, calcium arsenate [CCN]+TX, calcium cyanide (444)+TX, calcium polysulfide (IUPAC name) (111)+TX, camphechlor (941)+TX, carbanolate (943)+TX, carbaryl (115)+TX, carbofuran (118)+TX, carbon disulfide (IUPAC/Chemical Abstracts name) (945)+TX, carbon tetrachloride (IUPAC name) (946)+TX, carbophenothion (947)+TX, carbosulfan (119)+TX, cartap (123)+TX, cartap hydrochloride (123)+TX, cevadine (alternative name) (725)+TX, chlorbicyclen (960)+TX, chlordane (128)+TX, chlordecone (963)+TX, chlordimeform (964)+TX, chlordimeform hydrochloride (964)+TX, chlorethoxyfos (129)+TX, chlorfenapyr (130)+TX, chlorfenvinphos (131)+TX, chlorfluazuron (132)+TX, chlormephos (136)+TX, chloroform [CCN]+TX, chloropicrin (141)+TX, chlorphoxim (989)+TX, chlorprazophos (990)+TX, chlorpyrifos (145)+TX, chlorpyrifos-methyl (146)+TX, chlorthiophos (994)+TX, chromafenozide (150)+TX, cinerin I (696)+TX, cinerin II (696)+TX, cinerins (696)+TX, cis-resmethrin (alternative name)+TX, cismethrin (80)+TX, clocythrin (alternative name)+TX, cloethocarb (999)+TX, closantel (alternative name) [CCN]+TX, clothianidin (165)+TX, copper acetoarsenite [CCN]+TX, copper arsenate [CCN]+TX, copper oleate [CCN]+TX, coumaphos (174)+TX, coumithoate (1006)+TX, crotamiton (alternative name) [CCN]+TX, crotoxyphos (1010)+TX, crufomate (1011)+TX, cryolite (alternative name) (177)+TX, CS 708 (development code) (1012)+TX, cyanofenphos (1019)+TX, cyanophos (184)+TX, cyanthoate (1020)+TX, cyclethrin [CCN]+TX, cycloprothrin (188)+TX, cyfluthrin (193)+TX, cyhalothrin (196)+TX, cypermethrin (201)+TX, cyphenothrin (206)+TX, cyromazine (209)+TX, cythioate (alternative name) [CCN]+TX, d-limonene (alternative name) [CCN]+TX, d-tetramethrin (alternative name) (788)+TX, DAEP (1031)+TX, dazomet (216)+TX, DDT (219)+TX, decarbofuran (1034)+TX, deltamethrin (223)+TX, demephion (1037)+TX, demephion-O (1037)+TX, demephion-S (1037)+TX, demeton (1038)+TX, demeton-methyl (224)+TX, demeton-O (1038)+TX, demeton-O-methyl (224)+TX, demeton-S (1038)+TX, demeton-5-methyl (224)+TX, demeton-S-methylsulphon (1039)+TX, diafenthiuron (226)+TX, dialifos (1042)+TX, diamidafos (1044)+TX, diazinon (227)+TX, dicapthon (1050)+TX, dichlofenthion (1051)+TX, dichlorvos (236)+TX, dicliphos (alternative name)+TX, dicresyl (alternative name) [CCN]+TX, dicrotophos (243)+TX, dicyclanil (244)+TX, dieldrin (1070)+TX, diethyl 5-methylpyrazol-3-yl phosphate (IUPAC name) (1076)+TX, diflubenzuron (250)+TX, dilor (alternative name) [CCN]+TX, dimefluthrin [CCN]+TX, dimefox (1081)+TX, dimetan (1085)+TX, dimethoate (262)+TX, dimethrin (1083)+TX, dimethylvinphos (265)+TX, dimetilan (1086)+TX, dinex (1089)+TX, dinex-diclexine (1089)+TX, dinoprop (1093)+TX, dinosam (1094)+TX, dinoseb (1095)+TX, dinotefuran (271)+TX, diofenolan (1099)+TX, dioxabenzofos (1100)+TX, dioxacarb (1101)+TX, dioxathion (1102)+TX, disulfoton (278)+TX, dithicrofos (1108)+TX, DNOC (282)+TX, doramectin (alternative name) [CCN]+TX, DSP (1115)+TX, ecdysterone (alternative name) [CCN]+TX, EI 1642 (development code) (1118)+TX, emamectin (291)+TX, emamectin benzoate (291)+TX, EMPC (1120)+TX, empenthrin (292)+TX, endosulfan (294)+TX, endothion (1121)+TX, endrin (1122)+TX, EPBP (1123)+TX, EPN (297)+TX, epofenonane (1124)+TX, eprinomectin (alternative name) [CCN]+TX, esfenvalerate (302)+TX, etaphos (alternative name) [CCN]+TX, ethiofencarb (308)+TX, ethion (309)+TX, ethiprole (310)+TX, ethoate-methyl (1134)+TX, ethoprophos (312)+TX, ethyl formate (IUPAC name) [CCN]+TX, ethyl-DDD (alternative name) (1056)+TX, ethylene dibromide (316)+TX, ethylene dichloride (chemical name) (1136)+TX, ethylene oxide [CCN]+TX, etofenprox (319)+TX, etrimfos (1142)+TX, EXD (1143)+TX, famphur (323)+TX, fenamiphos (326)+TX, fenazaflor (1147)+TX, fenchlorphos (1148)+TX, fenethacarb (1149)+TX, fenfluthrin (1150)+TX, fenitrothion (335)+TX, fenobucarb (336)+TX, fenoxacrim (1153)+TX, fenoxycarb (340)+TX, fenpirithrin (1155)+TX, fenpropathrin (342)+TX, fenpyrad (alternative name)+TX, fensulfothion (1158)+TX, fenthion (346)+TX, fenthion-ethyl [CCN]+TX, fenvalerate (349)+TX, fipronil (354)+TX, flonicamid (358)+TX, flubendiamide (CAS. Reg. No.: 272451-65-7)+TX, flucofuron (1168)+TX, flucycloxuron (366)+TX, flucythrinate (367)+TX, fluenetil (1169)+TX, flufenerim [CCN]+TX, flufenoxuron (370)+TX, flufenprox (1171)+TX, flumethrin (372)+TX, fluvalinate (1184)+TX, FMC 1137 (development code) (1185)+TX, fonofos (1191)+TX, formetanate (405)+TX, formetanate hydrochloride (405)+TX, formothion (1192)+TX, formparanate (1193)+TX, fosmethilan (1194)+TX, fospirate (1195)+TX, fosthiazate (408)+TX, fosthietan (1196)+TX, furathiocarb (412)+TX, furethrin (1200)+TX, gamma-cyhalothrin (197)+TX, gamma-HCH (430)+TX, guazatine (422)+TX, guazatine acetates (422)+TX, GY-81 (development code) (423)+TX, halfenprox (424)+TX, halofenozide (425)+TX, HCH (430)+TX, HEOD (1070)+TX, heptachlor (1211)+TX, heptenophos (432)+TX, heterophos [CCN]+TX, hexaflumuron (439)+TX, HHDN (864)+TX, hydramethylnon (443)+TX, hydrogen cyanide (444)+TX, hydroprene (445)+TX, hyquincarb (1223)+TX, imidacloprid (458)+TX, imiprothrin (460)+TX, indoxacarb (465)+TX, iodomethane (IUPAC name) (542)+TX, IPSP (1229)+TX, isazofos (1231)+TX, isobenzan (1232)+TX, isocarbophos (alternative name) (473)+TX, isodrin (1235)+TX, isofenphos (1236)+TX, isolane (1237)+TX, isoprocarb (472)+TX, isopropyl 0-(methoxy-aminothiophosphoryl)salicylate (IUPAC name) (473)+TX, isoprothiolane (474)+TX, isothioate (1244)+TX, isoxathion (480)+TX, ivermectin (alternative name) [CCN]+TX, jasmolin I (696)+TX, jasmolin II (696)+TX, jodfenphos (1248)+TX, juvenile hormone I (alternative name) [CCN]+TX, juvenile hormone II (alternative name) [CCN]+TX, juvenile hormone III (alternative name) [CCN]+TX, kelevan (1249)+TX, kinoprene (484)+TX, lambda-cyhalothrin (198)+TX, lead arsenate [CCN]+TX, lepimectin (CCN)+TX, leptophos (1250)+TX, lindane (430)+TX, lirimfos (1251)+TX, lufenuron (490)+TX, lythidathion (1253)+TX, m-cumenyl methylcarbamate (IUPAC name) (1014)+TX, magnesium phosphide (IUPAC name) (640)+TX, malathion (492)+TX, malonoben (1254)+TX, mazidox (1255)+TX, mecarbam (502)+TX, mecarphon (1258)+TX, menazon (1260)+TX, mephosfolan (1261)+TX, mercurous chloride (513)+TX, mesulfenfos (1263)+TX, metaflumizone (CCN)+TX, metam (519)+TX, metam-potassium (alternative name) (519)+TX, metam-sodium (519)+TX, methacrifos (1266)+TX, methamidophos (527)+TX, methanesulphonyl fluoride (IUPAC/Chemical Abstracts name) (1268)+TX, methidathion (529)+TX, methiocarb (530)+TX, methocrotophos (1273)+TX, methomyl (531)+TX, methoprene (532)+TX, methoquin-butyl (1276)+TX, methothrin (alternative name) (533)+TX, methoxychlor (534)+TX, methoxyfenozide (535)+TX, methyl bromide (537)+TX, methyl isothiocyanate (543)+TX, methylchloroform (alternative name) [CCN]+TX, methylene chloride [CCN]+TX, metofluthrin [CCN]+TX, metolcarb (550)+TX, metoxadiazone (1288)+TX, mevinphos (556)+TX, mexacarbate (1290)+TX, milbemectin (557)+TX, milbemycin oxime (alternative name) [CCN]+TX, mipafox (1293)+TX, mirex (1294)+TX, monocrotophos (561)+TX, morphothion (1300)+TX, moxidectin (alternative name) [CCN]+TX, naftalofos (alternative name) [CCN]+TX, naled (567)+TX, naphthalene (IUPAC/Chemical Abstracts name) (1303)+TX, NC-170 (development code) (1306)+TX, NC-184 (compound code)+TX, nicotine (578)+TX, nicotine sulfate (578)+TX, nifluridide (1309)+TX, nitenpyram (579)+TX, nithiazine (1311)+TX, nitrilacarb (1313)+TX, nitrilacarb 1:1 zinc chloride complex (1313)+TX, NNI-0101 (compound code)+TX, NNI-0250 (compound code)+TX, nornicotine (traditional name) (1319)+TX, novaluron (585)+TX, noviflumuron (586)+TX, O-5-dichloro-4-iodophenyl O-ethyl ethylphosphonothioate (IUPAC name) (1057)+TX, O,O-diethyl O-4-methyl-2-oxo-2H-chromen-7-yl phosphorothioate (IUPAC name) (1074)+TX, O,O-diethyl O-6-methyl-2-propylpyrimidin-4-yl phosphorothioate (IUPAC name) (1075)+TX, O,O,O′,O′-tetrapropyl dithiopyrophosphate (IUPAC name) (1424)+TX, oleic acid (IUPAC name) (593)+TX, omethoate (594)+TX, oxamyl (602)+TX, oxydemeton-methyl (609)+TX, oxydeprofos (1324)+TX, oxydisulfoton (1325)+TX, pp′-DDT (219)+TX, para-dichlorobenzene [CCN]+TX, parathion (615)+TX, parathion-methyl (616)+TX, penfluoron (alternative name) [CCN]+TX, pentachlorophenol (623)+TX, pentachlorophenyl laurate (IUPAC name) (623)+TX, permethrin (626)+TX, petroleum oils (alternative name) (628)+TX, PH 60-38 (development code) (1328)+TX, phenkapton (1330)+TX, phenothrin (630)+TX, phenthoate (631)+TX, phorate (636)+TX, phosalone (637)+TX, phosfolan (1338)+TX, phosmet (638)+TX, phosnichlor (1339)+TX, phosphamidon (639)+TX, phosphine (IUPAC name) (640)+TX, phoxim (642)+TX, phoxim-methyl (1340)+TX, pirimetaphos (1344)+TX, pirimicarb (651)+TX, pirimiphos-ethyl (1345)+TX, pirimiphos-methyl (652)+TX, polychlorodicyclopentadiene isomers (IUPAC name) (1346)+TX, polychloroterpenes (traditional name) (1347)+TX, potassium arsenite [CCN]+TX, potassium thiocyanate [CCN]+TX, prallethrin (655)+TX, precocene I (alternative name) [CCN]+TX, precocene II (alternative name) [CCN]+TX, precocene III (alternative name) [CCN]+TX, primidophos (1349)+TX, profenofos (662)+TX, profluthrin [CCN]+TX, promacyl (1354)+TX, promecarb (1355)+TX, propaphos (1356)+TX, propetamphos (673)+TX, propoxur (678)+TX, prothidathion (1360)+TX, prothiofos (686)+TX, prothoate (1362)+TX, protrifenbute [CCN]+TX, pymetrozine (688)+TX, pyraclofos (689)+TX, pyrazophos (693)+TX, pyresmethrin (1367)+TX, pyrethrin I (696)+TX, pyrethrin II (696)+TX, pyrethrins (696)+TX, pyridaben (699)+TX, pyridalyl (700)+TX, pyridaphenthion (701)+TX, pyrimidifen (706)+TX, pyrimitate (1370)+TX, pyriproxyfen (708)+TX, quassia (alternative name) [CCN]+TX, quinalphos (711)+TX, quinalphos-methyl (1376)+TX, quinothion (1380)+TX, quintiofos (1381)+TX, R-1492 (development code) (1382)+TX, rafoxanide (alternative name) [CCN]+TX, resmethrin (719)+TX, rotenone (722)+TX, RU 15525 (development code) (723)+TX, RU 25475 (development code) (1386)+TX, ryania (alternative name) (1387)+TX, ryanodine (traditional name) (1387)+TX, sabadilla (alternative name) (725)+TX, schradan (1389)+TX, sebufos (alternative name)+TX, selamectin (alternative name) [CCN]+TX, SI-0009 (compound code)+TX, SI-0205 (compound code)+TX, SI-0404 (compound code)+TX, SI-0405 (compound code)+TX, silafluofen (728)+TX, SN 72129 (development code) (1397)+TX, sodium arsenite [CCN]+TX, sodium cyanide (444)+TX, sodium fluoride (IUPAC/Chemical Abstracts name) (1399)+TX, sodium hexafluorosilicate (1400)+TX, sodium pentachlorophenoxide (623)+TX, sodium selenate (IUPAC name) (1401)+TX, sodium thiocyanate [CCN]+TX, sophamide (1402)+TX, spinosad (737)+TX, spiromesifen (739)+TX, spirotetrmat (CCN)+TX, sulcofuron (746)+TX, sulcofuron-sodium (746)+TX, sulfluramid (750)+TX, sulfotep (753)+TX, sulphuryl fluoride (756)+TX, sulprofos (1408)+TX, tar oils (alternative name) (758)+TX, tau-fluvalinate (398)+TX, tazimcarb (1412)+TX, TDE (1414)+TX, tebufenozide (762)+TX, tebufenpyrad (763)+TX, tebupirimfos (764)+TX, teflubenzuron (768)+TX, tefluthrin (769)+TX, temephos (770)+TX, TEPP (1417)+TX, terallethrin (1418)+TX, terbam (alternative name)+TX, terbufos (773)+TX, tetrachloroethane [CCN]+TX, tetrachlorvinphos (777)+TX, tetramethrin (787)+TX, theta-cypermethrin (204)+TX, thiacloprid (791)+TX, thiafenox (alternative name)+TX, thiamethoxam (792)+TX, thicrofos (1428)+TX, thiocarboxime (1431)+TX, thiocyclam (798)+TX, thiocyclam hydrogen oxalate (798)+TX, thiodicarb (799)+TX, thiofanox (800)+TX, thiometon (801)+TX, thionazin (1434)+TX, thiosultap (803)+TX, thiosultap-sodium (803)+TX, thuringiensin (alternative name) [CCN]+TX, tolfenpyrad (809)+TX, tralomethrin (812)+TX, transfluthrin (813)+TX, transpermethrin (1440)+TX, triamiphos (1441)+TX, triazamate (818)+TX, triazophos (820)+TX, triazuron (alternative name)+TX, trichlorfon (824)+TX, trichlormetaphos-3 (alternative name) [CCN]+TX, trichloronat (1452)+TX, trifenofos (1455)+TX, triflumuron (835)+TX, trimethacarb (840)+TX, triprene (1459)+TX, vamidothion (847)+TX, vaniliprole [CCN]+TX, veratridine (alternative name) (725)+TX, veratrine (alternative name) (725)+TX, XMC (853)+TX, xylylcarb (854)+TX, YI-5302 (compound code)+TX, zeta-cypermethrin (205)+TX, zetamethrin (alternative name)+TX, zinc phosphide (640)+TX, zolaprofos (1469) and ZXI 8901 (development code) (858)+TX, cyantraniliprole [736994-63-19]+TX, chlorantraniliprole [500008-45-7]+TX, cyenopyrafen [560121-52-0]+TX, cyflumetofen [400882-07-7]+TX, pyrifluquinazon [337458-27-2]+TX, spinetoram [187166-40-1+187166-15-0]+TX, spirotetramat [203313-25-1]+TX, sulfoxaflor [946578-00-3]+TX, flufiprole [704886-18-0]+TX, meperfluthrin [915288-13-0]+TX, tetramethylfluthrin [84937-88-2]+TX,

a molluscicide selected from the group of substances consisting of bis(tributyltin) oxide

(IUPAC name) (913)+TX, bromoacetamide [CCN]+TX, calcium arsenate [CCN]+TX, cloethocarb (999)+TX, copper acetoarsenite [CCN]+TX, copper sulfate (172)+TX, fentin (347)+TX, ferric phosphate (IUPAC name) (352)+TX, metaldehyde (518)+TX, methiocarb (530)+TX, niclosamide (576)+TX, niclosamide-olamine (576)+TX, pentachlorophenol (623)+TX, sodium pentachlorophenoxide (623)+TX, tazimcarb (1412)+TX, thiodicarb (799)+TX, tributyltin oxide (913)+TX, trifenmorph (1454)+TX, trimethacarb (840)+TX, triphenyltin acetate (IUPAC name) (347) and triphenyltin hydroxide (IUPAC name) (347)+TX, pyriprole [394730-71-3]+TX, a nematicide selected from the group of substances consisting of AKD-3088 (compound code)+TX, 1,2-dibromo-3-chloropropane (IUPAC/Chemical Abstracts name) (1045)+TX, 1,2-dichloropropane (IUPAC/Chemical Abstracts name) (1062)+TX, 1,2-dichloropropane with 1,3-dichloropropene (IUPAC name) (1063)+TX, 1,3-dichloropropene (233)+TX, 3,4-dichlorotetrahydrothiophene 1,1-dioxide (IUPAC/Chemical Abstracts name) (1065)+TX, 3-(4-chlorophenyl)-5-methylrhodanine (IUPAC name) (980)+TX, 5-methyl-6-thioxo-1,3,5-thiadiazinan-3-ylacetic acid (IUPAC name) (1286)+TX, 6-isopentenylaminopurine (alternative name) (210)+TX, abamectin (1)+TX, acetoprole [CCN]+TX, alanycarb (15)+TX, aldicarb (16)+TX, aldoxycarb (863)+TX, AZ 60541 (compound code)+TX, benclothiaz [CCN]+TX, benomyl (62)+TX, butylpyridaben (alternative name)+TX, cadusafos (109)+TX, carbofuran (118)+TX, carbon disulfide (945)+TX, carbosulfan (119)+TX, chloropicrin (141)+TX, chlorpyrifos (145)+TX, cloethocarb (999)+TX, cytokinins (alternative name) (210)+TX, dazomet (216)+TX, DBCP (1045)+TX, DCIP (218)+TX, diamidafos (1044)+TX, dichlofenthion (1051)+TX, dicliphos (alternative name)+TX, dimethoate (262)+TX, doramectin (alternative name) [CCN]+TX, emamectin (291)+TX, emamectin benzoate (291)+TX, eprinomectin (alternative name) [CCN]+TX, ethoprophos (312)+TX, ethylene dibromide (316)+TX, fenamiphos (326)+TX, fenpyrad (alternative name)+TX, fensulfothion (1158)+TX, fosthiazate (408)+TX, fosthietan (1196)+TX, furfural (alternative name) [CCN]+TX, GY-81 (development code) (423)+TX, heterophos [CCN]+TX, iodomethane (IUPAC name) (542)+TX, isamidofos (1230)+TX, isazofos (1231)+TX, ivermectin (alternative name) [CCN]+TX, kinetin (alternative name) (210)+TX, mecarphon (1258)+TX, metam (519)+TX, metam-potassium (alternative name) (519)+TX, metam-sodium (519)+TX, methyl bromide (537)+TX, methyl isothiocyanate (543)+TX, milbemycin oxime (alternative name) [CCN]+TX, moxidectin (alternative name) [CCN]+TX, Myrothecium verrucaria composition (alternative name) (565)+TX, NC-184 (compound code)+TX, oxamyl (602)+TX, phorate (636)+TX, phosphamidon (639)+TX, phosphocarb [CCN]+TX, sebufos (alternative name)+TX, selamectin (alternative name) [CCN]+TX, spinosad (737)+TX, terbam (alternative name)+TX, terbufos (773)+TX, tetrachlorothiophene (IUPAC/Chemical Abstracts name) (1422)+TX, thiafenox (alternative name)+TX, thionazin (1434)+TX, triazophos (820)+TX, triazuron (alternative name)+TX, xylenols [CCN]+TX, YI-5302 (compound code) and zeatin (alternative name) (210)+TX, fluensulfone [318290-98-1]+TX,

a nitrification inhibitor selected from the group of substances consisting of potassium ethylxanthate [CCN] and nitrapyrin (580)+TX,

a plant activator selected from the group of substances consisting of acibenzolar (6)+TX, acibenzolar-5-methyl (6)+TX, probenazole (658) and Reynoutria sachalinensis extract (alternative name) (720)+TX, da rodenticide selected from the group of substances consisting of 2-isovalerylindan-1,3-dione (IUPAC name) (1246)+TX, 4-(quinoxalin-2-ylamino)benzenesulfonamide (IUPAC name) (748)+TX, alpha-chlorohydrin [CCN]+TX, aluminium phosphide (640)+TX, antu (880)+TX, arsenous oxide (882)+TX, barium carbonate (891)+TX, bisthiosemi (912)+TX, brodifacoum (89)+TX, bromadiolone (91)+TX, bromethalin (92)+TX, calcium cyanide (444)+TX, chloralose (127)+TX, chlorophacinone (140)+TX, cholecalciferol (alternative name) (850)+TX, coumachlor (1004)+TX, coumafuryl (1005)+TX, coumatetralyl (175)+TX, crimidine (1009)+TX, difenacoum (246)+TX, difethialone (249)+TX, diphacinone (273)+TX, ergocalciferol (301)+TX, flocoumafen (357)+TX, fluoroacetamide (379)+TX, flupropadine (1183)+TX, flupropadine hydrochloride (1183)+TX, gamma-HCH (430)+TX, HCH (430)+TX, hydrogen cyanide (444)+TX, iodomethane (IUPAC name) (542)+TX, lindane (430)+TX, magnesium phosphide (IUPAC name) (640)+TX, methyl bromide (537)+TX, norbormide (1318)+TX, phosacetim (1336)+TX, phosphine (IUPAC name) (640)+TX, phosphorus [CCN]+TX, pindone (1341)+TX, potassium arsenite [CCN]+TX, pyrinuron (1371)+TX, scilliroside (1390)+TX, sodium arsenite [CCN]+TX, sodium cyanide (444)+TX, sodium fluoroacetate (735)+TX, strychnine (745)+TX, thallium sulfate [CCN]+TX, warfarin (851) and zinc phosphide (640)+TX,

a synergist selected from the group of substances consisting of 2-(2-butoxyethoxy)ethyl piperonylate (IUPAC name) (934)+TX, 5-(1,3-benzodioxol-5-yl)-3-hexylcyclohex-2-enone (IUPAC name) (903)+TX, farnesol with nerolidol (alternative name) (324)+TX, MB-599 (development code) (498)+TX, MGK 264 (development code) (296)+TX, piperonyl butoxide (649)+TX, piprotal (1343)+TX, propyl isomer (1358)+TX, 5421 (development code) (724)+TX, sesamex (1393)+TX, sesasmolin (1394) and sulfoxide (1406)+TX, an animal repellent selected from the group of substances consisting of anthraquinone (32)+TX, chloralose (127)+TX, copper naphthenate [CCN]+TX, copper oxychloride (171)+TX, diazinon (227)+TX, dicyclopentadiene (chemical name) (1069)+TX, guazatine (422)+TX, guazatine acetates (422)+TX, methiocarb (530)+TX, pyridin-4-amine (IUPAC name) (23)+TX, thiram (804)+TX, trimethacarb (840)+TX, zinc naphthenate [CCN] and ziram (856)+TX,

a virucide selected from the group of substances consisting of imanin (alternative name) [CCN] and ribavirin (alternative name) [CCN]+TX,

a wound protectant selected from the group of substances consisting of mercuric oxide (512)+TX, octhilinone (590) and thiophanate-methyl (802)+TX,

and biologically active compounds selected from the group consisting of azaconazole (60207-31-0]+TX, bitertanol [70585-36-3]+TX, bromuconazole [116255-48-2]+TX, cyproconazole [94361-06-5]+TX, difenoconazole [119446-68-3]+TX, diniconazole [83657-24-3]+TX, epoxiconazole [106325-08-0]+TX, fenbuconazole [114369-43-6]+TX, fluquinconazole [136426-54-5]+TX, flusilazole [85509-19-9]+TX, flutriafol [76674-21-0]+TX, hexaconazole [79983-71-4]+TX, imazalil [35554-44-0]+TX, imibenconazole [86598-92-7]+TX, ipconazole [125225-28-7]+TX, metconazole [125116-23-6]+TX, myclobutanil [88671-89-0]+TX, pefurazoate [101903-30-4]+TX, penconazole [66246-88-6]+TX, prothioconazole [178928-70-6]+TX, pyrifenox [88283-41-4]+TX, prochloraz [67747-09-5]+TX, propiconazole [60207-90-1]+TX, simeconazole [149508-90-7]+TX, tebuconazole [107534-96-3]+TX, tetraconazole [112281-77-3]+TX, triadimefon [43121-43-3]+TX, triadimenol [55219-65-3]+TX, triflumizole [99387-89-0]+TX, triticonazole [131983-72-7]+TX, ancymidol [12771-68-5]+TX, fenarimol [60168-88-9]+TX, nuarimol [63284-71-9] +TX, bupirimate [41483-43-6]+TX, dimethirimol [5221-53-4]+TX, ethirimol [23947-60-6] +TX, dodemorph [1593-77-7]+TX, fenpropidine [67306-00-7]+TX, fenpropimorph [67564-91-4]+TX, spiroxamine [118134-30-8]+TX, tridemorph [81412-43-3]+TX, cyprodinil [121552-61-2]+TX, mepanipyrim [110235-47-7]+TX, pyrimethanil [53112-28-0]+TX, fenpiclonil [74738-17-3]+TX, fludioxonil [131341-86-1]+TX, benalaxyl [71626-11-4]+TX, furalaxyl [57646-30-7]+TX, metalaxyl [57837-19-1]+TX, R-metalaxyl [70630-17-0]+TX, ofurace [58810-48-3]+TX, oxadixyl [77732-09-3]+TX, benomyl [17804-35-2]+TX, carbendazim [10605-21-7]+TX, debacarb [62732-91-6]+TX, fuberidazole [3878-19-1]+TX, thiabendazole [148-79-8]+TX, chlozolinate [84332-86-5]+TX, dichlozoline [24201-58-9]+TX, iprodione [36734-19-7]+TX, myclozoline [54864-61-8]+TX, procymidone [32809-16-8]+TX, vinclozoline [50471-44-8]+TX, (S)-[3-(4-Chloro-2-fluoro-phenyl)-5-(2,4-difluoro-phenyl)-isoxazol-4-yl]-pyridin-3-yl-methanol (WO2010069881)+TX, 3-(4-Chloro-2-fluoro-phenyl)-5-(2,4-difluoro-phenyl)-isoxazol-4-yl]-pyridin-3-yl-methanol (WO2010069881)+TX, boscalid [188425-85-6]+TX, carboxin [5234-68-4]+TX, fenfuram [24691-80-3]+TX, flutolanil [66332-96-5]+TX, mepronil [55814-41-0]+TX, oxycarboxin [5259-88-1]+TX, penthiopyrad [183675-82-3]+TX, thifluzamide [130000-40-7]+TX, guazatine [108173-90-6]+TX, dodine [2439-10-3] [112-65-2] (free base)+TX, iminoctadine [13516-27-3]+TX, azoxystrobin [131860-33-8]+TX, dimoxystrobin [149961-52-4]+TX, enestroburin {Proc. BCPC, Int. Congr., Glasgow, 2003, 1, 93}+TX, fluoxastrobin [361377-29-9]+TX, kresoxim-methyl [143390-89-0]+TX, metominostrobin [133408-50-1]+TX, trifloxystrobin [141517-21-7]+TX, orysastrobin [248593-16-0]+TX, picoxystrobin [117428-22-5]+TX, pyraclostrobin [175013-18-0]+TX, ferbam [14484-64-1]+TX, mancozeb [8018-01-7]+TX, maneb [12427-38-2]+TX, metiram [9006-42-2]+TX, propineb [12071-83-9]+TX, thiram [137-26-8]+TX, zineb [12122-67-7]+TX, ziram [137-30-4]+TX, captafol [2425-06-1]+TX, captan [133-06-2]+TX, dichlofluanid [1085-98-9] +TX, fluoroimide [41205-21-4]+TX, folpet [133-07-3]+TX, tolylfluanid [731-27-1]+TX, bordeaux mixture [8011-63-0]+TX, copperhydroxid [20427-59-2]+TX, copperoxychlorid [1332-40-7]+TX, coppersulfat [7758-98-7]+TX, copperoxid [1317-39-1]+TX, mancopper [53988-93-5]+TX, oxine-copper [10380-28-6]+TX, dinocap [131-72-6]+TX, nitrothal-isopropyl [10552-74-6]+TX, edifenphos [17109-49-8]+TX, iprobenphos [26087-47-8] +TX, isoprothiolane [50512-35-1]+TX, phosdiphen [36519-00-3]+TX, pyrazophos [13457-18-6]+TX, tolclofos-methyl [57018-04-9]+TX, acibenzolar-5-methyl [135158-54-2]+TX, anilazine [101-05-3]+TX, benthiavalicarb [413615-35-7]+TX, blasticidin-S [2079-00-7] +TX, chinomethionat [2439-01-2]+TX, chloroneb [2675-77-6]+TX, chlorothalonil [1897-45-6]+TX, cyflufenamid [180409-60-3]+TX, cymoxanil [57966-95-7]+TX, dichlone [117-80-6]+TX, diclocymet [139920-32-4]+TX, diclomezine [62865-36-5]+TX, dicloran [99-30-9]+TX, diethofencarb [87130-20-9]+TX, dimethomorph [110488-70-5]+TX, SYP-LI90 (Flumorph) [211867-47-9]+TX, dithianon [3347-22-6]+TX, ethaboxam [162650-77-3] +TX, etridiazole [2593-15-9]+TX, famoxadone [131807-57-3]+TX, fenamidone [161326-34-7]+TX, fenoxanil [115852-48-7]+TX, fentin [668-34-8]+TX, ferimzone [89269-64-7]+TX, fluazinam [79622-59-6]+TX, fluopicolide [239110-15-7]+TX, flusulfamide [106917-52-6]+TX, fenhexamid [126833-17-8]+TX, fosetyl-aluminium [39148-24-8]+TX, hymexazol [10004-44-1]+TX, iprovalicarb [140923-17-7]+TX, IKF-916 (Cyazofamid) [120116-88-3]+TX, kasugamycin [6980-18-3]+TX, methasulfocarb [66952-49-6]+TX, metrafenone [220899-03-6]+TX, pencycuron [66063-05-6]+TX, phthalide [27355-22-2] +TX, polyoxins [11113-80-7]+TX, probenazole [27605-76-1]+TX, propamocarb [25606-41-1]+TX, proquinazid [189278-12-4]+TX, pyroquilon [57369-32-1]+TX, quinoxyfen [124495-18-7]+TX, quintozene [82-68-8]+TX, sulphur [7704-34-9]+TX, tiadinil [223580-51-6]+TX, triazoxide [72459-58-6]+TX, tricyclazole [41814-78-2]+TX, triforine [26644-46-2]+TX, validamycin [37248-47-8]+TX, zoxamide (RH7281) [156052-68-5] +TX, mandipropamid [374726-62-2]+TX, isopyrazam [881685-58-1]+TX, sedaxane [874967-67-6]+TX, 3-difluoromethyl-1-methyl-1H-pyrazole-4-carboxylic acid (9-dichloromethylene-1,2,3,4-tetrahydro-1,4-methano-naphthalen-5-yl)-amide (disclosed in WO 2007/048556)+TX, 3-difluoromethyl-1-methyl-1H-pyrazole-4-carboxylic acid [2-(2,4-dichlorophenyl)-2-methoxy-1-methyl-ethyl]-amide (disclosed in WO 2008/148570)+TX, 1-[4-[4-[(5S)5-(2,6-difluorophenyl)-4,5-dihydro-1,2-oxazol-3-yl]-1,3-thiazol-2-yl]piperidin-1-yl]-2-[5-methyl-3-(trifluoromethyl)-1H-pyrazol-1-yl]ethanone+TX, 1-[4-[4-[5-(2,6-difluorophenyl)-4,5-dihydro-1,2-oxazol-3-yl]-1,3-thiazol-2-yl]piperidin-1-yl]-2-[5-methyl-3-(trifluoromethyl)-1H-pyrazol-1-yl]ethanone [1003318-67-9], both disclosed in WO 2010/123791, WO 2008/013925, WO 2008/013622 and WO 2011/051243 page 20)+TX, and 3-difluoromethyl-1-methyl-1H-pyrazole-4-carboxylic acid (3′,4′,5′-trifluoro-biphenyl-2-yl)-amide (disclosed in WO 2006/087343)+TX.

Throughout this document the expression “composition” stands for the various mixtures or combinations of components TX and (B), for example in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the components TX and (B) is not essential for working the present invention.

The compositions according to the invention may also comprise more than one of the active components (B), if, for example, a broadening of the spectrum of disease control is desired. For instance, it may be advantageous in the agricultural practice to combine two or three components (B) with component TX. An example is a composition comprising a compound of formula (I), azoxystrobin and cyproconazole. In the above different lists of active ingredients to be mixed with a TX, the compound of the formula I is preferably a compound of Table 40 or 41.

In the above-mentioned mixtures of compounds of formula I, in particular a compound selected from said Tables 1-39, with other insecticides, fungicides, herbicides, safeners, adjuvants and the like, the mixing ratios can vary over a large range and are, preferably 100:1 to 1:6000, especially 50:1 to 1:50, more especially 20:1 to 1:20, even more especially 10:1 to 1:10. Those mixing ratios are understood to include, on the one hand, ratios by weight and also, on other hand, molar ratios.

The mixtures can advantageously be used in the above-mentioned formulations (in which case “active ingredient” relates to the respective mixture of TX with the mixing partner).

The following non-limiting Examples illustrate the above-described invention in greater detail without limiting it. Those skilled in the art will promptly recognise appropriate variations from the procedures both as to reactants and as to reaction conditions and techniques. All references mentioned herein are incorporated by reference in their entirety.

### PREPARATORY EXAMPLES

Throughout these examples, the isomer drawn is in excess in the reaction mixture and/or product

### Example 1

### Preparation of P.01

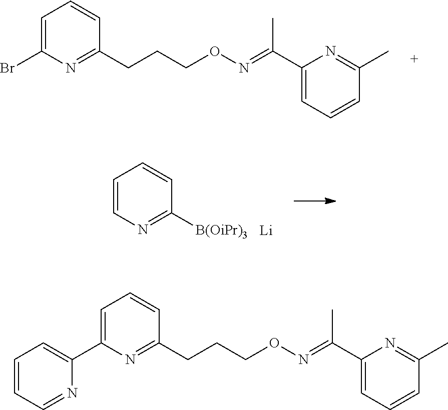

E-1-(6-Methyl-pyridin-2-yl)-ethanone O-[3-(6-bromo-pyridin-2-yl)-propyl]-oxime (150 mg) was added to potassium fluoride (75 mg), diphenylphosphine oxide (5 mg), tris(dibenzylideneacetone) dipalladium(0) (5 mg) and lithium triisopropyl-2-pyridyl-borate (176 mg) (for preparation see Angew. Chem. Int. Ed. 2008, 47, 4695-4698) in dioxane (3 mL). After stirring for 24 h at 100° C. the reaction mixture was diluted with ethyl acetate and washed with sodium bicarbonate (10% aqueous solution) and brine. The organic phase was dried over sodium sulfate, concentrated and purified by chromatography over silica to give an orange oil (50 mg).

### Preparation of E-1-(6-methyl-pyridin-2-yl)-ethanone O-[3-(6-bromo-pyridin-2-yl)-propyl]-oxime

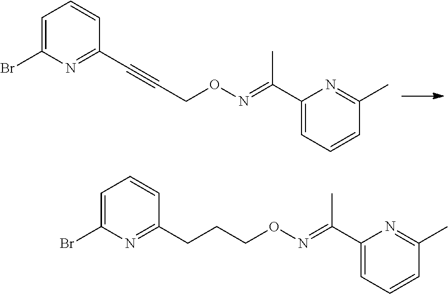

E-1-(6-Methyl-pyridin-2-yl)-ethanone O-[3-(6-bromo-pyridin-2-yl)-prop-2-ynyl]-oxime (921 mg) was dissolved in ethanol (30 mL). Platinum-(IV)-oxide hydrate (49 mg) was added and the reaction mixture was stirred for 90 min under an atmosphere of hydrogen. The reaction mixture was filtered, evaporated and purified over silica to give a colourless oil (711 mg). ¹H-NMR (CDCl3, 400 MHz): 7.69 (d, 1H), 7.55 (t, 1H), 7.48 (t, 1H), 7.32 (d, 1H), 7.16 (d, 1H), 7.11 (d, 1H), 4.28 (t, 2H), 2.92 (t, 2H), 2.59 (s, 3H), 2.23 (s, 3H), 2.22 (m, 2H)

### Preparation of E-1-(6-methyl-pyridin-2-yl)-ethanone O-[3-(6-bromo-pyridin-2-yl)-propyl-2-ynyl]-oxime

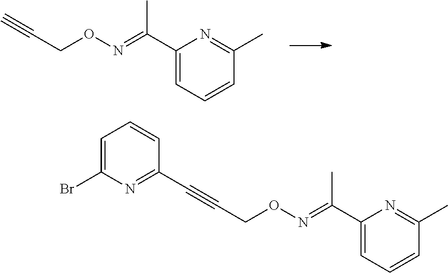 [SMILES: C#CCO/N=C(\C)c1cccc(C)n1 ; C/C(=N\OCC#Cc1cccc(Br)n1)c1cccc(C)n1]

2,6-Dibromo-pyridine (4.1 g) was added to a solution of E-1-(6-methyl-pyridin-2-yl)-ethanone O-prop-2-ynyl-oxime (2.5 g) in THF (80 mL), followed by diisopropylamine (3.75 mL), dichlorobis (triphenylphospine) palladium(II) (364 mg) and copper(I) iodide (263 mg) were added. After stirring for 16 h at ambient temperature the reaction mixture was diluted with ethyl acetate washed with sodium bicarbonate (10% aqueous solution) and brine. The organic phase was dried over sodium sulfate, concentrated and purified by chromatography over silica to give orange oil (2.14 g). ¹H-NMR (CDCl3, 400 MHz): 7.72 (d, 1H), 7.60-7.40 (m, 4H), 7.12 (d, 1H), 5.08 (s, 2H), 2.58 (s, 3H), 2.48 (s, 3H).

### Preparation of E-1-(6-methyl-pyridin-2-yl)-ethanone O-prop-2-ynyl-oxime

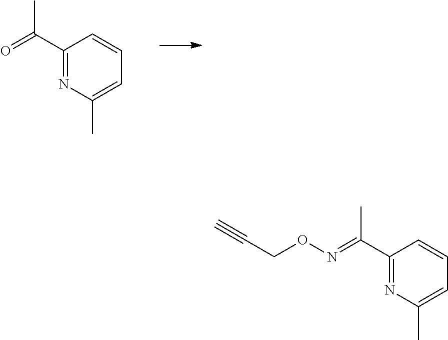

2-Acetyl-6-methyl-pyridine (1.5 g) was dissolved in ethanol (10 mL), and then Sodium acetate (1.37 g) and O-propargyl-hydroxylamine hydrochloride (1.45 g) were added. After stirring for 16 h at ambient temperature the reaction mixture was diluted with ethyl acetate washed with water, dried over sodium sulfate, filtrated and evaporated to give a brown oil (1.9 g). ¹H-NMR (CDCl3, 400 MHz): 7.70 (d, 1H), 7.54 (t, 1H), 7.10 (d, 1H), 4.81 (s, 2H), 2.58 (s, 3H), 2.49 (s, 1H), 2.37 (s, 3H)

### Example 2

### Preparation of P.02

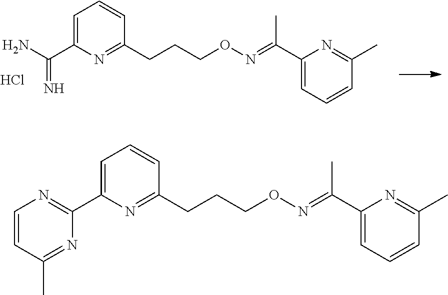 [SMILES: Cl ; C/C(=N\OCCCc1cccc(C(=N)N)n1)c1cccc(C)n1 ; C/C(=N\OCCCc1cccc(-c2nccc(C)n2)n1)c1cccc(C)n1]

Sodium carbonate (49 mg) and 4-trimethylsilyl-3-butyn-2-one were added to a solution of 6-{3-[1-(6-Methyl-pyridin-2-yl)-eth-(E)-ylideneaminooxy]-propyl}-pyridine-2-carboxamidine hydrochloride (80 mg) in acetonitrile (5 mL). After stirring for 72 h at 80° C. the reaction mixture was diluted with ethyl acetate washed with sodium bicarbonate (10% aqueous solution) and brine. The organic phase was dried over sodium sulfate, concentrated and purified by chromatography over silica to give an orange oil (50 mg).

### Preparation of 6-{3-[1-(6-methyl-pyridin-2-yl)-eth-(E)-ylideneaminooxy]-propyl}-pyridine-2-carboxamidine hydrochloride

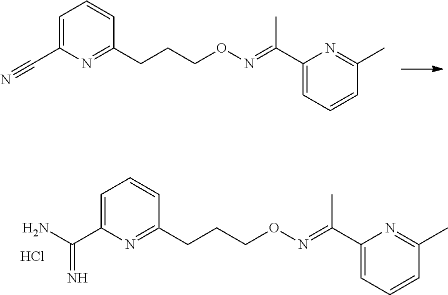 [SMILES: C/C(=N\OCCCc1cccc(C#N)n1)c1cccc(C)n1 ; Cl ; C/C(=N\OCCCc1cccc(C(=N)N)n1)c1cccc(C)n1]

Sodium methoxide (210 mg) was added to a solution of 6-{3-[1-(6-methyl-pyridin-2-yl)-eth-(E)-ylideneaminooxy]-propyl}-pyridine-2-carbonitrile (1.06 g) in methanol (40 mL). After stirring for 72 h at ambient temperature ammonium chloride (230 mg) was added and the reaction mixture was stirred at ambient temperature for further 24 h. The reaction mixture was evaporated, the solid residue was suspended in diethyl ether, filtered and washed with diethyl ether to give a beige solid (690 mg) which was used in the next step without further purification.

### Preparation of 6-{3-[1-(6-methyl-pyridin-2-yl)-eth-(E)-ylideneaminooxy]-propyl}-pyridine-2-carbonitrile

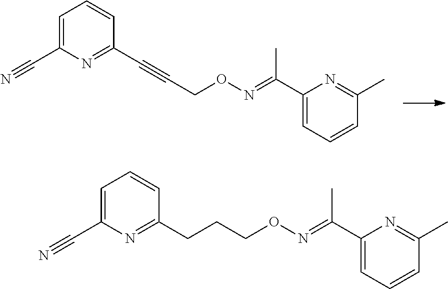 [SMILES: C/C(=N\OCC#Cc1cccc(C#N)n1)c1cccc(C)n1 ; C/C(=N\OCCCc1cccc(C#N)n1)c1cccc(C)n1]

6-{3-[1-(6-Methyl-pyridin-2-yl)-eth-(E)-ylideneaminooxy]-prop-1-ynyl}-pyridine-2-carbonitrile (128 mg) was dissolved in ethanol (5 mL). Palladium (5% on charcoal; 10 mg) was added and the reaction mixture was stirred for 5 h under an atmosphere of hydrogen. The reaction mixture was filtered and evaporated to give a yellow oil (118 mg). ¹H-NMR (CDCl3, 400 MHz): 7.73 (t, 1H), 7.68 (d, 1H), 7.61-7.53 (m, 2H), 7.42 (d, 1H), 7.12 (d, 1H), 4.29 (t, 2H), 3.00 (t, 2H), 2.59 (s, 3H), 2.32 (s, 3H), 2.23 (m, 2H)

### Preparation of 6-{3-[1-(6-methyl-pyridin-2-yl)-eth-(E)-ylideneaminooxy]-prop-1-ynyl}-pyridine-2-carbonitrile

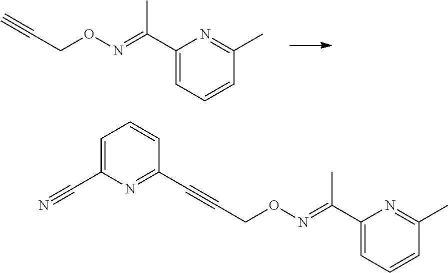 [SMILES: C#CCO/N=C(\C)c1cccc(C)n1 ; C/C(=N\OCC#Cc1cccc(C#N)n1)c1cccc(C)n1]

2-Bromo-6-cyanopyridin (1.57 g) and E-1-(6-methyl-pyridin-2-yl)-ethanone O-prop-2-ynyl-oxime (1.62 g) were dissolved in THF (40 mL). Diisopropylamine (2.42 mL), dichlorobis(triphenylphospine) palladium(II) (181 mg) and copper(I) iodide (131 mg) were added. After stirring for 16 h at ambient temperature the reaction mixture was diluted with ethyl acetate washed with sodium bicarbonate (10% aqueous solution) and brine. The organic phase was dried over sodium sulfate, concentrated and purified by chromatography over silica to give a pink solid (1.95 g). ¹H-NMR (CDCl3, 400 MHz): 7.80 (t, 1H), 7.71 (d, 1H), 7.63 (m, 2H), 7.56 (t, 1H), 7.12 (d, 1H), 5.08 (s, 2H), 2.58 (s, 3H), 2.48 (s, 3H).

### Example 3

### Preparation of P.03

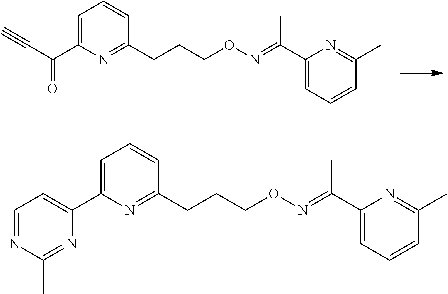 [SMILES: C#CC(=O)c1cccc(CCCO/N=C(\C)c2cccc(C)n2)n1 ; C/C(=N\OCCCc1cccc(-c2ccnc(C)n2)n1)c1cccc(C)n1]

Sodium carbonate (84 mg) and acetamidine hydrochloride (37 mg) were added to a solution of 1-(6-{3-[1-(6-methyl-pyridin-2-yl)-eth-(E)-ylideneaminooxy]-propyl}-pyridin-2-yl)-propynone (110 mg) in acetonitrile. After stirring for 3 h at 80° C. the reaction mixture was filtered and evaporated. The residue was purified by chromatography over silica to give yellow oil (57 mg).

### Preparation of 1-(6-{3-[1-(6-methyl-pyridin-2-yl)-eth-(E)-ylideneaminooxy]-propyl}-pyridin-2-yl)-propynone

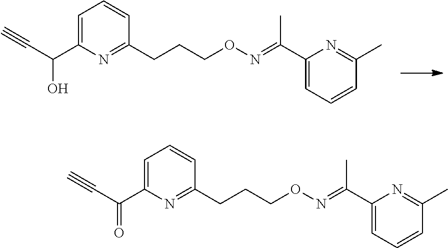

1,1,1-Tris(acetyloxy)-1,1-dihydro-1,2-benziodoxol-3-(1H)-one (1.48 g) was added to a solution of E-1-(6-methyl-pyridin-2-yl)-ethanone O-{3-[6-(1-hydroxy-prop-2-ynyl)-pyridin-2-yl]-propyl}-oxime (870 mg) in dichloromethane (45 mL). After stirring for 4 h at ambient temperature sodium hydrogen carbonate (20 mL; 20% aqueous solution) and sodium thiosulfate (20 mL; 30% aqueous solution) were added. After stirring for a further 40 min the organic phase was separated, washed with water, dried over sodium sulfate, filtrated and purified by chromatography over silica to give an orange oil (640 mg). ¹H-NMR (CDCl3, 400 MHz): 7.97 (d, 1H), 7.76 (t, 1H), 7.66 (d, 1H), 7.54 (t, 1H), 7.41 (d, 1H), 7.10 (d, 1H), 4.32 (t, 2H), 3.52 (s, 1H), 3.06 (t, 2H), 2.57 (s, 3H), 2.41 (s, 3H), 2.28 (m, 2H).

### Preparation of E-1-(6-methyl-pyridin-2-yl)-ethanone O-{3-[6-(1-hydroxy-prop-2-ynyl)-Pyridin-2-yl]-propyl}-oxime

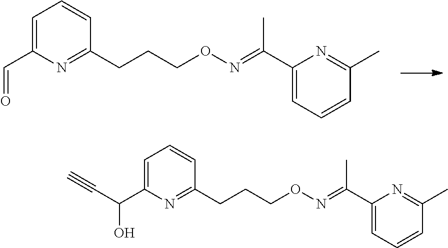

A solution of ethynylmagnesiumchloride (4.25 mL; 0.5M in THF) was added at −65° C. to a solution of 6-{3-[1-(6-methyl-pyridin-2-yl)-eth-(E)-ylideneaminooxy]-propyl}-pyridine-2-carbaldehyde (420 mg) in THF (15 mL) over 10 minutes. After stirring for 2 h at −65° C. ammonium chloride (2 mL; 15% aqueous solution) was added. The reaction mixture was diluted with ethyl acetate washed with sodium bicarbonate (10% aqueous solution) and brine. The organic phase was dried over sodium sulfate, concentrated and purified by chromatography over silica to give a pink oil (264 mg). ¹H-NMR (CDCl3, 400 MHz): 7.68 (m, 2H), 7.58 (t, 1H), 7.45 (d, 2H), 7.19 (d, 1H), 7.11 (d, 1H), 5.47 (s, broad, 1H), 5.19 (s, broad, 1H), 4.29 (t, 2H), 2.98 (t, 2H), 2.58 (s, 3H), 2.55 (d, 1H), 2.33 (s, 3H), 2.25 (m, 2H).

### Preparation of 6-{3-[1-(6-methyl-pyridin-2-yl)-eth-(E)-ylideneaminooxy]-propyl}-Pyridine-2-carbaldehyde

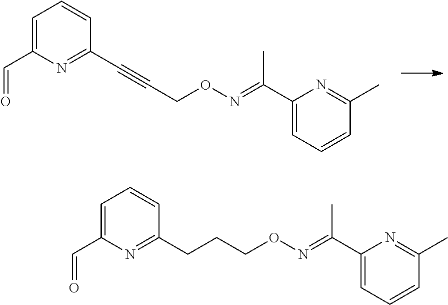 [SMILES: C/C(=N\OCC#Cc1cccc(C=O)n1)c1cccc(C)n1 ; C/C(=N\OCCCc1cccc(C=O)n1)c1cccc(C)n1]

6-{3-[1-(6-Methyl-pyridin-2-yl)-eth-(E)-ylideneaminooxy]-prop-1-ynyl}-pyridine-2-carbaldehyde (1.13 g) was dissolved in ethanol (40 mL). Platinum-(IV)-oxide hydrate (80 mg) was added and the reaction mixture was stirred for 3 h under an atmosphere of hydrogen. The reaction mixture was filtered, evaporated and purified over silica to give a yellow oil (235 mg). ¹H-NMR (CDCl3, 400 MHz): 10.05 (s, 1H), 7.79 (m, 2H), 7.67 (d, 1H), 7.54 (t, 1H), 7.42 (d, 1H), 7.10 (d, 1H), 4.30 (t, 2H), 3.03 (t, 2H), 2.47 (s, 3H), 2.31 (s, 3H), 2.25 (m, 2H).

### Preparation of 6-{3-[1-(6-methyl-pyridin-2-yl)-eth-(E)-ylideneaminom]-prop-1-ynyl}-pyridine-2-carbaldehyde

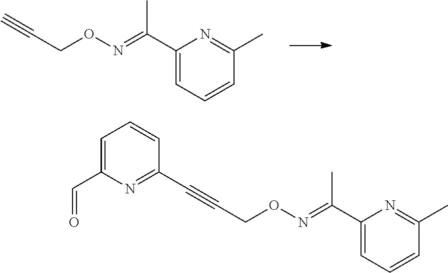 [SMILES: C#CCO/N=C(\C)c1cccc(C)n1 ; C/C(=N\OCC#Cc1cccc(C=O)n1)c1cccc(C)n1]

6-Bromo-pyridine-2-carbaldehyde (2.5 g) and 1-(6-methyl-pyridin-2-yl)-ethanone O-prop-2-ynyl-oxime (2.53 g) were dissolved in THF (80 mL). Diisopropylamine (3.79 mL), dichlorobis(triphenylphospine) palladium(II) (283 mg) and copper(I) iodide (205 mg) were added. After stirring for 6 h at ambient temperature the reaction mixture was diluted with ethyl acetate washed with sodium bicarbonate (10% aqueous solution) and brine. The organic phase was dried over sodium sulfate, concentrated and purified by chromatography over silica to give a beige solid (3.0 g). ¹H-NMR (CDCl3, 400 MHz): 10.05 (s, 1H), 7.90 (d, 1H), 7.85 (t, 1H), 7.70 (m, 2H), 7.55 (t, 1H), 7.12 (d, 1H), 5.10 (s, 2H), 2.68 (s, 3H), 2.40 (s, 3H).

### Example 4

### Preparation of P.11

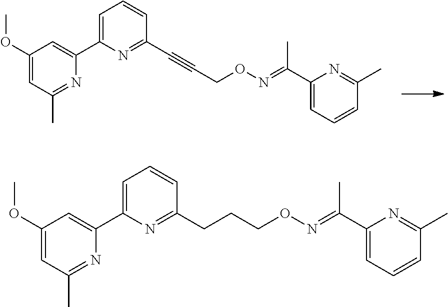

E-1-(6-Methyl-pyridin-2-yl)-ethanone-O-[3-(4′-methoxy-6′-methyl-[2,2]bipyridinyl-6-yl)-prop-2-ynyl]-oxime (908 mg) was dissolved in THF (15 ml). Palladium (10% on charcoal; 20 mg) was added and the reaction mixture was stirred for 16 h under an atmosphere of hydrogen. The reaction mixture was filtered and evaporated to give 1-(6-methyl-pyridin-2-yl)-ethanone-O-[3-(4′-methoxy-6′-methyl-[2,2]bipyridinyl-6-yl)-propyl]-oxime as a beige solid, m.p. 84-86° C.

### Preparation of E-1-(6-methyl-pyridin-2-yl)-ethanone-O-[3-(4′-methoxy-6′-methyl-[2,2]bipyridinyl-6-yl)-prop-2-ynyl]-oxime

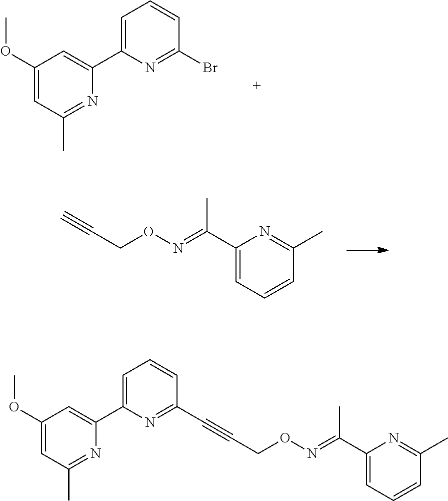 [SMILES: COc1cc(C)nc(-c2cccc(Br)n2)c1 ; C#CCO/N=C(\C)c1cccc(C)n1 ; COc1cc(C)nc(-c2cccc(C#CCO/N=C(\C)c3cccc(C)n3)n2)c1]

6′-Bromo-4-methoxy-6-methyl-[2,2′]bipyridinyl (1.1 g) and E-1-(6-methyl-pyridin-2-yl)-ethanone-O-prop-2-ynyl-oxime (1.12 g) were dissolved in THF (20 ml). Diisopropylamine (3.9 g), dichlorobis (triphenylphospine)palladium(II) (56 mg) and copper(I) iodide (61 mg) were added. After stirring for 1 h at 55° C. the reaction mixture was poured into water, extracted with ethyl acetate and washed with brine. The organic phase was dried over sodium sulfate, concentrated and purified by chromatography over silica to give 1-(6-methyl-pyridin-2-yl)-ethanone-O-[3-(4′-methoxy-6′-methyl-[2,2′]bipyridinyl-6-yl)-prop-2-ynyl]-oxime as a beige solid, m.p. 119-120° C.

### Preparation of 6′-bromo-4-methoxy-6-methyl-[2,2′]bipyridinyl

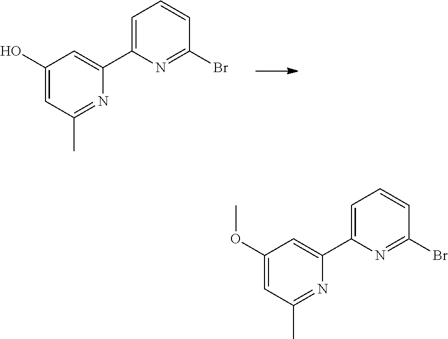 [SMILES: Cc1cc(O)cc(-c2cccc(Br)n2)n1 ; COc1cc(C)nc(-c2cccc(Br)n2)c1]

To 6′-bromo-6-methyl-[2,2′]bipyridinyl-4-ol (11 g) in acetone (80 ml) was added potassium carbonate (11.5 g) and iodomethane (14.7 g). After stirring overnight the reaction mixture was poured into water, extracted with ethyl acetate and washed with brine. The organic phase was dried over sodium sulfate, concentrated and purified by chromatography over silica to give 6′-bromo-4-methoxy-6-methyl-[2,2′]bipyridinyl as a yellow solid, m.p. 103-104° C.

### Preparation of 6′-bromo-6-methyl-[2,2′]bipyridinyl-4-ol

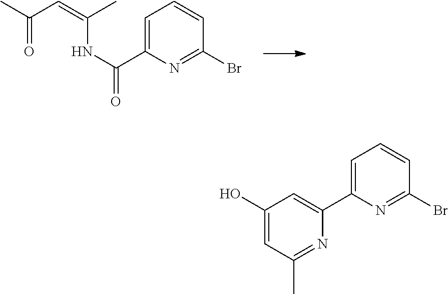 [SMILES: CC(=O)/C=C(/C)NC(=O)c1cccc(Br)n1 ; Cc1cc(O)cc(-c2cccc(Br)n2)n1]

To 6-bromo-pyridine-2-carboxylic acid-((Z)-1-methyl-3-oxo-but-1-enyl)-amide (19 g) in 1,2-dichloroethane (700 ml) was added at 0° C. diisopropylethylamine (34.7 g) and trimethylsilyl trifluoromethanesulfonate (74.6 g). The reaction mixture was stirred overnight at reflux and then poured into saturated ammonium chloride solution (800 ml), extracted with dichloromethane and dried over sodium sulfate. Filtration and concentration gave 6′-bromo-6-methyl-[2,2′]bipyridinyl-4-ol as a beige solid, which was recrystallised from ethyl acetate, m.p. 242° C.

### Preparation of 6-bromo-pyridine-2-carboxylic acid ((Z)-1-methyl-3-oxo-but-1-env-1)-amide

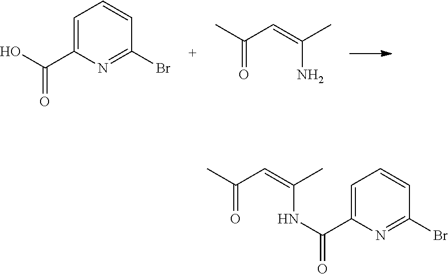

To 6-bromo-pyridin-2-carboxylic acid (15.4 g) and a catalytic amount of DMF in dichloromethane (150 ml) was added dropwise oxalyl chloride (11.6 g). The reaction mixture was stirred for 30 min at room temperature and 30 min at reflux and then concentrated to give 6-bromo-pyridine-2-carboxylic acid chloride as a beige solid, which was dissolved in dichloromethane (80 ml) and added dropwise to a solution of (Z)-4-amino-pent-3-en-2-one (7.6 g) in dichloromethane (70 ml) and triethylamine (9.3 g) at −20° C. The reaction mixture was stirred overnight at room temperature, then poured into saturated bicarbonate solution, extracted with dichloromethane and dried over sodium sulfate. Filtration and concentration gave after purification over silica 6-bromo-pyridine-2-carboxylic acid ((Z)-1-methyl-3-oxo-but-1-enyl)-amide as a yellowish solid, m.p. 113-114° C.

### Example 5

### Preparation of P.14

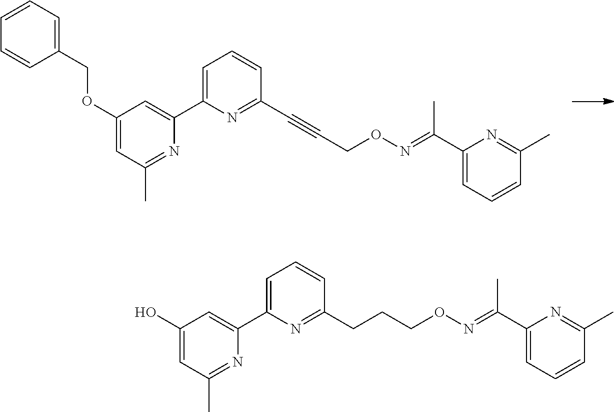 [SMILES: C/C(=N\OCC#Cc1cccc(-c2cc(OCc3ccccc3)cc(C)n2)n1)c1cccc(C)n1 ; C/C(=N\OCCCc1cccc(-c2cc(O)cc(C)n2)n1)c1cccc(C)n1]

1-(6-Methyl-pyridin-2-yl)-ethanone-O-[3-(4′-benzyloxy-6′-methyl-[2,2]bipyridinyl-6-yl)-prop-2-ynyl]-oxime (1.1 g) was dissolved in THF (20 ml). Palladium (10% on charcoal; 180 mg) was added and the reaction mixture was stirred for 16 h under an atmosphere of hydrogen. The reaction mixture was filtered and evaporated to give after purification over silica 1-(6-methyl-pyridin-2-yl)-ethanone-O-[3-(4′-hydroxy-6′-methyl-[2,2′]bipyridinyl-6-yl)-propyl]-oxime as an oil.

### Preparation of E-1-(6-methyl-pyridin-2-yl)-ethanone-O-[3-(4′-benzyloxy-6′-methyl-[2,2]bipyridinyl-6-yl)-prop-2-ynyl]-oxime

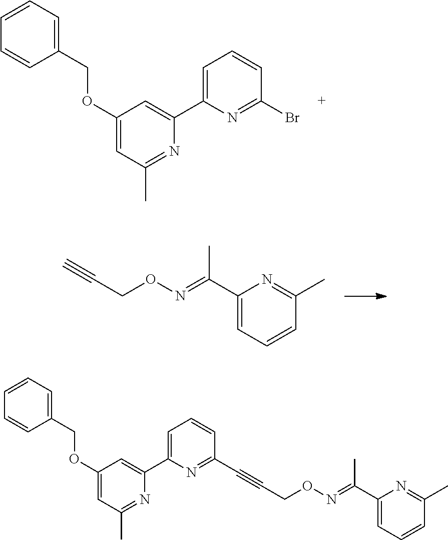 [SMILES: Cc1cc(OCc2ccccc2)cc(-c2cccc(Br)n2)n1 ; C#CCO/N=C(\C)c1cccc(C)n1 ; C/C(=N\OCC#Cc1cccc(-c2cc(OCc3ccccc3)cc(C)n2)n1)c1cccc(C)n1]

4-Benzyloxy-6′-bromo-6-methyl-[2,2′]bipyridinyl (1.05 g) and E-1-(6-methyl-pyridin-2-yl)-ethanone-O-prop-2-ynyl-oxime (835 m g) were dissolved in THF (30 ml). Diisopropylamine (2.99 g), dichlorobis (triphenylphospine)palladium(II) (92 mg) and copper(I) iodide (92 mg) were added. After stirring for 3 h at 55° C. the reaction mixture was poured into water, extracted with ethyl acetate and washed with brine. The organic phase was dried over sodium sulfate, concentrated and purified by chromatography over silica to give 1-(6-Methyl-pyridin-2-yl)-ethanone-O-[3-(4′-benzyloxy-6′-methyl-[2,2′]bipyridinyl-6-yl)-prop-2-ynyl]-oxime as a brown oil.

### Preparation of 4-benzyloxy-6′-bromo-6-methyl-[2,2]bipyridinyl

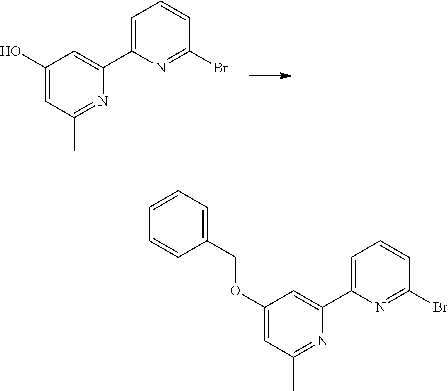 [SMILES: Cc1cc(O)cc(-c2cccc(Br)n2)n1 ; Cc1cc(OCc2ccccc2)cc(-c2cccc(Br)n2)n1]

To 6′-bromo-6-methyl-[2,2′]bipyridinyl-4-ol (1.4 g) in DMF (30 ml) was added potassium carbonate (0.61 g) and benzylbromide (0.75 g). After stirring overnight the reaction mixture was poured into water, extracted with ethyl acetate and washed with brine. The organic phase was dried over sodium sulfate, concentrated and purified by chromatography over silica to give 4-benzyloxy-6′-bromo-6-methyl-[2,2′]bipyridinyl as a beige solid, m.p. 96-97° C.

### Example 6

### Preparation of P.16

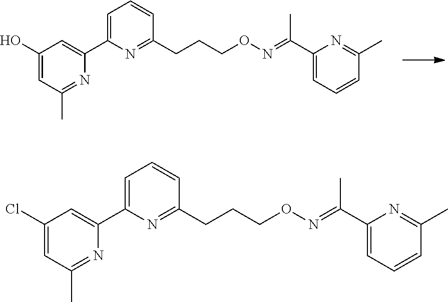 [SMILES: C/C(=N\OCCCc1cccc(-c2cc(O)cc(C)n2)n1)c1cccc(C)n1 ; C/C(=N\OCCCc1cccc(-c2cc(Cl)cc(C)n2)n1)c1cccc(C)n1]

E-1-(6-methyl-pyridin-2-yl)-ethanone-O-[3-(4′-hydroxy-6′-methyl-[2,2]bipyridinyl-6-yl)-propyl]-oxime (150 mg) and phosphorus oxychloride (3 ml) were stirred at 55° C. for 2 h. After concentration ethyl acetate (30 ml) and water (50 ml) were added, followed by 2N NaOH until the solution was neutral. The reaction mixture was extracted with ethyl acetate, washed with brine, dried over sodium sulfate and concentrated to give 1-(6-methyl-pyridin-2-yl)-ethanone-O-[3-(4′-chloro-6′-methyl-[2,2′]bipyridinyl-6-yl)-propyl]-oxime, which was recrystallised from tert-butyl methyl ether, m.p. 53-54° C.

### Example 7

### Preparation of P.39

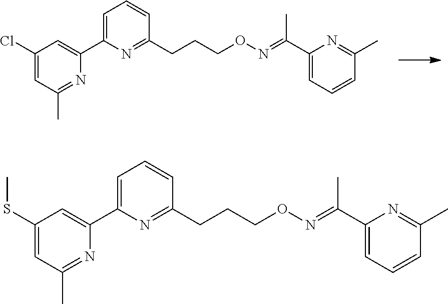 [SMILES: C/C(=N\OCCCc1cccc(-c2cc(Cl)cc(C)n2)n1)c1cccc(C)n1 ; CSc1cc(C)nc(-c2cccc(CCCO/N=C(\C)c3cccc(C)n3)n2)c1]

To E-1-(6-methyl-pyridin-2-yl)-ethanone-O-[3-(4′-chloro-6′-methyl-[2,2]bipyridinyl-6-yl)-propyl]-oxime (110 mg) in DMF (4 ml) was added sodium methanethiolate (26 mg). After stirring for 2 h at 45° C., the reaction mixture was poured into water, extracted with ethyl acetate, washed with brine, dried over sodium sulfate and concentrated to give after purification over silica 1-(6-methyl-pyridin-2-yl)-ethanone-O-[3-(4′-methylsulfanyl-6′-methyl-[2,2]bipyridinyl-6-yl)-propyl]-oxime as a beige solid, m.p. 76-77° C.

### Example 8

### Preparation of P.44

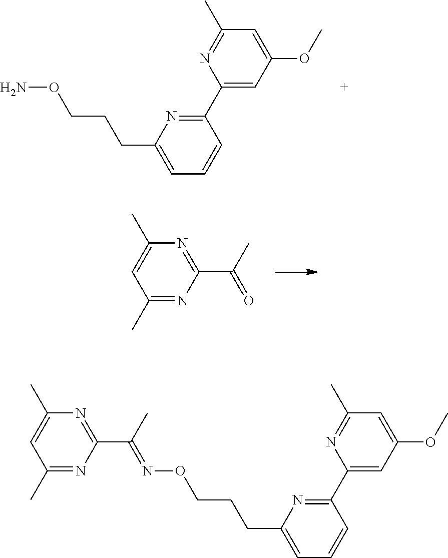 [SMILES: COc1cc(C)nc(-c2cccc(CCCON)n2)c1 ; CC(=O)c1nc(C)cc(C)n1 ; COc1cc(C)nc(-c2cccc(CCCO/N=C(\C)c3nc(C)cc(C)n3)n2)c1]

p-Toluenesulfonic acid monohydrate (8 mg) was added to O-[3-(4′-methoxy-[2-2′]bipyridinyl-6-yl)-propyl]-hydroxylamine (180 mg) and 1-(4,6-dimethylpyrimidin-2-yl)ethanone (100 mg) in ethanol (15 mL). After stirring at ambient temperature for 3 h the reaction mixture was poured into water, extracted with dichloromethane and washed with brine. The organic phase was dried over sodium sulfate, concentrated and purified by chromatography over silica to give a light yellow resin (210 mg) ¹H-NMR (CDCl3, 400 MHz): 8.24 (d, 1H), 7.87 (s, 1H), 7.72 (t, 1H), 7.21 (d, 1H), 7.00 (s, 1H), 6.70 (s, 1H), 4.49 (t, 2H), 3.95 (s, 3H), 3.02 (t, 2H), 2.59 (s, 3H), 2.53 (s, 6H), 2.38 (s, 3H), 2.31 (m, 2H).

### Preparation of O-[3-(4′-methoxy-[2-2′]bipyridinyl-6-yl)-propyl]-hydroxylamine

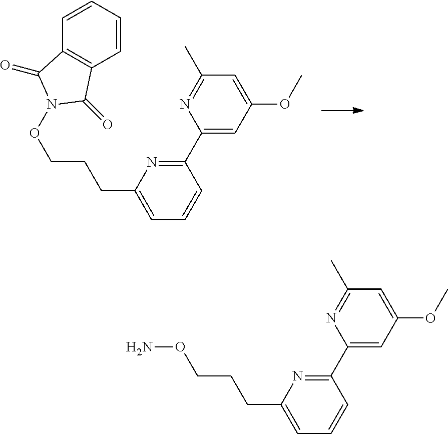 [SMILES: COc1cc(C)nc(-c2cccc(CCCON3C(=O)c4ccccc4C3=O)n2)c1 ; COc1cc(C)nc(-c2cccc(CCCON)n2)c1]

To 2-[3-(4′-methoxy-6′-methyl-[2,2′]bipyridinyl-6-yl)-propoxy]-isoindole-1,3-dione (560 mg) in ethanol (25 mL) was added hydrazine hydrate (140 mg). After 1 min, the reaction mixture was stirred for 2 h at ambient temperature. It was poured onto water (80 mL), and under good stirring, a 4N NaOH solution was added until pH 14. The reaction mixture was extracted with ethyl acetate. The organic phase was washed with brine, dried over sodium sulfate, concentrated to give a beige powder (340 mg). ¹H-NMR (CDCl3, 400 MHz): 8.2 (d, 1H), 7.8 (d, 1H), 7.7 (t, 1H), 7.15 (d, 1H), 6.7 (d, 1H), 5.4 (s, 2H), 3.9 (s, 3H), 3.75 (t, 2H), 2.9 (t, 2H), 2.55 (s, 3H), 2.1 (m, 2H).

### Preparation of 2-[3-(4′-methoxy-6′-methyl-[2,2]bipyridinyl-6-yl-propoxy]-isoindole-1,3-dione

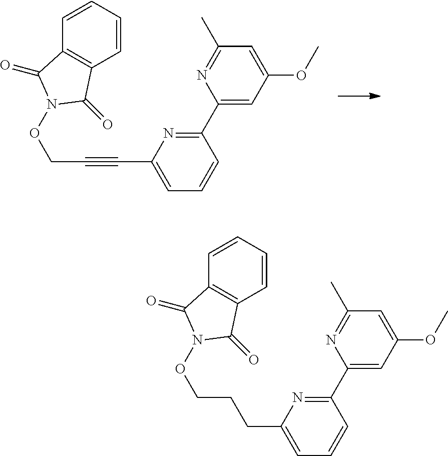 [SMILES: COc1cc(C)nc(-c2cccc(C#CCON3C(=O)c4ccccc4C3=O)n2)c1 ; COc1cc(C)nc(-c2cccc(CCCON3C(=O)c4ccccc4C3=O)n2)c1]

To 2-[3-(4′-methoxy-6′-methyl-[2,2′]bipyridinyl-6-yl)-prop-2-ynyloxy]-isoindole-1,3-dione (1.27 g) in THF (120 mL) was added palladium over charcoal (10%; 120 mg). The reaction mixture was stirred for 3.5 h under an atmosphere of hydrogen. It was filtrated, evaporated and purified over silica to give a pale yellow powder (580 mg). ¹H-NMR (CDCl3, 400 MHz): 8.2 (d, 1H), 7.8 (m, 6H), 7.35 (s, 1H), 6.7 (d, 1H), 4.3 (t, 2H), 3.95 (s, 3H), 3.1 (t, 2H), 2.6 (s, 3H), 2.8 (q, 2H).

### Preparation of 2-[3-(4′-methoxy-6′-methyl-[2,2]bipyridinyl-6-yl)-prop-2-ynyloxy]-isoindole-1,3-dione

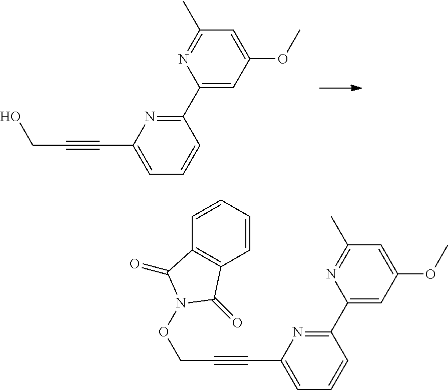

To 3-(4′-methoxy-6′-methyl-[2,2]bipyridinyl-6-yl)-prop-2-yn-1-ol (1.05 g) in THF (30 mL) was added N-hydroxyphtalimide (0.675 g) portion wise at 0° C. Triphenylphosphine (1.19 g) was added, then diisopropylazodicarboxylate (0.92 g) was added portionwise at 0° C. The reaction mixture was diluted with THF (15 mL), and stirred for 3 h at ambient temperature. It was evaporated and a mixture methanol-water (60 mL; 5:1 v/v) was added. It was filtrated, washed with the filtrate and dried to give a beige powder (1.31 g). ¹H-NMR (CDCl3, 400 MHz): 8.4 (d, 1H), 7.9 (d, 2H), 7.75 (m, 4H), 7.5 (d, 1H), 6.7 (d, 1H), 5.15 (s, 2H), 3.95 (s, 3H), 2.5 (s, 3H).

### Preparation of 3-(4′-methoxy-6′-methyl-[2,2′]bipyridinyl-6-yl)-prop-2-yn-1-ol

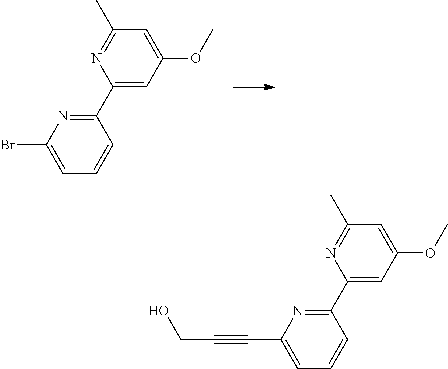 [SMILES: COc1cc(C)nc(-c2cccc(Br)n2)c1 ; COc1cc(C)nc(-c2cccc(C#CCO)n2)c1]

To 6′-bromo-4-methoxy-6-methyl-[2,2′]bipyridinyl (2.9 g) in toluene (50 mL) were added copper iodide (40 mg) and tetrakis(triphenylphosphine)palladium(0) (120 mg) under argon. Propargyl alcohol (0.87 g) then diisopropylamine (2.6 g) was added dropwise. The reaction mixture was stirred at ambient temperature overnight. It was then poured onto water, diluted with ethyl acetate and filtrated over celite. The organic phase was washed with brine, dried over sodium sulfate, evaporated and purified over silica to give a brown powder (0.66 g). ¹H-NMR (CDCl3, 400 MHz): 8.4 (d, 1H), 7.8 (m, 2H), 7.4 (d, 1H), 6.7 (d, 1H), 4.55 (s, 2H), 3.95 (s, 3H), 2.55 (s, 3H), 2.4 (s, 1H).

### Preparation of 1-(4,6-dimethylpyrimidin-2-yl)ethanone

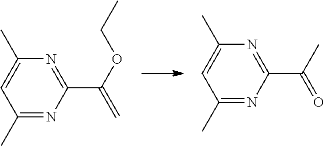

Hydrochloric acid in water (1M; 15 mL) was added to 1-(4,6-dimethylpyrimidin-2-yl)ethanone (2.9 g) in acetone (65 mL). After stirring for 16 h at ambient temperature the reaction mixture was diluted with water, the organic phase was separated and the water phase was extracted with tert-butylmethyl ether. The combined organic phases were washed with water, dried over sodium sulfate, concentrated and purified over silica to give a yellow liquid (800 mg) ¹H-NMR (CDCl3, 400 MHz): 7.17 (s, 1H), 2.77 (s, 3H), 2.59 (s, 6H).

### Preparation of 1-(4,6-dimethylpyrimidin-2-yl)ethanone

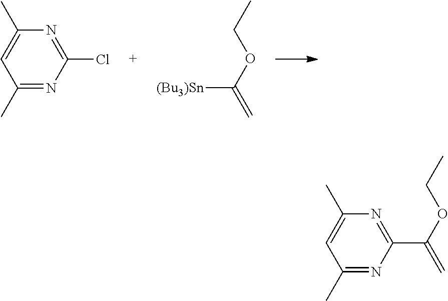

Tributyl(1-ethoxyvinyl)stannane (15.4 mL) was added to a solution of 2-chloro-4,6-dimethyl-pyrimidine (5 g) in dimethylformamide (70 mL). After stirring for 30 min at ambient temperature Bis(triphenylphospine) palladium(II) dichloride (500 mg) was added. The reaction mixture was stirred for 43 h at 100° C., then the reaction mixture was cooled to 25° C. Tert-butylmethyl ether (210 mL) and a solution of potassium fluoride (100 g) in water (40 mL) were then added. After stirring for 1 h at ambient temperature the reaction mixture was diluted with water, the organic phase was separated and the water phase was extracted with tert-butylmethyl ether and dichloromethane. The combined organic phases were washed with water and sodium hydrogen carbonate solution (15% in water), dried over sodium sulfate, concentrated and purified over silica to give a yellow liquid (2.9 g). ¹H-NMR (CDCl3, 400 MHz): 6.96 (s, 1H), 5.62 (d, 1H), 4.60 (d, 1H), 4.07 (q, 2H), 2.53 (s, 6H), 1.50 (t, 3H).

### Example 9

### Preparation of P.45

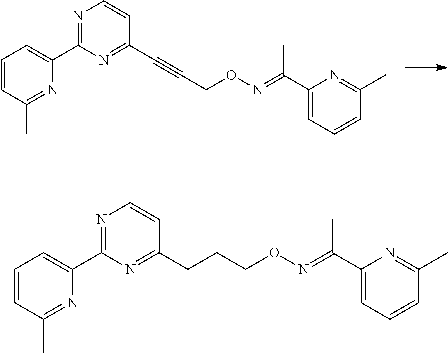 [SMILES: C/C(=N\OCC#Cc1ccnc(-c2cccc(C)n2)n1)c1cccc(C)n1 ; C/C(=N\OCCCc1ccnc(-c2cccc(C)n2)n1)c1cccc(C)n1]

E-1-(6-methyl-2-pyridyl)-N-[3-[2-(6-methyl-2-pyridyl)pyrimidin-4-yl]prop-2-ynoxy]ethanimine (240 mg) was dissolved in ethanol (45 mL). Platinoxide (40 mg) was added and the reaction mixture was stirred for 2 h under an atmosphere of hydrogen. The reaction mixture was filtered and evaporated to give E-1-(6-methyl-2-pyridyl)-N-[3-[2-(6-methyl-2-pyridyl)pyrimidin-4-yl]propoxy]ethanimine (114 mg) as a yellow oil. ¹H-NMR (CDCl3, 400 MHz): 8.82 (d, 1H), 8.32 (d, 1H), 7.73 (t, 1H), 7.67 (d, 1H), 7.53 (t, 1H), 7.27 (d, 1H), 7.19 (d, 1H), 7.09 (d, 1H), 4.33 (t, 2H), 3.02 (t, 2H), 2.73 (s, 3H), 2.57 (s, 3H), 2.33 (s, 3H), 2.29 (m, 2H).

### Preparation of E-1-(6-methyl-2-pyridyl)-N-[3-[2-(6-methyl-2-pyridyl)pyrimidin-4-yl]prop-2-ynoxy]ethanimine

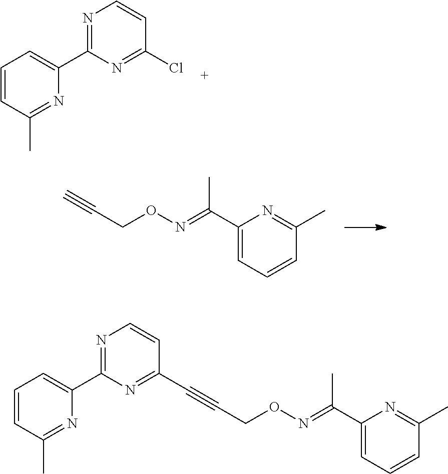 [SMILES: Cc1cccc(-c2nccc(Cl)n2)n1 ; C#CCO/N=C(\C)c1cccc(C)n1 ; C/C(=N\OCC#Cc1ccnc(-c2cccc(C)n2)n1)c1cccc(C)n1]

4-chloro-2-(6-methyl-2-pyridyl)pyrimidine (1.0 g prepared according to Bioorganic & Medicinal Chemistry Letters, 19(8), 2277-2281; 2009) and 1-(6-methyl-pyridin-2-yl)-ethanone O-prop-2-ynyl-oxime (1.1 g) were dissolved in THF (25 mL). Diisopropylamine (1.4 mL), dichlorobis(triphenyl-phospine) palladium(II) (102 mg) and copper(I) iodide (74 mg) were added. After stirring for 16 h at ambient temperature the reaction mixture was diluted with ethyl acetate washed with sodium bicarbonate (10% aqueous solution) and brine. The organic phase was dried over sodium sulfate, concentrated and purified by chromatography over silica to give a beige solid (362 mg). 1H-NMR (CDCl3, 400 MHz): 8.91 (d, 1H), 8.32 (d, 1H), 7.73 (m, 2H), 7.56 (t, 1H), 7.38 (d, 1H), 7.28 (d, 1H), 7.12 (d, 1H), 5.10 (s, 2H), 2.72 (s, 3H), 2.58 (s, 3H), 2.40 (s, 3H).

### Example 10

### Preparation of P.54

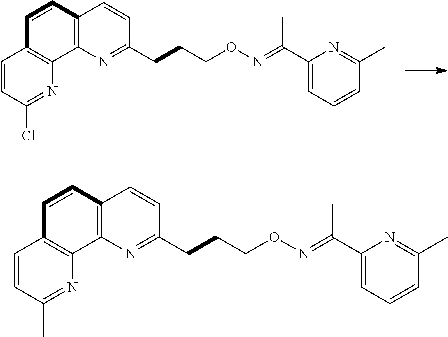

To 1-(6-Methyl-pyridin-2-yl)-ethanone-O-[3-(9-chloro-[1,10]phenanthrolin-2-yl)-propyl]-oxime (33 mg) in dioxane (5 mL) was added cesium carbonate (106 mg), trimethylboroxine (50 wt % in THF, 3.5 M; 0.03 mL) and (1,1′-bis(diphenylphosphino)ferrocene)dichloro-palladium(II) (7 mg). After stirring for 15 min at 95° C. the reaction mixture was poured into water, extracted with ethyl acetate and washed with brine. The organic phase was dried over sodium sulfate, concentrated and purified by chromatography over silica to give 1-(6-Methyl-pyridin-2-yl)-ethanone-O-[3-(9-methyl-[1,10]phenanthrolin-2-yl)-propyl]-oxime as an oil.

### Example 11

### Preparation of P.55

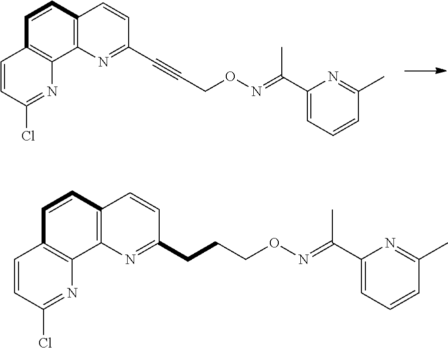

1-(6-Methyl-pyridin-2-yl)-ethanone-O-[3-(9-chloro-[1,10]phenanthrolin-2-yl)-prop-2-ynyl]-oxime (70 mg) was dissolved in THF (12 mL). Palladium (10% on charcoal; 30 mg) was added and the reaction mixture was stirred for 3 h under an atmosphere of hydrogen. The reaction mixture was filtered and evaporated to give after purification over silica 1-(6-Methyl-pyridin-2-yl)-ethanone-O-[3-(9-chloro-[1,10]phenanthrolin-2-yl)-propyl]-oxime as an oil.

### Preparation of E-1-(6-methyl-pyridin-2-yl-ethanone-O-[3-(9-chloro-[1,10]phenanthrolin-2-yl)-prop-2-ynyl]-oxime

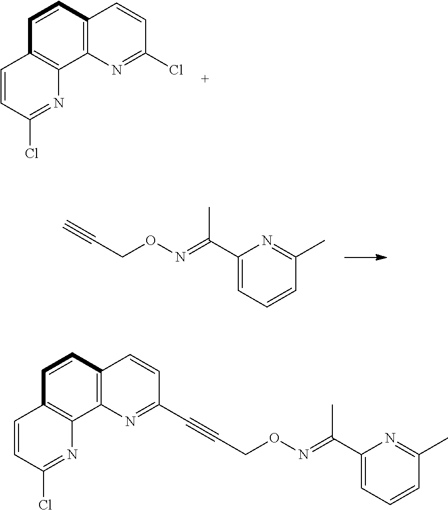

2,9-Dichloro-[1,10]phenanthroline (0.46 g) and E-1-(6-methyl-pyridin-2-yl)-ethanone-O-prop-2-ynyl-oxime (382 mg) were dissolved in THF (5 mL). Diisopropylamine (1.88 g), dichlorobis (triphenylphospine)palladium(II) (57 mg) and copper(I) iodide (58 mg) were added. After stirring for 3 h at 55° C. the reaction mixture was poured into water, extracted with ethyl acetate and washed with brine. The organic phase was dried over sodium sulfate, concentrated and purified by chromatography over silica to give 1-(6-Methyl-pyridin-2-yl)-ethanone-O-[3-(9-chloro-[1,10]phenanthrolin-2-yl)-prop-2-ynyl]-oxime as a brown solid.

TABLE 40
NMR data of compounds of formula (I):

| | Structure | ¹H-NMR (CDCl₃, 400 MHz) |
|---|---|---|
| P.01 | 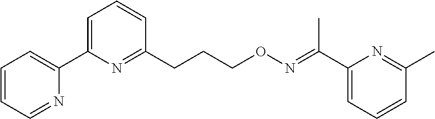 [SMILES: C/C(=N\OCCCc1cccc(-c2ccccn2)n1)c1cccc(C)n1] | 8.68 (d, 1H), 8.47 (d, 1H), 8.21 (d, 1H), 7.80 (t, 1H), 7.72 (t, 1H), 7.68 (d, 1H), 7.53 (t, 1H), 7.29 (m, 1H), 7.20 (d, 1H), 7.09 (d, 1H), 4.33 (t, 2H), 3.00 (t, 3H), 2.57 (s, 3H), 2.34 (s, 3H), 2.30 (m, 2H) |
| P.02 | 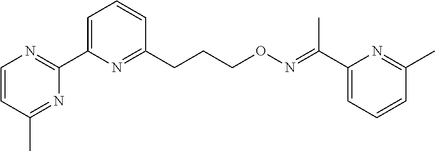 [SMILES: C/C(=N\OCCCc1cccc(-c2nccc(C)n2)n1)c1cccc(C)n1] | 8.78 (d, 1H), 8.30 (d, 1H), 7.76 (t, 1H), 7.69 (d, 1H), 7.54 (t, 1H), 7.31 (d, 1H), 7.16 (d, 1H), 7.08 (d, 1H), 4.32 (t, 2H), 3.12 (t, 3H), 2.63 (s, 3H), 2.56 (s, 3H), 2.32 (s, 3H), 2.25 (m, 2H) |
| P.03 | 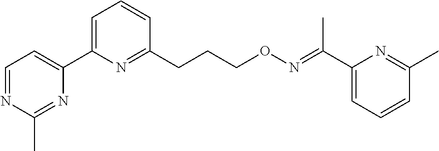 [SMILES: C/C(=N\OCCCc1cccc(-c2ccnc(C)n2)n1)c1cccc(C)n1] | 8.74 (d, 1H), 8.33 (d, 1H), 8.22 (d, 1H), 7.77 (t, 1H), 7.68 (d, 1H), 7.54 (t, 1H), 7.30 (d, 1H), 7.10 (d, 1H), 4.34 (t, 2H), 3.03 (t, 2H), 2.82 (s, 3H), 2.58 (s, 3H), 2.34 (s, 3H), 2.31 (m, 2H) |
| P.44 | 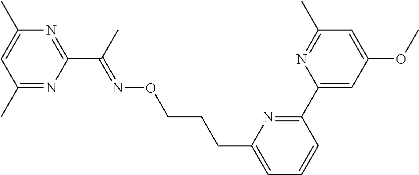 [SMILES: COc1cc(C)nc(-c2cccc(CCCO/N=C(\C)c3nc(C)cc(C)n3)n2)c1] | 8.24 (d, 1H), 7.87 (s, 1H), 7.72 (t, 1H), 7.21 (d, 1H), 7.00 (s, 1H), 6.70 (s, 1H), 4.49 (t, 2H), 3.95 (s, 3H), 3.02 (t, 2H), 2.59 (s, 3H), 2.53 (s, 6H), 2.38 (s, 3H), 2.31 (m, 2H). |
| P.45 | 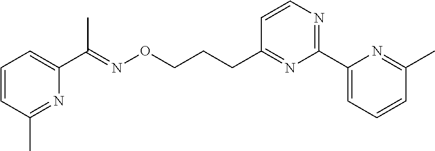 [SMILES: C/C(=N\OCCCc1ccnc(-c2cccc(C)n2)n1)c1cccc(C)n1] | 8.82 (d, 1H), 8.32 (d, 1H), 7.73 (t, 1H), 7.67 (d, 1H), 7.53 (t, 1H), 7.27 (d, 1H), 7.19 (d, 1H), 7.09 (d, 1H), 4.33 (t, 2H), 3.02 (t, 2H), 2.73 (s, 3H), 2.57 (s, 3H), 2.33 (s, 3H), 2.29 (m, 2H) |

TABLE 41
Physical data of compounds of formula (I):

| | | RT (mins) | Molecular | mp |
|---|---|---|---|---|
| | Structure | (method) | ion | (° C.) |
| P.04 | 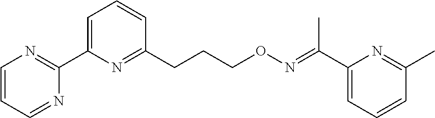 [SMILES: C/C(=N\OCCCc1cccc(-c2ncccn2)n1)c1cccc(C)n1] | 1.21 (ZCQ) | 348 ([M + 1]⁺) | |
| P.05 | 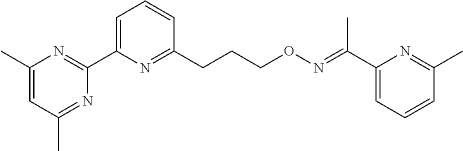 | 1.44 (ZDQ) | 376 ([M + 1]⁺) | |
| P.06 | 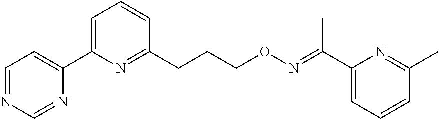 [SMILES: C/C(=N\OCCCc1cccc(-c2ccncn2)n1)c1cccc(C)n1] | 1.75 (ZDQ) | 348 ([M + 1]⁺) | |
| P.07 | 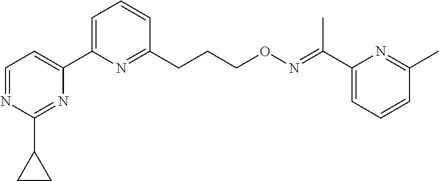 [SMILES: C/C(=N\OCCCc1cccc(-c2ccnc(C3CC3)n2)n1)c1cccc(C)n1] | 2.07 (ZDQ) | 388 ([M + 1]⁺) | |
| P.08 | 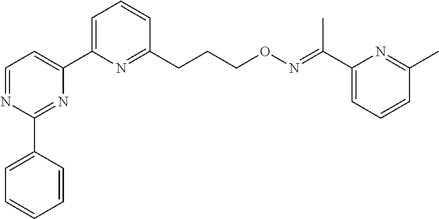 [SMILES: C/C(=N\OCCCc1cccc(-c2ccnc(-c3ccccc3)n2)n1)c1cccc(C)n1] | 2.07 (ZMD) | 424 ([M + 1]⁺) | |
| P.09 | 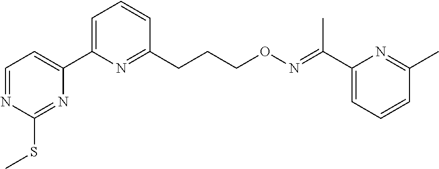 [SMILES: CSc1nccc(-c2cccc(CCCO/N=C(\C)c3cccc(C)n3)n2)n1] | 2.12 (ZDQ) | 394 ([M + 1]⁺) | |
| P.10 | 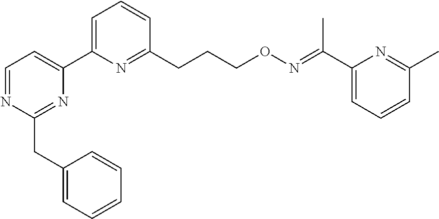 [SMILES: C/C(=N\OCCCc1cccc(-c2ccnc(Cc3ccccc3)n2)n1)c1cccc(C)n1] | 2.20 (ZDQ) | 438 ([M + 1]⁺) | |
| P.11 | 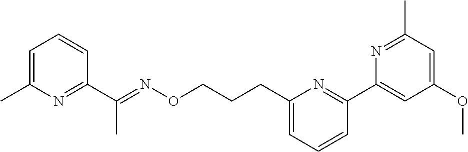 | | | 84-86 |
| P.12 | 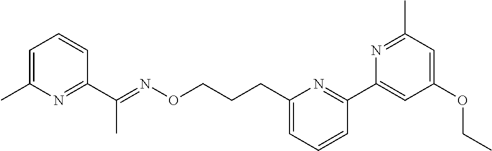 [SMILES: CCOc1cc(C)nc(-c2cccc(CCCO/N=C(\C)c3cccc(C)n3)n2)c1] | 1.31 (ZMD) | 405 ([M + 1]⁺) | |
| P.13 | 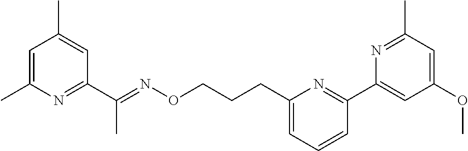 | 1.16 (ZDQ) | 405 ([M + 1]⁺) | |
| P.14 | 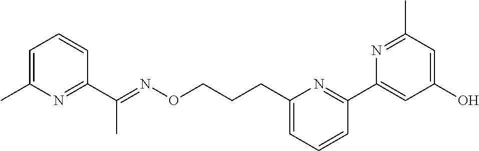 [SMILES: C/C(=N\OCCCc1cccc(-c2cc(O)cc(C)n2)n1)c1cccc(C)n1] | 1.35 (ZDQ) | 377 ([M + 1]⁺) | |
| P.15 | 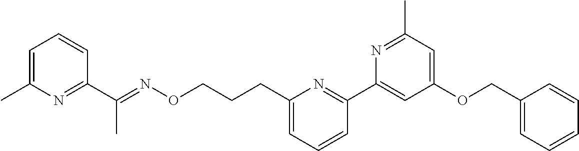 [SMILES: C/C(=N\OCCCc1cccc(-c2cc(OCc3ccccc3)cc(C)n2)n1)c1cccc(C)n1] | 1.68 (ZDQ) | 467 ([M + 1]⁺) | |
| P.16 | 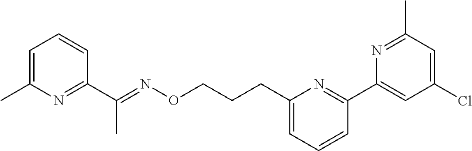 [SMILES: C/C(=N\OCCCc1cccc(-c2cc(Cl)cc(C)n2)n1)c1cccc(C)n1] | | | 53-54 |
| P.17 | 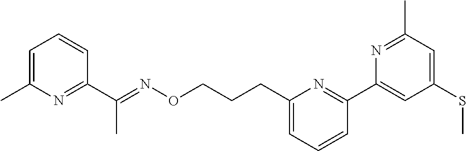 | | | 76-77 |
| P.18 | 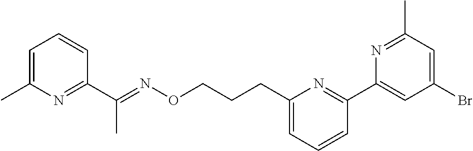 [SMILES: C/C(=N\OCCCc1cccc(-c2cc(Br)cc(C)n2)n1)c1cccc(C)n1] | 2.29 (ZDQ) | 441 ([M + 1]⁺) | |
| P.19 | 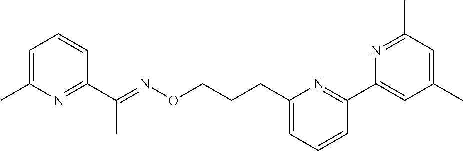 | 1.45 (ZMD) | 375 ([M + 1]⁺) | |
| P.20 | 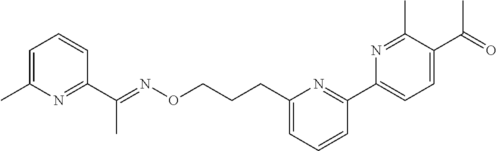 [SMILES: CC(=O)c1ccc(-c2cccc(CCCO/N=C(\C)c3cccc(C)n3)n2)nc1C] | 1.97 (ZDQ) | 403 ([M + 1]⁺) | |
| P.21 | 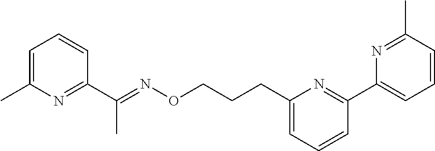 [SMILES: C/C(=N\OCCCc1cccc(-c2cccc(C)n2)n1)c1cccc(C)n1] | 1.62 (ZDQ) | 361 ([M + 1]⁺) | |
| P.22 | 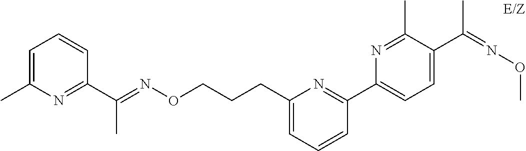 | 2.04/2.12 (ZDQ) | 432 ([M + 1]⁺) | |
| P.23 | 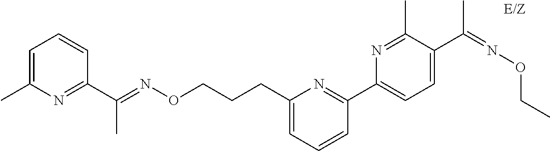 [SMILES: CCON=C(C)c1ccc(-c2cccc(CCCO/N=C(\C)c3cccc(C)n3)n2)nc1C] | 2.15/2.23 (ZDQ) | 446 ([M + 1]⁺) | |
| P.24 | 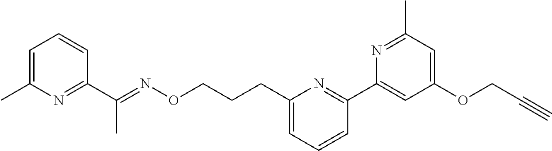 [SMILES: C#CCOc1cc(C)nc(-c2cccc(CCCO/N=C(\C)c3cccc(C)n3)n2)c1] | 1.49 (ZDQ) | 415 ([M + 1]⁺) | |
| P.25 | 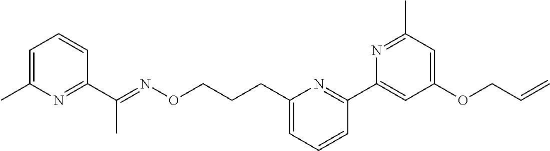 [SMILES: C=CCOc1cc(C)nc(-c2cccc(CCCO/N=C(\C)c3cccc(C)n3)n2)c1] | 1.48 (ZDQ) | 417 ([M + 1]⁺) | |
| P.26 | 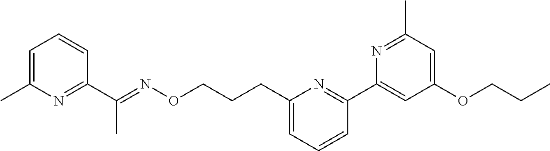 [SMILES: CCCOc1cc(C)nc(-c2cccc(CCCO/N=C(\C)c3cccc(C)n3)n2)c1] | 1.49 (ZDQ) | 419 ([M + 1]⁺) | |
| P.27 | 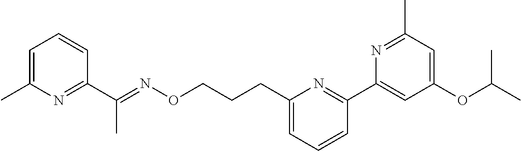 [SMILES: C/C(=N\OCCCc1cccc(-c2cc(OC(C)C)cc(C)n2)n1)c1cccc(C)n1] | 1.52 (ZMD) | 419 ([M + 1]⁺) | |
| P.28 | 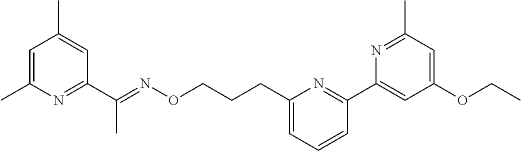 [SMILES: CCOc1cc(C)nc(-c2cccc(CCCO/N=C(\C)c3cc(C)cc(C)n3)n2)c1] | 1.27 (ZDQ) | 419 ([M + 1]⁺) | |
| P.29 | 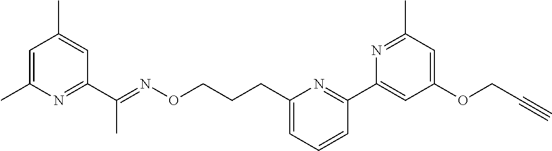 [SMILES: C#CCOc1cc(C)nc(-c2cccc(CCCO/N=C(\C)c3cc(C)cc(C)n3)n2)c1] | 1.37 (ZDQ) | 429 ([M + 1]⁺) | |
| P.30 | 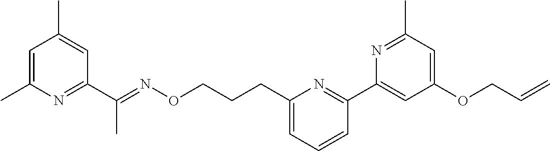 [SMILES: C=CCOc1cc(C)nc(-c2cccc(CCCO/N=C(\C)c3cc(C)cc(C)n3)n2)c1] | 1.37 (ZDQ) | 431 ([M + 1]⁺) | |
| P.31 | 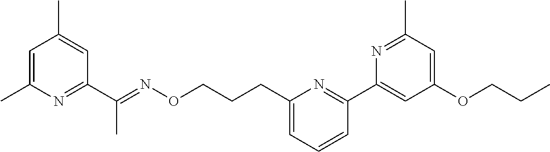 [SMILES: CCCOc1cc(C)nc(-c2cccc(CCCO/N=C(\C)c3cc(C)cc(C)n3)n2)c1] | 1.41 (ZDQ) | 433 ([M + 1]⁺) | |
| P.32 | 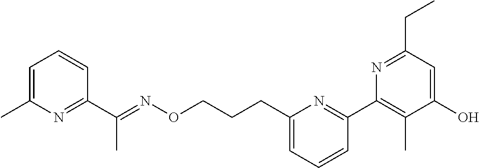 [SMILES: CCc1cc(O)c(C)c(-c2cccc(CCCO/N=C(\C)c3cccc(C)n3)n2)n1] | | | 128-130 |
| P.33 | 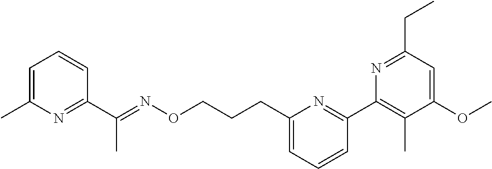 | 1.26 (ZDQ) | 419 ([M + 1]⁺) | |
| P.34 | 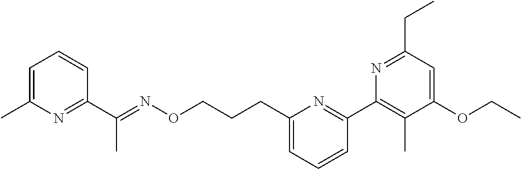 [SMILES: CCOc1cc(CC)nc(-c2cccc(CCCO/N=C(\C)c3cccc(C)n3)n2)c1C] | 1.35 (ZDQ) | 433 ([M + 1]⁺) | |
| P.35 | 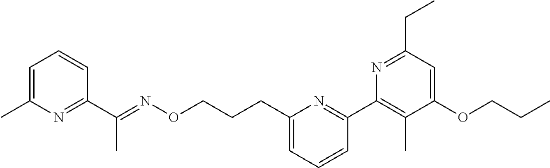 [SMILES: CCCOc1cc(CC)nc(-c2cccc(CCCO/N=C(\C)c3cccc(C)n3)n2)c1C] | 1.45 (ZDQ) | 447 ([M + 1]⁺) | |
| P.36 | 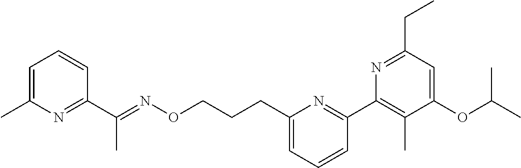 [SMILES: CCc1cc(OC(C)C)c(C)c(-c2cccc(CCCO/N=C(\C)c3cccc(C)n3)n2)n1] | 1.42 (ZDQ) | 447 ([M + 1]⁺) | |
| P.37 | 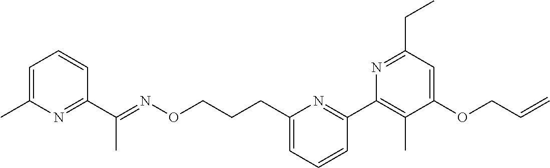 [SMILES: C=CCOc1cc(CC)nc(-c2cccc(CCCO/N=C(\C)c3cccc(C)n3)n2)c1C] | 1.39 (ZDQ) | 445 ([M + 1]⁺) | |
| P.38 | 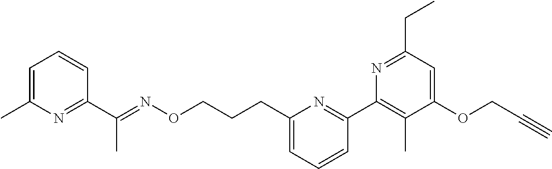 [SMILES: C#CCOc1cc(CC)nc(-c2cccc(CCCO/N=C(\C)c3cccc(C)n3)n2)c1C] | 1.38 (ZDQ) | 443 ([M + 1]⁺) | |
| P.39 | 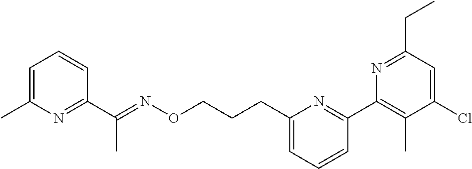 [SMILES: CCc1cc(Cl)c(C)c(-c2cccc(CCCO/N=C(\C)c3cccc(C)n3)n2)n1] | 2.19 (ZDQ) | 423 ([M + 1]⁺) | |
| P.40 | 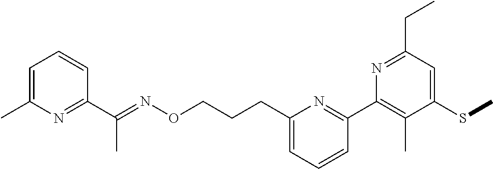 | 1.46 (ZCQ) | 435 ([M + 1]⁺) | |
| P.41 | 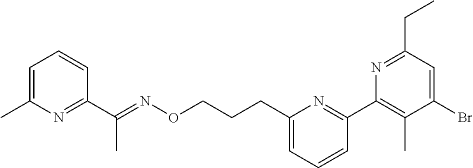 [SMILES: CCc1cc(Br)c(C)c(-c2cccc(CCCO/N=C(\C)c3cccc(C)n3)n2)n1] | 2.22 (ZDQ) | 469 ([M + 1]⁺) | |
| P.42 | 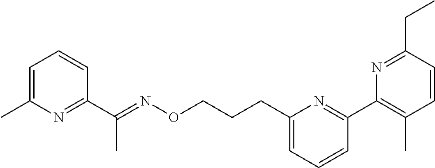 [SMILES: CCc1ccc(C)c(-c2cccc(CCCO/N=C(\C)c3cccc(C)n3)n2)n1] | 1.56 (ZDQ) | 389 ([M + 1]⁺) | |
| P.43 | 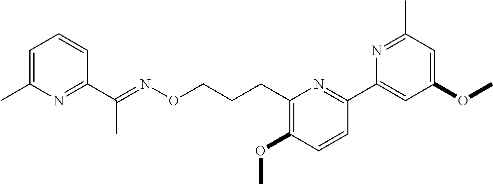 | 0.59 (OA_2min_ 30V) | 421 ([M + 1]⁺) | |
| P.46 | 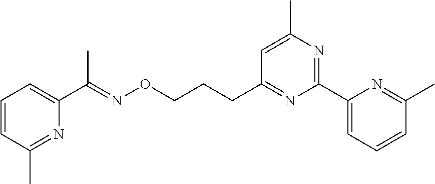 [SMILES: C/C(=N\OCCCc1cc(C)nc(-c2cccc(C)n2)n1)c1cccc(C)n1] | 1.41 (ZMD) | 376 ([M + 1]⁺) | |
| P.47 | 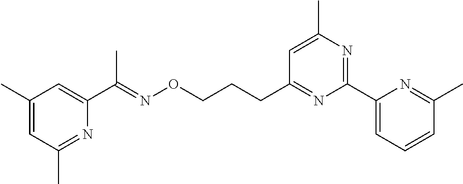 | 1.03 (SQD) | 390 ([M + 1]⁺) | |
| P.48 | 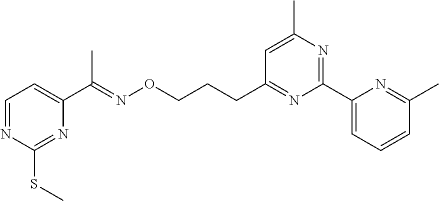 [SMILES: CSc1nccc(/C(C)=N/OCCCc2cc(C)nc(-c3cccc(C)n3)n2)n1] | 1.31 (ZMD) | 450 ([M + 42]⁺) | |
| P.49 | 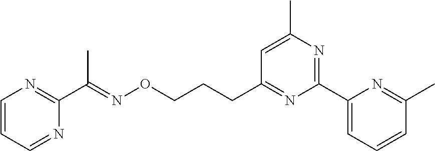 [SMILES: C/C(=N\OCCCc1cc(C)nc(-c2cccc(C)n2)n1)c1ncccn1] | 1.25 (ZMD) | 363 ([M + 1]⁺) | |
| P.50 | 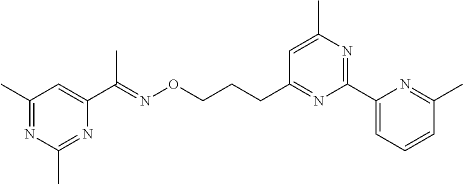 | 1.13 (ZMD) | 432 ([M + 42]⁺) | |
| P.51 | 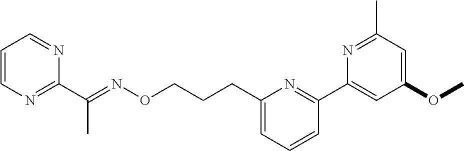 | 1.12 (ZCQ) | 378 ([M + 1]⁺) | |
| P.52 | 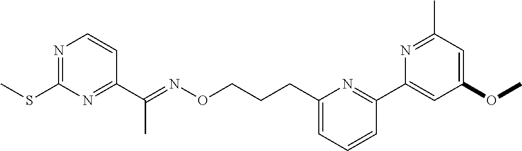 | 1.41 (ZCQ) | 424 ([M + 1]⁺) | |
| P.53 | 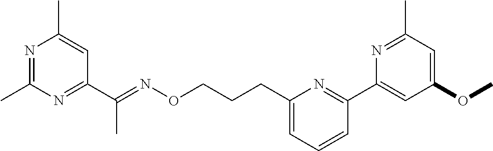 | 1.28 (ZCQ) | 406 ([M + 1]⁺) | |
| P.54 | 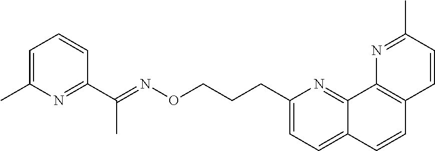 [SMILES: C/C(=N\OCCCc1ccc2ccc3ccc(C)nc3c2n1)c1cccc(C)n1] | 0.56 (OA_2min_ 30V) | 385 ([M + 1]⁺) | |
| P.55 | 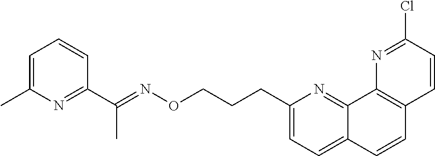 [SMILES: C/C(=N\OCCCc1ccc2ccc3ccc(Cl)nc3c2n1)c1cccc(C)n1] | 1.61 (OA_3min_ 30V) | 405 ([M + 1]⁺) | |
| P.56 | 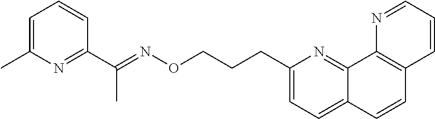 [SMILES: C/C(=N\OCCCc1ccc2ccc3cccnc3c2n1)c1cccc(C)n1] | 1.20 (OA_3min_ 30V) | 371 ([M + 1]⁺) | |
| P.57 | 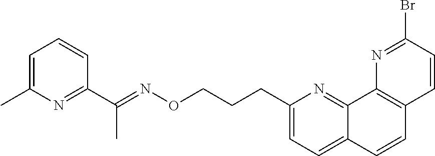 [SMILES: C/C(=N\OCCCc1ccc2ccc3ccc(Br)nc3c2n1)c1cccc(C)n1] | 0.86 (OA_2min_ 30V) | 449 ([M + 1]⁺) | |
| P.58 | 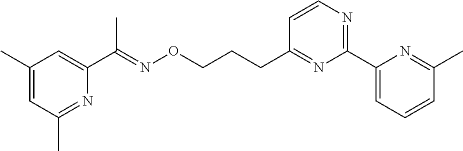 | 0.57 (OA_2min_ 30V) | 376 ([M + 1]⁺) | |

LC-Methods Used

Method A

Autopurification System from Waters: 2767 sample Manager, 2489 UV/Visible Detector, 2545 Quaternary Gradient Module.

Column: Phenomenex Synergi C18 Reversed Phase, 4 μm particle size, 80 Å, 75×30.00 mm,

100 mg of product dissolve in DMF injected

DAD Wavelength (nm): 220 and 254

Solvent Gradient:

A=water (Fluka Analytical)

B=Acetonitrile for prep. HPLC (Fluka Analytical)

| Time | A % | B % | Flow (mL/min) |
|---|---|---|---|
| 0.00 | 90.0 | 10.0 | 50.00 |
| 0.01 | 90.0 | 10.0 | 50.00 |
| 6.00 | 60.0 | 40.0 | 50.00 |
| 7.90 | 60.0 | 40.0 | 50.00 |
| 8.00 | 0.0 | 100.0 | 50.00 |
| 8.90 | 0.0 | 100.0 | 50.00 |
| 9.00 | 90.0 | 10.0 | 50.00 |
| 9.50 | 90.0 | 10.0 | 50.00 |
| 9.55 | 90.0 | 10.0 | 50.00 |

LC-MS Methods Used

Method ZMD

ZMD Mass Spectrometer from Waters (Single quadrupole mass spectrometer)

Instrument Parameter:

Ionisation method: Electrospray

Polarity: positive ions

Capillary (kV) 3.80, Cone (V), Extractor (V) 3.00, Source Temperature (° C.) 150, Desolvation Temperature (° C.) 350, Cone Gas Flow (L/Hr) OFF, Desolvation Gas Flow (L/Hr) 600

Mass range: 100 to 900 Da

HP 1100 HPLC from Agilent: solvent degasser, binary pump, heated column compartment and diode-array detector.

Column: Phenomenex Gemini C18, 3 mm particle size, 110 Å 30×3 mm,

Temp: 60° C.

DAD Wavelength range (nm): 200 to 500

Solvent Gradient:

A=water+0.05% HCOOH

B=Acetonitrile/Methanol (4:1, v:v)+0.04% HCOOH

| Time | A % | B % | Flow (mL/min) |
|---|---|---|---|
| 0.00 | 95.0 | 5.0 | 1.700 |
| 2.00 | 0.0 | 100.0 | 1.700 |
| 2.80 | 0.0 | 100.0 | 1.700 |
| 2.90 | 95.0 | 5.0 | 1.700 |
| 3.00 | 95.0 | 5.0 | 1.700 |

Method ZCQ

ZQ Mass Spectrometer from Waters (Single quadrupole mass spectrometer)

Instrument Parameter:

Ionisation method: Electrospray

Polarity: positive ions

Capillary (kV) 3.00, Cone (V) 30.00, Extractor (V) 2.00, Source Temperature (° C.) 100, Desolvation Temperature (° C.) 250, Cone Gas Flow (L/Hr) 50, Desolvation Gas Flow (L/Hr) 400

Mass range: 100 to 900 Da

HP 1100 HPLC from Agilent: solvent degasser, quaternary pump (ZCQ)/binary pump (ZDQ), heated column compartment and diode-array detector.

Column: Phenomenex Gemini C18, 3 mm particle size, 110 Å, 30×3 mm

Temp: 60° C.

DAD Wavelength range (nm): 200 to 500

Solvent Gradient:

A=water+0.05% HCOOH

B=Acetonitrile/Methanol (4:1, v:v)+0.04% HCOOH

| Time | A % | B % | Flow (mL/min) |
|---|---|---|---|
| 0.00 | 95.0 | 5.0 | 1.700 |
| 2.00 | 0.0 | 100.0 | 1.700 |
| 2.80 | 0.0 | 100.0 | 1.700 |
| 2.90 | 95.0 | 5.0 | 1.700 |
| 3.00 | 95.0 | 5.0 | 1.700 |

Method ZDQ

ZQ Mass Spectrometer from Waters (Single quadrupole mass spectrometer)

Instrument Parameter:

Ionisation method: Electrospray

Polarity: positive ions

Capillary (kV) 3.00, Cone (V) 30.00, Extractor (V) 2.00, Source Temperature (° C.) 100, Desolvation Temperature (° C.) 250, Cone Gas Flow (L/Hr) 50, Desolvation Gas Flow (L/Hr) 400

Mass range: 100 to 900 Da

HP 1100 HPLC from Agilent: solvent degasser, binary pump (ZCQ)/binary pump (ZDQ), heated column compartment and diode-array detector.

Column: Phenomenex Gemini C18, 3 mm particle size, 110 Å, 30×3 mm,

Temp: 60° C.

DAD Wavelength range (nm): 200 to 500

Solvent Gradient:

A=water+0.05% HCOOH

B=Acetonitrile/Methanol (4:1, v:v)+0.04% HCOOH

| Time | A % | B % | Flow (mL/min) |
|---|---|---|---|
| 0.00 | 95.0 | 5.0 | 1.700 |
| 2.00 | 0.0 | 100.0 | 1.700 |
| 2.80 | 0.0 | 100.0 | 1.700 |
| 2.90 | 95.0 | 5.0 | 1.700 |
| 3.00 | 95.0 | 5.0 | 1.700 |

Method U

ACQUITY SQD Mass Spectrometer from Waters (Single quadrupole mass spectrometer)

Ionisation method: Electrospray

Polarity: positive ions

Capillary (kV) 3.00, Cone (V) 20.00, Extractor (V) 3.00, Source Temperature (° C.) 150, Desolvation Temperature (° C.) 400, Cone Gas Flow (L/Hr) 60, Desolvation Gas Flow

(L/Hr) 700

Mass range: 100 to 800 Da

DAD Wavelength range (nm): 210 to 400

Method Waters ACQUITY UPLC with the following HPLC gradient conditions

Solvent Gradient:

A: Water/Methanol (9:1, v:v)+0.1% HCOOH

B: Acetonitrile+0.1% HCOOH

| Time | A % | B % | Flow (mL/min) |
|---|---|---|---|
| 0 | 100 | 0 | 0.75 |
| 2.5 | 0 | 100 | 0.75 |
| 2.8 | 0 | 100 | 0.75 |
| 3.0 | 100 | 0 | 0.75 |

Type of column: Waters ACQUITY UPLC HSS T3; Column length: 30 mm; Internal diameter of column: 2.1 mm; Particle Size: 1.8 micron; Temperature: 60° C.

OA_{—}2 min_{—}30V

SQD Mass Spectrometer from Waters (Single quadrupole mass spectrometer):

Ionization method: Electrospray; Polarity: positive and negative ions; Capillary (kV):

3.00; Cone (V): 30.00; Extractor (V): 2.00; Source Temperature (° C.): 150; Desolvation Temperature (° C.): 250; Cone Gas Flow (L/Hr): 0; Desolvation Gas Flow (L/Hr): 650;

Mass range: 100 to 900 Da

Acquity UPLC from Waters:

Binary pump, heated column compartment and diode-array detector;

Solvent degasser, binary pump, heated column compartment and diode-array detector;

Column: Phenomenex Gemini C18, 3·m, 30×2 mm;

Temp: 60° C.;

DAD Wavelength range (nm): 210 to 500

Solvent Gradient:

A=Water+5% methanol+0.05% HCOOH

B=Acetonitrile+0.05% HCOOH

| Time | A % | B % | Flow (mL/min) |
|---|---|---|---|
| 0.00 | 100 | 0 | 0.850 |
| 1.20 | 0 | 100 | 0.850 |
| 1.50 | 0 | 100 | 0.850 |

OA_{—}3 min_{—}30V

ZQ Mass Spectrometer from Waters (Single quadrupole mass spectrometer):

Ionization method: Electrospray;

Polarity: positive and negative ions;

Capillary (kV): 3.00;

Cone (V): 30.00;

Extractor (V): 2.00;

Source Temperature (° C.): 100;

Desolvation Temperature (° C.): 250;

Cone Gas Flow (L/Hr): 50;

Desolvation Gas Flow (L/Hr): 400;

Mass range: 100 to 900 Da

HP 1100 HPLC from Agilent:

Solvent degasser, binary pump, heated column compartment and diode-array detector;

Column: Phenomenex Gemini C18, 3·m, 30×3 mm; Temp: 60° C.; DAD Wavelength range (nm): 210 to 500;

Solvent Gradient:

A=water+5% MeOH+0.05% HCOOH

B=Acetonitrile+0.05% HCOOH

| Time | A % | B % | Flow (mL/min) |
|---|---|---|---|
| 0.00 | 100 | 0 | 1.700 |
| 2.00 | 0 | 100 | 1.700 |
| 2.80 | 0 | 100 | 1.700 |
| 2.90 | 100 | 0 | 1.700 |
| 3.00 | 100 | 0 | 1.700 |

### BIOLOGICAL EXAMPLES

Phytophthora Infestans/Tomato/Leaf Disc Preventative (Late Blight)

Tomato leaf disks were placed on water agar in multiwell plates (24-well format) and sprayed with the formulated test compound diluted in water at an application rate of 200 ppm. The leaf disks were inoculated with a spore suspension of the fungus 1 day after application. The inoculated leaf disks were incubated at 16° C. and 75% relative humidity under a light regime of 24 h darkness followed by 12/12 h (light/dark) in a climate cabinet and the activity of a compound was assessed as percent disease control compared to untreated when an appropriate level of disease damage appears in untreated check leaf disks (5-7 days after application). The following compounds gave at least 80% control of Phytophthora infestans: P.13, P.44

Plasmopara Viticola/Grape/Leaf Disc Preventative (Late Blight)

Grape vine leaf disks were placed on water agar in multiwell plates (24-well format) and sprayed with the formulated test compound diluted in water. The leaf disks were inoculated with a spore suspension of the fungus 1 day after application. The inoculated leaf disks were incubated at 19° C. and 80% relative humidity under a light regime of 12/12 h (light/dark) in a climate cabinet and the activity of a compound was assessed as percent disease control compared to untreated when an appropriate level of disease damage appears in untreated check leaf disks (6-8 days after application). The following compounds gave at least 80% control of Plasmopara viticola: P.13, P.28

Puccinia Recondita f. sp. Tritici/Wheat/Leaf Disc Preventative (Brown Rust):

Wheat leaf segments cultivated variety (cv) Kanzler were placed on agar in 24-well plates and sprayed with formulated test compound diluted in water at an application rate of 200 ppm. The leaf disks were inoculated with a spore suspension of the fungus 1 day after application. The inoculated leaf segments were incubated at 19° C. and 75% relative humidity under a light regime of 12/12 h (light/dark) in a climate cabinet and the activity of a compound was assessed as percent disease control compared to untreated when an appropriate level of disease damage appears in untreated check leaf segments (7-9 days after application). The following compounds gave at least 80% control of Puccinia recondita f. sp. tritici: P.16, P.15, P.01, P.05, P.02, P.13, P.04, P.12, P.11, P.17, P.18, P.19, P.21, P.22, P.23, P.24, P.25, P.26, P.27, P.28, P.29, P.30, P.31, P.33, P.34, P.35, P.36, P.37, P.38, P.40, P.42, P.43, P.44, P.45

Puccinia Recondita f. sp. Tritici/Wheat/Leaf Disc Curative (Brown Rust):

Wheat leaf segments cv Kanzler were placed on agar in 24-well plates. The leaf segments were inoculated with a spore suspension of the fungus. The plates were stored in darkness at 19° C. and 75% relative humidity. The formulated test compound diluted in water was applied at an application rate of 200 ppm 1 day after inoculation. The leaf segments were incubated at 19° C. and 75% relative humidity under a light regime of 12/12 h (light/dark) in a climate cabinet and the activity of a compound is assessed as percent disease control compared to untreated when an appropriate level of disease damage appears in untreated check leaf segments (6-8 days after application). The following compounds gave at least 80% control of Puccinia recondita f. sp. tritici: P.16, P.15, P.01, P.05, P.02, P.09, P.13, P.04, P.03, P.12, P.11, P.17, P.18, P.19, P.21, P.22, P.23, P.24, P.25, P.26, P.27, P.28, P.29, P.30, P.31, P.33, P.34, P.35, P. 36, P.37, P. 38, P.40, P.42, P.43, P.44, P.45

Phaeosphaeria Nodorum (Septoria nodorum)/Wheat/Leaf Disc Preventative (Glume Blotch):

Wheat leaf segments cv Kanzler were placed on agar in a 24-well plate and sprayed with formulated test compound diluted in water at an application rate of 200 ppm. The leaf disks are inoculated with a spore suspension of the fungus 2 days after application. The inoculated test leaf disks are incubated at 20° C. and 75% relative humidity under a light regime of 12/12 h (light/dark) in a climate cabinet and the activity of a compound is assessed as percent disease control compared to untreated when an appropriate level of disease damage appears in untreated check leaf disks (5-7 days after application). The following compounds gave at least 80% control of Phaeosphaeria nodorum: P.16, P.15, P.01, P.05, P.02, P.09, P.13, P.04, P.07, P.03, P.12, P.11, P.17, P.18, P.19, P.20, P.21, P.22, P.23, P.24, P.25, P.26, P.27, P.28, P.29, P.30, P.31, P.33, P.34, P.35, P.36, P.37, P.38, P.39, P.40, P.41, P.42, P.43, P.44, P.45

Pyrenophora Teres/Barley/Leaf Disc Preventative (Net Blotch):

Barley leaf segments cv Hasso are placed on agar in a 24-well plate and sprayed with formulated test compound diluted in water at an application rate of 200 ppm. The leaf segments are inoculated with a spore suspension of the fungus two days after application of the test solution. The inoculated leaf segments are incubated at 20° C. and 65% relative humidity under a light regime of 12/12 h (light/dark) in a climate cabinet and the activity of a compound is assessed as disease control compared to untreated when an appropriate level of disease damage appears in untreated check leaf segments (5-7 days after application).

The following compounds gave at least 80% control of Pyrenophora teres: P.16, P.15, P.01, P.05, P.02, P.09, P.10, P.13, P.07, P.03, P.12, P.11, P.17, P.18, P.19, P.20, P.21, P.22, P.23,

P.24, P.25, P.26, P.27, P.28, P.29, P.30, P.31, P.33, P.34, P.35, P.36, P.37, P.38, P.40, P.42, P.43, P.44, P.45

Botryotinia Fuckeliana (Botrytis cinerea)/Liquid Culture (Gray Mould):

Conidia of the fungus from cryogenic storage were directly mixed into nutrient broth (Vogels broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 3-4 days after application. The following compounds gave at least 80% control of Botryotinia fuckeliana: P.16, P.15, P.01, P.09, P.10, P.13, P.04, P.07, P.08, P.03, P.12, P.11, P.21, P.22, P.23, P.24, P.25, P.26, P.27, P.28, P.29, P.30, P.31, P.33, P.34, P.35, P.36, P.37, P.38, P.39, P.40, P.41, P.42, P.43, P.44, P.45

Glomerella Lagenarium (Colletotrichum lagenarium)/Liquid Culture (Anthracnose):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth is measured photometrically 3-4 days after application. The following compounds gave at least 80% control of Glomerella lagenarium: P.16, P.15, P.01, P.05, P.02, P.13, P.07, P.12, P.11, P.17, P.18, P.21, P.22, P.23, P.25, P.26, P.27, P.28, P.29, P.30, P.31, P.35, P.36, P.37, P.38, P.39, P.40, P.41, P.42, P.43, P.44, P.45

Mycosphaerella Arachidis (Cercospora arachidicola)/Liquid Culture (Early Leaf Spot):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates are incubated at 24° C. and the inhibition of growth was determined photometrically 4-5 days after application. The following compounds gave at least 80% control of Mycosphaerella arachidis: P.16, P.15, P.14, P.01, P.05, P.02, P.09, P.10, P.13, P.04, P.07, P.08, P.03, P.12, P.11, P.17, P.18, P.19, P.20, P.21, P.22, P.23, P.24, P.25, P.26, P.27, P.28, P.29, P.30, P.31, P.33, P.34, P.35, P.36, P.37, P.38, P.39, P.40, P.41, P.42, P.43, P.44, P.45

Mycosphaerella Graminicola (Septoria tritici)/Liquid Culture (Septoria Blotch):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. The following compounds gave at least 80% control of Mycosphaerella graminicola: P.16, P.15, P.14, P.05, P.02, P.09, P.10, P.13, P.07, P.08, P.06, P.03, P.11, P.17, P.18, P.19, P.21, P.22, P.23, P.24, P.25, P.26, P.27, P.28, P.29, P.30, P.31, P.33, P.34, P.35, P.36, P.37, P.38, P.39, P.40, P.41, P.42, P.43, P.44, P.45

Gaeumannomyces Graminis/Liquid Culture (Take-all of Cereals):

Mycelial fragments of the fungus from cryogenic storage were directly mixed into nutrient broth (PDB potato dextrose broth). After placing a DMSO solution of test compound into a 96-well microtiter plate at an application rate of 200 ppm, the nutrient broth Cp.33, containing the fungal spores is added. The test plates were incubated at 24° C. and the inhibition of growth was determined photometrically 4-5 days after application. The following compounds gave at least 80% control of Gaeumannomyces graminis: P.16, P.15, P.14, P.05, P.02, P.09, P.10, P.13, P.07, P.08, P.06, P.03, P.11, P.17, P.18, P.19, P.20, P.21, P.22, P.23, P.24, P.25, P.26, P.28, P.29, P.30, P.31, P.40, P.42, P.43, P.44

Thanatephorus cucumeris (Rhizoctonia solani)/liquid culture (foot rot, damping-off):

Mycelia fragments of a newly grown liquid culture of the fungus are directly mixed into nutrient broth (PDB potato dextrose broth). After placing a DMSO solution of the test compounds into a 96-well microtiter plate at an application rate of 200 ppm, the nutrient broth containing the fungal material was added. The test plates were incubated at 24° C. and the inhibition of growth was determined photometrically 3-4 days after application. The following compounds gave at least 80% control of Thanatephorus cucumeris: P.16, P.15, P.01, P.05, P.02, P.04, P.07, P.03, P.12, P.11, P.17, P.24, P.25, P.26, P.27, P.28, P.29, P.30, P.31, P.33, P.34, P.35, P.36, P.37, P.38, P.39, P.40, P.42, P.43, P.44, P.45

Monographella Nivalis (Microdochium nivale)/Liquid Culture (Foot Rot Cereals):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. The following compounds gave at least 80% control of Monographella nivalis: P.15, P.01, P.13, P.07, P.12, P.11, P.17, P.18,

P.24, P.25, P.26, P.27, P.28, P.29, P.30, P.31, P.39, P.40, P.41, P.42, P.43, P.44, P.45

Blumeria Graminis f. Sp. Tritici (Erysiphe graminis f. sp. Tritici)/Wheat/Leaf Disc Preventative (Powdery Mildew on Wheat):

Wheat leaf segments cv. Kanzler were placed on agar in a 24-well plate and sprayed with the formulated test compound diluted in water at an application rate of 200 ppm. The leaf disks were inoculated by shaking powdery mildew infected plants above the test plates 1 day after application. The inoculated leaf disks were incubated at 20° C. and 60% relative humidity under a light regime of 24 h darkness followed by 12 h/12 h (dark/light) in a climate chamber and the activity of a compound was assessed as percent disease control compared to untreated when an appropriate level of disease damage appears on untreated check leaf segments (6-8 days after application). The following compounds gave at least 80% control of Blumeria graminis: P.16, P.15, P.01, P.05, P.02, P.13, P.04, P.07, P.12, P.11, P.17, P.18, P.19, P.20, P.21, P.22, P.23, P.24, P.25, P.26, P.27, P.28, P.29, P.30, P.31, P.33, P.34, P.35, P.36, P.37, P.38, P.39, P.40, P.41, P.42, P.43, P.44, P.45

Alternaria Solani/Tomato/Leaf Disc (Early Blight):

Tomato leaf disks cultivated variety (cv.) Baby were placed on agar in multiwell plates (24-well format) and sprayed with the formulated test compound diluted in water at an application rate of 200 ppm. The leaf disks were inoculated with a spore suspension of the fungus 2 days after application. The inoculated leaf disks were incubated at 23° C./21° C. (day/night) and 80% relative humidity under a light regime of 12/12 h (light/dark) in a climate cabinet and the activity of a compound was assessed as percent disease control compared to untreated when an appropriate level of disease damage appears on untreated check disk leaf disks (5-7 days after application). The following compounds gave at least 80% control of Alternaria solani: P.12, P.13, P.21, P.22, P.27, P.29, P.42, P.44

Pythium Ultimum/Liquid Culture (Seedling Damping Off)

Mycelia fragments and oospores of a newly grown liquid culture of the fungus were directly mixed into nutrient broth (potato dextrose broth). After placing a DMSO solution of test compound into a 96-well format microtiter plate at an application rate of 200 ppm, the nutrient broth containing the fungal mycelia/spore mixture was added. The test plates were incubated at 24° C. and the inhibition of growth was determined photometrically 2-3 days after application. The following compounds gave at least 80% control of Pythium ultimum: P.05, P.13, P.12, P.17, P.18, P.19, P.21, P.25, P.27, P.28, P.43, P.44, P.45

1. A compound of formula (I): 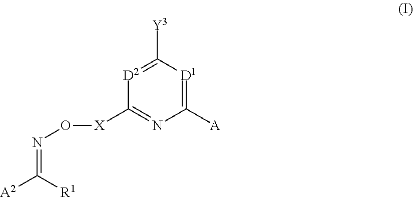
wherein
R¹ represents hydrogen, halogen, CN, SH, C₁-C₈ alkylthio, C₁-C₈ alkylsulphinyl, C₁-C₈ alkylsulphonyl, NH₂, C₁-C₁₀ alkyl, C₃-C₈ cycloalkyl, C₂-C₈ alkenyl, C₂-C₈ alkynyl, (R⁷O)carbonyl(C₁-C₄ alkyl), phenyl or pyridyl, wherein the alkyl, cycloalkyl, alkenyl, alkynyl, phenyl and pyridyl are optionally substituted by one or more groups independently selected from halogen, CN, NH₂, NH—C₁-C₈ alkyl, N(C₁-C₈ alkyl)₂, NO₂, OW, C₁-C₄ alkyl, C₁-C₄ haloalkyl, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms;
A² represents cycle G-1: 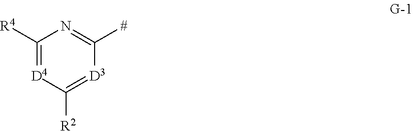
D¹ represents N or C—Y¹;
D² represents N or C—Y²;
wherein both D¹ and D² cannot be N;
D³ represents N or C—R⁶;
D⁴ represents N or C—R⁵;
wherein both D³ and D⁴ cannot be N;
R², R⁴, R⁵ and R⁶ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, COR⁸, OR⁷, SH, C₁-C₈ alkylthio, C₁-C₈ alkylsulphinyl, C₁-C₈ alkylsulphonyl, phenylthio, phenylsulphinyl, phenylsulphonyl, N(R⁹)₂, CO₂R⁷, O(CO)R⁸, CON(R⁹)₂, NR⁹COR⁸ or CR⁸N—OR⁷, wherein the alkyl, cycloalkyl, alkenyl, alkynyl, phenyl and heterocycle are optionally substituted by one or more groups independently selected from halogen, CN, NH₂, NO₂, OR⁷, C₁-C₄ alkyl, C₁-C₄ haloalkyl;
or R⁴ and R⁵, R⁵ and R², or R⁶ and R² together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, and wherein the ring formed by R⁴ and R⁵, R⁵ and R², or R⁶ and R² is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
X represents X-2, X-3, X-4 or X-5: 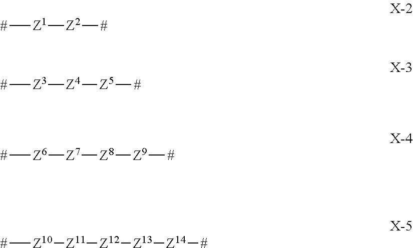
Z¹, Z², Z³, Z⁵, Z⁶, Z⁷, Z⁸, Z⁹, Z¹⁰, Z¹¹, Z¹³ and Z¹⁴ independently of one another represent CR¹⁰R¹¹, C═O or C═CR¹²R¹³;
Z⁴ and Z¹² represent CR¹⁴R¹⁵, SiR¹⁶R¹⁷, C═O or C═CR¹²R¹³;
or in each case two adjacent radicals Z⁴ and Z⁵ or Z⁷ and Z⁸ or Z⁸ and Z⁹ or Z¹¹ and Z¹² or Z¹² and Z¹³ or Z¹³ and Z¹⁴ may together represent a group selected from CR¹⁰═CR¹¹— and —C≡C—, wherein X-4 or X-5 may not contain more than one such group;
each R¹⁰ and R¹¹ independently of one another represent hydrogen, halogen, CN, OH, Cᵣ C₄ alkyl, C₁-C₄ haloalkyl or phenyl, wherein the phenyl is optionally substituted by one or more groups independently selected from halogen, CN, C₁-C₄ alkyl, C₁-C₄ haloalkyl, C₁-C₄ alkoxy and C₁-C₄ haloalkoxy;
or R¹⁰ and R¹¹ together with the carbon atom to which they are attached may form a C₃-C₆ cycloalkyl group or a C₃-C₆ halocycloalkyl group;
each R¹² and R¹³ independently of one another represent hydrogen, halogen, C₁-C₄ alkyl or C₁-C₄ haloalkyl;
each R¹⁴, R¹⁵, R¹⁶ and R¹⁷ independently of one another represent hydrogen, halogen, CN, OH, C₁-C₄ alkyl, C₁-C₄ haloalkyl, C₁-C₄ alkoxy or phenyl, wherein phenyl is optionally substituted by one or more groups independently selected from halogen, CN, C₁-C₄ alkyl, C₁-C₄ haloalkyl, C₁-C₄ alkoxy and C₁-C₄ haloalkoxy;
or R¹⁴ and R¹⁵ together with the carbon atom to which they are attached may form a C₃-C₆ cycloalkyl group or a C₃-C₆ halocycloalkyl group;
wherein the groupings X-2, X-3, X-4 and X-5 contain at most one ring which contains either only one of the radicals Z¹ to Z¹⁴ or two radicals Z¹ to Z¹⁴ or three radicals Z¹ to Z¹⁴ or four radicals Z¹ to Z¹⁴ as ring members; and wherein radicals Z¹, Z³, Z⁶ and Z¹⁰ are not substituted by OH; and wherein none of Z¹, Z², Z³, Z⁴, Z⁵, Z⁶, Z⁷, Z⁸, Z⁹, Z¹⁰, Z¹¹, Z¹², Z¹³ and Z¹⁴ represent a carbon atom substituted by two OH;
Y¹, Y² and Y³ independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, COR⁸, OR⁷, SH, C₁-C₈ alkylthio, C₁-C₈ alkylsulphinyl, C₁-C₈ alkylsulphonyl, phenylthio, phenylsulphinyl, phenylsulphonyl, N(R⁹)₂, CO₂R⁷, O(CO)R⁸, CON(R⁹)₂, NR⁹COR⁸ or CR⁸N—OR⁷, wherein the alkyl, cycloalkyl, alkenyl, alkynyl, phenyl, and heterocycle are optionally substituted by one or more groups independently selected from halogen, CN, NH₂, NO₂, OR⁷, C₁-C₄ alkyl and C₁-C₄ haloalkyl;
or Y¹ and Y³, or Y² and Y³ together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, and wherein the ring formed by Y¹ and Y³, or Y² and Y³ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
A¹ represents cycle A-1, A-2, A-3, A-4, A-5, A-6 or A-7: 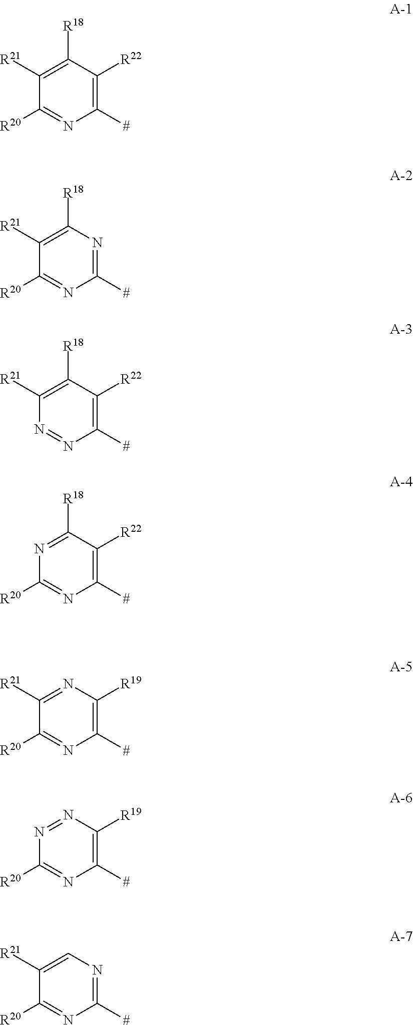
R¹⁸, R¹⁹, R²⁰, R²¹ and R²² independently of one another represent hydrogen, halogen, CN, NO₂, C₁-C₈ alkyl, C₃-C₈ cycloalkyl, C₂-C₈ alkenyl, C₂-C₈ alkynyl, phenyl, a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, benzyl, COR⁸, OR⁷, SH, C₁-C₈ alkylthio, C₁-C₈ alkylsulphinyl, C₁-C₈ alkylsulphonyl, phenylthio, phenylsulphinyl, phenylsulphonyl, N(R⁹)₂, CO₂R⁷, O(CO)R⁸, CON(R⁹)₂, NR⁹COR⁸ or CR⁸N—OR⁷, wherein the alkyl, cycloalkyl, alkenyl, alkynyl, phenyl, heterocycle and benzyl are optionally substituted by one or more groups independently selected from halogen, CN, NH₂, NO₂, OR⁷, C₁-C₄ alkyl, C₁-C₄ haloalkyl;
or R¹⁸ and R²¹, R¹⁸ and R²², or R²⁰ and R²¹ together with the fragment of the ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, and wherein the ring formed by R¹⁸ and R²¹, R¹⁸ and R²², or R²⁰ and R²¹ is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
when A¹ is A-1 and D¹ is C—Y¹, then R²² and Y¹ together with the fragment to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, and wherein the ring formed by R²² and Y¹ is optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy and C₁-C₄ alkylthio;
each R⁷ independently of one another represents hydrogen, C₁-C₈ alkyl, C₃-C₈ cycloalkyl, C₃-C₈ alkenyl, C₃-C₈ alkynyl, C₁-C₄ alkylsulphonyl, phenyl, benzyl or a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms, wherein the alkyl, cycloalkyl, alkenyl, alkynyl, phenyl, benzyl and heterocycle are optionally substituted by one or more groups independently selected from halogen, CN, NH₂, NO₂, OH, C₁-C₄ alkyl, C₁-C₄-haloalkyl, C₁-C₄ alkoxy, C₁-C₄ haloalkoxy, C₁-C₄-alkyl-C₁-C₄-alkoxy and C₁-C₄-alkoxy-C₁-C₄-alkyl;
each R⁸ independently of one another represents hydrogen, C₁-C₈ alkyl, C₃-C₈ cycloalkyl, C₂-C₈ alkenyl, C₂-C₈ alkynyl, phenyl, benzyl or pyridyl, wherein the alkyl, cycloalkyl, alkenyl, alkynyl, phenyl, benzyl and pyridyl are optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy;
each R⁹ independently of one another represents hydrogen, OH, C₁-C₈ alkyl, C₁-C₈ alkoxy, C₁-C₈-alkoxy-C₁-C₄alkyl, C₃-C₈ alkenyl, C₃-C₈ alkynyl, or COR⁸, wherein the alkyl, alkoxy, alkenyl and alkynyl are optionally substituted by one or more halogen;
wherein when two radicals R⁹ are attached to the same nitrogen atom, these radicals can be identical or different;
wherein when two radicals R⁹ are attached to the same nitrogen atom, both of these radicals cannot be OH, C₁-C₄ alkoxy or C₁-C₄ haloalkoxy;
and wherein when two radicals R⁹ are attached to the same nitrogen atom, these two radicals together with the nitrogen atom to which they are attached may form a cycle B-1, B-2, B-3, B-4, B-5, B-6, B-7 or B-8: 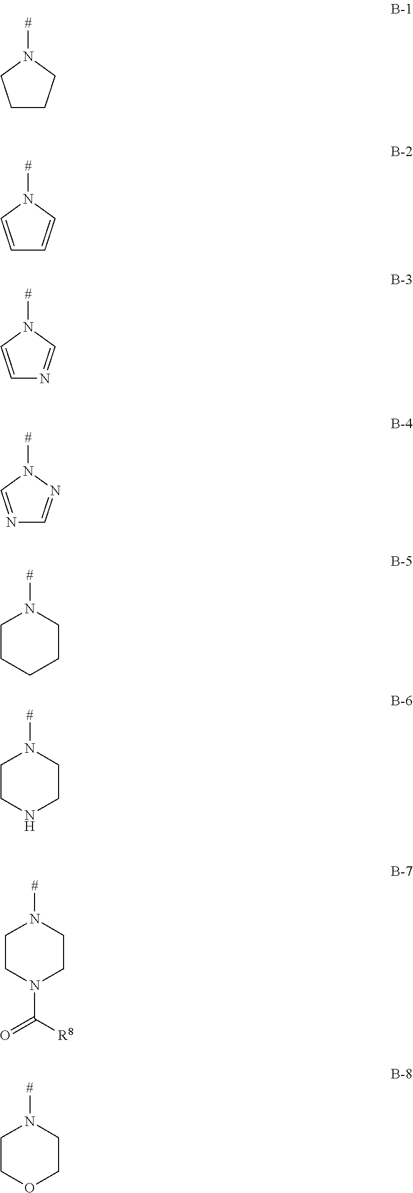
wherein the cycle formed is optionally substituted by one or more groups independently selected from halogen, CN, NH₂, NO₂, OH, C₁-C₄ alkyl, C₁-C₄ haloalkyl, C₁-C₄ alkoxy and C₁-C₄ haloalkoxy; or a salt or N-oxide thereof.

2. A compound according to claim 1, wherein
R¹ represents hydrogen, C₁-C₈ alkyl, C₂-C₈ alkenyl, C₂-C₈ alkynyl, C₃-C₈ cycloalkyl, phenyl, pyridyl, or (R⁷O)carbonyl(C₁-C₄ alkyl), wherein the alkyl, alkenyl, alkynyl, cycloalkyl, phenyl and pyridyl are optionally substituted by one or more groups independently selected from halogen, CN, OR⁷, NH₂, NH—C₁-C₈ alkyl, N(C₁-C₈ alkyl)₂, C₁-C₄ alkyl, C₁-C₄ haloalkyl, C₃-C₆ cycloalkyl and pyridyl;
D¹ represents N or C—Y¹;
D² represents C—Y²;
D³ represents N or C—R⁶;
D⁴ represents C—R⁵;
R², R⁴, R⁵ and R⁶ independently of one another represent hydrogen, halogen, CN, OR⁷, C₁-C₈ alkyl, C₂-C₈ alkenyl, C₃-C₈ cycloalkyl, phenyl, pyridyl, N(R⁹)₂, CO₂R⁷, NR⁹COR⁸, SH, C₁-C₈ alkylthio, C₁-C₈ alkylsulphinyl, C₁-C₈ alkylsulphonyl, phenylthio, phenylsulphinyl or phenylsulphonyl, wherein the alkyl, alkenyl, cycloalkyl, phenyl and pyridyl are optionally substituted by one or more groups independently selected from halogen, CN, OR⁷, C₁-C₄ alkyl and C₁-C₄ haloalkyl;
or R⁴ and R⁵, R⁵ and R², or R² and R⁶, together with the fragment of the pyridyl ring to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, wherein the ring formed by R⁴ and R⁵, R⁵ and R², or R² and R⁶ is optionally substituted by one or more groups independently selected from halogen, CN, C₁-C₄ alkyl, C₁-C₄ haloalkyl, C₁-C₄ alkoxy and C₁-C₄ haloalkoxy;
X represents X-3 or X-5;
Z³, Z⁵, Z¹⁰, Z¹¹, Z¹³ and Z¹⁴ independently of one another represent CR¹⁰R¹¹ or C═CR¹²R¹³;
Z⁴ and Z¹² represent CR¹⁴R¹⁵ or C═CR¹²R¹³;
or in each case two adjacent radicals Z⁴ and Z⁵ or Z¹¹ and Z¹² or Z¹² and Z¹³ or Z¹³ and Z¹⁴ may together represent a group selected from —CR¹⁰═CR¹¹— and —C≡C—, wherein X-3 or X-5 may not contain more than one such group;
each R¹⁰ and R¹¹ independently of one another represent hydrogen, halogen, CN, OH, C₁-C₄ alkyl or C₁-C₄ haloalkyl;
each R¹² and R¹³ independently of one another represent hydrogen, halogen, C₁-C₄ alkyl or C₁-C₄ haloalkyl;
each R¹⁴ and R¹⁵ independently of one another represent hydrogen, halogen, CN, OH, C₁-C₄ alkyl, C₁-C₄ haloalkyl, C₁-C₄ alkoxy or phenyl, wherein the phenyl is optionally substituted by one or more groups independently selected from halogen, CN, methyl, halomethyl, methoxy and halomethoxy;
or R¹⁴ and R¹⁵ together with the carbon atom to which they are attached may form a C₃-C₆ cycloalkyl group or a C₃-C₆ halocycloalkyl group;
Y¹, Y² and Y³ independently of one another represent hydrogen, halogen, CN, OR⁷, C₁-C₈ alkyl, C₂-C₈ alkenyl, C₃-C₈ cycloalkyl, phenyl, pyridyl, N(R⁹)₂, CO₂R⁷, NR⁹COR⁸, SH, C₁-C₈ alkylthio, C₁-C₈ alkylsulphinyl, C₁-C₈ alkylsulphonyl, phenylthio, phenylsulphinyl or phenylsulphonyl, wherein the alkyl, alkenyl, cycloalkyl, phenyl and pyridyl are optionally substituted by one or more groups independently selected from halogen, CN, OR⁷, C₁-C₄ alkyl and C₁-C₄ haloalkyl;
A¹ represents cycle A-1, A-2, A-3, A-4, A-5, A-6 or A-7;
R¹⁸, R¹⁹, R²⁰, R²¹ and R²² independtly of one another represent hydrogen, halogen, CN, OR⁷, C₁-C₈ alkyl, C₂-C₈ alkenyl, C₃-C₈ cycloalkyl, phenyl, pyridyl, benzyl, N(R⁹)₂, CO₂R⁷, NR⁹COR⁸, SH, CR⁸N—OR⁷, C₁-C₈ alkylthio, C₁-C₈ alkylsulphinyl, C₁-C₈ alkylsulphonyl, phenylthio, phenylsulphinyl or phenylsulphonyl, wherein the alkyl, alkenyl, cycloalkyl, phenyl, pyridyl and benzyl are optionally substituted by one or more groups independently selected from halogen, CN, OR⁷, C₁-C₄ alkyl and C₁-C₄ haloalkyl;
each R⁷ independently of one another represents hydrogen, C₁-C₈ alkyl, C₁-C₈ haloalkyl, C₃-C₈ alkenyl, C₃-C₈ alkynyl, C₃-C₈ haloalkenyl, C₃-C₈ haloalkynyl, C₁-C₄ alkylsulphonyl, C₁-C₄ haloalkylsulphonyl, phenyl, benzyl or pyridyl, wherein the phenyl, benzyl and pyridyl are optionally substituted by one or more groups independently selected from halogen, CN, NH₂, NO₂, OH, C₁-C₄ alkyl, C₁-C₄-haloalkyl, C₁-C₄ alkoxy and C₁-C₄ haloalkoxy;
each R⁸ independently of one another represents hydrogen, C₁-C₈ alkyl or C₁-C₈ haloalkyl;
each R⁹ independently of one another represents hydrogen, C₁-C₈ alkyl or COR⁸;
wherein when two radicals R⁹ are attached to the same nitrogen atom, these radicals can be identical or different;
and wherein when two radicals R⁹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

3. A compound according to claim 1, wherein
R¹ represents hydrogen, C₁-C₄ alkyl, C₂-C₄ alkenyl, phenyl or pyridyl, wherein the alkyl, alkenyl, phenyl and pyridyl are optionally substituted by one or more groups independently selected from halogen, CN, OH, NH₂, NH—C₁-C₄ alkyl, N(C₁-C₄ alkyl)₂, C₁-C₄ alkyl, C₁-C₄ haloalkyl, C₁-C₄ alkoxy, C₁-C₄ haloalkoxy and C₃-C₆ cycloalkyl;
D¹ represents N or C—Y¹;
D² represents C—Y²;
D³ represents N or C—R⁶;
D⁴ represents C—R⁵;
R², R⁴, R⁵ and R⁶ independently of one another represent hydrogen, halogen, OR⁷, CN, C₁-C₄ alkyl, C₃-C₆ cycloalkyl, N(R⁹)₂, phenyl, CO₂R⁷ or NR⁹COR⁸, wherein the alkyl, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;
or R⁴ and R⁵, R⁵ and R², or R² and R⁶, together with the fragment of the pyridyl ring to which they are attached may form a fully or partially unsaturated 5- or 6-membered carbocyclic ring, optionally substituted by one or more groups independently selected from halogen, methyl and halomethyl;
X represents X-3;
Z³ and Z⁵ independently of one another represent CR¹⁰R¹¹ or C═CR¹²R¹³;
Z⁴ represents CR¹⁴R¹⁵ or C═CR¹²R¹³;
or Z⁴ and Z⁵ together represent a group selected from —CR¹⁰═CR¹¹— and —C≡C—;
each R¹⁰ and R¹¹ independently of one another represent hydrogen, halogen, CN, OH, C₁-C₄ alkyl or C₁-C₄ haloalkyl;
each R¹² and R¹³ independently of one another represent hydrogen, halogen, C₁-C₄ alkyl or C₁-C₄ haloalkyl;
each R¹⁴ and R¹⁵ independently of one another represent hydrogen, halogen, CN, OH, C₁-C₄ alkyl, C₁-C₄ alkoxy, C₁-C₄ haloalkyl or phenyl, wherein the phenyl is optionally substituted by one or more groups independently selected from halogen, CN, methyl, halomethyl, methoxy and halomethoxy;
or R¹⁴ and R¹⁵ together with the carbon atom to which they are attached may form a C₃-C₆ cycloalkyl group or a C₃-C₆ halocycloalkyl group;
wherein at least two of Z³, Z⁴ and Z⁵ are substituted only by hydrogen or Z⁴ and Z⁵ together represent —C≡C—;
Y¹, Y² and Y³ independently of one another represent hydrogen, halogen, OR⁷, CN, C₁-C₄ alkyl, C₃-C₆ cycloalkyl, N(R⁹)₂, phenyl, CO₂R⁷ or NR⁹COR⁸, wherein the alkyl, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;
A¹ represents cycle A-1, A-2 or A-4;
R¹⁸, R²⁰, R²¹ and R²² independently of one another represent hydrogen, halogen, OR⁷, CN, C₁-C₄ alkyl, C₃-C₆ cycloalkyl, N(R⁹)₂, C₁-C₄ alkylthio, C₁-C₄ alkylsulphinyl, C₁-C₄ alkylsulphonyl, phenyl, benzyl, CO₂R⁷, CR⁸N—OR⁷ or NR⁹COR⁸, wherein the alkyl, cycloalkyl, phenyl and benzyl are optionally substituted by one or more groups independently selected from halogen, CN, C₁-C₄ alkyl, C₁-C₄-haloalkyl, C₁-C₄ alkoxy and C₁-C₄ haloalkoxy;
each R⁷ independently of one another represents hydrogen, C₁-C₈ alkyl, C₁-C₈ haloalkyl, C₃-C₈ alkenyl, C₃-C₈ haloalkenyl, C₃-C₈ alkynyl, C₃-C₈ haloalkynyl, C₁-C₄ alkylsulphonyl, C₁-C₄ haloalkylsulphonyl, phenyl, benzyl, or pyridyl, wherein the phenyl, benzyl and pyridyl are optionally substituted by one or more groups independently selected from halogen, CN, C₁-C₄ alkyl, C₁-C₄-haloalkyl, C₁-C₄ alkoxy and C₁-C₄ haloalkoxy;
each R⁸ independently of one another represents hydrogen, C₁-C₄ alkyl or C₁-C₄ haloalkyl;
each R⁹ independently of one another represents hydrogen or C₁-C₄ alkyl;
wherein when two radicals R⁹ are attached to the same nitrogen atom, these radicals can be identical or different;
and wherein when two radicals R⁹ are attached to the same nitrogen atom, these two radicals together with the nitrogen atom to which they are attached may form a cycle B-1, B-2, B-3, B-4 or B-5 wherein the cycle formed is optionally substituted by one or more groups independently selected from halogen, methyl and halomethyl.

4. A compound according to claim 1, wherein
R¹ represents hydrogen, C₁-C₄ alkyl, C₁-C₄ haloalkyl, phenyl or pyridin-2-yl, wherein the phenyl and pyridin-2-yl are optionally substituted by one or more groups independently selected from halogen, CN, methyl, halomethyl, methoxy and halomethoxy;
D¹ represents C—Y¹;
D² represents C—Y²;
D³ represents C—R⁶;
D⁴ represents C—R⁵;
R², R⁴, R⁵ and R⁶ independently of one another represent hydrogen, halogen, OH, CN, C₁-C₄ alkyl, C₁-C₄ alkoxy, C₃-C₆ alkenyloxy, C₃-C₆ cycloalkyl, N(R⁹)₂, phenyl or CO₂R⁷, wherein the alkyl, alkoxy, alkenyloxy, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;
or R⁴ and R⁵, R⁵ and R², or R² and R⁶, together with the fragment of the pyridyl ring to which they are attached may form a fully or partially unsaturated 6-membered carbocyclic ring optionally substituted by one or more groups independently selected from halogen, methyl and halomethyl;
X represents X-3;
Z³ and Z⁵ independently of one another represent CR¹⁰R¹¹ or C═CR¹²R¹³;
Z⁴ represents CR¹⁴R¹⁵ or C═CR¹²R¹³;
or Z⁴ and Z⁵ together represent a group selected from —CR¹⁰═CR¹¹— and —C≡C—;
each R¹⁰ and R¹¹ independently of one another represent hydrogen, halogen, CN, OH, C₁-C₄ alkyl or C₁-C₄ haloalkyl;
each R¹² and R¹³ independently of one another represent hydrogen, halogen, methyl or halomethyl;
each R¹⁴ and R¹⁵ independently of one another represent hydrogen, halogen, CN, OH, C₁-C₄ alkyl, C₁-C₄ haloalkyl, C₁-C₄ alkoxy or phenyl, wherein the phenyl is optionally substituted by one or more groups independently selected from halogen, CN, methyl, halomethyl, methoxy and halomethoxy;
or R¹⁴ and R¹⁵ together with the carbon atom to which they are attached may form a C₃-C₆ cycloalkyl group or a C₃-C₆ halocycloalkyl group;
wherein at least two of Z³, Z⁴ and Z⁵ are substituted only by hydrogen or Z⁴ and Z⁵ together represent —C≡C—;
Y¹, Y², and Y³ independently of one another represent hydrogen, halogen, OH, CN, C₁-C₄ alkyl, C₁-C₄ alkoxy, C₃-C₆ alkenyloxy, C₃-C₆ cycloalkyl, N(R⁹)₂, phenyl or CO₂R⁷, wherein the alkyl, alkoxy, alkenyloxy, cycloalkyl and phenyl are optionally substituted by one or more groups independently selected from halogen, CN, C₁-C₄ alkyl, C₁-C₄-haloalkyl, C₁-C₄ alkoxy and C₁-C₄ haloalkoxy;
A¹ represents cycle A-1, A-2 or A-4;
R¹⁸, R²⁰, R²¹ and R²² independently of one another represent hydrogen, halogen, OH, CN, C₁-C₄ alkyl, C₁-C₄ alkoxy, C₃-C₆ alkenyloxy, C₃-C₆ cycloalkyl, N(R⁹)₂, C₁-C₄ alkylthio, C₁-C₄ alkylsulphinyl, C₁-C₄ alkylsulphonyl, phenyl, phenyloxy, benzyl, benzyloxy, CR⁸N—OR⁷, or CO₂R⁷, wherein the alkyl, alkoxy, alkenyloxy, cycloalkyl, phenyl and benzyl are optionally substituted by one or more groups independently selected from halogen, CN, C₁-C₄ alkyl, C₁-C₄-haloalkyl, C₁-C₄ alkoxy and C₁-C₄ haloalkoxy;
each R⁷ independently or one another represents hydrogen, C₁-C₄ alkyl or C₁-C₄ haloalkyl;
each R⁹ independently of one another represents hydrogen or C₁-C₄ alkyl;
wherein when two radicals R⁹ are attached to the same nitrogen atom, these radicals can be identical or different;
and wherein when two radicals R⁹ are attached to the same nitrogen atom, these two radicals together with the nitrogen atom to which they are attached may form a cycle B-1, B-2, B-3, B-4 or B-5, wherein the cycle formed is optionally substituted by one or more groups independently selected from halogen, methyl and halomethyl.

5. A compound according to claim 1, wherein R¹ represents pyridyl, optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy, C₃-C₆ cycloalkyl and a 5- or 6-membered heterocycle containing one to three heteroatoms independently selected from O, S and N, providing that the heterocycle does not contain adjacent oxygen atoms, adjacent sulphur atoms, or adjacent sulphur and oxygen atoms.

6. A compound according to claim 1, wherein A² and R¹ represent pyridin-2-yl, optionally substituted by one or more groups independently selected from halogen, CN, NH₂, NO₂, OH, C₁-C₄-alkyl, C₁-C₄-haloalkyl, C₁-C₄-alkoxy, C₁-C₄-haloalkoxy, C₃-C₆ cycloalkyl and a 5 or 6-membered heterocycle containing one to three heteroatoms independently selected from O, S and N, providing that the heterocycle does not contain adjacent oxygen atoms, adjacent sulphur atoms, or adjacent sulphur and oxygen atoms.

7. A compound according to claim 1, wherein R¹ represents C₁-C₄ alkyl, C₂-C₄ alkenyl, phenyl or pyridyl, wherein the alkyl, alkenyl, phenyl and pyridyl are optionally substituted by one or more groups independently selected from halogen, CN, C₁-C₄ alkoxy and C₁-C₄ haloalkoxy.

8. A compound according to claim 1, wherein D¹ represents C—Y¹ and D² represents C—Y².

9. A compound according to claim 1, wherein R², R⁴, R⁵ and R⁶ independently of one another represent hydrogen, C₁-C₄ alkyl, CN or C₁-C₄ alkoxy, wherein the alkyl and alkoxy are optionally substituted by one or more groups independently selected from halogen, CN, C₁-C₄ alkoxy and C₁-C₄ haloalkoxy.

10. A compound according to claim 1, wherein X represents X-3 or X-5.

11. A compound according to claim 1, wherein X represents X-3.

12. A compound according to claim 1, wherein
X represents X-3;
Z³ and Z⁵ represent methylene;
Z⁴ represents CR¹⁴R¹⁵ or C═CR¹²R¹³;
each R¹² and R¹³ independently of one another represent hydrogen, halogen, methyl or halomethyl;
each R¹⁴ and R¹⁵ independently of one another represent hydrogen, halogen, CN, OH, C₁-C₄ alkyl, C₁-C₄ haloalkyl, C₁-C₄ alkoxy or phenyl, wherein the phenyl is optionally substituted by one or more groups independently selected from halogen, CN, methyl, halomethyl, methoxy and halomethoxy;
or R¹⁴ and R¹⁵ together with the carbon atom to which they are attached may form a C₃-C₆ cycloalkyl group optionally substituted by halogen.

13. A compound according to claim 1, wherein Y¹ and Y² independently of one another represent hydrogen, halogen, C₁-C₄ alkyl, CN or C₁-C₄ alkoxy, wherein the alkyl and alkoxy are optionally substituted by one or more groups independently selected from halogen, CN, C₁-C₄ alkoxy and C₁-C₄ haloalkoxy.

14. A compound according to claim 1,
wherein Y¹, Y² and Y³ independently of one another represent hydrogen, halogen, C₁-C₄ alkyl, CN or C₁-C₄ alkoxy, wherein the alkyl and alkoxy are optionally substituted by one or more groups independently selected from halogen, CN, C₁-C₄ alkoxy and C₁-C₄ haloalkoxy.

15. A compound according to claim 1, A¹ represents A-1, A-2 or A-4.

16. A compound according to claim 1, A represents A-1 or A-2.

17. A compound according to claim 2 wherein when A¹ is A-1 and D¹ is C—Y¹, then R²² and Y¹ together with the fragment to which they are attached may form a partially or fully unsaturated 5- to 7-membered carbocyclic ring or a partially or fully unsaturated 5- to 7-membered heterocyclic ring containing one to three heteroatoms independently selected from O, S, N and N(R⁹), providing that the heterocycle does not contain adjacent oxygen atoms, adjacent sulphur atoms, or adjacent sulphur and oxygen atoms, and wherein the ring formed by R²² and Y¹ is optionally substituted by one or more groups independently selected from halogen, CN, NH₂, NO₂, OH, C₁-C₄ alkyl, C₁-C₄ haloalkyl, C₁-C₄ alkoxy, C₁-C₄ haloalkoxy and C₁-C₄ alkylthio.

18. A compound of formula (VII) 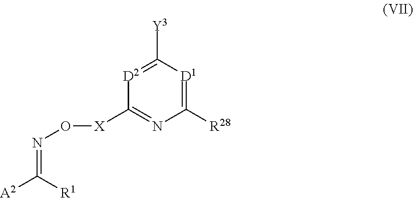
wherein R²⁸ is a halogen;
A², R¹, X, D¹, D² and Y³ are as defined for a compound of formula (I) in claim 1; or a salt or N-oxide thereof;
or a compound of formula (IX) 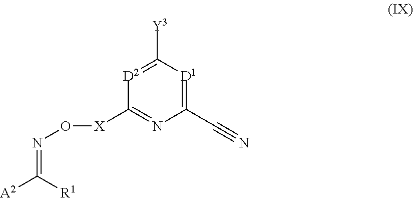
wherein A², R¹, X, D¹, D² and Y³ are as defined for a compound of formula (I) ine claim 1; or a salt or N-oxide thereof;
or a compound of formula (X) 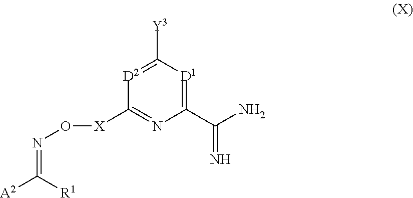
wherein A², R¹, X, D¹, D² and Y³ are as defined for a compound of formula (I) in claim 1; or a salt or N-oxide thereof;
or a compound of formula (XI) 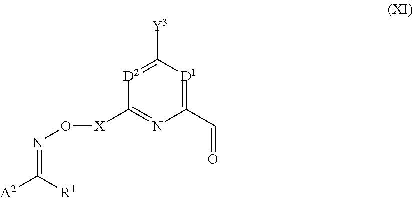
wherein A², R¹, X, D¹, D² and Y³ are as defined for a compound of formula (I) in claim 1; or a salt or N-oxide thereof;
or a compound of formula (XIII) 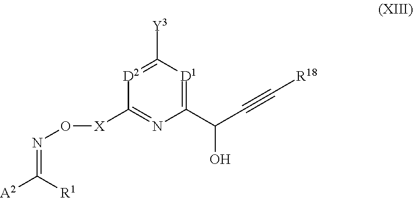
wherein A², R¹, X, D¹, D², Y³, and R¹⁸ are as defined for a compound of formula (I) in claim 1; or a salt or N-oxide thereof;
or a compound of formula (XIV) 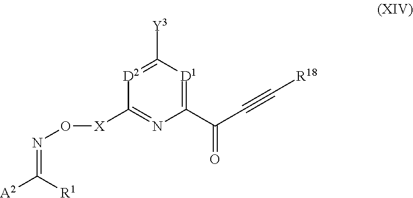
wherein A², R¹, X, D¹, D², Y³, and R¹⁸ are as defined for a compound of formula (I) in claim 1; or a salt or N-oxide thereof.

19. A compound according to compound (VII) according to claim 18 wherein R²⁸ represents chlorine, bromine or iodine.

20. A fungicidal composition comprising a fungicidally effective amount of a compound of formula (I) as defined in claim 1, optionally comprising at least one additional active ingredient.

21. A method of controlling or preventing phytopathogenic diseases on useful plants or on propagation material thereof, which comprises applying to the useful plants, the locus thereof or propagation material thereof a fungicidally effective amount of a compound of formula (I) as defined in claim 1.
